(19) United States
(12) Patent Application Publication
(10) Pub. No.: US 2026/0275109 A1
(43) Pub. Date: Sep. 17, 2026

(54) TUNABLE BIOCOMPOSITE MATERIALS AND RELATED PARTICULATE, COMPOSITIONS, METHODS AND SYSTEMS

(71) Applicants: CALIFORNIA INSTITUTE OF TECHNOLOGY, Pasadena, CA (US); UT-BATTELLE, LLC, Oak Ridge, TN (US)

(72) Inventors: Helen E Wexler, Pasadena, CA (US); Anthony R Stephen, Pasadena, CA (US); Chiara Daraio, Pasadena, CA (US); Xianhui Zhao, Knoxville, TN (US)

(21) Appl. No.: 19/359,530

(22) Filed: Oct. 15, 2025

Related U.S. Application Data
(60) Provisional application No. 63/710,928, filed on Oct. 23, 2024.

(51) Int. Cl. C08L 89/00; C08J 3/12; C08K 5/00; C08K 5/1545; C08K 11/00; C08L 63/00

(52) U.S. Cl. CPC C08L 89/00; C08J 3/126; C08K 5/0016; C08K 5/1545; C08K 11/005; C08L 63/00; C08J 2389/00; C08J 2463/00; C08L 2205/06; C08L 2205/16; C08L 2207/53; C08L 2312/00

(57) ABSTRACT

Methods for engineering a tuned biocomposite, engineered bio-powders used therein, and the resulting biocomposite, are described, as well as method for engineering the biopowder and related devices methods and systems The engineered bio-powder comprises discrete particles derived from a dried biomass and is characterized by a specific biochemical composition of protein, lipid, and carbohydrate content, as well as by a controlled particle aspect ratio distribution. The method for engineering the biopowder comprises pulverizing the biomass to achieve a target particle morphology, such as a granular powder for stiffness or a filamentous powder for toughness, and then consolidating the powder via an aqueous plasticization or a thermo-mechanical route. The method for engineering the biopowder and/or to manufacture the biocomposite from the engineered biopowder can include incorporating additives, such as fillers, and applying surface treatments, like a bio-epoxy coating, to engineer interfacial adhesion.

### CROSS REFERENCE TO RELATED APPLICATIONS

The present application claims priority to U.S. Provisional Application No. 63/710,928 entitled “Biomaterial From Algae With Plant Residue Reinforcement Using A Compression Method” filed Oct. 23, 2024 with Docket No. CIT 9225-P, which is incorporated herein by reference in its entirety. The present application is also related to international PCT application S/N PCT/US25/51125 entitled “Tunable Biocomposite Materials And Related Particulate, Compositions, Methods And Systems” filed on Oct. 15, 2025 with docket number P3292-PCT, which is incorporated by reference in the present disclosure in its entirety.

### STATEMENT OF GOVERNMENT GRANT

This invention was made with government support under Grant No. 2330702 awarded by the National Science Foundation and under Grant No. DE-AC05-00OR22725 awarded by the US Department of Energy. The government has certain rights in the invention.

### FIELD

The present disclosure relates to a biocomposite material and related, particulate, compositions, devices, methods and systems. In particular, the present disclosure relates to materials combinations and methods to produce tunable biocomposites from biological material and related compositions methods and systems which can be provided from a sustainable source including plant cells, algae, and agricultural waste.

### BACKGROUND

The emerging need for materials that are sustainable from an environmental point of view has led to the introduction of biological polymers and fibers in composites to limit the amount of non-degradable components and reduce their impact on the environment.

Despite efforts in providing new sustainable materials, the ability to predictably tune or control the final properties of a biocomposite from a given feedstock is highly desired, yet remains a significant challenge and so is developing with developing materials with controlled physical and mechanical properties from an environmentally sustainable source.

### SUMMARY

Described herein are tunable biocomposites and related biopowder, compositions, methods, and systems for providing sustainable materials with predictable and controllable material properties.

The tunable biocomposites of the disclosure are obtained following the operation of protein percentage (%), the lipid percentage (%), the carbohydrate percentage %, as well as powder aspect ratio distribution and the mean particle volume of an engineered powder derived from a dry biomass. In particular, the engineered powder derived from a dry biomass have a composition and morphology configured for fabricating a bio-composite with at least one tuned material properties selected from selected from a mechanical property, thermal stability and barrier function of the bio-composite.

According to a first aspect, a method for engineering bio-powder for fabricating a tuned bio-composite, the method comprising: a) providing a dried feedstock biomass having a dried feedstock biomass composition including biomass protein %, biomass lipid % and biomass carbohydrate %; and b) processing the dried feedstock biomass.

In the method processing the dried feedstock biomass comprises:
i. based on at least one tunable property of the bio-composite, pulverizing the dried feedstock biomass to provide discrete particles; alone or optionally in combination with
ii. chemically modifying the dried feedstock biomass; and/or
iii chemically modifying the discrete particles,
In the method, the processing is performed to obtain engineered bio-powder having an engineered bio-powder composition including powder protein %, powder lipid %, powder carbohydrate %, powder aspect ratio distribution and a mean particle volume ranging from 1.0×10² μm³ to 1.0×10⁷ μm³ and in some preferred embodiments from 1.0×10³ μm³ to 1.0×10⁶ μm³.

In the method, the powder protein %, the powder lipid %, the powder carbohydrate %, the powder aspect ratio distribution and the mean particle volume ranging from 1.0×10² μm³ to 1.0×10⁷ μm³ and in some preferred embodiments from 1.0×10³ μm³ to 1.0×10⁶ μm³, are configured for fabricating the tuned bio-composite.

In the method, the least one tunable property of the bio-composite is selected from a mechanical property, thermal stability and barrier function of the bio-composite.

According to a second aspect, an engineered bio-powder for fabricating a tuned bio-composite, the bio-powder comprising a plurality of discrete, multi-cell particles derived from a dried feedstock biomass, wherein the engineered bio-powder has a composition comprising: a) a powder protein content, a powder lipid content, and a powder carbohydrate content, wherein each content is a percentage of the dry weight of the particles; b) a powder aspect ratio distribution; and c) a mean particle volume ranging from 1.0×10² μm³ to 1.0×10⁷ μm³ and in some preferred embodiments from 1.0×10³ μm³ to 1.0×10⁶ μm³.

In the engineered bio-powder the composition is configured to fabricate a tuned bio-composite having at least one tunable property selected from a mechanical property, thermal stability, and a barrier function.

According to a third aspect, a method is described for coating particles for use in a biocomposite to improve interfacial resistance. The method comprises: a) providing a plurality of particles selected from the group consisting of an engineered bio-powder of herein described, a filler, and combinations thereof; and b) preparing a coating solution comprising an epoxy resin and a hardener dissolved in a solvent. The method further comprises c) applying the coating solution to the plurality of particles to form coated particles; and d) drying the coated particles to remove the solvent, and e) curing the coating of the coated particle.

According to a third aspect, a coated particle composition for fabricating a tuned bio-composite is described. The composition comprises a plurality of particles selected from the group consisting of an engineered bio-powder herein described, a filler, and combinations thereof; in the composition the plurality of particles is coated with a layer of an epoxy system comprising an epoxy resin and a hardener. In some embodiments the layer of epoxy resin and a hardener can be dried.

According to a fifth aspect, a method is described for fabricating a tuned bio-composite using an aqueous plasticization route, the method comprising: a) providing an engineered bio-powder, the bio-powder having a composition including a powder protein content, a powder lipid content, a powder carbohydrate content, a powder aspect ratio distribution, and a mean particle volume, wherein the composition is configured for fabricating the tuned bio-composite with at least one tunable property;

The method further comprises b) rehydrating the engineered bio-powder with a predetermined amount of water to form a plasticized, moldable paste.

The method also comprises c) compressing the moldable paste at a temperature below 100° C. to consolidate particles of the paste into a monolithic body.

The method additionally comprises d) drying the monolithic body under conditions and for a time sufficient to remove the water, wherein removal of the water causes formation of hydrogen bonds between adjacent particle surfaces to form the tuned bio-composite having the at least one tunable property.

According to a sixth aspect a method is described for fabricating a tuned bio-composite using a thermo-mechanical route. The method comprises a) providing an engineered bio-powder, the bio-powder having a composition including a powder protein content, a powder lipid content, a powder carbohydrate content, a powder aspect ratio distribution, and a mean particle volume, wherein the composition is configured for fabricating the tuned bio-composite with at least one tunable property;

The method further comprises b) optionally, blending the engineered bio-powder with a dry filler powder to form a blended powder.

The method also comprises c) consolidating the engineered bio-powder or the blended powder by: i. subjecting the powder to a pressure and a temperature simultaneously in a mold to cause thermal fusion of particles of the powder at their contact points; and ii. cooling the fused particles under pressure to form the tuned bio-composite having the at least one tunable property. The pressure and temperature can be selected in view of the composition of the powder and the presence and chemical composition of the filler as will be understood by a skilled person upon reading of the disclosure.

According to a seventh aspect, a tuned bio-composite is described, The tuned biocomposite comprises: a monolithic body comprising a plurality of consolidated, discrete, multi-cell particles derived from a dried feedstock biomass, the particles being self-adhered to one another at interfacial boundaries, wherein the monolithic body has a water content of less than 15 wt % and is poreless or having pores with a diameter of less than 10 μm.

In the tuned biocomposite the plurality of consolidated, discrete, multi-cell particles is characterized by a composition comprising: a) a protein content, a lipid content, and a carbohydrate content, wherein each content is a percentage of the dry weight of the particles; b) a particle aspect ratio distribution; and c) a mean particle volume of said discrete multicell particles ranging from 1.0×10² μm³ to 1.0×10⁷ μm³ and in some preferred embodiments from 1.0×10³ μm³ to 1.0×10⁶ μm³.

The tuned biocomposite the composition of the consolidated particles provides the tuned bio-composite with at least one tunable property selected from a mechanical property, thermal stability, and a barrier function.

The tunable biocomposites and related materials, compositions, methods and systems herein described, represent a paradigm shift from approaches where the biocomposite is provided from a feedstock biomass because they require engineering a dry biomass to provide a bio-powder with composition and morphology selected to fabricate a bio-composite with at least one material properties tuned as a result of the bio-powder composition and morphology.

The tunable biocomposites and related materials, compositions, methods and systems herein described, represent a paradigm shift from the conventional approach to creating biocomposites, because the properties of the resulting biocomposite result from the engineering of the particles that constitute the matrix itself with no need for a separate binder. Even if additives such as binders and fillers can be advantageously used, the biomass particles of the present disclosure are engineered to provide a self-adhering matrix within a monolithic solid as will be understood by a skilled person upon reading of the present disclosure.

The tunable biocomposites and related materials, compositions, methods and systems herein described, allow in several embodiments the fabrication of biocomposites that can be specifically tailored for a desired performance characteristic, such as high toughness or high stiffness, by controlling the biochemical composition and particle morphology of the feedstock preprocessed in a powdered form.

The tunable biocomposites and related materials, compositions, methods and systems herein described, allows in several embodiments to provide biocomposites with predictable and controllable material properties based on the initial selection of starting biomass feedstock as well as the biochemical composition and particle morphology of the derived biopowder.

The tunable biocomposites and related materials, compositions, methods and systems herein described, allows in several embodiments to provide biocomposites with predictable and controllable material properties that can be used as in a variety of application, such as construction materials packaging material, furniture material, automotive materials for the interior of vehicles, with a positive environmental impact by generating large quantities of the material, from renewable sources such as recycled and waste bioproducts.

The tunable biocomposites and related materials, compositions, methods and systems herein described, are designed in several embodiments to transform abundant and inexpensive waste streams, such as wastewater-derived algae and agricultural residues like switchgrass and almond shells, contaminated food grade algae, nutraceutical algae, or wild algae-into high-performance, value-added materials. This supports a circular bioeconomy by creating value from materials that would otherwise be discarded.

The tunable biocomposites and related materials, compositions, methods and systems herein described, allows in several embodiments to provide biocomposites with predictable and controllable mechanical properties without need for treatment with a chemical (e.g. solvent/acid/base) treatment and/or addition of adhesives.

The tunable biocomposites and related materials, compositions, methods and systems herein described, allows in several embodiments to actively engineer the interface, between the biomaterial matrix and agricultural fillers, to improve poor stress transfer, mitigating fiber pull-out and significantly increasing both the strength and stiffness of the final composite as will be understood by a skilled person upon reading of the present disclosure.

The biocomposites and related materials, compositions, methods and systems herein described, can be used in connection with any applications wherein an environmentally sustainable material having mechanical properties comparable or superior to existing fossil-based material is desired. Exemplary applications comprise materials for construction and/or insulation, (such as panels and bricks), as well as various types of packaging material including single use packaging material (e.g. food containers, make up containers), multi-use packaging material, such as plastic and wood alternative (e.g. plastic cafeteria trays, furniture, clothes hangers, flower pots, coffins), small scale packaging (e.g. small volume, small production batches), packaging material not requiring waterproof properties, waterproof material. Additional applications comprise automotive: door panels, interior trim, seat backs, and dashboard components, acoustic applications, 3D printing filaments, medical applications (disposable trays and packaging) and additional identifiable by a skilled person. Additional uses and application applications are also identifiable by a skilled person.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a schematic flowchart illustrating an exemplary method for fabricating a tuned bio-composite material in accordance with the disclosure.

FIG. 2 shows schematic representation of biocomposite fabrication workflow and Representative Samples: (1) Dry biomaterials are sourced (algae and agricultural residues). (2) Comminution: feedstocks are size-reduced using a blade grinder until a fine powder is obtained. (3) Sieving: ground powders are sieved with a 40 mesh sieve to exclude oversized particles. (4) Blending: sieved powders are homogenized in a high-shear speed mixer to combine algae with agricultural residues, forming a uniform mixture. (5) Compression molding: blended powders are compacted into cylindrical forms under controlled pressure. (6) Extract and measure: molded samples are demolded, measured for physical dimensions (height in mm±SD, SD=standard deviation) and density (g cm⁻³±SD), and prepared for further testing. Right panel: representative biocomposite specimens fabricated from Chlorella, Tribonema, Hilmar, and Delhi feedstocks, with annotated dimensions.

FIGS. 3-8 show charts and pictures reporting particle-scale statistics and resulting surface textures for electric-ground algae powders: in particular, FIG. 4 Correlations between arithmetic mean surface roughness Rₐ of compression-molded panels and FIG. 3 mean profile element spacing R_{Sm}, peak-to-valley amplitude R_{z}. FIG. 5 Kernel-density estimates (Gaussian bandwidth 0.15) of particle aspect ratio (horizontal Feret diameter divided by vertical Feret diameter) extracted from more than 18,000 fragments per strain. FIG. 6 Cumulative-distribution functions (CDFs) of the same aspect-ratio data; the y-axis gives the fraction of particles with aspect ratio less than or equal to x. FIG. 7 Violin plots (99th percentile trimmed, central line=median) comparing, from left to right, particle volume, aspect ratio, and specific surface coefficient (surface area divided by cross-sectional area) among the four algae. FIG. 8 Representative thresholded optical micrographs illustrate the fragment morphologies that underlie the distributions in 3-7 (scale bar 400 μm).

FIGS. 9-11B show charts and schematics reporting the mechanical and surface characterization of exemplary pure algal biomaterials: In particular, FIG. 9 Maximum force at failure, FIG. 10 and Young's modulus of single-strain biomaterials (Chlorella, Tribonema) and multi-strain biomaterials (Delhi, Hilmar). Data represent mean±SD (n≥4). FIG. 11B Representative stress strain curves from compression testing, highlighting differences in stiffness and maximum load among the four strains. FIG. 11A Static water contact angle measurements on biomaterial surfaces indicate relative hydrophobicity: Tribonema (65°), Chlorella (88°), Delhi (102°), and Hilmar (107°).

FIG. 12 shows 16S PCR DNA extraction of the eukaryotes of Tribonema, Chlorella, Delhi and Hilmar. Phylum is the taxonomic level.

FIGS. 13-15 show micrographs reporting the microstructural characterization of exemplary Algal Biomaterials: in particular, FIG. 13 SEM micrographs featuring the fracture surfaces for single-strain (Tribonema, Chlorella) and multi-strain (Hilmar, Delhi) biomaterials (200 and 20 μm scale bars) FIG. 14 Optical micrographs of internal fracture surfaces (800 μm scale bar), showing heterogeneous textures across strains. FIG. 15 Optical micrographs of exterior sample surfaces (100 μm scale bar), with arrows marking distinct features such as filamentous algae fibers, algae geometry, or voids.

FIGS. 16-18 show charts reporting the results of a Comparison of Experimental and Theoretical Predictions of exemplary Composite Modulus of biocomposites in accordance with the disclosure In particular FIG. 16 Ishai-Cohen model predictions for the effective composite modulus of algae-biomass composites (Chlorella, Delhi, Hilmar, Tribonema matrices with almond shell or switchgrass reinforcement). Literature values (Liu et al 2017) (Pfister and Laroc 2013) and weighted averages are included for reference. Across all models, theoretical predictions overestimate stiffness compared to experimental data. The experimentally measured moduli of the algal-fiber composites lie below classical micromechanics predictions that assume perfect particle-matrix bonding. These bounds represent ideal two-phase, void-free, cube-in-cube geometries and therefore tend to over-predict stiffness for natural-fiber systems that experience interfacial slip, porosity, graded interphases, and non-uniform particle morphology. FIG. 17 Comparison of Experimental Results and Theoretical Predictions of Composite Modulus: Lollipop plot comparing theoretical Ec from Rule-of-Mixtures, Halpin-Tsai, Ishai-Cohen, and Counto theoretical models with experimental Ec for Hilmar/SG-B-II (as-received, +epoxy, dried +epoxy). FIG. 18 Adhesion-factor curves Ec (Kadhesion) from the cube-in-cube framework is an extension of the Ishai-Cohen theoretical model; epoxy treatments shift both switchgrass and almond composites to higher Kadhesion and Ec. Kadhesion ranges from 0 to 1 and scales the effective stress-transfer area of the inclusion, so values below 1 capture imperfect bonding without altering Ef, Em, or Vf, whereas 1 represents perfect adhesion. Applying the adhesion-factor analysis to Hilmar matrices with switchgrass or almond substrates shows that untreated composites occupy lower Kadhesion and lower Ec. Epoxy treatment increases Kadhesion and Ec, and drying plus epoxy shifts the materials further along the adhesion curve to still higher Kadhesion and Ec. The gap between idealized models and experiment is expected for natural-fiber systems that lack perfect interfaces, but the interface can be tangibly improved through epoxy pre-treatment of the fibers.

FIGS. 19-25 show charts micrographs and schematics reporting results of experiments illustrating the influence of agricultural waste fillers on algae-based biocomposites: FIG. 19 Classification of agricultural, herbaceous, and woody waste fillers (almond, corn stover, switchgrass, pine) and distinguishing features such as particle size, particle shape, supplier, and plant part showing that representative fillers were selected for experimentation. FIG. 21 Compressive strength and Young's modulus of Hilmar algae composites (50-50% by weight ratio) fabricated with different fillers, showing enhanced stiffness and strength with herbaceous residues such as switchgrass, compared to almond and pine. The compressive strength is not just influenced by the fiber size, as evidence by the fact that SW-B-III is smaller particle size than almond and still has better performance. But particle size is one factor, because the lower aspect ratio small particle SW-B-III performs worse than other switchgrass fillers with higher aspect ratios. FIG. 20 Surface roughness parameters (Rₐ, R_{q}, R_{Sm}) quantified by profilometry, revealing microstructural differences in filler morphology. FIG. 22 Contact angle measurements highlighting hydrophobicity variations across fillers. In particular FIG. 22 shows the contact angle of Hilmar fiber composites fabricated with the 277 MPa force setup, with dirty pine, corn stover II, switchgrass II and almond. All composites are 50% Hilmar 50% varied fiber by weight. FIG. 23 Microstructural characterization by SEM showing interfacial features and filler distribution within Hilmar algae composites reinforced with switchgrass and FIG. 24 showing interfacial features and filler distribution within Hilmar algae composites reinforced with almond. FIG. 25 Microstructural characterization by SEM of epoxy treated switchgrass in a Hilmar-switchgrass composite showing increased filler matrix adhesion and fiber embedding with epoxy treatment. FIG. 25 SEM images of interfacial behavior: top shows algae adhesion to switchgrass fibers when bio-epoxy is used; bottom shows fiber retention (fiber remains embedded in the algae matrix), contrasting with the pull-out voids observed in FIG. 23.

FIGS. 26, 27 and 28 show charts and schematics Mechanical Properties of Hilmar Switchgrass and Hilmar Almond Biocomposites. In particular, FIG. 26 Maximum compressive stress and Young's modulus for SG II and almond fillers in three conditions: as received, epoxy coated, and dried+epoxy coated (mean±SD; n≥4). FIG. 27 Surface profilometry distributions (Sₜᵣ, S_{dr}, Sₐ) for switchgrass and almond fillers; FIG. 28 3D profilometry topography maps illustrating the surface roughness of the ‘as received’ fillers and bioepoxy treated fillers for both almond and switchgrass hilmar blended (50-50 ratio by weight) composites.

FIG. 29 shows a schematic representation of an exemplary biocomposite fabrication system of the instant disclosure.

FIGS. 30-35 show charts and micrographs illustrating the characterization of exemplary As-Received Agricultural Fillers Used in Algal Biocomposites: FIGS. 30-33 The Kernel Density Estimates (KDE) of particle volume (left) and aspect ratio (right) for agricultural wastes employed as fillers. FIG. 30 Switchgrass (three as-received batches plus KSW reference), showing variability between suppliers and particle size distributions. FIG. 31 Pine (clean vs. dirty), representing woody biomass fractions derived from different plant parts. FIG. 32 Corn stover (two batches plus KCS reference), illustrating supplier-dependent differences and particle size distributions. FIG. 33 Almond shells, chosen for their distinct particle morphology compared to herbaceous and woody feedstocks. FIG. 34 Representative optical micrographs (100 μm scale bars) of filler particles, highlighting natural differences in geometry and surface features between switchgrass and almond. FIG. 35 Surface profilometry results (mean±SD of Rₐ, R_{Sm}, and R_{z}) demonstrating characteristic roughness signatures for each biomass type.

FIGS. 36-39 show charts and micrographs reporting the Mechanical and Microstructural Properties of exemplary algae-agricultural waste composites: In particular, FIG. 36 Compressive stress (left) and Young's modulus (right), as a function of almond filler content (30%, 50%, 70%), for composites fabricated with four algal matrices (Chlorella, Delhi, Hilmar, Tribonema). FIG. 37 Comparison of composites reinforced with 50% switchgrass, showing superior mechanical properties with Hilmar and Tribonema matrices. FIG. 38 Surface profilometry maps of switchgrass-reinforced composites fabricated with different algal strains, revealing distinct roughness signatures associated with each algae-biomass interface. FIG. 39 Optical micrographs (50 μm scale bars) of algae switchgrass composite.

FIGS. 40-44 show charts, micrographs and schematics illustrating structural and mechanical behavior of exemplary Hilmar-Switchgrass composites: In particular, FIG. 40 Compressive stress and Young's modulus of 50:50 (by weight) Hilmar composites reinforced with switchgrass II or almond, comparing aligned and orthogonal fiber orientations. FIG. 26 Variation of compressive strength (kN) and Young's modulus (MPa) as a function of Hilmar-to-switchgrass ratio (by weight). Data points correspond to composites with algae: SG ratios of 70:30, 60:40, 50:50, 40:60, and 30:70, alongside the pure Hilmar baseline. C Schematic of the two compression test directions, orthogonal to the fabrication compression direction and aligned with it. FIGS. 43 and 44 Representative fracture morphologies after compression testing. FIG. 42: Photo of cube sample used for used for anisotropy testing with arrows demonstrating loading conditions for anisotropy testing. FIG. 43 photo of fracture after loading parallel to the fabrication compression direction, producing fragmentation. FIG. 44: photo of fracture after loading orthogonal to the fabrication compression direction, producing delamination of layered structures. FIG. 41 Bar graph showing the relationship between switchgrass loading percentage and compressive strength, with increased surface roughness (S_{dr}) correlating with reduced strength.

FIG. 45 (top row) shows an example Biomaterial Sample Fabrication Workflow (1) Algae biomass is extracted from raceway tanks, sun dried (Tribonema) or freeze dried (Chlorella), and the dry biomass is obtained. (2) Dry-powder comminution: Algal biomass is size-reduced by one of three methods: (2.A) planetary ball-milling, (2.B) high-shear speed-mixing, or (2.C) granite mortar-and-pestle, until a fine powder is obtained. (3) Particles are sieved to exclude oversized granules (4) Rehydration: Crushed powders are mixed with deionized water at optimized weight ratios (see Methods) to form a homogeneous slurry. (5) Overhead mixing: Slurries are stirred at 25 rpm for 15 min in a temperature-controlled oil bath to ensure uniform dispersion. (6) Compression molding. (7) Desiccation: demolded samples are dried under vacuum in a desiccator for 15 days to remove residual moisture and reduce cracking.

FIG. 45 (bottom row) shows an example Compression molding of binder-free biomaterial composites. Slurry is cast into porous aluminum molds (6.A) and subjected to a stepwise pressure ramp (6.B) (10 psi→20 psi→40 psi→80 psi over 4 hours), then held at peak pressure for 20 hours until they are demolded at 24 hours (6.C). Image at right shows image and dimensions of typical fabricated samples.

FIGS. 46-51 show example Physicochemical Characterization of Algal Feedstock: FIG. 46 Optical photographs of 10 g dry algal biomass prior to comminution, with Chlorella (left) and Tribonema (right), imaged at identical scale (2 cm). Showing that Tribonema algae is orders of magnitude larger than Chlorella at the start of the process, and thus it necessitates more premolding processing. FIG. 47 Mean sphere diameter (μm) following ball mill, mortar-and-pestle, and speed mixer comminution for both Tribonema and Chlorella. For Chlorella there is also a measurement of the mean sphere diameter prior to comminution (Tribonema was too large to measure using the same consistent methodology). FIG. 48 Airyscan fluorescence microscopy (bottom) and corresponding bright-field (BF) micrographs (top) showing cell morphology of Chlorella (left) and Tribonema (right); scale bars as annotated. FIG. 49 Surface roughness distributions derived from optical profilometry of particles. Top: maximum profile height (Sz, μm); Bottom: arithmetic mean height (Sₐ, μm), averaged across all Chlorella samples and all Tribonema samples. FIG. 50 TGA mass-loss curves (25° C.→250° C. at 10° C. min-1, N2), capturing moisture loss and thermal decomposition behavior of Chlorella (light grey) and Tribonema (darker grey) powders. FIG. 51 FTIR spectra of Chlorella and Tribonema powders (dotted lines) and bulk materials (full lines).

FIGS. 52 to 55 show example Morphological and Topographic Characterization of Algal Powders and Biomaterials: FIG. 52 BF micrographs of dry algal powders processed via ball mill, mortar-and-pestle, or speed mixer. Top row: Chlorella powders; middle row: Tribonema powders at intermediate magnification; bottom row: higher-magnification images of Tribonema highlighting different fibrous structure. FIG. 53 3D topography maps of individual Tribonema powder particles following ball milling (left), mortar-and-pestle (center), and speed mixing (right). Rendered maps show particle height ranges up to 2500 μm. FIG. 54 3D surface profilometry maps of compression-molded biomaterial surfaces for Chlorella (top row) and Tribonema (bottom row) under each comminution condition. Scale bars and grayscale depth reflect height variations from 0 to 75 μm. FIG. 55 Summary statistics comparing surface roughness of Tribonema (dark gray) and Chlorella (light gray) of bulk biomaterials, averaged across all preprocessing techniques. Metrics include Spc (arithmetic mean peak curvature), Rₐ (arithmetic mean profile height), S_{dr} (developed interfacial area ratio), and Sₐ (arithmetic mean surface height); data are reported as distributions with corresponding mean±standard deviation.

FIG. 56 is a chart showing the post-molding volumetric shrinkage of Chlorella and Tribonema biomaterials over a 15-day drying period, comparing the effects of different comminution methods on the volume of the bulk biocomposites. In particular, the illustration of FIG. 56 shows a post-molding volumetric shrinkage (mm³; mean±SD; n=5) of Chlorella (light grey) and Tribonema (dark grey) biomaterials measured over a 15-day drying period for each comminution method: ball mill (left), mortar & pestle (center), and speed mixer (right). Timepoints include immediate demolding (t=0), 24 h, 72 h, 5 d, 7 d, 9 d, 11 d, 13 d, and 15 d.

FIG. 57 provides representative images showing the top and side views of fully dried biomaterial panels, with annotated average final dimensions for specimens made from Chlorella and Tribonema processed by ball mill, mortar & pestle, and speed mixer (n=to 5). In particular the illustration of FIG. 57 shows images of fully dried biomaterial panels (top and side views) showing average post-drying dimensions for Chlorella (top row) and Tribonema (bottom row) processed by ball mill, mortar & pestle, or speed mixer. Length and height values reflect the mean of five specimens per condition. Chlorella panels ranged from 38.14-38.42 mm in length, 11.15-12.48 mm in top-view height, and 4.86-4.92 mm in side-view height. Tribonema panels ranged from 35.84-36.52 mm in length, 9.56-9.68 mm in top-view height, and 4.48-4.68 mm in side-view height.

FIGS. 58 to 61 show example Surface Wettability and Density Evolution of Bulk Algal Biomaterials: FIG. 58 Representative sessile-drop profiles used to extract static contact angles (0) for panels fabricated from Chlorella (left trio) and Tribonema (right trio) after speed-mixing, ball-milling, or mortar-and-pestle comminution. FIG. 59 Summary of wettability. Mean contact angle±SD (n=3 droplets, 2 μm of water) for the six panel types; error bars reflect inter-specimen variability. FIG. 60 Average density by algal strain and comminution method (g/cm 3, mean±SD, n=5). FIG. 61 Density of Chlorella by comminution method: solid, dashed, and dotted lines correspond to ball-milled, mortar-ground, and speed-mixed biomaterial preprocessing techniques, respectively.

FIGS. 62 to 69 show example Mechanical and Morphological Characterization of Algal Biomaterials by 3-Point Bending. FIG. 62 Schematic of the 3-point bending specimen (cross-section: 5 mm×11 mm; length: 37 mm; support span: 26 mm), with accompanying photograph showing sample mounted on the testing fixture. FIG. 63 Force-displacement curves (mean±SD, n=5) for biomaterials fabricated with speed mixing, comparing Tribonema (dark gray) and Chlorella (light gray). FIG. 64 Force-displacement curves for mortar-and-pestle processing. FIG. 65 Force-displacement curves for ball mill processing. FIG. 66 Flexural modulus (MPa) for each algae and comminution method, derived from the initial slope of the linear elastic region. FIG. 67 Flexural strength (MPa) calculated from peak force and specimen geometry. FIG. 68 Flexural stiffness (kN/mm2), representing resistance to deformation under bending load. FIG. 69 Maximum force (N) sustained before failure for each biomaterial condition.

FIGS. 70-72 show example Surface and Fracture Morphology of Algal biomaterials: FIG. 70 Optical micrographs of as-molded biomaterial surfaces for Chlorella (left) and Tribonema (right), fabricated via ball milling, mortar-and-pestle, and speed mixing. FIG. 71 Optical micrographs of fracture surfaces from biomaterial specimens for each algae and preprocessing method. Scale bar=500 μm. FIG. 72 SEM micrographs of the fracture cross-sections at 500×(top) and 5,000×(bottom) magnification. Chlorella-derived samples are shown on the left; Tribonema-derived samples on the right. The SEM results suggests that gentler comminution (ball mill or mortar-and-pestle) preserves Tribonema's filamentous network, enabling fiber pull-out and enhanced toughness, whereas aggressive speed mixing erodes this advantage and yields a microstructure that resembles the more granular Chlorella matrix. Conversely, Chlorella's spherical particles are largely insensitive to comminution severity; speed mixing simply compacts them into a smoother, denser fracture surface, which helps explain the convergence of mechanical performance between the two algae under high-shear processing.

FIG. 73 Surface roughness definition: illustration showing how arithmetical mean height Rₐ is calculated.

FIG. 74 Surface roughness definition: illustration showing how maximum height of the profile R_{z}.

FIG. 75 Surface roughness definition: illustration showing how mean Width of the profile elements R_{Sm}.

FIG. 76 is a bar chart comparing the mean thermal conductivity of Chlorella and Tribonema algal powders. In particular, the bar char of FIG. 76 reports the thermal conductivity of unprocessed algal powders Tribonema (dark gray) and Chlorella (light gray). Tribonema (dark gray) powder demonstrated a slightly higher thermal conductivity (0.094=0.003 W m⁻¹ K⁻¹) compared to the Chlorella (light gray) powder (0.085=0.002 W m⁻¹ K⁻¹)

FIG. 77 is a chart illustrating the microbial community composition of the Chlorella and Tribonema feedstocks based on 16S and 18S rRNA gene sequencing, reported as phylum-level relative abundance.

FIG. 78 is a thermogram from Differential Scanning calorimetry (DSC) for an unprocessed Tribonema powder sample, showing specific heat flow as a function of temperature.

FIG. 79 is a thermogram from Differential Scanning calorimetry (DSC) for an unprocessed Chlorella powder sample, showing specific heat flow as a function of temperature.

FIG. 80 shows examples of algae/switchgrass composites made from different algae strains.

FIG. 81 shows an example ultrasonic bath used to pre-process algae, optionally in the presence of filler materials such as rubber.

FIG. 82 shows an example planetary mill (right-closed, left-open).

FIG. 83 shows an example speed mixer.

FIG. 84 shows an example cryomill.

FIG. 85 shows an example carver press for compression molding.

FIG. 86 shows an example extruder with hopper.

FIG. 87 shows an example blade grinder/coffee grinder.

### DETAILED DESCRIPTION

Described herein is a tunable biocomposite and the related compositions, methods, and systems based on cultured algal and/or plant cells.

The term “composite” or “composite material” as used herein indicates a material made from two or more constituent materials with significantly different physical or chemical properties that, when combined, produce a material with characteristics different from the individual components. In a composite material, the individual components remain separate and distinct within the finished structure, differentiating composites from mixtures and solid solutions. Exemplary composite materials with a polymer main component (also called matrix) are found in the 2 provided references, mixed with different types of filler additives. (A. C. Balazs, T. Emrick and T. P. Russell, 2006; Kinloch et al., 2018). They combine high specific mechanical properties at low densities with processability, making them essential in widespread applications, from automotive to sports goods and robotics.

The term “biocomposite” as used herein indicates a composite material in which the two or more constituent materials with significantly different physical or chemical properties of biological origin (herein also biomaterials). Typically, the two materials comprise a rigid biomaterial in a matrix. The rigid biomaterial can be of various biological origins and in particular can be derived from plants, such as fibers from crops (e.g. cotton, flax or hemp), recycled wood, waste paper, crop processing byproducts or regenerated cellulose fiber (e.g. viscose/rayon). In biocomposites, the rigid biomaterial and its configuration are typically mainly responsible for the mechanical properties of the biocomposite while the matrix typically protects the rigid biomaterial from environmental degradation and mechanical damage, and holds the rigid biomaterial together and to transfer the loads on it.

Exemplary biocomposite in the sense of the disclosure can be formed living matter, at an organism or cellular level, to serve as the main component, or assemble the main component such as the biocomposite reviewed and classified as Engineering Living Materials, ELM (Nguyen et al., 2018). Within ELM, composites created from living organisms and synthetic nanomaterials, can give rise to another sub-category, nanobionics or bionicomposites, described e.g. in Pugno and Valentini, 2019. L. Valentini et al., 2016; Luca Valentini et al., 2016, Di Giacomo, Maresca, Angelillo, et al., 2013; Di Giacomo, Maresca, Porta, et al., 2013; Di Giacomo, Daraio and Maresca, 2015 Haneef et al., 2017. Living organism that can form biocomposite includes for example bacteria and more complex living organisms, such as fungi, algae and fermenting yeast and eukaryotic biological growth for production possibly as part of “self-growing” composites. The option of adding synthetic nanoparticles in the growth medium allows added properties in the final composite, such as catalytic, electronic and sensing (Bigall et al., 2008) or to create hybrid panel composites of wood, fungal mycelium, and cellulose nanofibrils (CNF) with improved mechanical properties, compared to all-mycelium materials (Sun et al., 2019).

Biocomposites according to the present disclosure comprise plants and/or algae cell, which are compacted to form a biocomposite comprising rigid biopolymers and an amorphous matrix of biopolymers from the plant and/or algae cell wall. The term “cell” as used herein indicates the basic structural, functional, and biological unit of all known organisms. Cells are of two types: eukaryotic, which contain a nucleus, and prokaryotic, which do not. Most cells are only visible under a microscope, with dimensions between 1 and 150 micrometers. Cells consist of cytoplasm enclosed within a membrane, which contains many biomolecules such as proteins and nucleic acids.

The cell membrane is typically formed by a lipid bilayer or monolayer, including cholesterols (a lipid component) that sit between phospholipids to maintain their fluidity at various temperatures. The cell membrane typically also contains membrane proteins, including integral proteins that go across the membrane serving as membrane transporters, and peripheral proteins that loosely attach to the outer (peripheral) side of the cell membrane, acting as enzymes shaping the cell.

The term “cytoplasm” or “cytoplasmic material” as used herein indicates all of the material within a cell, enclosed by the cell membrane, including the nucleoplasm (cellular material inside the nucleus and contained within the nuclear membrane). The main components of the cytoplasm are cytosol, a gel-like substance, the organelles—the cell's internal sub-structures, and various cytoplasmic inclusions. The cytoplasm is about 80% water and usually colorless.

Cells in the sense of the disclosure typically comprise organelles. An “organelle” in the sense of the disclosure indicates a specialized subunit, usually within a cell, that has a specific function. Organelles are either separately enclosed within their own lipid bilayers (also called membrane-bound organelles) or are spatially distinct functional units without a surrounding lipid bilayer (non-membrane bound organelles).

The term “plant and/or algae cell” as used herein indicates a eukaryotic cell comprising at least a primary cell wall and possibly a secondary cell wall, such as eukaryotic cells of a eukaryote organism of the kingdom Plantae and eukaryotic cells of any eukaryote organism of the taxon Algae.

Plant and/or algae cells' distinctive features in the sense of the disclosure comprises presence of i) a primary cell walls, ii) a cell membrane, iii) internal organelles comprised within iv) cytoplasmic material. Internal organelles of plant cells in the sense of the disclosure comprise, the nucleus, a plastids, with the capability to perform photosynthesis, a vacuole that regulates turgor pressure mitochondrion, Golgi apparatus and additional organelles identifiable by a skilled person; and v).a biochemical composition characterized by presence of biomolecules, in particular carbohydrates, primarily forming the structural cell wall; proteins, located in the membranes and cytoplasm; and lipids, which form the cell membrane, and water which is the predominant component of the cytoplasm, which constitutes the bulk of the cell's internal volume.

In particular, plant and/or algae cells' distinctive features in the sense of the disclosure is the presence of detectable amounts of proteins, lipids, and carbohydrates, in combination with a water content, which detectable presence constitutes an indicator of a material of biological origin. As will be described in further detail, this signature is not merely qualitative but can be quantitatively defined by specific ranges or ratios, which are used as “result-effective variables” to engineer a biocomposite with predictably tuned properties in accordance with the present disclosure.

In plant cells, the most distinctive feature is the cell wall, which is itself a natural composite material. The cell wall of plant cells is typically composed of a crystalline framework of cellulose microfibrils, which serve as the main load-bearing component, providing the cell with remarkable strength and stiffness. This framework is immersed in a complex amorphous matrix of other polysaccharides, primarily hemicelluloses and pectins. The hemicelluloses bind the cellulose fibrils together, assisting in load transfer, while the pectins form a gel-like substance that provides cohesion and flexibility. In mature plant cells, lignin, an amorphous phenolic polymer, may also be present to provide additional structural integrity.

In algae cells, the composition of the cell wall is significantly more diverse and species-dependent than in land plants. While some algae contain cellulose, many are constructed from a different and varied set of biopolymers. Algal cell walls are typically composed of glycoproteins and a wide array of polysaccharides, including alginate (from brown algae), as well as carrageenan and agar (from red algae). For example, the cell wall of Chlamydomonas reinhardtii is cellulose-deficient and is instead composed of glycoproteins and other polypeptides. This vast diversity in composition is a reason why different algal species, when used as a feedstock, can produce biocomposites with a wide range of tunable properties.

A “cell wall” in the sense of the disclosure indicates a structural layer surrounding some types of cells, just outside the cell membrane. A cell wall provides the cell with both structural support and protection, and also acts as a filtering mechanism A cell wall has mechanical properties depending on the related composition and configuration. A cell wall major function is to act as pressure vessels, preventing over-expansion of the cell when water enters.

In a “plant and/or algae cell” according to the instant disclosure, a cell wall of the plant and/or algae cell is a composite which comprises primarily a combination of glucose based biopolymers such as polysaccharides and glycoproteins, which provide a rigid component of the cell wall as well as sugar-based biopolymers and/or phenol based biopolymers such as hemicellulose and/or pectin and/or a combination of alginate carrageenan, starch and/or agar which provide the matrix component of the cell wall.

As used herein, a “sugar-based biopolymer” refers to a natural polymer that can be produced by a living organism or cell and that contains at least three monosaccharide monomeric moieties. Exemplary monosaccharide monomers include D-glucose units, D-mannopyranuronose, L-gulopyranuronose, and L-gulopyranuronic acid. Sugar-based biopolymer in which the at least three monosaccharide monomeric moieties are D-glucose units are indicated identified as “glucose based.” Exemplary biopolymer of D-glucose units include cellulose. Exemplary biopolymer of D-mannuronic acid, and L-guluronic acid includes alginic acid Additional, exemplary sugar-based biopolymer in cell wall of a plant and/or algae cell comprises glycoproteins, polysaccharides, starches an additional biopolymers identifiable by a skilled person.

As used herein, a phenol-based biopolymer refers to a natural polymer that can be produced by a living organism or cell and that contains at least three phenolic or substituted phenolic monomeric moieties. Exemplary phenolic or substituted phenolic monomers include paracoumaryl alcohol, coniferyl alcohol and sinapyl alcohol.

Plant cell walls are naturally secreted by the protoplast on the outer surface of the plasma membrane of the plant cells. In particular, in a plant cell according to the disclosure the composition of cell walls varies between species and may depend on cell type and developmental stage.

The primary cell wall of photosynthetic eukaryotes of the kingdom Plantae is structured as a composite typically composed of at least the polysaccharides cellulose, hemicelluloses and pectin, in which the cellulose provides a crystalline component and the hemicelluloses and pectin are comprised in an amorphous matrix. In particular, primary cell wall of photosynthetic eukaryotes of the kingdom Plantae primarily consists of four building blocks, cellulose, hemicellulose, pectin and possibly lignin in Plantae, at varying concentrations and spatial organization depending on the plant species, the cell's stage of development and function they serve. In those plant cells Cellulose is the main load bearing component of the cell wall of photosynthetic eukaryotes of the kingdom Plantae and is organized into semi-crystalline microfibrils with excellent mechanical properties, with Young's modulus up to 220 GPa, and tensile strength up to 7.7 GPa, depending on crystallinity and physical characteristics (16). In the cell wall of photosynthetic eukaryotes of the kingdom Plantae, cellulose microfibrils are immersed in a matrix of amorphous polysaccharides, hemicelluloses and pectins (30). Hemicelluloses bind individual cellulose fibrils together, assisting in the load transfer within the cell wall. Pectins form gels around the cellulose-hemicellulose fibrils which allow for sideways fibril slippage and heavily influence the cell wall porosity and thickness). Lignin, an amorphous phenolic polymer which is deposited within the carbohydrate matrix of the cell wall in the final stages of cell differentiation, provides structural integrity by enabling load transfer to the cellulose microfibrils, while also providing resistance to external pathogens.

Accordingly, in some embodiments of biocomposite of the disclosure and related compositions, methods and systems, plant cell walls of photosynthetic eukaryotes of the kingdom Plantae according to the disclosure are primarily composed of semi-crystalline cellulose microfibrils, which have remarkable mechanical properties (Young's modulus up to 220 GPa, and tensile strength up to 7.7 GPa, depending on crystallinity and physical characteristics (Gibson, 2012)) and are immersed in a complex matrix of amorphous hemicelluloses, lignins and pectins. Model of the structure and functions of plant cell wall components still remains to be refined (Cosgrove, 2005, 2014).

Exemplary plant cells present in a photosynthetic eukaryote of the kingdom Plantae comprises a cell from Chlorokybophyta, Mesostigmatophyta, Spirotaenia, Chlorobionta, Chlorophyta, Streptobionta, Klebsormidiophyceae, Charophyta (stoneworts), Chaetosphaeridiales, Coleochaetophyta, Zygnematophyta, Embryophyta (land plants), Marchantiophyta (liverworts), Bryophyta (mosses), Anthocerotophyta (hornworts), Horneophyta, Aglaophyta, and Tracheophyta (vascular plants).

In particular exemplary trachephyta plant cells comprise plant cells of the Nicotiana genus in Solanaceae family, includes Nicotiana attenuate (coyote tobacco), Nicotiana obtusifolia, Nicotiana acuminate, Nicotiana Africana, Nicotiana alata, Nicotiana benthamiana, Nicotiana clevelandii, Nicotiana glauca, Nicotiana glutinosa, Nicotiana langsdorffii, Nicotiana longiflora, Nicotiana occidentalis, Nicotiana otophora, Nicotiana plumbaginifolia, Nicotiana quadrivalvis, Nicotiana rustica, Nicotiana suaveolens, Nicotiana Sylvestris, Nicotiana tabacum, and Nicotiana tomentosiformis.

Exemplary trachephyta plant cells further comprise plant cells of the Arabidopsis genus of the Brassicaceae family, comprising Arabidopsis arenicola, Arabidopsis arenosa (L.) Lawalrée, Arabidopsis croatica (Schott), Arabidopsis halleri (L.), Arabidopsis lyrata (L), Arabidopsis neglecta (Schultes) Arabidopsis pedemontana (Boiss.) Arabidopsis suecica (Fries) Norrlin, Meddel. And Arabidopsis thaliana (L.) Heynh.

An algal cell in the sense of the disclosure indicates a eukaryotic cell having a cell wall located outside the cell membrane. The cell wall provides the cell with structural support and protection. The cell walls of algae are highly diverse and species-dependent, and in many embodiments are composed of glycoproteins and a wide array of polysaccharides. This diverse composition is a feature that allows different algal species to produce biocomposites with a wide range of tunable properties in accordance with the present disclosure.

In some embodiments, the algal cell wall comprises specific polysaccharides depending on the taxonomic group. For example, the cell wall can be comprised of alginate, as is found in brown algae (Phacophyceae). In other embodiments, such as in red algae (Rhodophyta), the cell wall may comprise a composite structure of cellulose, xylan, or mannan fibrils embedded within a matrix of polysaccharides including carrageenan and agar. In yet other embodiments, the algal cell wall may be substantially cellulose-deficient and composed primarily of glycoproteins, as is the case for Chlamydomonas reinhardtii.

In some embodiments, the algal cells can be classified by their physical morphology, which is a variable for controlling the mechanical properties of the final biocomposite in accordance with the present disclosure. In certain embodiments, the algal cells are unicellular or granular, forming equiaxed or spheroidal particles when processed. An exemplary unicellular alga is Chlorella vulgaris. In other embodiments, the algal cells are filamentous, possessing a high-aspect-ratio, fiber-like structure. An exemplary filamentous alga is Tribonema minus, which grows in long, unbranched filaments. Another exemplary morphology is the helical trichome structure found in Spirulina.

In some embodiments, suitable algae can be selected from a wide variety of eukaryotic organisms, which can be identified by their major taxonomic classifications. In some embodiments, the algae may be selected from the group of Green Algae, including the phyla Chlorophyta and Charophyta. In other embodiments, the algae may be selected from Red Algae (Rhodophyta) or Brown Algae (Phaeophyceae). In further embodiments, the algae may be selected from other groups including, but not limited to, Diatoms (Bacillariophyceae), Golden Algae (Chrysophyceae), and Yellow-Green Algae (Xanthophyceae).

In algae cells in accordance with the disclosure the native composition of the of the cell walls is more diverse than in plants and is species-dependent. Cell walls of algae cells are composite in nature having a crystalline component and an amorphous component. In particular cell walls of algae, have glycoproteins and carbohydrates as the main glucose-based components crystalline biopolymer, rigid and of glucosic nature forming a crystalline, which in some instances can be in a fibrous form, (e.g. as cellulose). Cell wall biopolymers of algae form one or more distinct layers (possibly at least 2), identifiable by TEM.

Accordingly, the primary cell wall of photosynthetic eukaryotes of the group Algae is typically composed of glycoproteins and polysaccharides such as alginate, starch carrageenan and agar. Algae cell walls are extremely diverse and have very different arrangements among different species. For example, the cell wall of Chlamydomonas reinhardtii is a multilayered extracellular matrix, cellulose-deficient, composed of carbohydrates and 20-25 polypeptides. Other algae also have a multilayered cell wall with several distinct layers (e.g. at least 3 or 5 layers depending on the species), some of which form a highly crystalline lattice comprised of glycoprotein subunits. The outer layer can be fibrous. The red algae possess complex composite cell walls made of cellulose, xylan or mannan fibrils and extensive matrix polysaccharides including the economically important carrageenan and agar.

In some algae cells, the cell wall can be thin (e.g. 30 nm at minimum-), contain no cellulose and be comprised of carbohydrates and several hydroxyproline-rich glycoproteins which are cross-linked to short oligosaccharides. In those algae the crystalline lattice formed from hydroxyproline-rich glycoproteins. The same crystalline component is found for example at least in 15 green algae species belonging to the Volvocales, Chlorococcales, Codiolales, Desmidialesand Zygnematales. In some green algae with different glycoprotein crystalline structures. Another algae's species, Botryococcusis composed of a fibrous cell wall layer of uniform thickness (50 nm) In other algae the polysaccharide cell walls comprise agarose (agar) and carrageenan are sulfated galactans (in red seaweeds). In some algae cell wall, the polysaccharide is comprised of the repeating disaccharide 3-α-D-Galp-1-4-3,6-anhydro-α-L-Galp-1 unit. Alginic acid, a linear polysaccharide composed of 1-4-linked β-D-ManA and its C-5 epimer 1-4-linked α-L-GulA, is obtained from various species of brown seaweed. (see: Chapter 24 reference 76).

Exemplary Alga eukaryote organism comprise a cell from Archaeplastida, Plantae/green algae, Mesostigmatophyceae, Chlorokybophyceae, Chlorophyta, Charophyta, Rhodophyta (red algae), Glaucophyta, Rhizaria, Excavata, Chlorarachniophytes, Euglenids, Chromista, Alveolata, Heterokonts, Bacillariophyceae (Diatoms), Axodines, Bolidomonas, Eustigmatophyceae, Phaeophyceae (brown algae), Chrysophyceae (golden algae), Raphidophyceae, Synurophyceae Xanthophyceae (yellow-green algae), Cryptophyta, Dinoflagellata Haptophyta and Chlamydomonas.

In particular, exemplary Chlamydomonas algae suitable for the biocomposite of the disclosure that can be found in stagnant water and on damp soil, in freshwater, seawater, comprise Chlamydomonas includes Species: C. aalesundensis—C. abbreviata Chlamydomonas acidophila, Chlamydomonas caudata Wille, Chlamydomonas ehrenbergii Gorozhankin, Chlamydomonas elegans Chlamydomonas moewusii, Chlamydomonas nivalis, Chlamydomonas ovoidae and Chlamydomonas reinhardtii.

In plant cells in accordance with the disclosure the native composition of the plant cell primary and possibly secondary walls, as well as the arrangement of the different components within the cell wall and on the hierarchical organization of the cells at the microscale are the primary responsible for the mechanical properties of any biomaterials based on the plant cells. (Gibson and Ashby, 1997; Gibson, 2012).

In a plant cell according to the disclosure the composition of cell walls varies between species and may depend on cell type and developmental stage. Accordingly, in biocomposites according to the present disclosure, by controlling the native composition of plant cell walls, organization of the main components in the cell walls and varying the cellular microstructure, plants can exhibit this remarkable range of mechanical properties of biomaterials based on plant cells in the sense of the disclosure.

In some embodiments, the biocomposite of the present disclosure comprise a mixture of plant and algae cells from various sources and feedstock biomass, preferably from renewable and/or sustainable sources.

In some embodiments, the biocomposite of the present disclosure comprise only plant cells. from various sources and feedstock biomass, preferably from renewable and/or sustainable sources.

In some embodiments, the biocomposite of the present disclosure comprise only algal cells from various sources and feedstock biomass, preferably from renewable and/or sustainable sources.

In embodiments of the instant disclosure, a dried feedstock biomass is provided from a biomass of biological origin following harvesting from a source such as a wastewater purification facility, “wild capture” of the biomass from nature, or laboratory-scale cultivation.

In particular, in some embodiments, the feedstock biomass can be sourced from dedicated cultivation systems designed specifically for growing algae. Cultivation systems can include large-scale, purpose-built systems such as Open Raceway Ponds (ORPs) or more controlled, closed Photobioreactors (PBRs). Cultivation systems that can be used to provide feedstock biomass in the sense of the disclosure also comprises biomass from commercial operations that produce high-purity, biomass such as food-grade or nutraceutical-grade algae. In a particularly preferred embodiment, the feedstock biomass can be sourced from commercial batches that are off-spec, contaminated, or otherwise fail to meet buyer specifications, transforming a potential loss into a valuable input material. Laboratory-scale cultivation is also a source for development and testing.

In some preferred embodiments where the methods and systems and related feedstock biomass are used in connection with applications directed to enable a circular economy, the biomass can be cultivated from waste valorization streams. The source of a waste valorization stream can comprise municipal, agricultural, or industrial wastewater, where the algae consume nutrients, providing a bioremediation benefit. Specific examples of such nutrient-rich streams include livestock sludge and industrial effluents like brine water from other industrial processes.

In further embodiments, harvesting the biomass can be obtained by direct harvesting from the environment. In those embodiments, harvesting can be performed by extraction of naturally occurring “wild” plant cells or algal cells, such as algal blooms from a range of managed and unmanaged bodies of water. Examples include natural sources such as oceans, lakes, and ponds, as well as managed sources like municipal reservoirs and golf course water hazards. This approach also encompasses the harvesting of Harmful Algal Blooms (HABs), thereby providing a method to remediate an environmental problem by converting the toxic or problematic biomass into a durable and valuable biocomposite material starting from a dried feed biomass.

In preferred embodiments, harvesting of a feedstock biomass can be performed by physical or gravity-based harvesting methods in particular when the biomass composed primarily of, or consists of, algal cells. These methods comprise the use of physical screens, particularly for filamentous algae, as well as methods like natural settling (sedimentation) followed by scraping or decanting. These methods are preferred over use of chemical flocculants or coagulants, such as aluminum chlorohydrate, because they concentrate the biomass without introducing chemical contaminants which can affect the final composite's mechanics For example, biocomposites made from the “Delhi” feedstock, which was harvested using an aluminum-based coagulant, demonstrated significantly lower cohesive strength compared to the “Hilmar” feedstock, which was harvested via natural settling. In embodiments, where cohesive strength is desired uses of physical or gravity-based harvesting methods is thus preferred as will be understood by a skilled person.

In some embodiments, a harvested feedstock biomass comprises a mixture of plant and algae cells, or can consist entirely of algal cells from various sources.

In addition to the chemical and physical analyses, the molecular composition and origin of the biomass can be further defined through genetic characterization. This involves analyzing the nucleic acid sequences of the organism or organisms constituting the biomass to confirm taxonomic identity and ensure the consistency of the feedstock. In some embodiments, this characterization is performed using established DNA barcoding techniques, wherein specific and highly conserved gene regions are amplified and sequenced to identify the source species. For example, the 16S ribosomal RNA gene may be used for identifying bacterial or archaeal species, while the Internal Transcribed Spacer (ITS) region is commonly used for fungal identification. For biomass derived from mixed microbial cultures or environmental consortia, metagenomic analysis may be employed to characterize the entire genetic content of the sample and determine the relative abundance of the constituent species. Such genetic verification provides a definitive method for identifying the source organism and correlating the genetic profile with desirable biochemical compositions, such as high protein content or specific lipid profiles, thereby ensuring the reproducibility of the final biocomposite's properties.

In preferred embodiments, the harvested feedstock biomass can be composed primarily of, or consists entirely of, algal cells, from various sources preferably from renewable and/or sustainable sources, such as algal cells which can be cultivated without competing for arable land or freshwater resources (e.g. wastewater or saline environments). In those embodiments, tunable biocomposites and related materials, compositions, methods and systems herein described, enable integration of the process and workflows herein described into waste valorization streams, turning a byproduct of water remediation into a valuable feedstock.

In some embodiments, the harvested a feedstock biomass can comprise algal cells composed primarily of or consists of Green Algae (e.g., from the phyla Chlorophyta and Charophyta), which are closely related to land plants; Red Algae (Rhodophyta), which are known sources of polysaccharides like carrageenan and agar; and Brown Algae (Phaeophyceae), which are a primary source of alginic acid. Other exemplary groups include Diatoms (Bacillariophyceae), Golden Algae (Chrysophyceae), and Yellow-Green Algae (Xanthophyceae), among others.

In some preferred embodiments, the harvested feedstock biomass can comprise, be composed primarily of or consists of unicellular or granular algae, such as Chlorella vulgaris, which form equiaxed or spheroidal particles when processed. This harvested biomass is particularly useful for creating stiff, rigid biocomposites through dense particle packing as will be understood by a skilled.

In some preferred embodiments, the harvested feedstock biomass can comprise, be composed primarily of or consists of filamentous algae, such as Tribonema minus, which possess a high-aspect-ratio, fiber-like structure. in those embodiments, preserving this morphology through processing is functional to creating tough, flexible biocomposites, as the filaments form an interlocking network that enhances strength and resists fracture as will be understood by a skilled person upon reading of the present disclosure.

In some embodiments, the harvested feedstock biomass can comprises, be composed primarily of or consists of a mixture of different algal species of different classification, pigmentation and/or morphology. In those embodiments, the mixture of different algal species can be provided either through an engineered blend of single-strain culture, or by using a native polyculture. A “native polyculture” in the sense of the disclosure indicates a mixed-strain microbial community, such as those harvested from wastewater treatment facilities. (see Hilmar and Delhi in the Examples section).

In some preferred embodiments, the harvested feedstock biomass can be composed primarily of, or consists of, algal cells, which alone or in mixtures, naturally possess a balanced composition of proteins, lipids, and carbohydrates which allows preferred tunability of the final biocomposite as will be understood by a skilled person upon reading of the present disclosure.

In some embodiments, the harvested feedstock biomass can be composed primarily of, or consists of, a mixture of different algal species provided alone or in combination with plants species before or after the harvesting of the feedstock biomass.

in embodiments herein described the harvested biomass is dried to provide a dried feedstock biomass to be used in the method engineer a biopowder in accordance with the present disclosure.

The term “dried feedstock biomass” as used herein indicates a biomass that has been subjected to a drying process to reduce its water content in preparation for subsequent processing steps, such as comminution or pulverization. Specifically, a dried feedstock biomass in embodiments herein described indicate a biomass with a water content of less than 15% by weight. The specific drying technique can be selected based on the nature of the biomass and the desired properties of the resulting feedstock.

In some embodiments, the recovered biomass can be sun-dried. In other embodiments, such as for food-grade algae, the biomass can be freeze-dried (e.g. lyophilization), a method which involves freezing the material and sublimating the ice under vacuum can be used to minimize microbial contamination and eliminate exposure to uncontrolled outdoor environments. Additionally, oven drying at temperatures below 100° C. can be performed on the extracted biomass for a duration required to reach a desired water loss.

In some embodiments, drying can comprise mechanical dewatering. For example, in some embodiments, prior to the final drying step, a preliminary mechanical dewatering step can be performed to reduce the bulk water content of the harvested biomass slurry. In those embodiments, methods such as centrifugation can be used to separate a significant fraction of the free water, resulting in a dense paste. This initial dewatering reduces the energy and time required for the subsequent thermal drying stages.

In other embodiments, the drying can comprise industrial-scale drying methods such as spray drying process where a liquid biomass suspension is atomized into fine droplets inside a chamber with hot air, which instantly dries them into a powder.

In some embodiments the drying can be performed drum drying, where the algae slurry is applied as a thin film onto a heated rotating drum. In those embodiments the direct heat rapidly dries the algae, which is then scraped off with techniques identifiable by a skilled person.

In some embodiments the drying can comprise drying methods based on electromagnetic radiation. In particular, in some embodiments the drying can comprise performing microwave drying which uses microwave energy to heat and evaporate the water from within the biomass, which can offer rapid and uniform drying. In some embodiments the drying can comprise infrared drying which uses infrared radiation to heat and dry the biomass.

In some embodiments in which the drying comprises any of the thermal drying methods, such as oven drying, the drying can also be performed under vacuum (vacuum oven drying). The reduced pressure lowers the boiling point of water, allowing for faster and more gentle drying at lower temperatures, which further minimizes thermal degradation.

In some embodiments, the drying can comprise advanced drying techniques such as fluidized bed drying applicable to granular materials, where hot air is passed through the biomass with enough force to make the particles behave like a fluid, ensuring uniform and efficient drying while helping to preserve bioactive compounds. In some embodiments, where maximum preservation of heat-sensitive compounds is desired the drying can be performed by supercritical drying. This advanced, gentle method uses a supercritical fluid, such as carbon dioxide, to extract water at low temperatures, according to approaches identifiable by a skilled person.

Following the completion of one or more of these drying techniques, the resulting dried feedstock biomass is in a configuration suitable for further processing to i) modify the related morphology, for example by performing particle size reduction and optionally ii) perform a chemical modification of the biomass, to provide an engineered bio-powder with target biomass composition and morphology configured to fabricate a biocomposite with at least one tuned material property.

The term “biomass composition” as used herein refers to the biochemical makeup of the feedstock, characterized by its relative percentages of protein, lipids, and carbohydrates as a percentage of dry weight. This composition is an inherent and result-effective variable that differs significantly between algal species and can be influenced by cultivation conditions, allowing for the selection of a feedstock to achieve a desired performance characteristic in the final biocomposite.

In some embodiments, a compositional analysis of the cell wall components of the biomass can be performed before the processing step of the engineering method of the disclosure, to determine the content of specific biopolymers. These analytical methods can include the anthrone-sulfuric acid colorimetric method for cellulose, acidic hydrolysis for hemicellulose, the carbazole colorimetric method for pectin, and the Klason method for lignin as will be understood by a skilled person.

In some embodiments, detecting total protein content of a biomass can be performed by indirect or direct methods. The most common indirect methods are based on measuring the total nitrogen content of the biomass. The Kjeldahl method is the traditional reference standard, which involves digesting the sample to convert organic nitrogen into ammonia for quantification. A more modern and faster alternative is the Dumas method, which measures total nitrogen through combustion. In both cases, the total nitrogen value is then multiplied by a nitrogen-to-protein conversion factor to estimate the protein content. More direct measurements can be made using spectrophotometric methods like the Lowry or Bradford assays. The most accurate method, however, is direct amino acid analysis, which involves hydrolyzing the protein and quantifying the individual amino acids via chromatography, as this technique is not affected by non-protein nitrogen sources.

In some embodiments, detecting total lipid content of a biomass can be performed by gravimetrically after extracting lipids from the dried biomass using a solvent. A standard approach is Soxhlet extraction, where a solvent such as hexane or a chloroform-methanol mixture is repeatedly passed through the biomass to dissolve the lipids. After the solvent is evaporated, the remaining lipid mass is weighed. For a more detailed analysis of the fatty acid profile, the extracted lipids can be transesterified to form Fatty Acid Methyl Esters (FAMEs), which are then separated and quantified using Gas Chromatography (GC). Advanced techniques like Mass Spectrometry (MS) can also be used to provide a comprehensive lipidomic profile.

In some embodiments, detecting the carbohydrate content of a biomass can be performed by standard method for determining structural carbohydrates, such as cellulose and hemicellulose, is a two-step sulfuric acid hydrolysis. The biomass is first treated with concentrated sulfuric acid to break down the crystalline structure, then diluted and heated to complete the hydrolysis of polysaccharides into their constituent monomeric sugars. These soluble monosaccharides are then accurately quantified using High-Performance Liquid Chromatography (HPLC). The acid-insoluble residue remaining after this hydrolysis is typically quantified gravimetrically as Klason lignin. A simpler, though less detailed, alternative to HPLC for carbohydrate quantification is to use a spectrophotometric method on the hydrolysate to get an overall concentration of total sugars.

In some embodiments, the content of protein, carbohydrates, and lipids, in the biomass typically expressed as a percentage of dry weight can thus be performed using standard analytical techniques. In other embodiments, the determination can be performed by combining the results of direct analytical measurements with known or published values for the specific species of plant or algae known to be present in the biomass. Furthermore, the composition can be determined using any other suitable methods identifiable by a person of ordinary skill in the art.

In embodiments herein described, the characterization of the starting biomass allows the identification of the molecular components of the biomass composition forming a combination of “result-effective variables” or “tuning dials” that are operated to obtain a tuned biocomposite with predictable and controlled properties in accordance with the present disclosure. These variables include the intrinsic biochemical composition of the starting biomass, specifically its carbohydrate component, protein component, and lipid component, as well as process variables like water content during fabrication as will be understood by a skilled person upon reading of the present disclosure.

In embodiments herein described, the protein content of the feedstock biomass is a primary “result-effective variable” that is directly correlated with the stiffness and rigidity of the final bio-composite. In the engineered powder and related biocomposite, the strength of the material is derived from the self-adhesion of the biomass particles. Proteins, as hydrophilic biopolymers present on the particle surfaces, play a role in forming the extensive hydrogen-bond network that holds the consolidated matrix together. A higher protein content provides more sites for this intermolecular bonding, resulting in a more cohesive and densely interconnected structure that is highly resistant to elastic deformation. Therefore, to engineer a stiff and rigid biocomposite, a person skilled in the art would select a dried biomass with a high protein content, preferably greater than 40% by dry weight. An additional benefit is that higher protein content also correlates with improved thermal stability.

Accordingly, for example feedstock with a high protein content, such as Spirulina or Chlorella with over 40-50% protein by dry weight, is selected to produce a stiff and rigid final material, making it a prime candidate for forming protein-based biocomposites with high thermal stability.

In particular in embodiments here described, the lipid content of the feedstock biomass is a result-effective variable primarily used to tune the toughness and flexibility of the final biocomposite. Accordingly, in embodiments herein described, the lipid content functions as an intrinsic plasticizer, imparting toughness, pliability, and flexibility. These effects are expected to be associated with the ability of lipids to act as an intrinsic plasticizer by increasing the free volume between the biopolymer chains of the matrix, which allows for greater chain mobility and reduces the brittleness of the material. These effects are also expected to be associated with lipids ability to physically interfere with the formation of the primary self-adhesion mechanism, which is the hydrogen-bond network that forms between the hydrophilic proteins and polysaccharides on adjacent particle surfaces.

Accordingly in some embodiments herein described the lipid content of the feedstock biomass and/or resulting engineered particles is controlled to balance the plasticizing effect against the potential disruption of the inter-particle bonding that gives the material its structural integrity, as will be understood by a skilled person upon reading of the present disclosure.

Additionally, in some embodiments herein described the plasticizer effect of lipids is also controlled in synergy with the particle morphology of the engineered powder to achieve a desired mechanical profile as will be understood by a skilled person upon reading of the present disclosure.

In embodiments, herein described the carbohydrate content, comprising the various polysaccharides of the cell wall, provides the fundamental structural backbone of the material. Within this carbohydrate fraction, glucose-based biopolymers like cellulose form a rigid, crystalline, load-bearing component, while other sugar-based biopolymers such as hemicelluloses and pectins form an amorphous matrix that binds the crystalline fibrils together and assists in load transfer.

The term “amorphous matrix” as used herein indicates a solid that lacks a long range order and which serves to embed another solid substance. Accordingly, an amorphous matrix is characterized by a highly irregular structure compared with that of the crystalline component and can have a gel-like consistency.

The term “fibril” as used herein indicate a linear aggregate composed of linear biopolymers, characterized by rod-like structures with a thickness of 1 to 10 nm and a high length-to-diameter ratios of at least 2 to 1, preferably at least 10 to 1, more preferable at least 100 to 1. Fibrils can spontaneously arrange into helical structures. Fibrils are usually found alone but rather are parts of greater hierarchical structures commonly found in biological systems. Differences in structure between fibrils of different origin is typically determined by x-ray diffraction. A scanning electron microscope (SEM) can be used to observe specific details on larger fibril species.

The term “fiber” as used herein indicates rod shaped substance that has a length at least twice longer than its width or diameter having thickness between 10-50 nanometers and forming micro to milli-scale structures. As used herein, a fiber can made of a plurality of fibrils arranged in parallel and in contact with each other.

Polysaccharide fibrils in the sense of the disclosure comprise any polysaccharide that comprises at least three monosaccharide monomeric moieties aggregates as a rod structure. Exemplary polysaccharide fibril includes cellulose which comprises β(1→4) linked D-glucose units. Another exemplary polysaccharide fibril includes alginate fibril which comprises repeat sequences of β-D-mannopyranuronosyl-(1→4)-α-L-gulopyranuronosyl-(1→4)-α-L-gulopyranuronate.

In biocomposite of the present disclosure, wherein the plant and/or algae cells comprise an algae cell, comprise e crystalline glucose based biopolymers, such as hydroxyproline-rich glycoproteins, polysaccharide fibrils such as cellulose, alginic acid or calcium alginate, a biopolymer containing or a polysaccharide of beta-1,3-xylan, beta-1,4-xylan, and/or beta-1,4-mannan, in particular wherein the plant and/or algae cells comprise an algae cell.

This framework of controlling the protein, lipid, and carbohydrate ratios allows for the fabrication of a tuned bio-composite with a predetermined set of mechanical properties.

In embodiments of the disclosure, the carbohydrate component of the biomass serves as the structural backbone or “canvas” of the final material. The specific carbohydrate content can be selected in view of the desired structural backbone for the composite which ensures that the material remains tunable by the lipid and protein components.

In some embodiments, the carbohydrate component can be selected to achieve a desired balance between the biomass's crystalline and amorphous polysaccharide components. The crystalline fraction, primarily comprising biopolymers like cellulose, acts as the intrinsic reinforcement, forming a rigid, load-bearing framework that provides the material with its fundamental stiffness and strength. Concurrently, the amorphous fraction, which includes biopolymers such as hemicelluloses and pectins, functions as an intrinsic binder. This amorphous matrix provides the material with cohesion, toughness, and processability by binding the crystalline fibrils together and assisting in load transfer.

In preferred embodiments, a biomass can selected with a carbohydrate content within a specific preferred compositional range from 25% to 40% by dry weight. If the carbohydrate content is higher than 40%, as is common in wood or straw), the material can become brittle and lose tunability, as the relative influence of the other components is diminished. If the carbohydrate content lower than 25% the material can result in a soft or waxy solid and thus lack a sufficient structural backbone to form a robust composite should such a composite be desired.

Therefore, a desired combination of stiffness and toughness is achieved by selecting a feedstock with this optimal balance of crystalline and amorphous component, which works in concert with the other “tuning dials” of the framework: the protein content also contributes to the binding matrix, while the lipid content acts as a plasticizer that modulates the overall stiffness imparted by the carbohydrate backbone.

In embodiments herein described thus a whole cells approach is pursued where the protein, lipid and carbohydrate components of the biomass are not extracted and separated, rather the entire biomass cell is used as the primary building block for the composite material while the related composition and morphological features which can be selected or modified in function of desired properties of the final biocomposite.

Accordingly, in some embodiments, a method of engineering bio-powder for fabricating a tuned bio-composite is described where a dried feedstock biomass is provided which has a dried feedstock biomass composition including biomass protein %, biomass lipid % and biomass carbohydrate %; be selected or modified based on at least one tunable property of the bio-composite, to be fabricated.

In some embodiments of the disclosure, the biocomposite is engineered to have one or more tunable properties selected from the group consisting of a mechanical property, thermal stability, and a barrier function.

The wording “mechanical properties” as used herein indicates the characteristics that describe how the biocomposite material responds to applied forces. These properties are used to quantify the material's performance and suitability for various applications. As used in the disclosure, the term “mechanical properties” comprise mechanical strength, stiffness, toughness, and flexibility.

The term “mechanical strength” as used herein indicates the material's ability to withstand a force before failure and can be measured by parameters such as tensile strength and compressive Strength (resistance to a crushing force).

The tensile strength of a material is defined as the maximum stress a material can withstand while being stretched or pulled before it fractures, representing the material's ultimate resistance to tension. This property is determined from a tensile test, wherein a sample is pulled apart at a constant rate, and the parameter is the peak stress value reached on the stress-strain curve before the sample fractures.

The compressive strength of a material is a measure of the maximum compressive or “crushing” stress a material can withstand before it fractures or fails. Compressive modulus is thus a measure of the material's stiffness when under a crushing or compressive load. This property can determined from a compression test. As a force is applied to the specimen, the stress increases until it reaches a maximum point, after which the material begins to fail. This peak stress value is defined as the compressive strength. In particular, specimen can be pressed between two parallel plates at a constant rate. The compressive modulus is calculated from the linear portion of the resulting stress-strain curve. The compressive strengths of a material is indicator of a material's ability to perform in load-bearing applications. In certain preferred embodiments, the biocomposite is engineered to have a Compressive Strength greater than 100 MPa.

The term “stiffness” as used herein indicates the material's resistance to elastic deformation under an applied load and is quantitatively measured by the parameter of Young's Modulus. Young's Modulus, also known as the elastic modulus, is a fundamental mechanical property that measures a material's stiffness, or its resistance to being deformed elastically when a force is applied. Young's modulus describes the relationship between stress (force per unit area) and strain (proportional deformation) in a material. A higher Young's modulus indicates a stiffer material. Stiffer material as will be understood by a skilled person. In some embodiments, Young modules can be determined from data obtained during a compression test. During this test, a specimen is compressed at a constant rate, and the resulting stress and strain are recorded. The Young's Modulus is calculated from the slope of the linear elastic portion of the resulting stress-strain curve. A higher Young's Modulus value indicates a stiffer, more rigid material. In certain preferred embodiments, the biocomposite is engineered to have a Young's Modulus greater than 900 MPa.

The terms “Toughness” and “Flexibility” relate to the material's ability to bend or deform under a load without fracturing, a characteristic that is quantitatively measured by the parameter of Flexural Strength. Flexural Strength, also known as the modulus of rupture or bending strength, is a measure of a material's strength when subjected to a bending load. It represents the maximum stress the material can sustain during bending before it ruptures. This property is determined from a three-point bending test. In this test, a rectangular specimen is placed on two supports and a force is applied to its center at a constant rate until the specimen fails. The Flexural Strength is then calculated based on the peak load applied, the distance between the supports, and the cross-sectional dimensions of the specimen. It is a critical parameter for evaluating a material's toughness and flexibility. In certain preferred embodiments, the biocomposite is engineered to have a Flexural Strength greater than 10 MPa.

The mechanical properties of biocomposites can determined experimentally using several standardized testing methods, typically performed on a universal testing machine (Instron).

Tension tests are performed to determine a material's Young's modulus and tensile strength. During this test, a sample is pulled apart at a constant strain rate until it fails. The Young's modulus is calculated from the initial linear elastic portion of the resulting stress-strain curve, and the ultimate tensile strength is the maximum stress the material can withstand before fracturing.

Point Bending (Flexural) Tests Flexural tests can be used to measure the flexural modulus and the modulus of rupture (bending strength) A sample is placed on two supports and a force is applied to the center at a constant strain rate until the sample fails⁸. These tests can reveal the anisotropic nature of the material, as stiffness can vary depending on the orientation of the sample relative to the applied load.

Compression tests measure the compressive modulus and compressive strength. A cylindrical or rectangular specimen is placed between two plates and squeezed at a constant rate. The compressive modulus can be calculated from the linear part of the unloading stress-strain curve, while the compressive strength is defined as the peak stress the material sustains before failure or densification.

Additional properties that can be tuned with the engineered powder of the disclosure and related composition methods and systems comprise thermal stability.

The wording “thermal stability” as user herein indicates a material's ability to resist chemical decomposition at elevated temperatures. In the context of the of the present disclosure thermal stability refers to the temperature at which the biopolymer components of the composite, such as pectins, hemicelluloses, and cellulose, begin to break down. Accordingly, the wording “thermal stability”, as used herein, indicates a material's ability to maintain its structure and resist chemical decomposition at elevated temperatures. A material with higher thermal stability will maintain its structure and properties up to a higher temperature before degrading. For example, in embodiments here described phenolic compounds have the highest thermal stability of the biocomposite's components because they decompose at higher temperatures than the others.

Thermal stability can be detected with methods identifiable by a skilled person. A primary method described in the documents for detecting and quantifying the thermal stability of the biocomposite is Thermogravimetric Analysis (TGA). The TGA measurement involves heating a small sample of the material from room temperature up to a high temperature (e.g., 1000° C.) at a constant, controlled heating rate (e.g., 1° C./min) in an inert atmosphere, such as nitrogen (N₂) flow. During this process, the instrument continuously measures the mass of the sample as a function of temperature.

The resulting data is plotted as a TGA curve, which shows distinct steps of mass loss. Each step corresponds to the decomposition temperature of a specific component within the biocomposite. Further analysis is performed using Derivative Thermogravimetry (DTG), which plots the first derivative of the TGA curve. The peaks on the DTG curve indicate the precise temperatures at which the maximum rate of degradation occurs for each component, such as pectins, hemicelluloses, and cellulose.

Accordingly, the thermogravimetric analysis (TGA). involves heating a sample of the material at a constant rate in an inert atmosphere and continuously measuring its mass as a function of temperature. The primary parameter derived from this analysis is the onset of decomposition temperature, which is the temperature at which significant mass loss begins to occur. In certain preferred embodiments, the biocomposite is engineered to have an onset of thermal decomposition of at least 200° C. as will be understood by a skilled person.

A further property that can be tuned with the engineered powder of the disclosure and related composition methods and systems comprises barrier function.

The term “barrier function”, as used herein, indicates a tunable property of the biocomposite that describes its ability to resist the permeation of substances, particularly water. This function is directly related to the material's surface wettability (hydrophobicity) and its resistance to water absorption, which affects its durability and suitability for applications in humid environments or in contact with liquids. The barrier function can be engineered by selecting specific feedstocks; for example, biocomposites made from mixed-strain wastewater feedstocks like Hilmar and Delhi can be made hydrophobic.

The barrier function of a material can be detected with methods identifiable by a skilled person. The barrier function of the biocomposite can primarily detected and quantified using two methods: static water contact angle measurements using the Static Water Contact Angle Measurement with initial contact angle measurement herein described and water uptake tests.

The Static Water Contact Angle Measurement with initial contact angle measurement herein described is used to determine the surface wettability or hydrophobicity of the biocomposite in accordance with the present disclosure. The test is performed using a goniometer, where a small droplet of deionized water (e.g., 2 μL) is deposited onto the material's surface using the sessile drop method. The angle formed between the droplet and the surface is measured immediately ( 1/10 of a second to 2 second range). A static water contact angle greater than 90° indicates a hydrophobic, water-resistant surface.

In particular, the Static Water Contact Angle Measurement with initial contact angle measurement can be performed on a DataPhysics OCA 50 goniometer using the sessile-drop method at room temperature. A 2 μL droplet of deionized water is dispensed onto each specimen from a distance of 0.2-3 mm (avoiding bounce or spread from excess height), images are captured immediately ( 1/10 of a second to 2 second range) using the instrument's built in high speed camera, and the contact angle is computed from the droplet profile in the OCA software (dpiMAX/Dipmax). Typically, at least three measurements are taken per sample type and averaged to give the contact angle for that specimen.

The Water Uptake and Thickness Swelling Tests measures the bulk absorption of water by the biocomposite. Dry samples of a known mass and dimension are completely immersed in distilled water for a set period, such as 2 or 24 hours⁹. After immersion, the samples are removed, dried of excess surface water, and their relative mass increase and volume (thickness) increase are measured. The results, expressed as a percentage of weight gain (water uptake) and volume increase (thickness swelling), quantify the material's sensitivity to water.

In embodiments of the present disclosure, the primary result effective variables a dried feedstock biomass which can be operated to tune one or more material property of a final biocomposite, are lipid/protein ratio, carbohydrate component of the dried biomass, as well as water content and morphology.

In some embodiments of the method, the dried feedstock biomass is selected or modified based on at least one tunable property of the bio-composite to achieve a target lipid-to-protein ratio. This biochemical ratio is a primary “result-effective variable” or “tuning dial” used to control the mechanical profile, particularly the balance between stiffness and toughness, of the final tuned bio-composite. The relative percentages of these hydrophilic (protein) and hydrophobic (lipid) components can be modulated to achieve a desired balance of stiffness and toughness also in view of the particle morphology as will be understood by a skilled person upon reading of the present disclosure.

In certain embodiments for fabricating a stiff and rigid biocomposite, a feedstock is selected having a high protein content, for example greater than 40% by dry weight. The abundance of protein, a hydrophilic biopolymer, provides more sites for the formation of the hydrogen-bond network that self-adheres the particles, resulting in a more cohesive and densely interconnected matrix that is highly resistant to deformation.

In other embodiments for fabricating a tough and flexible biocomposite, the lipid content is modulated in synergy with the particle morphology. In one such embodiment, a feedstock with a higher lipid content, for example greater than 30% by dry weight, is selected, wherein the lipids act as an intrinsic plasticizer to increase the flexibility of the matrix.

In some embodiments, selection or modification of the carbohydrate content of the biomass can also be desired in particular to achieve high stiffness and strength, a feedstock can be selected or modified to achieve a high proportion of crystalline polysaccharides like cellulose to serve as the primary reinforcement. To ensure the material has good cohesion, toughness, and processability, the same feedstock can be selected or modified to also contains a sufficient amount of amorphous polysaccharides to act as an effective intrinsic binder.

In some embodiments, selection or modification of the carbohydrate content of the biomass can also be desired an optimal balance of both crystalline and amorphous carbohydrates to achieve the desired combination of stiffness and toughness. In those embodiments selection or modification of a feedstock biomass can is performed with protein content which also contributes to the binding matrix, while the lipid content acts as a plasticizer that modulates the overall stiffness imparted by the carbohydrate backbone as will be understood by a skilled person upon reading of the present disclosure.

In certain preferred embodiments, regardless of the specific protein-to-lipid ratio, the feedstock biomass is selected such that the combined content of protein and carbohydrates is greater than 50% by dry weight. In those embodiments, the engineered powder contains a sufficient mass fraction of hydrophilic biopolymers to enable the formation of the strong, hydrogen-bonded network that is central to the self-adhesion and consolidation of the binder-free composite. This characteristic also functionally excludes feedstocks with excessively high lignin or ash content that would interfere with this mechanism.

In some embodiments, once a target lipid/protein ratio and target carbohydrate content and composition is determined, the corresponding target biomass composition can be obtained by selecting a biomass which comprises the lipid and protein in the desired amounts. These embodiments are preferred, as the composition is achieved with a biomass that naturally contains the desired profile without need of an additional biochemical modification. In some embodiments should biomass fail to contain the desired amounts of lipid and proteins following identification of the composition of initial biomass the composition is optionally chemically modified: to meet the target profile. Actively altering the composition of a starting biomass can include blending different biomass types (e.g., a high-protein algae with a high-lipid algae) or other chemical treatments to adjust the relative content of proteins and lipids.

In most preferred embodiments, the biomass composition is selected or modified to have lipid content, protein content carbohydrate content within the compositional window defined by the following combination of protein Content: 40% to 70% (by dry weight) lipid content: 5% to 65% (by dry weight), carbohydrate content: 25% to 40% (by dry weight) and Initial Water Content: <15% (by weight). In those embodiments, the resulting feedstock biomass defines a versatile and highly tunable platform for engineering biocomposites as will be understood by a skilled person. Each component range within the most preferred compositional window serves a distinct and synergistic function, allowing a person of ordinary skill in the art to predictably control the final material properties.

In embodiments, wherein the initial water content is selected to be less than 15% by weight is preferred as it defines the material as a stable, dried feedstock. This provides a consistent and controlled starting point for fabrication. For the thermo-mechanical route, a dry powder is required to prevent the formation of steam and voids during hot-pressing. For the aqueous plasticization route, starting from a known dry state is important for the subsequent step of controlled rehydration, which is essential for forming the hydrogen-bond network that gives the final binder-free composite its structural integrity.

In embodiments, wherein the carbohydrate content is selected to be within the range of 25% to 40% by dry weight, of carbohydrate content, the resulting biopowder will have a fundamental structural backbone of the material optimized for tunability by lipid and protein components. If the carbohydrate content is above this range, the material can become brittle and lose its capacity to be tuned by the other components. If the carbohydrate content is below this range, the material may lack a sufficient structural backbone to form a robust composite, instead behaving more like a soft, waxy solid as will be understood by a skilled person.

In embodiments, wherein the protein content is selected to be within the range of 40% to 70% by dry weight, the resulting biopowder will have a protein content optimized for stiffness, rigidity, and thermal stability. A higher protein content provides more sites for the formation of a cohesive hydrogen-bond network during consolidation, resulting in a stiffer and more thermally stable material.

In embodiments, wherein the lipid content is selected to be within the range of 5% to 65% by dry weight the resulting biopowder will have a lipid content optimized for the full spectrum of tunability for toughness and flexibility. Lipids act as an intrinsic plasticizer, and the optimal amount is selected in synergy with the particle morphology to achieve the desired level of toughness as will be understood by a skilled person upon reding of the present disclosure.

Accordingly, the biomass composition and in particular the lipid-to-protein ratio of the feedstock biomass is a primary result-effective variable, or “tuning dial,” for setting the mechanical profile of the final biocomposite in combination with the particle morphology primary result-effective variable, or microstructure dial of the mechanical properties of the biocomposite to be provided.

In the method of engineering biopowder the dried feedstock biomass is processed based on at least one tunable property of the bio-composite, by pulverizing the dried feedstock biomass to provide discrete particles having a target morphology which is also functional to the at least one tunable properties of the biocomposite material to be fabricated with the engineered bio-powder.

The term “pulverizing” as used herein with respect to a reference solid material, like a rock or dried biomass, indicates the action of reducing the material into a fine powder or dust. Accordingly, a pulverizing process in the sense of the disclosure involves applying mechanical forces that result in impact, compression, shear, and attrition to break down the solid material. In particular the pulverizing process, typically involves crushing, pressing, or rubbing the material until it breaks down into tiny particles.

In some embodiments, the pulverization of the dried feedstock biomass can be performed using a particle size reduction protocol, also referred to as comminution or grinding. This processing step is configured to obtain an engineered bio-powder with a specific and predetermined particle morphology. The pulverization can be performed on the dried biomass in a dry state (dry grinding) or with the biomass suspended in a liquid medium (wet grinding). The process involves applying mechanical forces that result in impact, compression, shear, and attrition to break down the material into discrete particles.

In some embodiments, the pulverization is carried out using mechanical grinding equipment. The equipment can be selected from a group consisting of a blade grinder, a coffee blender, a hammer mill, a pin mill, a disc mill, a knife mill, a jet mill (also known as a fluid energy mill), a vibration mill, a ball mill, or a mortar and pestle. The selection of a particular technique may be based on the inherent morphology of the starting biomass and the desired characteristics of the final powder, such as a target aspect ratio distribution.

In other embodiments, the pulverization step can comprise a cryogenic grinding process, also referred to as cryo-grinding or cryo-milling. In this method, the biomass is cooled to cryogenic temperatures before or during the comminution process. For example, the biomass, such as agricultural fibers, may be frozen with a cryogen, such as dry ice, to increase its brittleness, thereby facilitating fracture and size reduction in a grinding apparatus like a blade grinder. This technique is particularly suitable for temperature-sensitive materials or for achieving specific particle fracture patterns. After cryogenic grinding, the resulting powder can be dried to remove any residual moisture or cryogen.

In embodiments herein described, pulverization is a performed for a time and under conditions to turn dried algae into an “engineered bio-powder” with a specific morphology which is used in combination with the composition of the biomass as a result effective variable for creating biocomposites with at least one tuned material property.

The term particle “morphology”, as applied to the bio-powder of the disclosure, refers to the physical characteristics of the discrete, multi-cell particles that constitute the engineered powder. These characteristics include the shape, size, and three-dimensional structure of the individual particles. In some embodiments, the particle morphology is a primary result-effective variable, or “tuning dial,” that is deliberately controlled during the processing of the dried feedstock biomass. The morphology of the particles is a factor as it directly influences how the particles pack, interlock, and self-adhere during the consolidation process, which in turn governs the internal architecture and final mechanical properties, such as stiffness and toughness, of the tuned biocomposite.

In some embodiments, the engineered bio-powder can be described as having one of at least two distinct morphologies. In certain embodiments, the powder is characterized by a granular morphology, wherein the constituent particles are substantially equiaxed or spheroidal, with dimensions that are approximately equal in all directions. This morphology is typical of powders derived from unicellular algae, such as Chlorella, and is conducive to forming a densely packed matrix. In other embodiments, the powder is characterized by a filamentous morphology, wherein the constituent particles possess a fiber-like, thread-like, or flake-like structure on the surface of the particle while the geometry of the particle can be round, elongated or amorphous as will be understood by a skilled person. This morphology is typical of powders derived from filamentous algae, such as Tribonema or the mixed-strain Hilmar feedstock, and promotes the formation of an interlocking network within the composite.

In embodiments of the disclosure, pulverizing the dried feedstock biomass is thus a particle size reduction protocol performed to provide discrete particles for the fabrication of a tuned bio-composite. This processing step, also referred to as comminution, is used to obtain an engineered bio-powder with a specific and predetermined particle aspect ratio distribution. The selection of a particular pulverization technique is based on the inherent morphology of the starting dried biomass, such as whether it is filamentous or granular in nature, and the desired characteristics of the final powder.

In some embodiments, pulverizing a dried biomass can be performed by selecting a pulverization technique to either preserve or modify the original structure of the biomass particles in view of a target powder aspect ratio and aspect powder distribution selected in turn based on the material properties of the biocomposite to be manufactured with the resulting engineered biopowder.

The term “aspect ratio” as used herein refers to a measure of a particle's elongation. The aspect ratio of a particle is specifically calculated as the horizontal Feret diameter divided by the vertical Feret diameter of a particle fragment. This ratio quantifies the shape of the individual particles that make up a powder is used as a defining characteristic of the particles to quantitatively define and control these different morphologies.

In particular, in embodiments, herein described, particles with a granular or equiaxed morphology are characterized by having an aspect ratio approaching 1.0. In contrast, particles with a filamentous or fiber-like morphology are characterized by having a high aspect ratio, for example, a value greater than 1.5 or, in some cases, greater than 2.0.

In embodiments herein described, by engineering a powder to have a specific and predetermined distribution of particle aspect ratios, the final mechanical properties of the biocomposite can be predictably tuned.

The term “aspect ratio distribution” as used herein refers to the statistical summary of the aspect ratios for the entire plurality of particles within an engineered powder. This distribution serves as a quantitative “fingerprint” for the powder and is a key result-effective variable that is configured to fabricate a tuned bio-composite. The distribution can be visualized and analyzed using methods such as Cumulative Distribution Functions (CDFs) and Kernel Density Estimates (KDEs).

The character of the distribution indicates the overall morphology of the powder:

For example, a. narrow, unimodal, and symmetric distribution centered at a low aspect ratio (e.g., ≈1.2) is characteristic of a uniform powder composed of substantially granular particles. Conversely a broad, right-skewed, or bimodal distribution indicates a powder containing a substantial population of elongated, high-aspect-ratio particles, which is typical of a filamentous material as will be understood by a skilled person.

In the context of the disclosure, an aspect ratio distribution that is described as narrow, unimodal, and symmetric refers to a population of discrete particles that are highly uniform in their shape. Such a distribution is characteristic of an engineered powder composed of substantially equiaxed or granular particles, wherein the vast majority of particles have a similar, low aspect ratio centered around a single, most frequent value.

The term “unimodal” indicates that the distribution has a single, distinct peak, meaning that there is one most common aspect ratio value around which the other particles are clustered. This single peak is centered at a low value, specifically at an aspect ratio ranging from 1.1 to 1.3., preferably having an aspect ratio of 1.2.

The term “symmetric” indicates that the distribution of aspect ratios is evenly balanced around this central peak. Quantitatively, this can be defined by the relationship between the distribution's median (the 50th percentile) and its mode (the peak). A distribution is considered evenly balanced when its median value is within approximately +10% of its modal value.

The term “narrow” indicates that the particles do not deviate significantly from the central, most common aspect ratio, which signifies a high degree of uniformity in the particle shapes throughout the powder. Narrow distribution can be quantitatively defined as a distribution where greater than 90% of the particles have an aspect ratio of less than 1.5. This type of distribution is typically engineered to promote dense particle packing during the consolidation of the biocomposite.

A narrow, unimodal, and symmetric aspect ratio distribution is quantitatively defined as a distribution where the single central peak (unimodal) is located at an aspect ratio of approximately 1.2, and where greater than 90% of the particles have an aspect ratio of less than 1.5 (narrow and symmetric).

This specific quantitative profile is characteristic of an engineered powder with a granular morphology, composed of substantially uniform and equiaxed particles,

As used herein, the term “substantially granular” refers to a powder composed of particles that are predominantly equiaxed. This is quantitatively defined by the powder's aspect ratio distribution. In a preferred embodiment, a powder is defined as being substantially granular and having a narrow distribution when greater than 90 percent of the particles by count have an aspect ratio of less than 1.5. Exemplary substantially granular powder is provided by the powder reported in the Examples section derived from Chlorella and Delhi feedstocks. This type of precisely defined distribution is engineered to promote efficient and dense particle packing during consolidation, which in turn results in a biocomposite with high stiffness and rigidity.

In embodiments herein described, the statistical distribution of the aspect ratios of the discrete particles within the powder defines the particle morphology of the engineered bio-powder as a primary result-effective variable, or “microstructure dial,” that is deliberately controlled to determine how the mechanical properties of the final biocomposite. This physical characteristic is defined by. By engineering the powder to have a specific and predetermined aspect ratio distribution, the balance between stiffness and toughness in the final consolidated material can be predictably tuned.

In certain embodiments, to fabricate a tuned biocomposite with high stiffness and rigidity, an engineered bio-powder having a granular morphology is prepared. The powder is engineered such that greater than 90% of the discrete particles have an aspect ratio of less than 1.5. This distribution of substantially equiaxed particles promotes efficient and dense particle packing during consolidation, which results in a final material that is highly resistant to elastic deformation and thus exhibits high stiffness.

In other embodiments, to fabricate a tuned biocomposite with high toughness and flexibility, an engineered bio-powder having a filamentous morphology is prepared. The powder is engineered such that at least 10% of the discrete particles have an aspect ratio of greater than 2.0. This significant population of high-aspect-ratio particles forms an interlocking fibrous network within the consolidated matrix, which enables efficient stress transfer and energy-dissipating failure mechanisms, thereby imparting toughness and resistance to fracture. Accordingly in some embodiments where the starting biomass has a filamentous structure and the goal is to retain that high-aspect-ratio morphology, a gentler method such as a pestle-and-mortar can be used. For an intermediate level of processing, high-shear speed mixing can be employed, which causes some fracture of the filamentous structure if present. In embodiments where significant structural modification is desired, a more aggressive technique such as ball milling is selected, which causes significant fracture of any filamentous structure. For a starting biomass that already has a granular morphology, ball milling may result in the agglomeration and densification of the material. Other general grinding processes that can be used for comminution include blade grinders, coffee grinders, and high shear cryo grinding.

In some embodiments of the disclosure, the final mechanical properties of the biocomposite, particularly the balance between stiffness and toughness, are tuned by engineering the aspect ratio distribution of the discrete particles within the bio-powder. This is achieved through the selection of both the starting feedstock biomass and the specific pulverization method or methods used to create the powder, which together control the final particle morphology.

In certain embodiments, to fabricate a biocomposite with high toughness, high strength, and the ability to dissipate significant energy before failure, an engineered powder is prepared having a broad, right-skewed, or bimodal aspect ratio distribution. This distribution is characterized by a substantial population of elongated, filamentous particles.

A “substantial population” refers to a portion of the total particles in the engineered bio-powder that is large enough to significantly influence the final mechanical properties of the biocomposite, specifically imparting toughness and strength. Quantitatively, it is defined as a powder where at least 10% of the particles by count.

In some embodiments, for example, when the substantial population can form elongated filamentous particles, the powder can be engineered such that at least 10 percent of the particles by count exhibit an aspect ratio of 2.0 or greater, and in some cases, such that no more than 5 percent of the particles have an aspect ratio greater than 5.0. During consolidation, these high-aspect-ratio particles entangle and interlock to form an intrinsic reinforcing network within the self-adhered matrix. This network provides efficient stress transfer and enables energy-dissipating failure mechanisms such as fiber pull-out and crack bridging, thereby preventing catastrophic brittle failure. This embodiment can be obtained by selecting a feedstock with an inherently filamentous morphology and using a gentle pulverization method, such as a mortar and pestle, to preserve the native filament structure.

In other embodiments, to fabricate a biocomposite with high stiffness and rigidity, an engineered powder is prepared having a narrow, unimodal, and symmetric aspect ratio distribution. This distribution is characteristic of a powder consisting of substantially uniform, equiaxed, or granular particles. For example, the powder can be engineered such that greater than 90 percent of the particles have an aspect ratio of less than 1.5. These low-aspect-ratio particles pack more efficiently during consolidation, leading to a higher final density and a more continuous, monolithic matrix with minimized interstitial voids. This dense packing maximizes the inter-particle contact area available for self-adhesion, resulting in a very stiff material that is highly resistant to elastic deformation. This embodiment can be performed by selecting a feedstock with a granular morphology or by using an aggressive pulverization method, such as a high-shear speed mixer or ball mill, to fracture a filamentous feedstock into granular fragments.

In further embodiments, the desired particle size and aspect ratio distribution can be achieved using a multi-step pulverization process. Such a process may comprise using a more aggressive comminution method initially to achieve a general particle size reduction of the feedstock, followed by a gentler method to refine the particle morphology to the final desired distribution. The processing may also include a separate step for homogenizing or mixing different powders or components, for which an apparatus such as a coffee grinder or a speed mixer may be used.

In some embodiments, to fabricate a biocomposite with high stiffness, a high Young's Modulus, and high rigidity, an engineered powder is prepared having a narrow, unimodal, and symmetric aspect ratio distribution centered at a low value. In such embodiments, the powder consists of substantially uniform, equiaxed, or granular particles, for example, having a mean aspect ratio of less than 1.5. This morphology is specifically engineered to create a final material whose mechanical properties are dominated by dense particle packing.

In some embodiments, a low-aspect-ratio, granular particles of engineered powder pack more efficiently during the consolidation process, which leads to a higher final density and a more continuous, monolithic matrix with minimized interstitial voids.

In the context of the disclosure, a low-aspect-ratio, granular particle is a discrete particle that is substantially equiaxed or spheroidal in shape, meaning its dimensions are approximately equal in all directions, in contrast to an elongated, filamentous particle. While this describes the shape of an individual particle, the term is more precisely defined by the statistical characteristics of the engineered powder it comprises. In a preferred embodiment, an engineered powder composed of low-aspect-ratio, granular particles is quantitatively defined as having an aspect ratio distribution wherein greater than 90 percent of the particles by count have an aspect ratio of less than 1.5. The distribution for such a powder is also typically unimodal and symmetric, with a single central peak located at an aspect ratio of approximately 1.2.

An engineered powder with this specific distribution of low-aspect-ratio, granular particles is intentionally created to promote dense particle packing during the consolidation of the biocomposite. This efficient packing maximizes inter-particle contact and minimizes interstitial voids, which results in a final biocomposite with high stiffness and rigidity. This type of powder is characteristic of feedstocks such as unicellular algae like Chlorella, or may be produced by subjecting a filamentous feedstock to an aggressive pulverization method.

In embodiments where the particles of the biopowder have a dense packing maximizes the inter-particle contact area available for self-adhesion, such as through hydrogen bonding, resulting in a material that is highly resistant to elastic deformation and thus exhibits high stiffness. A person of ordinary skill in the art would realize this embodiment by selecting a feedstock with an inherently unicellular or granular morphology, such as Chlorella, or by using an aggressive pulverization method, such as a high-shear speed mixer or a ball mill, to fracture a filamentous feedstock into granular fragments. The resulting biocomposite would exhibit a high Young's Modulus and may present a planar, featureless fracture surface characteristic of a densely packed but potentially more brittle material.

In some embodiments of the disclosure, a person of ordinary skill in the art can predictably tune the final mechanical properties of the biocomposite by first selecting a target mechanical profile, such as a profile dominated by toughness versus one dominated by stiffness. Following this selection, the bio-powder is engineered to have a particle aspect ratio distribution that corresponds to the selected target profile. This is achieved through the selection of both the starting feedstock biomass and the specific pulverization method, as these two factors together control the final particle morphology of the engineered powder and thus the performance of the final consolidated biocomposite.

In some embodiments, the engineered bio-powder is characterized by a specific and predetermined particle aspect ratio distribution that is configured to produce a biocomposite with high toughness and strength.

In a preferred embodiment, the engineered bio-powder is prepared to have an aspect ratio distribution wherein a substantial population of the discrete particles are elongated. This is quantitatively defined such that at least 10 percent of the particles by count exhibit an aspect ratio of 2.0 or greater. This characteristic is typical of powders derived from filamentous feedstocks, such as Tribonema and Hilmar, where the population of particles having an aspect ratio of 2.0 or greater may be approximately 20 percent. This is distinct from powders derived from granular feedstocks, such as Chlorella and Delhi, wherein the population of particles with an aspect ratio of 2.0 or greater is substantially smaller, for example between 2 and 5 percent. In certain further embodiments, the aspect ratio distribution may be further defined by an upper bound, wherein no more than 5 percent of the particles by count have an aspect ratio greater than 5.0.

In embodiments of the disclosure, the particle morphology obtained by the pulverization can also be defined by a powder with a target mean particle volume as will be understood by a skilled person which is also selected in view of the desired properties of the biocomposite to be prepared with the biopowder.

The term “mean particle volume” as used herein refers to the average three-dimensional (3D) volume of the discrete, multi-cell particles that constitute the engineered bio-powder. The mean particle volume is a result-effective variable that is deliberately controlled through the pulverization process to influence the packing density and pore structure of the final consolidated biocomposite.

In embodiments of the disclosure the mean particle volume is selected to be within a range from 1.0×10² μm³ to 1.0×10⁷ μm³ and in some preferred embodiments where the biomass comprises and in particular is primarily composed from 1.0×10³ μm³ to 1.0×10⁶ μm³ depending on the cell composition of the dried feedstock biomass used to provide the bio-powder.

In some embodiments, the broader range for the mean particle volume encompass embodiments wherein the dried feedstock biomass comprises plant cells, such as those from agricultural waste, in addition to or in place of algal cells. For example, particulate residues such as almond shells can include fine particulates with volumes as low as approximately 1.0×10² μm³. In other examples, fibrous and woody materials such as switchgrass, corn stover, and pine may consist of larger fragments and elongated particles, with volume distributions extending up to approximately 1.0×10⁷ μm³.

Therefore, in a preferred embodiment, compositions where the dried feedstock biomass is a mixture of algal cells and plant-derived particles from agricultural or woody waste, the mean particle volume of the discrete particles is described as being within the range of approximately 1.0×10² μm³ to 1.0×10⁷ μm³ and accounts for the inherent heterogeneity and different morphological characteristics of various plant-derived materials that can be used in the engineered bio-powder as will be understood by a skilled person.

In embodiments herein described the mean particular volume can also be selected in function of the properties of the biocomposite to be fabricated, since this parameter that also influences the packing dynamics, pore structure, and final density of the consolidated biocomposite as will be understood by a skilled person upon reading of the present disclosure. For example, a powder with a smaller mean particle volume, like that from Chlorella (≈1.37×10⁴ μm³), packs densely but leaves less room for further densification during pressing, which can affect the final mechanical properties.

The mean particle volume is obtained and controlled by the selected pulverization technique and its intensity. Different methods, such as blade grinding, ball milling, or hammer mill, knife mill, coffee blender or using a mortar and pestle, will fracture and reduce the starting dried biomass to varying degrees, resulting in a powder with a specific and predetermined mean particle volume. The volume of the individual particles can be determined experimentally using an optical microscope to capture images of the powder at various magnifications. Subsequently, image analysis software is used to segment the particles in the micrographs, from which their three-dimensional volumes are measured and an average is calculated.

In some embodiments, the particle size, volume, and morphology of the engineered bio-powder can be determined using various analytical techniques. Such techniques can comprise, laser diffraction particle size analysis, three-dimensional reconstruction from scanning electron microscopy images, or an electrical sensing zone method.

In certain embodiments configured to produce a biocomposite with high toughness, the engineered powder is characterized by an aspect ratio distribution wherein at least 10 percent of the particles by count exhibit an aspect ratio of 2.0 or greater. This distribution is characteristic of powders derived from filamentous feedstocks such as Tribonema and Hilmar, which may have approximately 20 percent of particles above this threshold, and is distinct from powders derived from granular feedstocks such as Chlorella and Delhi, which may have only 2 to 5 percent of particles above the same threshold. In further preferred embodiments, the aspect ratio distribution may be further defined by an upper bound to prevent undesirable effects such as particle clumping or poor consolidation, wherein the engineered powder is prepared such that no more than 5 percent of the particles by count have an aspect ratio greater than 5.0.

In other embodiments, the engineered powder can be characterized by a ratio of the particles' aspect ratio to their volume. An effective engineered powder for reinforcement may be defined as having a high aspect ratio relative to its volume. This ratio serves to distinguish particles that are functionally fibrous and provide effective mechanical interlocking from particles that may be large in volume but are not sufficiently elongated to contribute to a reinforcing network.

In addition to the biochemical composition and morphology, in some embodiments, the dried biomass composition can have a target density depending on the properties of the final consolidated biocomposite and the methods for the related fabrication available or selected among the approaches identified in the present disclosure (thermoplastic route or wet route). A higher final density in the monolithic body, typically ranging from approximately 0.89 g/cm³ to 1.46 g/cm³ depending on the feedstock and processing method, is an important indicator of structural integrity as will be understood by a skilled person. This is because a denser material signifies more efficient particle packing and the successful elimination of interstitial voids that can act as stress concentrators and weaken the composite. As demonstrated in the examples, processing methods that lead to a denser, better-packed matrix can result in a significant increase in the material's mechanical strength. Exemplary density values for exemplary algal biomass are reported in Table 1A and Table 1B

TABLE 1A

| | Density (grams) ± SD of high pressure |
|---|---|
| Algae Name | bulk biocomposites: |
| Chlorella | 1.131 ± 0.0089 |
| Tribonema | 0.893 ± 0.0076 |
| Hilmar | 1.457 ± 0.0248 |
| Delhi | 1.309 ± 0.0163 |

TABLE 1B

| | Density of loose powders before |
|---|---|
| Algae Name | compaction: |
| Switchgrass 0 | 0.372 |
| Switchgrass I | 0.299 |
| Switchgrass II | 0.275 |
| Almond shells | 0.536 |
| Hilmar algae | 0.860 |
| Switchgrass III | 0.374 |
| Chlorella | 0.699 |
| Tribonema | 0.324 |
| Delhi | 1.009 |

In some embodiments of the method the dried feedstock the pulverization of the processing step is comprised: alone or in combination with the optional chemical modification of the dried feedstock biomass; and/or of the discrete particles, forming the bio-powder.

In some of those embodiments the chemical modification can be performed on the biomass and/or the particles to adjust the protein, lipid carbohydrate and/or water content of the biomass and/or the particles obtained to meet target protein, lipid carbohydrate and/or water content in view of the material properties desired in the biocomposite to be produced with the engineered bio-powder.

In the method, the processing is performed to obtain engineered bio-powder having an engineered bio-powder composition including powder protein %, powder lipid %, powder carbohydrate %, powder aspect ratio distribution and a mean particle volume ranging from 1.0×10³ μm³ to 1.0×10⁶ μm³, configured for fabricating the tuned bio-composite, in which the least one tunable property of the bio-composite is selected from a mechanical property, thermal stability and barrier function of the bio-composite.

For example, in some embodiments, to achieve a biocomposite with high stiffness and strength, a feedstock with a high protein content, for example greater than 40%, is selected. This feedstock is then processed to create an engineered powder with a granular morphology, wherein greater than 90% of the particles have an aspect ratio of less than 1.5. This powder is then blended with a fibrous, epoxy-coated filler and consolidated using a thermo-mechanical route at a temperature of at least 150° C. and a pressure of at least 200 MPa.

In other exemplary embodiments, to create a biocomposite with enhanced flexibility and toughness, a feedstock with a balanced protein and carbohydrate content can be selected. This feedstock is processed to generate an engineered powder with a more fibrillar or heterogeneous morphology, where a significant fraction of the particles have an aspect ratio greater than 2.0. This powder can then be consolidated using a lower-energy thermo-mechanical route. This process utilizes a temperature below 120° C., for example in the range of 90° C. to 110° C., and a pressure of less than 100 MPa. This method is designed to achieve good particle fusion without making the resulting biocomposite overly brittle, thereby yielding a material with increased fracture toughness suitable for applications requiring impact resistance.

In some embodiments to achieve a biocomposite with high toughness and flexibility, a feedstock with a higher lipid content, for example greater than 30%, is selected. This feedstock is processed to create an engineered powder with a filamentous morphology, wherein at least 10% of the particles have an aspect ratio greater than 2.0. This powder is then consolidated using an aqueous plasticization route, wherein the powder is rehydrated with approximately 40% water by weight before being compressed at a temperature below 100° C.

In some embodiments to achieve a biocomposite with a hydrophobic barrier function, a feedstock is selected from a mixed-strain microbial community, such as the algae harvested from a wastewater treatment facility. This feedstock can then be consolidated using either a thermo-mechanical route to also achieve high strength or an aqueous plasticization route for a binder-free version.

In some embodiments, to achieve a biocomposite with a balance of stiffness and toughness, a feedstock with a balanced biochemical profile, such as a protein content of 30-40% and a lipid content of 30-40%, is selected. This feedstock is then engineered into a powder with an intermediate or bimodal aspect ratio distribution, characterized by significant populations of both low-aspect-ratio (less than 1.5) and high-aspect-ratio (greater than 2.0) particles.

In some embodiments, the tuned mechanical property comprises high toughness. Toughness is defined as the material's ability to dissipate significant energy under load and resist brittle fracture. This property can be achieved through a mechanism of mechanical interlocking, wherein long, high-aspect-ratio filamentous particles physically entangle during consolidation to create an intrinsic reinforcing network within the biocomposite. When under load, this network enables energy-dissipating failure mechanisms, such as crack-bridging and fiber pull-out. The presence of such failure mechanisms may be detected by analyzing the fracture surfaces of the material.

In a specific exemplary embodiment, a biocomposite with high toughness and strength can be fabricated by leveraging a synergy between particle morphology and biochemistry. For example, in some embodiments, a feedstock with an inherently high-aspect-ratio, filamentous morphology can be selected to provide the primary toughening mechanism through mechanical interlocking. This feedstock can be further selected to have a low lipid content. In this binder-free system, the primary adhesion holding the particles together is a hydrogen-bond network between hydrophilic proteins and polysaccharides. In some of these embodiments a low lipid content is advantageous as it minimizes hydrophobic interference with this bonding, thereby increasing the overall strength and integrity of the matrix needed to hold the tough, interlocked fibrous structure together. To realize this embodiment, a person of ordinary skill in the art would select a filamentous feedstock and use a gentle pulverization method, such as a mortar and pestle, to preserve the fibrous structure of the particles before consolidation. The resulting biocomposite exhibits enhanced toughness, and its fracture surfaces may be characterized by the presence of visible fibrous networks and evidence of fiber pull-out. In another preferred embodiment, particularly for feedstocks with a high-aspect-ratio, filamentous morphology, a feedstock is selected having a low lipid content, for example less than 15% by dry weight. In this configuration, the material's toughness is primarily derived from the mechanical interlocking of the filaments, and a lower lipid content is advantageous as it minimizes hydrophobic interference with the hydrogen-bonding mechanism that provides the matrix its cohesive strength.

In some embodiments, the tuned mechanical property comprises thermal stability of the biocomposite. In those embodiments, the thermal stability can be tuned by selecting a feedstock with a high protein content. A higher protein content in the biomass is correlated with improved thermal stability in the final consolidated material. To achieve a biocomposite with high thermal stability, a feedstock with a protein content approaching 70% by dry weight may be selected. In an embodiment directed to achieving both high thermal stability and high stiffness, a feedstock with the highest possible protein content is selected and processed to form a granular powder.

In some embodiments, the tuned mechanical property comprises the material barrier function. In those embodiments, a biocomposite with a hydrophobic barrier function can be fabricated by selecting a specific type of feedstock biomass. It has been found that biocomposites made from a mixed-strain microbial community, such as the algae harvested from wastewater treatment facilities like the Hilmar or Delhi feedstocks, result in a hydrophobic surface. In an embodiment directed to achieving both high mechanical strength and a hydrophobic barrier, a mixed-strain microbial feedstock that also has a high protein content, for example greater than 40%, is selected and consolidated using a thermo-mechanical process.

In some embodiments of the method of engineer a biopowder herein described the dried feedstock biomass comprises plant cells or cells from agricultural residues.

In some embodiments of the method of engineer a biopowder herein described dried feedstock biomass comprises algal cells and the mean particle volume of the engineered bio-powder ranges from approximately 1.0×10³ μm³ to 1.0×10⁶ μm³.

In some embodiments of the method of engineer a biopowder herein described the dried feedstock biomass has a composition comprising a protein content from 40% to 70% by dry weight, a lipid content from 5% to 65% by dry weight, and a carbohydrate content from 25% to 40% by dry weight.

In some embodiments of the method of engineer a biopowder herein described the at least one tunable property comprises high stiffness and rigidity, and wherein the dried feedstock biomass is selected to have a protein content of greater than 40% by dry weight.

In some embodiments of the method of engineer a biopowder herein described the pulverizing is controlled to obtain an engineered bio-powder having a narrow, unimodal, and symmetric aspect ratio distribution, wherein greater than 90% of the discrete particles have an aspect ratio of less than 1.5.

In some embodiments of the method of engineer a biopowder herein described the feedstock biomass comprises a filamentous biomass and the pulverizing is performed by a high-shear speed mixer or a ball mill to fracture the filamentous feedstock biomass into granular particles.

In some embodiments of the method of engineer a biopowder herein described the feedstock biomass comprises a granular feedstock, and the pulverizing is performed by a high-shear speed mixer or a ball mill to agglomerate the granular feedstock.

In some embodiments of the method of engineer a biopowder herein described the at least one tunable property comprises high toughness and flexibility, and wherein the dried feedstock biomass is selected to have a lipid content of greater than 30% by dry weight.

In some embodiments of the method of engineer a biopowder herein described the at least one tunable property comprises high toughness and flexibility, and wherein the pulverizing is controlled to obtain an engineered bio-powder having a broad, right-skewed, or bimodal aspect ratio distribution, wherein at least 10% of the discrete particles have an aspect ratio of 2.0 or greater.

In some embodiments of the method of engineer a biopowder herein described the aspect ratio distribution is further characterized in that no more than 5% of the discrete particles have an aspect ratio greater than 5.0.

In some embodiments of the method of engineer a biopowder herein described the pulverizing comprises a gentle pulverization method, such as a mortar and pestle, to preserve a native filamentous structure of the feedstock.

In some embodiments of the method of engineer a biopowder herein described the at least one tunable property is a hydrophobic barrier function, and wherein the dried feedstock biomass comprises a mixed-strain microbial community.

In some embodiments of the method of engineer a biopowder herein described the engineered bio-powder is configured to fabricate a tuned bio-composite having a Young's Modulus of greater than 900 MPa and a Compressive Strength of greater than 100 MPa.

In some embodiments of the method of engineer a biopowder herein described the dried feedstock biomass is selected to have a protein content equal to or greater than 40% by dry weight and the processing is performed to obtain an engineered bio-powder wherein greater than 90% of particles have an aspect ratio of less than 1.5.

In some embodiments of the method of engineer a biopowder herein described the engineered bio-powder is configured to fabricate a tuned bio-composite having a Flexural Strength of greater than 10 MPa.

In some embodiments of the method of engineer a biopowder herein described the dried feedstock biomass is selected to have a lipid content equal to or greater than 30% by dry weight and the processing is performed to obtain an engineered bio-powder wherein at least 10% of particles have an aspect ratio greater than 2.0.

In some embodiments of the method of engineer a biopowder herein described the engineered bio-powder is configured to fabricate a tuned bio-composite having a Young's Modulus between 400 MPa and 800 MPa and a Compressive Strength between 40 MPa and 80 MPa.

In some embodiments of the method of engineer a biopowder herein described the dried feedstock biomass has a protein content ranging from 30-40% by dry weight and a lipid content ranging from 30-40% by dry weight, and the processing is performed to obtain an engineered bio-powder comprising a bimodal aspect ratio distribution with at least 10% of particles having an aspect ratio of less than 1.5 and at least 10% of particles having an aspect ratio of greater than 2.0.

In some embodiments of the method of engineer a biopowder herein described the engineered bio-powder is configured to fabricate a tuned bio-composite having a thermal stability characterized by an onset of thermal decomposition of greater than 200° C.

In some embodiments of the method of engineer a biopowder herein described the dried feedstock biomass has a protein content ranging from 65% to 70% by dry weight and the processing is performed to obtain an engineered bio-powder wherein greater than 90% of particles have an aspect ratio of less than 1.5.

In some embodiments of the method of engineer a biopowder herein described the engineered bio-powder is configured to fabricate a tuned bio-composite having a barrier function characterized by a hydrophobic surface with a static water contact angle of greater than 100 degrees.

In some embodiments of the method of engineer a biopowder herein described the processing comprises chemically modifying the dried feedstock biomass or the discrete particles.

In some embodiments of the method of engineer a biopowder herein described the chemical modification comprises blending particles from at least two different biomass sources to achieve a target composition or particle morphology.

In some embodiments of the method of engineer a biopowder herein described the chemical modification is a surface treatment selected from the group consisting of an alkali treatment, silanization, acylation, an isocyanate treatment, and a plasma treatment.

In some embodiments of the method of engineer a biopowder herein described the chemical modification is a bulk modification selected from the group consisting of plasticization, graft copolymerization, and cross-linking.

In some embodiments of the method of engineer a biopowder herein described the pulverizing is performed using a method selected from the group consisting of a blade grinder, a ball mill, a hammer mill, a knife mill, a coffee blender, a mortar and pestle, a pin mill, a disc mill, a jet mill, a vibration mill, cryogenic grinding, and combinations thereof.

In embodiments herein described the methods for engineering a dried feedstock biomass results in an engineered bio-powder configured for fabricating a tuned bio-composite, the bio-powder comprising a plurality of discrete, multi-cell particles derived from a dried feedstock biomass,

In embodiments herein described, the engineered bio-powder has a composition comprising: a) a powder protein content, a powder lipid content, and a powder carbohydrate content, wherein each content is a percentage of the dry weight of the particles; b) a powder aspect ratio distribution; and c) a mean particle volume ranging from 1.0×10² μm³ to 1.0×10⁷ μm and in some preferred embodiments from 1.0×10³ μm³ to 1.0×10⁶ μm³. In the engineered bio-powder the composition is configured to fabricate a tuned bio-composite having at least one tunable property selected from a mechanical property, thermal stability, and a barrier function.

In some embodiments of the disclosure, the engineered bio-powder is specifically configured to produce a biocomposite having a controlled combination of high-performance properties. The biochemical composition and the particle morphology of the powder are deliberately selected and engineered to achieve a final material with a predetermined set of target property thresholds.

In an exemplary embodiment, the engineered bio-powder is configured to produce a biocomposite having a Young's Modulus of greater than 900 MPa and a Compressive Strength of greater than 100 MPa. To achieve this, the bio-powder is prepared from a feedstock having a high protein content, for example greater than 40 percent by dry weight. The powder is further engineered to have a granular morphology, wherein greater than 90 percent of the particles have an aspect ratio of less than 1.5. This type of powder is often intended for use in a thermo-mechanical fabrication route and may be blended with fibrous, epoxy-coated fillers to maximize the final mechanical properties.

In another exemplary embodiment, the engineered bio-powder is configured to produce a biocomposite having a Flexural Strength of greater than 10 MPa, which is indicative of high toughness and flexibility. To achieve this, the bio-powder may be prepared from a feedstock having a higher lipid content, for example greater than 30 percent by dry weight. The powder is also engineered to have a filamentous morphology, wherein at least 10 percent of the particles have an aspect ratio greater than 2.0, to promote mechanical interlocking.

In yet another exemplary embodiment, the engineered bio-powder is configured to produce a biocomposite having a hydrophobic surface with a static water contact angle of greater than 100 degrees. To achieve this enhanced barrier function, the bio-powder is prepared from a feedstock comprising a mixed-strain microbial community, such as a biomass harvested from a wastewater source. The morphology of this powder can be further engineered to achieve secondary mechanical properties as desired.

In a further exemplary embodiment, the engineered bio-powder is configured to produce a biocomposite having high thermal stability, with an onset of thermal decomposition of greater than 200° C. To achieve this, the bio-powder is prepared from a feedstock selected for its very high protein content, for example a protein content approaching 70 percent by dry weight, as a higher protein content is correlated with improved resistance to thermal degradation.

In some embodiments of the engineered bio-powder, the composition comprises a protein content from 40% to 70% by dry weight, a lipid content from 5% to 65% by dry weight, and a carbohydrate content from 25% to 40% by dry weight.

In some embodiments of the engineered bio-powder, the composition is configured to fabricate a tuned bio-composite with a Young's Modulus of greater than 900 MPa, and wherein the powder protein content is greater than 40% by dry weight and the powder aspect ratio distribution is characterized by greater than 90% of the discrete particles having an aspect ratio of less than 1.5.

In some embodiments of the engineered bio-powder, the composition is configured to fabricate a tuned bio-composite with a Flexural Strength of greater than 10 MPa, and wherein the powder lipid content is greater than 30% by dry weight and the powder aspect ratio distribution is characterized by at least 10% of the discrete particles having an aspect ratio of 2.0 or greater.

In some embodiments of the engineered bio-powder, the powder aspect ratio distribution is further characterized in that no more than 5% of the discrete particles have an aspect ratio greater than 5.0.

In some embodiments of the engineered bio-powder, the composition is configured to fabricate a tuned bio-composite with a balance of stiffness and toughness, and wherein the protein content is from 30% to 40% by dry weight, the lipid content is from 30% to 40% by dry weight, and the powder aspect ratio distribution is bimodal, the distribution comprising at least 10% of particles having an aspect ratio of less than 1.5 and at least 10% of particles having an aspect ratio of greater than 2.0.

In some embodiments of the engineered bio-powder, the discrete particles are derived from a dried feedstock biomass comprising a mixed-strain microbial community, and wherein the powder is configured to fabricate a tuned bio-composite having a hydrophobic surface with a static water contact angle of greater than 100 degrees.

In some embodiments of the engineered bio-powder, the discrete particles are derived from a dried feedstock biomass comprising algal cells, and wherein the mean particle volume ranges from 1.0×10³ μm³ to 1.0×10⁶ μm³.

In some embodiments of the engineered bio-powder, the plurality of discrete particles comprises a blend of particles derived from at least two different dried feedstock biomass sources.

In some embodiments of the engineered bio-powder, the discrete particles have been chemically modified.

In some embodiments of the engineered bio-powder, the chemical modification is a surface treatment selected from the group consisting of an alkali treatment, silanization, acylation, an isocyanate treatment, and a plasma treatment.

In some embodiments of the engineered bio-powder, the chemical modification is a bulk modification selected from the group consisting of plasticization, graft copolymerization, and cross-linking.

In some of those embodiments a chemical and/or physical modification can be performed on the particles to adjust the properties of the particle surface such as roughness as well as chemical properties of the particle surface.

The wording “surface roughness” as used herein refers to the fine-scale irregularities on the surface of the particles. This property is determined experimentally using techniques such as optical profilometry, which generates data for several defining parameters. These parameters include, but are not limited to, Ra (Arithmetic Mean Height), which is the average deviation of the profile from a mean line; Rz (Maximum Height of the Profile), which is the vertical distance between the highest peak and lowest valley; and RSm (Mean Width of Profile Elements), which is the average horizontal spacing between surface features. In certain embodiments, a higher surface roughness, particularly on filamentous or fibrous particles, is indicative of enhanced potential for mechanical interlocking, which contributes to the toughness and strength of the composite.

The chemical properties of the surfaces of the biomass particles are characterized by hydrophilic and hydrophobic components presented on the surface of the particles. The hydrophilic components, which include proteins and polysaccharides, are rich in polar functional groups that enable the formation of a strong hydrogen-bond network between adjacent particles during consolidation. This network is the primary adhesion mechanism in binder-free embodiments. The hydrophobic components, primarily lipids, can physically interfere with the formation of this hydrogen-bond network. The surface chemistry can be analyzed using methods such as Fourier-Transform Infrared Spectroscopy (FTIR), where shifts in absorption bands upon consolidation can confirm the formation of new hydrogen bonds.

In some embodiments, the surface roughness and chemical properties of the particles the engineered bio-powder can be advantageously further engineered to control the properties of the particles interface with optional additive components such as fillers or binders which can also be engineered to achieve controlled and improved properties of the resulting biocomposite.

in particular, in connection with those embodiments a method for improving the interfacial adhesion and resistance between the matrix and the additive in a biocomposite is described. The method comprises the steps of applying an epoxy system to the particles obtained by the method of engineering a biopowder, concurrently or after the processing of the dried biomass. In addition, or in the alternative the epoxy system can be applied to an additive before or concurrently with the related combination with the engineered bio-powder.

In particular, in some embodiments, a method for coating particles for use in a biocomposite to improve interfacial resistance is described, the method comprising:
a) providing a plurality of particles selected from the group consisting of an engineered bio-powder of any one of claims 28 to 39, a filler, and combinations thereof;
b) preparing a coating solution comprising an epoxy resin and a hardener dissolved in a solvent;
c) applying the coating solution to the plurality of particles to form coated particles; and
d) drying the coated particles to remove the solvent, and
e) curing the coating of the coated particle.

The curing the coating of the coated particles can be performed by heating the composite to activate the coating when the coating is heat activated or e2) UV curing if the epoxy is UV activated.

In particular, in some embodiments curing of the coating on the particles may be accomplished through thermal activation. In this embodiment, the coated particles are subjected to an elevated temperature for a predetermined period to facilitate the cross-linking of the epoxy resin system. The coated particles may be placed in a convection oven, a fluidized bed heater, or a similar apparatus capable of providing uniform heat distribution. The specific temperature may range, for example, from approximately 80 degrees Celsius to 200 degrees Celsius, depending on the specific formulation of the epoxy resin and hardener. The duration of the heating step is sufficient to achieve a complete cure and may last from several minutes to several hours. This thermal energy initiates and accelerates the polymerization reaction, transforming the liquid or semi-solid coating into a rigid, durable, and fully cross-linked thermoset layer that is chemically bonded to the surface of the particles.

In some embodiment, the curing of the coating can be performed using ultraviolet irradiation. This method is particularly suitable for epoxy formulations that incorporate a photoinitiator. The coated particles are exposed to a source of ultraviolet light, which emits radiation typically within a wavelength range of 200 to 400 nanometers. The exposure can be carried out by passing the particles under a high-intensity UV lamp, such as a mercury-vapor lamp or a light-emitting diode array. Upon exposure, the photoinitiator absorbs the ultraviolet energy and generates a reactive species that initiates a rapid polymerization of the epoxy resin. This process, often referred to as photocuring, can be completed in a matter of seconds to minutes and is typically performed at or near ambient temperature. The result is a fully cured, hardened polymeric coating on the particles, achieved without the need for significant thermal input.

In those embodiments of the epoxy system can used as a binder or coating to enhance the interfacial adhesion between the matrix and the fillers. As used herein, the wording “epoxy system” refers to a two-component system comprising an epoxy resin and a hardener, also known as a curing agent. The epoxy resin and hardener are typically dissolved in a solvent to form a coating solution that can be applied to the fillers prior to their incorporation into the biocomposite.

The term epoxy resin indicates a component of a two-part system that, when combined with a hardener, undergoes a chemical reaction (polymerization) to form a rigid and durable solid material. The reaction is initiated by the hardener and involves the epoxide groups within the resin molecules. The term can refer to a range of substances, including bio-based resins like Ecopoxy biopoxy 36 and Entropy Resins high biobased laminating epoxy, as well as other types such as poly(bisphenol A-co-epichlorohydrin) glycidyl end-capped, bisphenol A diglycidyl ether, and poly(ethylene glycol) diglycidyl ether.

The term “hardener”, also referred to as a curing agent, is the second component in an epoxy system. Its function is to initiate the chemical reaction that cures, or hardens, the epoxy resin by creating a cross-linked polymer network. The choice of hardener can influence the properties of the final material and the conditions required for curing, with some requiring elevated temperatures to achieve full polymerization. Hardeners can be selected from various chemical classes capable of reacting with the epoxy groups of the resin to form a rigid, cross-linked thermoset polymer network. The selection of a particular class of hardener can be used to tailor the properties of the resulting coating, including its cure schedule, thermal stability, chemical resistance, and mechanical toughness. Suitable classes of hardeners include, but are not limited to, amines, anhydrides, amides, polyamides, and phenalkamines. For instance, amine-based hardeners encompass aliphatic, cycloaliphatic, and aromatic amines, each imparting different characteristics to the cured epoxy. Anhydride hardeners are often selected for applications requiring high thermal and electrical resistance, while polyamide and phenalkamine hardeners can provide enhanced flexibility, adhesion, and moisture tolerance to the final coating.

In some embodiments, the hardener is an amide, such as dicyandiamide, which provides a latent cure that is activated by heat. In other embodiments, the hardener may be an amine, such as an aliphatic amine like diethylenetriamine (DETA), a cycloaliphatic amine like isophorone diamine (IPDA), or a high-performance aromatic amine like diaminodiphenyl sulfone (DDS) for enhanced thermal stability. Alternatively, an anhydride hardener may be selected, such as phthalic anhydride or nadic methyl anhydride (NMA). Furthermore, bio-based hardeners such as phenalkamines, which are derived from cashew nutshell liquid, may be used, being particularly suitable when paired with a bio-epoxy resin. It is also contemplated that combinations of these or other hardeners may be used to achieve a desired balance of properties in the cured coating.

In some embodiments, the hardener is an aliphatic amine, such as Tetraethylenepentamine (TEPA). This hardener may be used in combination with various epoxy resins. Suitable resins can include bio-based epoxy resins, such as the resin component of the Ecopoxy Biopoxy 36 kit or Entropy Resins high bio-based laminating epoxy. Additionally, the hardener may be used with synthetic epoxy resins, for example poly(bisphenol A-co-epichlorohydrin) glycidyl end-capped, bisphenol A diglycidyl ether, or poly(ethylene glycol) diglycidyl ether. A mixture of any of the foregoing epoxy resins may also be used.

In further embodiments, the hardener can be selected from a group consisting of bio-based hardeners, such as Ecopoxy biopoxy 36 kit resin part B or Entropy Resins high biobased slow laminating hardener, and synthetic hardeners, such as dicyandiamide, amine, anhydride, poly(ethylene glycol) bis(carboxymethyl) ether, or tetraethylenepentamine. A mixture of any of the foregoing hardeners can also be used. The solvent used to dissolve the epoxy system may be selected from a group consisting of methanol, ethanol, isopropanol, acetone, hexane, toluene, xylene, ethyl acetate, water, or a mixture thereof.

In some embodiments, the epoxy-coated fillers are prepared using an impregnation method. An epoxy solution is prepared by combining the epoxy resin and the hardener in a solvent. The mass ratio of the epoxy resin to the hardener may range from approximately 0.1 to 10. The concentration of the total epoxy system in the solvent may range from approximately 0.5 to 50 weight percent. The components can be mixed in various sequences and are shaken vigorously to ensure the solution is homogeneous. The prepared solution is then applied to the fillers gradually and uniformly, targeting a mass ratio of the epoxy system to the filler in the range of approximately 0.01 to 1. After application, the treated fillers may be left at room temperature to allow for initial solvent evaporation, for example for approximately 15 minutes, before being subsequently dried. The drying process is performed to remove the solvent and any absorbed moisture and may be carried out at a temperature ranging from approximately 20° C. to 150° C. for a duration ranging from approximately 0.1 to 100 hours.

In some embodiments of the disclosure, in addition to or in place of epoxy-based systems, other chemical or physical modifications may be applied to the feedstock biomass or the engineered bio-powder to further tune the interfacial properties, bulk characteristics, and final performance of the biocomposite. These modifications can be categorized as either surface modifications, which primarily alter the exterior of the particles, or bulk modifications, which alter the properties of the entire particle.

In certain embodiments, a surface modification is applied to the biomass particles to improve interfacial adhesion and compatibility. Such a modification may comprise an alkali treatment, also known as mercerization, wherein the biomass is treated with an alkaline solution, such as sodium hydroxide, to clean the particle surface, remove impurities, increase surface roughness, and expose more hydroxyl groups for stronger interfacial bonding. In another embodiment, the surface modification may comprise silanization, wherein the powder is treated with silane coupling agents that act as a chemical bridge between the hydrophilic surface of the biomass and a more hydrophobic matrix or filler, forming strong covalent bonds to improve stress transfer. In yet another embodiment, the surface modification may comprise acylation, such as acetylation, which involves reacting the hydroxyl groups on the biomass surface with an acylating agent to replace polar hydroxyl groups with less polar acetyl groups, thereby making the biomass more hydrophobic and improving its compatibility with nonpolar matrices.

In other embodiments, a bulk modification is applied to the particles to alter their fundamental properties, such as flexibility, processability, or thermal stability. Such a modification may comprise plasticization, wherein for a protein-rich or starch-rich biomass, plasticizers such as glycerol or urea are blended with the powder. These small molecules position themselves between the biopolymer chains, increasing free volume and chain mobility to reduce brittleness and increase the flexibility of the final material. In another embodiment, the bulk modification may comprise graft copolymerization, wherein new polymer chains are chemically grafted onto the backbone of the native biopolymers in the biomass, creating a hybrid material with significantly improved compatibility and adhesion. In a further embodiment, the bulk modification may comprise cross-linking, wherein the biomass is treated with cross-linking agents to form covalent bonds between the biopolymer chains, which increases the molecular weight and creates a more rigid network structure, leading to improved thermal stability, water resistance, and mechanical strength.

In various embodiments, the aforementioned surface or bulk modifications may be applied either to the raw feedstock biomass before the pulverization step or to the engineered powder itself after the pulverization step, providing multiple points in the process to deliberately engineer the material's final performance. In another embodiment, the engineered powder may comprise a blend of particles from different biomass sources to achieve a combination of properties. For example, a powder derived from a feedstock with a filamentous morphology, such as Tribonema, may be blended with a powder derived from a feedstock with a granular morphology, such as Chlorella, to fabricate a biocomposite with a balance of toughness derived from filament adhesion and high density derived from efficient granular packing.

In some embodiments of the disclosure, the biomass particles or fillers may be subjected to a physical surface treatment to alter the physical topography or energy of the particle surface without necessarily changing the bulk chemistry. These methods are used to improve the interfacial adhesion between the particles and the matrix in the final consolidated biocomposite.

In certain embodiments, the physical surface treatment comprises a plasma or a corona treatment. These methods involve using an electric discharge to activate the surface of the fiber or particle. The treatment can introduce new functional groups onto the surface, clean the surface of contaminants, and increase surface roughness through an etching effect. These effects can lead to significantly improved adhesion in the final composite through a combination of enhanced chemical bonding and mechanical interlocking.

In other embodiments, the physical surface treatment comprises the deposition of nanoparticles onto the surface of the fiber or particle. This deposition can be carried out using various methods, including but not limited to, electrophoretic deposition (EPD), chemical vapor deposition (CVD), or the in-situ growth of inorganic metal oxides, such as zinc oxide, via a hydrothermal synthesis process. The presence of these nanoparticles on the surface can improve adhesion and provide additional toughening mechanisms at the particle-matrix interface.

In some embodiments of the method to improve interfacial adhesion and/or resistance herein described, the epoxy resin is selected from the group consisting of a bio-based epoxy resin, poly(bisphenol A-co-epichlorohydrin) glycidyl end-capped, bisphenol A diglycidyl ether, poly(ethylene glycol) diglycidyl ether, and mixtures thereof.

In some embodiments of the method to improve interfacial adhesion and/or resistance herein described, the hardener is selected from the group consisting of a bio-based hardener, dicyandiamide, an amine, an anhydride, poly(ethylene glycol) bis(carboxymethyl) ether, tetraethylenepentamine, and mixtures thereof.

In some embodiments of the method to improve interfacial adhesion and/or resistance herein described, the solvent is selected from the group consisting of methanol, ethanol, isopropanol, acetone, hexane, water, and mixtures thereof.

In some embodiments of the method to improve interfacial adhesion and/or resistance herein described, the mass ratio of the epoxy resin to the hardener is from 0.1 to 10, and wherein the concentration of the epoxy resin and hardener in the solvent is from 0.5 to 50 weight percent.

In some embodiments of the method to improve interfacial adhesion and/or resistance herein described, the drying is performed at a temperature from 20° C. to 150° C. for a duration from 0.1 to 100 hours.

Of course. It's an excellent point by Helen; clarity on these distinct steps is crucial for a patent. The single paragraph is ambiguous because “drying” serves different purposes at different stages.

Here are three distinct paragraphs that elaborate on Helen's points, suitable for a detailed description. They can replace the original, unclear paragraph.

In some embodiments, a preliminary drying step is performed on the filler particles or fibers prior to the application of the coating solution. The purpose of this initial step is to remove adsorbed moisture from the surface of the filler, which can interfere with the adhesion and subsequent curing of the epoxy resin. This pre-drying may be accomplished by heating the fibers in a convection or vacuum oven at a temperature from approximately 60° C. to 120° C. for a duration sufficient to achieve a desired low moisture content, for example, for a period of 1 to 120 hours.

In some embodiments, following the application of the coating solution to the fibers, a second drying step is performed to remove the solvent from the epoxy resin mixture. This step is conducted under conditions designed to evaporate the solvent without initiating a premature cure of the epoxy. For example, the coated fibers may be dried at a relatively low temperature, such as from ambient room temperature (approximately 20° C.) up to 80° C., for a period of 0.5 to 72 hours. This process results in tack-free, coated fibers where the epoxy resin is in a stable, uncured state, ready for integration with the engineered bio-powder.

In some embodiments, a final heating step can be performed after the coated fibers are mixed with the engineered bio-powder and consolidated into the final composite form. This step is distinct from the previous drying steps, as its primary purpose is to thermally activate and cure the epoxy resin coating. This curing process is typically performed at a higher temperature, for example from 120° C. to 180° C., and is an integral part of the thermo-mechanical consolidation. The heat facilitates the chemical cross-linking of the epoxy, thereby forming a strong interfacial bond between the filler and the biocomposite matrix and solidifying the final structure.

In some embodiments of the present disclosure, in the coated particle composition is described for fabricating a tuned bio-composite, the composition comprising: a plurality of particles selected from the group consisting of an engineered bio-powder herein described, a filler, and combinations thereof. In the coated particle composition herein described the plurality of particles is coated with a dried layer of an epoxy system comprising an epoxy resin and a hardener.

In some embodiments of the coated particle composition herein described, the filler comprises particles derived from an agricultural residue and are selected from the group consisting of powder, elongated particles, fibers, whiskers, and flakes.

In some embodiments of the coated particle composition herein described, the particles comprise an engineered bio-powder having a protein content from 40% to 70% by dry weight, a lipid content from 5% to 65% by dry weight, and a carbohydrate content from 25% to 40% by dry weight.

In some embodiments of the coated particle composition herein described, the composition comprises a blend of coated fillers and uncoated engineered bio-powder.

In some embodiments of the coated particle composition herein described the epoxy resin is a bio-epoxy resin and the hardener is bio-hardener or dicyandiamide.

In some embodiments the biopowder can be used to provide a biocomposite with methods herein described which further process the biopowder follow the aqueous plasticization route or the thermo-mechanical route The selection between the aqueous plasticization route and the thermo-mechanical route is contingent upon the desired final properties and the specific composition of the biocomposite, with particular consideration given to the inclusion of fillers or heat-activated binders as will be understood by a skilled person. The choice of fabrication method allows for the deliberate engineering of the biocomposite's mechanical performance.

In some embodiments, the selection of the fabrication route can also be dictated by other factors, such as the energy use requirements of the manufacturing process or the initial hydration state of the received biomass. Additionally, the desired geometry of the final part can influence the selection, as certain methods have specific tooling requirements; for example, the low-pressure aqueous plasticization method requires the use of porous molds to allow for the egress of water during consolidation.

In other embodiments, the thermo-mechanical route is selected for fabricating reinforced composites, particularly when the objective is to achieve maximum interfacial adhesion and enhanced mechanical strength. The consolidation mechanism for this route is the thermal fusion of particles at their contact points, which is accomplished through the simultaneous application of high heat and pressure. This fabrication method is specifically required when the biocomposite formulation includes additives, such as a bio-epoxy surface treatment on a filler material, that necessitate elevated temperatures (e.g., 150-180° C.) to cure and achieve full polymerization. By facilitating stronger, chemically bonded adhesion between the algal matrix and the filler, this route delivers enhanced strength and is the preferred method for high-performance, reinforced biocomposites.

In some embodiments, the biocomposite can be prepared by combining one or more additives to enhance or modify its properties, such as its mechanical performance, processability, or surface characteristics. These additives comprise fillers, binders, surface modification agents, and bulk modification agents. The additives can be incorporated into the engineered bio-powder during a blending step or applied to one or more components of the biocomposite during the fabrication process.

In certain embodiments, the additive is a filler, which can be incorporated to provide reinforcement, reduce cost, or modify the density of the final material. The filler can be a lignocellulosic or other natural fiber. In some embodiments, the filler can be selected from a group consisting of agricultural residues such as switchgrass, corn stover, almond shells, rice hulls, wheat straw, bagasse, banana fibers, palm, sugarcane or leaves; woody biomass such as pine or wood waste; and other bio-based materials such as hemp, bamboo, sisal, flax miscanthus, biochar, or cellulose.

In other embodiments, the additive is a binder or a surface modification agent, which is used to improve the interfacial adhesion between the biomass matrix and the fillers. In a preferred embodiment, the additive is a binder, such as a two-component epoxy system comprising an epoxy resin and a hardener. In other embodiments, other surface modification agents may be used to enhance adhesion. These may include alkali treatment solutions such as sodium hydroxide; silane coupling agents; acylating agents such as acetic anhydride; or isocyanates. The surface of the fillers or biomass particles may also be modified by the deposition of nanoparticles, such as inorganic metal oxides.

In further embodiments, the additive is a bulk modification agent, which is used to alter the fundamental properties of the biomass particles themselves. In one such embodiment, the additive is a plasticizer. Plasticizers, for example glycerol, urea, or triethyl citrate, may be blended with the biomass to increase the flexibility and toughness of the final composite. In another embodiment, a cross-linking agent, such as glutaraldehyde, epichlorohydrin, or citric acid, can be added to form covalent bonds between biopolymer chains to improve thermal stability, water resistance, and mechanical strength. In yet other embodiments, the biocomposite can include thermal additives to improve its processing window and thermal stability, or may be treated with biodegradable coatings to enhance its barrier properties, such as water resistance.

In some embodiments, a method is described for fabricating a tuned bio-composite using an aqueous plasticization route.

The method further comprises rehydrating any one of the engineered bio-powder herein described with a predetermined amount of water to form a plasticized, moldable paste. In this step, an engineered bio-powder, having a predetermined composition and particle morphology, is combined with a specific and predetermined amount of water to form a plasticized and moldable paste or slurry. The amount of water added is a result-effective variable that is selected based on the properties of the specific bio-powder being used, and the initial water content of the dried biomass.

In particular, as controlled rehydration is performed to achieve a consistency suitable for casting and compression molding and is required to facilitate the formation of a strong hydrogen-bonded network between the particles in the resulting composite upon subsequent desiccation.

In some embodiments, a method is described for fabricating a tuned bio-composite using an aqueous plasticization route. The method comprises rehydrating an engineered bio-powder with a predetermined amount of water to form a plasticized, moldable paste or slurry. In this step, an engineered bio-powder, having a predetermined composition and particle morphology, is combined with a specific and predetermined amount of water. The amount of water added is a result-effective variable that is selected based on the properties of the specific bio-powder being used to achieve a consistency suitable for casting and compression molding. This controlled rehydration is required to facilitate the formation of a strong hydrogen-bonded network between the particles in the resulting composite upon subsequent desiccation.

In certain embodiments, the predetermined amount of water to be added is influenced by several factors, including the amount of water already present in the biomass being processed. This can depend on both the intra-cellular and inter-cellular water content, which can vary between different species of algae. Furthermore, the accessibility of the water to form hydrogen bonds may be influenced by the extent to which the particle cell walls are ruptured or broken open during the pulverization step, as this can release water that was previously trapped inside the cells.

The rehydration is performed to achieve a specific target consistency for the moldable paste. If the water content is too high, the paste may be overly fluid, causing it to seep out from the seams of the mold during compression and preventing the formation of a bulk composite. An excessively wet paste may also be prone to rotting if left in the mold for too long. Conversely, if the water content is too low, the paste may lack sufficient cohesion and behave like wet sand that will not stick together, also failing to form a bulk composite. The target consistency is a homogeneous, plasticized paste with a viscosity somewhere between that of wet sand and that of peanut butter or toothpaste.

In some embodiments, the process may involve a multi-step hydration and partial dehydration process. For example, it may be beneficial to initially hydrate the bio-powder to a higher water content to achieve a mixable viscosity, particularly when incorporating fillers such as fibers into the paste. Following the mixing step, a portion of the water may be evaporated from the paste to achieve the final target consistency before the paste is placed into the mold for compression.

Accordingly, in an exemplary embodiment, a powder derived from Chlorella may be rehydrated with a water content of approximately 20%, while a powder derived from the filamentous alga Tribonema can require a water content of approximately 40%.

In some embodiments, the rehydration of the engineered bio-powder is controlled to achieve a specific target consistency that is suitable for subsequent molding and consolidation. The consistency is selected to be sufficient to ensure the particles will self-adhere and form a bulk composite under pressure, but not so high as to cause the paste to become overly fluid. If the water content is too low, the paste may lack sufficient cohesion, behaving like a granular material that does not form a monolithic body. Conversely, if the water content is too high, the paste may seep from the mold during compression, preventing the formation of a dense composite, and may be susceptible to biological degradation if processing times are extended. The target consistency is a homogeneous, plasticized paste having a texture and viscosity that allows it to be molded without significant fluid loss under pressure.

In certain embodiments, particularly when incorporating fillers such as fibers into the mixture, a multi-step hydration and partial dehydration process may be employed. This process comprises first hydrating the bio-powder to a higher water content to achieve a viscosity suitable for achieving a uniform blend with the fillers. Following the mixing step, a portion of the water is then removed from the paste, for example by evaporation, to achieve the final target consistency before the paste is placed into the mold for the consolidation step.

In some embodiments of the disclosure that utilize the aqueous plasticization fabrication route, various additives can be incorporated to modify the properties of the final biocomposite. In particular in some embodiments, if fillers and/or binders are desired, they can be added and processed into the mixture during or after this rehydration step.

In some embodiments of the aqueous plasticization fabrication route, the additives are typically introduced during or after the rehydration step, when the engineered bio-powder is being formed into a plasticized, moldable paste or slurry. The aqueous nature of the paste facilitates the uniform dispersion of the additives prior to the consolidation step.

In certain embodiments, a filler, such as a natural fiber from an agricultural residue, is incorporated into the paste. The filler may be added to the engineered bio-powder before the addition of water, or it may be added to the mixture during or after the rehydration step. The components are then subjected to a mixing process, such as overhead mixing, to ensure the filler is uniformly dispersed throughout the plasticized biomass matrix. Once a homogeneous mixture is achieved, the resulting paste containing the filler is ready to be transferred to a porous mold for consolidation.

In other embodiments, water-soluble or water-dispersible additives, such as bulk modification agents, may be incorporated during the rehydration step. For example, a plasticizer, such as glycerol or urea, may be added to the mixture of the bio-powder and water. The mixing that occurs during the formation of the paste facilitates the even distribution of the plasticizer throughout the biomass. The plasticizer then acts to increase the flexibility and toughness of the final consolidated biocomposite after the desiccation step is complete.

In further embodiments, a binder may be added to the paste to enhance cohesion or adhesion. Such a binder would be selected for its compatibility with an aqueous system and its ability to cure or set under the low-temperature and high-moisture conditions of the aqueous plasticization route, or during the final drying and desiccation step. The binder is mixed into the paste to ensure its uniform distribution before the material is consolidated.

The method for fabricating a tuned bio-composite using an aqueous plasticization route also comprises compressing the moldable paste at a temperature below 100° C. to consolidate particles of the paste into a monolithic body.

In those embodiments, a compression step can be performed consolidate the discrete particles of the paste into a single, solid, monolithic body. The compression is carried out using a compression tool, such as a mold, that applies a controlled pressure to the paste. at a temperature below 100° C. This low-temperature condition ensures that the consolidation occurs through mechanical compaction of the plasticized particles rather than through thermal fusion, setting the stage for the subsequent desiccation step where hydrogen bonds will form to create the final, hardened biocomposite.

The method for fabricating a tuned bio-composite using an aqueous plasticization route additionally comprises desiccating the monolithic body to remove the water, wherein removal of the water causes formation of hydrogen bonds between adjacent particle surfaces to form the tuned bio-composite having the at least one tunable property.

The method additionally comprises d) drying the monolithic body under conditions and for a time sufficient to remove the water, wherein removal of the water causes formation of hydrogen bonds between adjacent particle surfaces to form the tuned bio-composite having the at least one tunable property.

In embodiments herein described of the method for fabricating a tuned bio-composite using an aqueous plasticization route, this drying step is performed under conditions and for a time sufficient to remove the residual water that was used as a plasticizer. The removal of this water is a critical step that causes the formation of a strong hydrogen-bond network between the surfaces of adjacent particles, which self-adheres the particles and provides the final, tuned bio-composite with its structural integrity and desired mechanical properties.

In embodiments herein described of the method for fabricating a tuned bio-composite using an aqueous plasticization route, specific conditions and duration of the drying step may be varied to achieve the final material properties. In one embodiment, the drying is performed at ambient or room temperature in an uncontrolled environment. In another embodiment, to accelerate the removal of water and control the drying process to reduce the risk of cracking, the drying is performed in a controlled environment, such as in a desiccator. The drying process within the desiccator may be further enhanced by the application of a vacuum. The duration of the drying step is selected to be sufficient to remove substantially all of the residual water and allow for the complete formation of the hydrogen-bond network. This may be an extended period of time, for example, approximately 15 days, to ensure the material reaches a stable, fully dried state.

In some embodiments of method for fabricating a tuned bio-composite using an aqueous plasticization route, the engineered bio-powder has a powder aspect ratio distribution that is broad, right-skewed, or bimodal, and wherein at least 10% of the discrete particles have an aspect ratio of 2.0 or greater.

In some embodiments of method for fabricating a tuned bio-composite using an aqueous plasticization route, the engineered bio-powder has a powder lipid content of greater than 30% by dry weight.

In some embodiments of method for fabricating a tuned bio-composite using an aqueous plasticization route, the predetermined amount of water used in the rehydrating step is between approximately 20% and 40% by weight of the engineered bio-powder.

In some embodiments of method for fabricating a tuned bio-composite using an aqueous plasticization route, the rehydrating is performed to form a plasticized, moldable paste having a texture and viscosity sufficient to be molded without significant fluid loss under pressure.

In some embodiments of method for fabricating a tuned bio-composite using an aqueous plasticization route, the method can further comprise incorporating an additive into the moldable paste during the rehydrating step.

In some embodiments of method for fabricating a tuned bio-composite using an aqueous plasticization route, the additive is a filler selected from the group consisting of an agricultural residue, a natural fiber, woody biomass, biochar, and cellulose.

In some embodiments of method for fabricating a tuned bio-composite using an aqueous plasticization route, the additive is a water-soluble or water-dispersible agent, such as a plasticizer.

In some embodiments of method for fabricating a tuned bio-composite using an aqueous plasticization route, the compressing is performed in a porous mold configured to allow for the egress of water from the moldable paste.

In some embodiments of the method for fabricating a tuned bio-composite using an aqueous plasticization route, the compressing is performed in a specially designed mold configured to allow for the egress of water from the moldable paste during consolidation. The mold can be constructed from a porous material, such as sintered metal, which is permeable to water and steam but retains the solid biocomposite particles. Alternatively, or in conjunction with a porous material, the mold may be a solid, non-porous body that incorporates one or more strategically placed escape channels. These channels are precisely machined or integrated into the mold design to provide a dedicated pathway for liquid water and vapor to exit the mold cavity under pressure. Such egress channels ensure efficient dewatering of the paste as it is heated and compressed, preventing the buildup of steam pressure and facilitating the formation of a dense, consolidated, and void-free final composite structure.

In some embodiments of method for fabricating a tuned bio-composite using an aqueous plasticization route, the compressing is performed by applying a pressure in a gradual ramp up to a final pressure of approximately 0.55 MPa.

In some embodiments of method for fabricating a tuned bio-composite using an aqueous plasticization route, the desiccating is performed for an extended period, for example approximately 15 days, in a desiccator, optionally under vacuum.

In some embodiments of method for fabricating a tuned bio-composite using an aqueous plasticization route, the tuned bio-composite has a mechanical property characterized by a Flexural Strength of greater than 10 MPa.

In some embodiments of method for fabricating a tuned bio-composite using an aqueous plasticization route, the engineered biopowder is within the coated particle composition according to any one of the embodiment herein described.

In some embodiment, fabricating a tuned bio-composite is performed using a thermo-mechanical route.

In those embodiments comprises consolidating the engineered bio-powder or the blended powder by: i. subjecting the powder to a pressure and a temperature simultaneously in a mold to cause thermal fusion of particles of the powder at their contact points; and ii. cooling the fused particles under pressure to form the tuned bio-composite having the at least one tunable property.

In some embodiments of the disclosure, the thermo-mechanical route for fabricating the biocomposite can be performed under various conditions of temperature, pressure, and time. The selection of these parameters is dependent on the composition of the engineered bio-powder and the desired properties of the final material. The process can be performed with or without the application of heat, a choice that is primarily dictated by the presence or absence of a heat-activated additive, such as a bio-epoxy binder.

In some embodiments, the thermo-mechanical route is selected for fabricating reinforced composites, particularly when the objective is to achieve maximum interfacial adhesion and enhanced mechanical strength. The consolidation mechanism for this route is the thermal fusion or bonding of particles at their contact points, which is accomplished through the simultaneous application of heat and pressure. This fabrication method is particularly useful when the biocomposite formulation includes additives, such as a bio-epoxy surface treatment on a filler material, that necessitate elevated temperatures to cure and achieve full polymerization. By facilitating stronger, chemically bonded adhesion between the algal matrix and the filler, this route delivers enhanced strength and is a preferred method for high-performance, reinforced biocomposites. The specific parameters of pressure, temperature, and time can be varied depending on the composition of the biopowder, particularly the presence or absence of a heat-activated binder.

In certain embodiments, wherein the engineered bio-powder or blended powder does not contain a heat-activated additive, the consolidation is performed at ambient temperature. In this variation, the formation of the dense, monolithic composite is achieved primarily through the application of high pressure, which compacts the particles and causes them to self-adhere through mechanisms such as mechanical interlocking and physical bonding at their contact points. The pressure applied can be in a range from 25 MPa to 227 MPa. In some embodiment the pressure applied can be up to 1000 MPa as will be understood by a skilled person upon reading of the present disclosure.

In other embodiments, particularly when the bio-powder is blended with a heat-activated additive such as a bio-epoxy, the consolidation is performed at an elevated temperature that is applied simultaneously with pressure. The application of heat is required to activate and cure the additive, thereby creating strong chemical bonds at the interfaces within the composite and maximizing its mechanical strength. The temperature is selected based on the requirements of the specific additive, for example, a temperature of approximately 85° C. for low-temperature epoxies or a temperature in the range of 170° C. to 185° C. for high-temperature epoxies.

In yet another embodiment, an elevated temperature can be applied during the consolidation of a binder-free bio-powder. In this variation, the application of heat in conjunction with high pressure may further enhance the properties of the final composite. The heat may promote the thermal fusion of particles at their contact points and facilitate the formation of a more densely consolidated and integrated monolithic structure, potentially improving the final mechanical properties of the biocomposite.

In some embodiments consolidating the engineered bio-powder or the blended powder by: i. subjecting the powder to a pressure of at least 200 MPa and a temperature of at least 150° C.

In some embodiments consolidating the engineered bio-powder or the blended powder by: i. subjecting the powder to a pressure of 25-28 MPa of pressure at room temperature.

In some embodiments, the biocomposite fabrication method according to the thermomechanical methods herein described can further optionally comprises, blending the engineered bio-powder with a dry filler powder to form a blended powder.

In some embodiments of the disclosure that utilize the thermo-mechanical fabrication route, various additives may be incorporated to create a reinforced or modified biocomposite. The process involves consolidating a dry powder mixture under a controlled pressure, with the application of heat being dependent on the specific additive used. The consolidation is performed under a controlled pressure, which may be in a range from approximately 25 MPa to 227 MPa, to physically compact the particles and form a dense, monolithic body.

In one embodiment, the additive is a dry filler, such as a pulverized agricultural residue, a natural fiber, or other bio-based materials like biochar or cellulose. In this variation, the filler is first blended with the engineered bio-powder to form a uniform, dry mixture. This blending may be performed using an apparatus such as a high-shear speed mixer. The resulting blended powder is then placed into a mold and consolidated under the controlled pressure, which may be performed at ambient temperature, to form a dense, reinforced biocomposite.

In another embodiment, the additive is a filler that has been pre-treated with a heat-activated surface coating, such as a bio-epoxy, to enhance interfacial adhesion. In this process, the filler is first coated and dried. The dried, coated filler is then blended with the engineered bio-powder. The resulting mixture is placed into a mold and consolidated under the controlled pressure while simultaneously being subjected to an elevated temperature. The temperature is selected to activate and cure the coating, for example, a temperature between approximately 85° C. and 185° C., thereby creating strong chemical bonds at the filler-matrix interface and maximizing the mechanical strength of the composite.

In further embodiments, the additive can be a bulk modification agent that is suitable for melt-blending, such as a plasticizer or a thermal additive. The additive is combined in a dry state with the engineered bio-powder or a powder-filler blend. The mixture is then subjected to the thermo-mechanical process, wherein the application of both elevated temperature and the controlled pressure facilitates the melting, dispersion, and integration of the additive throughout the biomass matrix during the consolidation step. In yet other embodiments, additives such as cross-linking agents, silane coupling agents, or isocyanates may be incorporated by applying them to the powder or fillers prior to consolidation. The elevated temperatures and high pressures of the thermo-mechanical route can facilitate the chemical reactions of these agents within the composite, leading to a modified biocomposite with enhanced properties such as improved strength, thermal stability, or water resistance.

In some embodiments where epoxy fillers are comprised in the biopowder consolidating the engineered bio-powder or the blended powder by: i. subjecting the powder to a pressure of 25-28 MPa at temperature of 85 C Its just for the epoxy I need heat to activate the adhesion mechanism in the epoxy. And there are low activation temperature epoxies that activate at 85Cn other embodiments, wherein the powder contains a heat-activated additive such as a bio-epoxy binder, an elevated temperature is applied simultaneously with pressure. The selected temperature depends on the activation requirements of the specific additive used. For a biocomposite containing a low-temperature epoxy, a temperature of approximately 85° C. or greater may be used to facilitate curing. For a biocomposite containing a high-temperature epoxy, a temperature in the range of approximately 170° C. to 185° C. may be used to achieve full polymerization and maximize interfacial bonding.

In further embodiments, the duration of the thermo-mechanical treatment is also controlled. The powder is held under the selected pressure and temperature for a predetermined time to ensure complete consolidation and, if applicable, complete curing of any additives. For example, a mold containing the powder may be pre-heated for approximately one hour before pressure is applied. After the application of pressure, the material may be maintained under both heat and pressure before being allowed to cool gradually to room temperature over a period of several hours, for instance, approximately 12 hours, while still under pressure. This controlled cooling cycle ensures the formation of a stable, dense, and fully consolidated biocomposite part.

In some embodiments of the disclosure that utilize the thermo-mechanical fabrication route, various additives can be incorporated into the biocomposite to enhance or modify its final properties. The method of incorporating these additives depends on the nature of the additive and typically occurs prior to the final high-pressure consolidation step. The additives can include dry powdered fillers, fillers that have been pre-treated with a surface coating, or melt-blendable agents.

In certain embodiments, a dry filler, such as a pulverized agricultural residue, is added to the engineered bio-powder. The filler and the bio-powder are combined in a predetermined ratio and are then homogenized to form a uniform blended powder. This blending may be performed using an apparatus such as a high-shear speed mixer to ensure even distribution of the filler within the biomass matrix. The resulting blended powder is then placed into a mold for consolidation via the thermo-mechanical route.

In other embodiments, particularly for enhancing interfacial adhesion between the filler and the matrix, a surface-treated or coated filler is used. This process comprises first applying a surface treatment, such as a bio-epoxy coating, to the filler material. The coated filler is then subjected to a drying step to remove any solvents and prepare it for blending. After drying, the pre-treated filler is blended with the engineered bio-powder to form a homogenized mixture. This mixture is then consolidated via the thermo-mechanical route, wherein the heat applied during the high-pressure compression step also serves to cure the heat-activated coating or binder, thereby creating strong adhesion at the filler-matrix interface.

In further embodiments, bulk modification agents that are suitable for melt-blending can be incorporated directly with the dry powder. For example, an additive such as a plasticizer may be combined with the engineered bio-powder or a powder blend containing fillers. The resulting mixture is then subjected to the thermo-mechanical process. In this case, the elevated temperature applied during the high-pressure consolidation step facilitates the melting, distribution, and integration of the plasticizer throughout the biomass matrix, resulting in a final biocomposite with modified properties such as increased flexibility.

In some embodiment of the method for fabricating a tuned bio-composite using a thermo-mechanical route, the dry additive is a filler.

In some embodiment of the method for fabricating a tuned bio-composite using a thermo-mechanical route, the filler comprises particles selected from the group consisting of powder, elongated particles, fibers, whiskers, and flakes.

In some embodiment of the method for fabricating a tuned bio-composite using a thermo-mechanical route, the selected temperature is ambient temperature.

In some embodiment of the method for fabricating a tuned bio-composite using a thermo-mechanical route, the selected temperature is an elevated temperature.

In some embodiment of the method for fabricating a tuned bio-composite using a thermo-mechanical route, the elevated temperature is at least 85° C.

In some embodiment of the method for fabricating a tuned bio-composite using a thermo-mechanical route, the elevated temperature is in a range from 170° C. to 185° C.

In some embodiment of the method for fabricating a tuned bio-composite using a thermo-mechanical route, the blended powder comprises a heat-activated additive, such as a bio-epoxy, and wherein the elevated temperature is selected to activate the additive.

In some embodiment of the method for fabricating a tuned bio-composite using a thermo-mechanical route, the mechanical pressure is in a range from 25 MPa to 227 MPa.

In some embodiment of the method for fabricating a tuned bio-composite using a thermo-mechanical route, the consolidation further comprises pre-heating the mold for a period of approximately one hour before applying the mechanical pressure, and wherein the cooling is performed for a duration of approximately 12 hours.

In some embodiment of the method for fabricating a tuned bio-composite using a thermo-mechanical route, the engineered biopowder is within the coated particle composition of any one of the embodiments herein described.

A biocomposite according to the disclosure The tuned biocomposite comprises: a monolithic body comprising a plurality of consolidated, discrete, multi-cell particles derived from a dried feedstock biomass, the particles being self-adhered to one another at interfacial boundaries, wherein the monolithic body has a water content of less than 15 wt % and is poreless or having pores with a diameter of less than 10 μm.

The term “poreless” or “substantially poreless” as used herein indicates that a material has been highly densified to effectively eliminate the interstitial voids that typically exist between constituent particles in an aggregated material. In some embodiments, a material is considered substantially poreless if it does not contain detectable pores, or if any existing pores have a diameter of less than approximately 10 micrometers. This threshold is significant as it is on the same dimensional scale as the constituent multi-cell particles themselves, which structurally defines a material that is a true, continuous solid rather than a porous aggregate. The substantial absence of pores is critical for the material's ability to function as a load-bearing, structural body.

The presence or absence of pores, and their size, may be determined using methods of detection available to a person of ordinary skill in the art. Such methods include, but are not limited to, direct visualization of the material's internal and external surfaces using microscopy techniques. For example, Scanning Electron Microscopy or optical microscopy may be used to examine cryo-fractured internal surfaces or as-pressed exterior surfaces of the biocomposite to identify and measure the size of any voids or pores to confirm that the material is substantially poreless according to the definition herein.

In general in biocomposite of the instant disclosure, SEM images show that with the present approach almost no pores/air voids are observed. Therefore, fabrication method and resulting biocomposite of the instant disclosure porosity is reduced in order to improve mechanical properties, because that correlation is known to exist in all bulk materials between porosity and mechanical properties.

In the tuned biocomposite the plurality of consolidated, discrete, multi-cell particles is characterized by a composition comprising: a) a protein content, a lipid content, and a carbohydrate content, wherein each content is a percentage of the dry weight of the particles; b) a particle aspect ratio distribution; and c) a mean particle volume ranging from 1.0×10² μm³ to 1.0×10⁷ μm³ and preferably from 1.0×10³ μm³ to 1.0×10⁶ μm³.

In some preferred embodiments reports these final biocomposite densities as ranging from 1.0 to 1.1 g/cm3. In some of those embodiments the biomass is compsed of alagal cells, in particular, for example for Chlorella composites, the final density varied from 1.017 g/cm3 to 1.088 g/cm3 depending on the pulverization technique used.

In some embodiments, the composition and morphology of the consolidated particles provide the tuned bio-composite with at least one tunable property selected from the group consisting of a mechanical property, thermal stability, and a barrier function. The properties of the final material are governed by a multi-scale design approach, wherein characteristics are engineered at the nano-scale, micro-scale, and macro-scale.

In certain embodiments, the macro-scale mechanical properties of the biocomposite, such as the balance between stiffness and toughness, are governed by the micro-scale particle morphology of the engineered bio-powder. For example, a biocomposite with high stiffness is achieved by using a powder with a granular particle morphology, which promotes dense particle packing during consolidation. In contrast, a biocomposite with high toughness is achieved by using a powder with a filamentous particle morphology, which promotes mechanical interlocking and energy dissipation.

In another embodiment, the surface properties of the biocomposite, such as the barrier function, are controlled by the biological origin of the feedstock. It has been unexpectedly found that the use of a feedstock comprising a mixed-strain microbial community, such as that harvested from wastewater, can result in a biocomposite with a hydrophobic surface.

In some embodiments of the disclosure, a tuned biocomposite is provided that is engineered to exhibit a specific combination of high-performance properties. The biocomposite comprises a dense, monolithic body of consolidated, self-adhered particles derived from a biomass feedstock, with a structure and composition that is deliberately configured to meet or exceed certain property thresholds.

In an exemplary embodiment, a biocomposite is provided having high mechanical strength and stiffness, characterized by a Young's Modulus of greater than 900 MPa and a Compressive Strength of greater than 100 MPa. This biocomposite is typically formed from a densely packed matrix of granular, low-aspect-ratio particles and further comprises a reinforcing filler, such as fibrous particles, that is strongly adhered to the matrix through an engineered interface, for example, an interface created with a bio-epoxy.

In another exemplary embodiment, a biocomposite is provided having high toughness and flexibility, characterized by a Flexural Strength of greater than 10 MPa. This biocomposite is characterized by an internal microstructure comprising an interlocking network of consolidated, high-aspect-ratio, filamentous particles. This network provides energy-dissipating mechanisms, such as fiber pull-out and crack bridging, which contribute to the material's ability to resist fracture.

In yet another exemplary embodiment, a biocomposite is provided having an enhanced barrier function, characterized by a hydrophobic surface with a static water contact angle of greater than 100 degrees. This biocomposite is formed from a feedstock comprising a mixed-strain microbial community, which imparts the hydrophobic properties to the final consolidated surface of the material.

In a further exemplary embodiment, a biocomposite is provided having high thermal stability, characterized by an onset of thermal decomposition of greater than 200° C. This biocomposite is formed from a feedstock having a very high protein content, for example a protein content approaching 70 percent by dry weight, which provides the material with enhanced resistance to thermal degradation. In other embodiments, a biocomposite may be engineered to have a combination of these properties, such as high stiffness and high thermal stability, or high strength and a hydrophobic barrier function.

In further embodiments, particularly for reinforced biocomposites containing fillers, the ultimate strength of the material is dominated by nano-scale interfacial engineering. This comprises creating strong chemical adhesion at the interface between the biomass matrix and the filler particles, for example, through the application of a bio-epoxy coating. This engineered interface eliminates performance-limiting voids and ensures efficient stress transfer, thereby maximizing the strength of the reinforced composite.

A tuned bio-composite in the sense of the disclosure comprises a monolithic body, which is the final, solid, single-piece material formed from consolidated particles. The monolithic body is composed of a plurality of discrete, multi-cell particles derived from a dried feedstock biomass, which are self-adhered to one another at their interfacial boundaries. This adhesion can be achieved through the formation of hydrogen bonds between particle surfaces upon the removal of water or through thermal fusion at the particles' contact points under high temperature and pressure. The compression process creates a hierarchical and anisotropic microstructure.

In some embodiments, the biocomposite of the disclosure comprises a dense, monolithic, solid body composed entirely of consolidated, multi-cell particles derived from biomass that are self-adhered to one another at their interfacial boundaries. The particles themselves form the matrix by bonding directly to one another, either through the formation of a hydrogen-bond network or through thermal fusion. This self-adhering and binder-free nature is distinct from conventional biocomposites where biomass is used as a passive filler within a separate, continuous polymer matrix. This structure makes the material inherently more sustainable and simplifies its end-of-life profile.

In certain embodiments, the biocomposite is characterized by a distinctive hierarchical and anisotropic microstructure created by the consolidation process. Under microscopic examination, the constituent particles are observed to be flattened and aligned substantially perpendicular to the axis of compression, thereby forming a layered or lamellar structure. This alignment is a structural feature that results in direction-dependent mechanical properties, wherein the material exhibits high strength when loaded along the compression axis. This anisotropy is an advantage that can be leveraged in structural applications where the primary load direction is known.

In further embodiments, the material is highly densified, having a final density typically between approximately 0.89 and 1.41 g/cm³. The structure is substantially poreless, which is defined as either being free of detectable voids or having any existing pores with a diameter of less than approximately 10 micrometers. This threshold is critical because it is on the same dimensional scale as the individual constituent cells, meaning the large interstitial voids common in other aggregated biomaterials have been effectively eliminated. This dense, low-porosity structure is directly responsible for the biocomposite's ability to function as a load-bearing, structural material.

In embodiments where the biocomposite is a reinforced composite containing fillers, the filler-matrix interface is a defining and engineered structural characteristic. The reinforced biocomposite is characterized by an engineered interface with strong matrix-filler adhesion and significant fiber embedding, with minimal observable void space. This superior interfacial structure, which may be achieved through the use of a surface treatment such as a bio-epoxy coating on the fillers, allows for efficient stress transfer between the matrix and the filler and is directly responsible for the high strength and stiffness of the reinforced composite.

In some embodiments, the tuned biocomposite of the disclosure comprises a dense, monolithic body composed of a plurality of consolidated, discrete, multi-cell particles derived from a dried feedstock biomass. The particles are self-adhered to one another at their interfacial boundaries to form the solid body. In certain embodiments, this self-adhesion is achieved through the formation of a strong hydrogen-bond network between adjacent particle surfaces, which is typically formed during the desiccation step of an aqueous plasticization route. In other embodiments, the self-adhesion is achieved through the thermal fusion of particles at their contact points, which occurs during the high-pressure, high-temperature consolidation of a thermo-mechanical route. The monolithic body may be composed solely of these self-adhered biomass particles, or it may be a reinforced composite wherein the self-adhered biomass forms a matrix containing fillers.

The monolithic body is further characterized by its physical properties, including a low final water content of less than 15 percent by weight. The body is also substantially poreless, which is defined as either being free of detectable voids or having any existing pores with a diameter of less than approximately 10 micrometers. This dense, low-porosity structure is a result of the high-pressure consolidation process, which effectively eliminates the large interstitial voids that are common in other aggregated biomaterials, thereby enabling the biocomposite to function as a load-bearing, structural material.

The plurality of consolidated particles is characterized by a specific composition that is engineered to tune the final properties of the biocomposite. In certain embodiments, the composition is selected to achieve high stiffness, wherein the protein content of the particles is greater than 40 percent by dry weight. In other embodiments, the composition is selected to achieve high toughness, wherein the lipid content may be greater than 30 percent to act as a plasticizer, or alternatively, may be less than 15 percent when used in synergy with a filamentous particle morphology. In many preferred embodiments, the carbohydrate content is selected to be within a range of 25 to 40 percent to provide a structural backbone while maintaining the tunability of the material.

The particles are also characterized by their physical morphology, including a particle aspect ratio distribution and a mean particle volume. In embodiments designed for high stiffness, the aspect ratio distribution is characterized by having greater than 90 percent of particles with an aspect ratio of less than 1.5. In embodiments designed for high toughness, the aspect ratio distribution is characterized by having at least 10 percent of particles with an aspect ratio of greater than 2.0. The mean particle volume of the discrete multi-cell particles may also be varied. In some preferred embodiments, particularly those derived primarily from algal feedstocks, the mean particle volume is in a range from 1.0×10³ μm³ to 1.0×10⁶ μm³. In other embodiments, which may include plant cells or agricultural residues as part of the biomass, the mean particle volume may be in a broader range from 1.0×10² μm³ to 1.0×10⁷ μm³.

In some embodiments of the tuned biocomposite the monolithic body is substantially poreless and/or has a mean particle volume ranging from 1.0×10³ μm³ to 1.0×10⁶ μm³.

In some embodiments of the tuned biocomposite, the monolithic body has a density between 0.89 and 1.41 g/cm³.

In some embodiments of the tuned biocomposite, the monolithic body has an anisotropic, layered microstructure wherein the consolidated particles are flattened and aligned substantially perpendicular to an axis of compression.

In some embodiments of the tuned biocomposite, the particles are self-adhered to one another by a hydrogen-bond network or by thermal fusion at their interfacial boundaries.

In some embodiments of the tuned biocomposite, the composition comprises a protein content from 40% to 70% by dry weight, a lipid content from 5% to 65% by dry weight, and a carbohydrate content from 25% to 40% by dry weight.

In some embodiments of the tuned biocomposite, the protein content is greater than 40% by dry weight and the particle aspect ratio distribution is characterized by greater than 90% of the particles having an aspect ratio of less than 1.5.

In some embodiments of the tuned biocomposite, the mechanical property is characterized by a Young's Modulus of greater than 900 MPa and a Compressive Strength of greater than 100 MPa.

In some embodiments of the tuned biocomposite, the lipid content is greater than 30% by dry weight and the particle aspect ratio distribution is characterized by at least 10% of the particles having an aspect ratio of 2.0 or greater.

In some embodiments of the tuned biocomposite, the mechanical property is characterized by a Flexural Strength of greater than 10 MPa.

In some embodiments of the tuned biocomposite, the protein content is from 30% to 40% by dry weight, the lipid content is from 30% to 40% by dry weight, and the particle aspect ratio distribution is bimodal, the distribution comprising at least 10% of particles having an aspect ratio of less than 1.5 and at least 10% of particles having an aspect ratio of greater than 2.0.

In some embodiments of the tuned biocomposite, the protein content is from 65% to 70% by dry weight and the thermal stability is characterized by an onset of thermal decomposition of greater than 200° C.

In some embodiments of the tuned biocomposite, the discrete particles are derived from a mixed-strain microbial community and the barrier function is characterized by a hydrophobic surface with a static water contact angle of greater than 100 degrees.

In some embodiments of the tuned biocomposite, the monolithic body further comprises a filler dispersed within a matrix formed by the self-adhered particles.

In some embodiments of the tuned biocomposite, the filler and the matrix are bonded by an engineered interface, and wherein microscopic examination of a fracture surface of the monolithic body shows fiber embedding within the matrix and an absence of interfacial voids having a diameter greater than 10 micrometers.

In some embodiments of the tuned biocomposite, the engineered interface comprises a cured bio-epoxy.

In some embodiments, the tuned biocomposite of the disclosure and related powder compositions methods and system provides a framework for creating biocomposites with predictable and controllable material properties. by selecting a biomass feedstock and engineering its powder based on variables such as its biochemical composition and particle morphology, leveraging the protein, lipid, and carbohydrate content of the starting algae which can dictates the material's intrinsic properties.

For instance, in some embodiments, in the tuned biocomposite of the disclosure and related powder compositions methods and system a high-protein feedstock like Chlorella can be chosen to create a stiff and rigid final product, while a high-lipid feedstock like Tribonema can be used for a tougher, more flexible composite. Mechanical processing creates a powder with a specific, non-random particle aspect ratio and volume distribution.

In some embodiments, in the tuned biocomposite of the disclosure and related powder compositions methods and system powders with elongated, filamentous particles, such as those from Hilmar or Tribonema algae, lead to composites with high toughness due to mechanical interlocking. Conversely, powders with granular, equiaxed particles, such as those from Chlorella, create stiff composites through dense packing.

In some embodiments, in the tuned biocomposite of the disclosure and related powder compositions methods and system the compositions are also designed to transform abundant and inexpensive waste streams-such as wastewater-derived algae and agricultural residues like switchgrass and almond shells-into high-performance, value-added materials This supports a circular bioeconomy by creating value from materials that would otherwise be discarded as will be understood by a skilled person.

In some embodiments, the fabrication methods herein described are versatile, sustainable, and designed to overcome key limitations of existing biocomposites. The methods can create dense, strong biocomposites without requiring chemical treatments or the addition of synthetic, petroleum-based binders or adhesives. This simplifies manufacturing and improves the final product's biodegradability and recyclability compared to conventional biocomposites.

in some embodiments, the tuned biocomposite of the disclosure and related powder compositions methods and system includes flexible fabrication options to suit different needs, such as a thermo-mechanical route which uses high pressure and temperature to consolidate a dry powder and an aqueous plasticization route where the engineered powder is rehydrated to form a moldable paste before being compressed and dried.

in some embodiments, in the tuned biocomposite of the disclosure and related powder compositions methods and system the ability to actively engineer the interface between the algae matrix and agricultural fillers allows to provide improved biocomposite. Applying a bio-epoxy coating to fillers solves the critical problem of poor stress transfer, mitigating fiber pull-out and significantly increasing both the strength and stiffness of the final composite. The process is scalable and includes a low-energy mechanical compaction route, providing a pathway for the large-scale production of sustainable materials for applications like packaging, insulation, and lightweight structural panels.

In some embodiments, the final biocomposite material provides a sustainable, high-performance alternative to conventional plastics and wood products. The biocomposites are strong, stiff, and lightweight, with properties that can be tailored to exceed those of some commercial plastics and particle boards. For example, epoxy-treated Hilmar-switchgrass composites achieved a Young's modulus of over 950 MPa and a compressive strength greater than 100 MPa. The material's surface properties and barrier function can also be controlled; by selecting specific feedstocks like the mixed-strain Hilmar algae, the resulting biocomposite can be made hydrophobic with a water contact angle over 100° C., making it resistant to water and humidity without additional coatings.

in some embodiments, in the tuned biocomposite of the disclosure and related powder compositions methods and system the biocomposite is fully biodegradable and sourced from renewable materials. Its production actively contributes to environmental health by utilizing waste streams and sequestering CO₂ during the growth of the algal biomass The compression-based fabrication process creates a unique lamellar, anisotropic microstructure where compacted cells are aligned. This layered structure provides high strength when loaded along the primary axis, making it ideal for lightweight structural applications.

In several embodiments, the tunable biocomposites and related systems herein described provide in several embodiments a significant climate benefit through a dual-action approach: active carbon sequestration and avoided methane emissions. First, the algal biomass, which serves as the primary matrix, actively captures atmospheric CO₂ during its growth, sequestering approximately 1.6 to 2 grams of CO₂ for every gram of biomass produced. By consolidating this carbon-rich biomass into a durable material, the resulting biocomposite acts as a carbon sink for the lifetime of the product, effectively locking the captured carbon away. Second, when agricultural residues are incorporated as reinforcing fillers, the invention prevents the methane emissions that would have occurred from their natural decomposition in fields or landfills—a critical benefit, as methane is a greenhouse gas with a warming potential approximately 84 times greater than CO₂ over a 20-year period. This synergistic approach of combining active CO₂ removal with the prevention of potent methane release results in a material with a substantially improved climate footprint.

The technology of the disclosure provides a significant environmental benefit as a form of advanced waste valorization that can uniquely integrate and upcycle multiple distinct and underutilized waste streams. For example, the algal biomass can be cultivated using nutrients from wastewater, industrial brine water, or livestock sludge. Furthermore, agricultural residues, which are another waste stream, can be incorporated directly into the biocomposite material as fillers or as part of the primary biomass.

In another embodiment, the biocomposites and methods provide a climate benefit through carbon sequestration. The algal biomass actively captures atmospheric CO2 during its growth. By processing this biomass into a durable material, the resulting biocomposite acts as a carbon sink for the lifetime of the product, effectively locking the captured carbon out of the atmosphere. When agricultural residues are incorporated into the biocomposite, the process also prevents the methane emissions that would have resulted from their natural decomposition, further enhancing the overall climate benefit of the material.

Plant cells, cultured plant cells, culture medium, biomass and a compression tools can be provided as part a system to provide a biocomposite herein described, the system comprising a cultured biomass comprising cultured plant and/or algae cells, dried biomass, optional additives such as fillers and binders, reagents for the related treatment such as epoxy resin systems, and tools and equipment for the related fabrication and/or use to fabricate a biocomposite of the disclosure in combination.

In some embodiments, a system for fabricating a tuned biocomposite is provided. The system comprises a source of biomass, which may include cultured plant or algae cells; means for processing the biomass into a dried feedstock and subsequently into an engineered bio-powder with a predetermined composition and particle morphology; and a compression tool for consolidating the powder into a monolithic body. The system may also include optional components such as a source of additives, including fillers and binders, and means for incorporating these additives into the biocomposite. The components of the system are configured to work together to produce a biocomposite with tunable properties, such as mechanical, thermal, or barrier properties.

In one embodiment, the system is configured for an aqueous plasticization route. This system comprises a source of dried feedstock biomass and means for processing it into an engineered bio-powder. The system further includes means for rehydrating the powder with a controlled amount of water to form a moldable paste, and a compression tool. In this embodiment, the compression tool comprises a low-pressure press, such as a pneumatic press, and a porous mold. The porous nature of the mold, which may be a porous aluminum mold, is configured to allow for the egress of water from the paste during consolidation at temperatures below 100° C.

In another embodiment, the system is configured for a thermo-mechanical route. This system comprises a source of dry engineered bio-powder, which may be provided as a blend with dry fillers. The system further comprises a compression tool, which in this embodiment is a high-pressure press, such as a hydraulic, mechanical, or electromechanical press. The press is configured to apply pressures in a range of approximately 25 MPa to 227 MPa, or greater. The compression tool may further comprise a hot press, wherein the pressure plates are configured to be heated to an elevated temperature, for example, between 85° C. and 185° C. This configuration is used for consolidating the dry powder through thermal fusion or for curing heat-activated additives.

In further embodiments, the system can include components for preparing and incorporating additives into the biocomposite. This includes a source of fillers, such as agricultural residues, and means for pulverizing and blending these fillers with the engineered bio-powder, such as a high-shear mixer. The system may also comprise a coating apparatus for applying a surface treatment, such as a bio-epoxy coating, to the fillers. This apparatus would include means for preparing an epoxy solution and applying it to the fillers, as well as a drying apparatus, such as an oven, for drying the coated fillers prior to their incorporation into the biocomposite.

As used herein, a compression tool indicates any mechanism that can apply controlled levels of pressure to a material. The tool may be a press, such as a hydraulic, pneumatic, mechanical, or electromechanical press, and may be configured as a hot press to apply heat simultaneously with pressure. The tool may be used with a mold to contain the material, and the mold may be solid or porous depending on the fabrication route being employed.

The biocomposites, methods and systems herein described are further illustrated in the following examples, which are provided by way of illustration and are not intended to be limiting.

### EXAMPLES

The tunable biocomposites, methods and systems herein described are further illustrated in the following examples, which are provided by way of illustration and are not intended to be limiting.

In particular, biocomposites from algae are described to fabricate exemplary biopowder and biocomposite according to exemplary methods and systems of the disclosure.

A person skilled in the art will appreciate the applicability and the necessary modifications to adapt the features described in detail in the present section, to additional biocomposites and related compositions, methods and systems according to embodiments of the present disclosure. A skilled person will understand how to adapt the specific, materials, and methods used in the following examples to additional materials, and methods identifiable in view of the instant disclosure such as additional, plant cells, biomass, mediums, compression mold, fillers, culturing, compression and/or detection processes in accordance with the present disclosure.

The exemplary tunable, compositions, methods and systems exemplified in this section were prepared and analyzed using the following materials and methods.

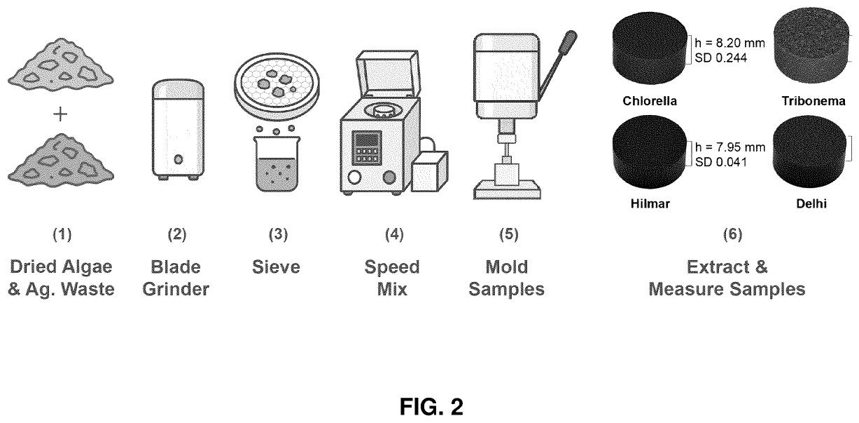

Pure Algae Biomaterials Fabrication: Dry algal feedstocks (Chlorella, Tribonema, Hilmar, and Delhi) were first comminuted using a blade grinder until a fine powder was obtained. The ground material was sieved to remove oversized fragments and ensure a uniform particle size distribution. The sieved powders were then directly compacted into cylindrical specimens by compression molding under controlled loading (8 tonnes) at ambient temperature. After demolding, the samples were measured for height (mm±SD) and density (g cm⁻³±SD). (see illustration of FIG. 2).

Algae-Agricultural Waste Composites Fabrication: For composite formulations, sieved algal powders were combined with agricultural residues (e.g., switchgrass, almond shell) in prescribed ratios. The powders were homogenized using a high-shear speed mixer operated for 30 seconds at 1500 RPM, producing a uniform mixture. The blended feedstocks were then subjected to compression molding under the same conditions used for the pure algae samples.

Epoxy-Treated Biomaterials Fabrication: Epoxy-modified composites were prepared by impregnating the agricultural fibers with a bio-epoxy solution. The epoxy coated fibers were allowed to dry at 60° C. for ~48 h following impregnation. To fabricate test specimens, the prepared algae-fiber mixtures were placed into molds that had been pre-heated in an oven at 175° C. for ~1 h and then 8T of loading were applied to the molds. The filled molds were maintained at this temperature and pressure and then left to cool gradually to room temperature for ~12 h (overnight). This procedure produced fully consolidated composites in which the epoxy facilitated stronger adhesion between algae and lignocellulosic fillers.

Algal Biomass Sources; Four distinct algal feedstocks were employed in this study, each reflecting different cultivation, harvesting, and drying techniques. The Hilmar biomass was obtained from a mixed-strain culture sourced from a wastewater purification facility. Harvesting occurred only during the summer months, using natural settling followed by decanting of the supernatant and scraping of the concentrated biomass from the tank bottom. The recovered material was subsequently sun-dried. In contrast, the Delhi biomass, also a mixed-strain source, was harvested year-round using aluminum chlorohydrate as a chemical coagulant in combination with dissolved air flotation, and then sun-dried. A third feedstock, Tribonema minus, was cultivated at laboratory scale in municipal wastewater, harvested using a physical screen, and likewise sun-dried. Finally, Chlorella vulgaris, a food grade algae, was freeze-dried to minimize microbial contamination and to eliminate exposure to uncontrolled outdoor environments. Together, these feedstocks capture a range of algal morphologies and extraction-drying strategies spanning both laboratory-scale and industrial wastewater treatment processes.

Preprocessing Techniques: To standardize the feedstocks for biocomposite fabrication, the dried algal biomasses were subjected to a particle size reduction protocol. Agglomerated material was first broken down using a coffee grinder operated in 30-second mixing intervals. The partially ground material was then passed through a 40-mesh sieve to exclude oversized particles. This cycle of grinding and sieving was repeated iteratively until the biomass reached a sufficiently fine and homogeneous particle size distribution, ensuring comparability across feedstocks during subsequent processing.

Bio-Epoxy Coating: Epoxy-coated fibers were prepared using an impregnation method with Ecopoxy biopoxy 36 kit resin part A and hardener part B. Epoxy resin and dicyandiamide (curing agent) were combined in a mass ratio (e.g., 4:1) and dissolved to form 8 weight percent (wt. %) solutions of epoxy in methanol (epoxy 8 wt. %, methanol 92 wt. %). The epoxy system (simply called epoxy, unless otherwise noted) was a two-component system combining epoxy resin and curing agent. Epoxy coatings were prepared by first dispensing the epoxy resin into a glass vial, then sequentially adding methanol and dicyandiamide. The mixture was shaken vigorously to ensure homogeneity prior to application. To coat the fibers, the solution was distributed gradually and uniformly, targeting a mass ratio of 1:30 between epoxy and biomass fibers. The treated fibers were left at room temperature for approximately 15 minutes to allow methanol to evaporate, and were subsequently dried at 60° C. for approximately 48 hours before further characterization and composite fabrication.

Microscopy; Algae powders and bulk biomaterials were characterized using optical imaging with a Keyence VK-X3000 microscope and by scanning electron microscopy (Zeiss Merlin SEM, operated at 1 kV, 100 pA with the SE2 detector). Samples were sputter coated with 6 nm of gold before SEM imaging. Bulk specimens were cryo-fractured in liquid nitrogen to expose internal surfaces for imaging. Particle size distributions were obtained with the Keyence analysis software, which was also employed to assess powder morphology and the surface features of the consolidated biomaterials.

Photographic Imaging: Photographic images of the bulk biomaterials were taken using an iPhone 15 with the iOS camera software using portrait mode with studio lighting. The images were edited in Adobe Photoshop to remove the background and shadows.

Particle Volume Analysis: Particles were imaged with the Keyence VK-X3000 optical microscope (20×, 10×, 5×, and 2.5× objectives). For each treatment, ≥10 particles were segmented in thresholded grayscale micrographs using the built in Keyence area selection features software, and their three-dimensional (3D) volumes were measured and visualized in topography maps. The range of the color mapping (0-75) was manually adjusted to ensure standardized colorization between different samples to allow for visual inspection and comparison of the different samples.

Surface Profile Roughness Analysis: Beyond aerial topography, surface roughness of the dried biomaterials was characterized with a VK-X3000 3D surface profiler. For each condition, six line scans (three horizontal and three vertical) were taken from the topography maps. Roughness metrics were then derived in accordance with ISO 21920-2:2021. As presented in FIG. 2 and in the supplementary data, the principal parameters include the arithmetic mean profile height (Rₐ), the maximum profile height (R_{z}, obtained as Rₚ+Rᵥ), and the mean spacing of surface elements (R_{Sm}), which reflects the average peak-valley interval across a given scan. The instrument's software automatically computes R_{Sm} by determining the width of each element and calculating the mean across the sampling length. In addition, optical profilometry was employed to determine the ISO-standard maximum surface height (S_{z}), defined as the distance between the highest peak and lowest valley within the measured area.

Thermal Conductivity; Thermal conductivity was measured using a Trident thermal conductivity system (C-Thermal Technologies, Canada) at 25° C. For these measurements, a Modified Transient Plane Source (MTPS) method was used in accordance with standard ASTM D7984 protocol. Five measurements were conducted for each sample and the average value was reported.

Surface Wettability: The wettability of the biomaterials was measured with a dataphysics OCA 50 goniometer using the sessile drop method at room temperature. The data was processed with Dipmax software. For each sample type, at least three replicate measurements were performed using 2 μL droplets of deionized water. Contact angles were recorded immediately upon droplet deposition on the material surface. In particular static water contact angle was measured on a DataPhysics OCA 50 goniometer using the sessile-drop method at room temperature. A 2 μL droplet of deionized water was dispensed onto each specimen from a distance of 0.2-3 mm (avoiding bounce or spread from excess height), images were captured immediately ( 1/10 of a second to 2 second range) using the instrument's built in high speed camera, and the contact angle was computed from the droplet profile in the OCA software (dpiMAX/Dipmax). At least three measurements were taken per sample type and averaged to give the contact angle for that specimen.

Compression Testing: Cylindrical specimens were prepared with a constant diameter of 19 mm and variable heights ranging from 7.2 to 9.0 mm (see Biomaterials Fabrication section). Compression tests were performed using an Instron 5982 universal testing machine equipped with a 100 kN load cell. Samples were positioned between two fixed parallel, polished stainless steel compression platens to ensure uniform loading. Each specimen was loaded under displacement control at a constant crosshead speed of 1 mm/min, and force-displacement data were continuously recorded at 50 Hz with no pre-load placed on the samples. The raw data were processed using Instron Bluehill software to determine mechanical properties. Young's modulus was calculated from the linear portion of the stress-strain curve using crosshead displacement and initial sample height as the strain measurement, while the maximum compressive stress was defined as the peak stress sustained by each specimen prior to failure or densification. To minimize frictional effects and misalignment, specimens were carefully centered on the platen prior to testing. Three to five replicate tests were performed per condition to ensure reproducibility.

Other materials and methods are described and/or identifiable by a skilled person in the description of the following examples and in view of the disclosure as a whole.

### Example 1: Characterization and Selection of Algal Feedstocks for Biocomposite Fabrication

The biochemical and productive characteristics of different algal genera were characterized to establish their suitability as sustainable feedstocks for biocomposites. The purpose of this analysis was to demonstrate that different algae possess distinct, inherent biochemical compositions (e.g., % protein, % lipid) which can be leveraged within the disclosure 's design framework. By understanding these intrinsic properties, a person of ordinary skill in the art can select an appropriate starting material to achieve a specific, desired performance characteristic in the final biocomposite product³.

This example is based on a synthesis of data characterizing key algal strains, including Spirulina platensis, Chlorella vulgaris, and Tribonema minus, under various cultivation conditions. The characterization focuses on the comparative biochemical composition (protein, carbohydrate, and lipid content as a percentage of dry weight) and biomass productivity, particularly when cultivated in standard laboratory media versus nutrient-rich waste streams, such as municipal or dairy wastewater.

The characterization is summarized in Table 2

TABLE 2
Comparative Biochemical Composition and Productivity of Key Algae Under Different Cultivation Conditions

| Algal | | | Carbo- | | | Specific | Biomass | Nutrient | |
|---|---|---|---|---|---|---|---|---|---|
| Genus/ | Cultivation | Protein | hydrate | Lipid | Ash | Compounds/ | Productivity | Removal | Reference |
| Species | Condition | (% DW) | (% DW) | (% DW) | (% DW) | Notes | (approx.) | (%) | Snippet(s) |
| Spirulina | Standard | 50-70 | ~33 | Variable | Variable | High Phycocyanin, | High | N/A | ⁶³ |
| platensis | Medium | | | | | Essential Amino | | | |
| | (General) | | | | | Acids, Vitamins. | | | |
| | | | | | | Thermally stable | | | |
| | | | | | | to 200° C. | | | |
| Spirulina | Dairy | High | Variable | Variable | Variable | High N | 1.98 g/L | N: 92.6, | ²⁸ |
| platensis | Wastewater | | | | | removal. | (final | P: ~70-87 | |
| | (75% DW + | | | | | | conc.) | | |
| | 25% BG11) | | | | | | | | |
| Spirulina | Brewery | Elevated | Elevated | Variable | Variable | Enhanced | 3.70 g/L | N/A | ⁵⁵ |
| platensis | Wastewater | | | | | Phycocyanin | (max | | |
| | (2% BWW + | | | | | yield (100 mg/g). | conc.) | | |
| | Seawater) | | | | | Increased | | | |
| | | | | | | C16:0, C18:1 | | | |
| | | | | | | FAMEs. | | | |
| Chlorella | Standard | Variable | Variable | Variable | Variable | Benchmark for | 25.5-28.2 | N/A | ³⁵ |
| vulgaris | Medium | | | | | wastewater | mg/L/d | | |
| | (WC) | | | | | studies. | | | |
| Chlorella | Municipal | Variable | Variable | Variable | Variable | TAG content | 21.5-28.1 | N/A | ³⁵ |
| vulgaris | Wastewater | | | | | 22.5-41.3% | mg/L/d | (uses | |
| | (Secondary | | | | | w/w of lipids. | | WWN) | |
| | Effluent) | | | | | Suitable | | | |
| | | | | | | FAME profile | | | |
| | | | | | | (C16-C22) | | | |
| | | | | | | for biodiesel. | | | |
| Chlorella | Membrane- | 49.6 ± 1.4 | 26.1 ± 0.6 | 10.4 ± 1.8 | Variable | High | 0.04 g/L/d | N: 80, | ³⁷ |
| vulgaris | Treated | | | | | protein | | P: 94, | |
| | Distillery | | | | | content | | COD: 72 | |
| | Wastewater | | | | | observed. | | | |
| Chlorella | Dairy | Variable | Variable | Variable | Variable | Good | 1.92 g/L | N: 86.9, | ²⁸ |
| vulgaris | Wastewater | | | | | N & P | (final | P: 83.5 | |
| | (75% DW + | | | | | removal. | conc.) | | |
| | 25% BG11) | | | | | | | | |
| Tribonema | Standard | Variable | Variable | 38-61 | Variable | High lipid | 0.35-0.42 | N/A | ⁶⁰ |
| sp. | Medium | | | | | potential. | g/L/d | | |
| | (BG11, | | | | | Dominant FAs: | | | |
| | batch) | | | | | C16:0, C16:1. | | | |
| | | | | | | Suitable for | | | |
| | | | | | | biodiesel & | | | |
| | | | | | | bioethanol. | | | |
| Tribonema | Standard | 37.6 ± 0.7 | 28.3 ± 0.4 | 6.1 ± 0.3 | Variable | Lower lipid | Variable | N/A | ⁶⁷ |
| minus | Medium | | | | | content in | | | |
| | (Monoculture, | | | | | this study. | | | |
| | year-round) | | | | | Predominant | | | |
| | | | | | | FAME: EPA | | | |
| | | | | | | (Eicosapenta- | | | |
| | | | | | | enoic acid). | | | |
| Tribonema | Nitrogen | Decreased | Increased | Decreased | Variable | Lipid content | Variable | N/A | ⁶⁷ |
| sp. | Deprivation | | | | | decreased with | | | |
| | (Relative | | | | | N-starvation | | | |
| | to 1N-BG11) | | | | | (unusual). No | | | |
| | | | | | | starch observed. | | | |
| | | | | | | TAG decreased. | | | |
| Scenedesmus | 5% | Variable | Variable | 34 | Variable | Increased SFA, | Decreased | N/A | ³⁸ |
| dimorphus | Salinity | | | | | decreased PUFA | vs | | |
| | Stress | | | | | content compared | control | | |
| | | | | | | to control. | | | |
| Scenedesmus | 5% | Variable | Variable | 39 | Variable | Increased SFA, | Decreased | N/A | ³⁸ |
| minutum | Salinity | | | | | decreased PUFA | vs | | |
| | Stress | | | | | content compared | control | | |
| | | | | | | to control. | | | |
| Mixed | Dairy | High | Variable | Variable | Variable | Highest biomass | 2.51 g/L | N: 93.3, | ²⁸ |
| Culture | Wastewater | | | | | yield and P | (final | P: 86.7 | |
| (S.p., M., | (75% DW + | | | | | removal among | conc.) | | |
| C.v.) | 25% BG11) | | | | | tested cultures. | | | |
| | | | | | | High N removal. | | | |

Note:
DW = Dry Weight; N/A = Not Applicable or Not Available in cited snippets. Productivity and composition values are highly dependent on specific strain, exact medium composition, and cultivation conditions (light, temp, CO2, etc.) and should be interpreted within the context of the cited study.

Table 2 synthesizes data illustrating how algal composition and productivity vary significantly based on species and, critically, the cultivation environment. It highlights the potential of wastewater cultivation for biomass generation and nutrient removal but also underscores the resulting variability in biochemical makeup (e.g., lipid content differences in Chlorella or Tribonema under different nutrient regimes), which is a key consideration for developing reliable biocomposite feedstocks.

This characterization reveals distinct and valuable profiles for each genus. In particular Spirulina is characterized by an exceptionally high protein content, ranging from 50-70% of its dry weight, and good thermal stability up to 200° C., making it a prime candidate for forming rigid, protein-based biocomposites. Chlorella is a robust, fast-growing alga well-suited for wastewater remediation⁸⁸. It also contains a high protein content of approximately 50% when cultivated in waste streams, though its lipid content is highly variable depending on growth conditions. Tribonema, a filamentous alga, has the potential to accumulate high levels of lipids, with some reports showing 38-61% of dry weight¹⁰. This high lipid content is advantageous for creating tougher, more pliable composites where the lipids can act as an intrinsic plasticizer.

The data further shows that cultivation in waste streams, such as dairy wastewater, can support high biomass productivity and nutrient removal efficiencies exceeding 90% for nitrogen and 80% for phosphorus, validating the use of waste valorization as a viable and sustainable feedstock source.

The results of this characterization demonstrate that different algal feedstocks possess distinct biochemical fingerprints that can be predictably linked to the properties of a final biocomposite. A person of ordinary skill in the art can use this knowledge to practice the invention by selecting a starting material based on its chemical makeup. For instance, to engineer a stiff and rigid biocomposite, a skilled person would select a feedstock with a high protein content (>40%), such as Chlorella or Spirulina.

Conversely, to engineer a tough and flexible biocomposite, a skilled person would select a feedstock with a high lipid content (>30%), such as Tribonema, to serve as an internal plasticizer.

### Example 2 Exemplary Decision-Making Workflow for Biocomposite Fabrication

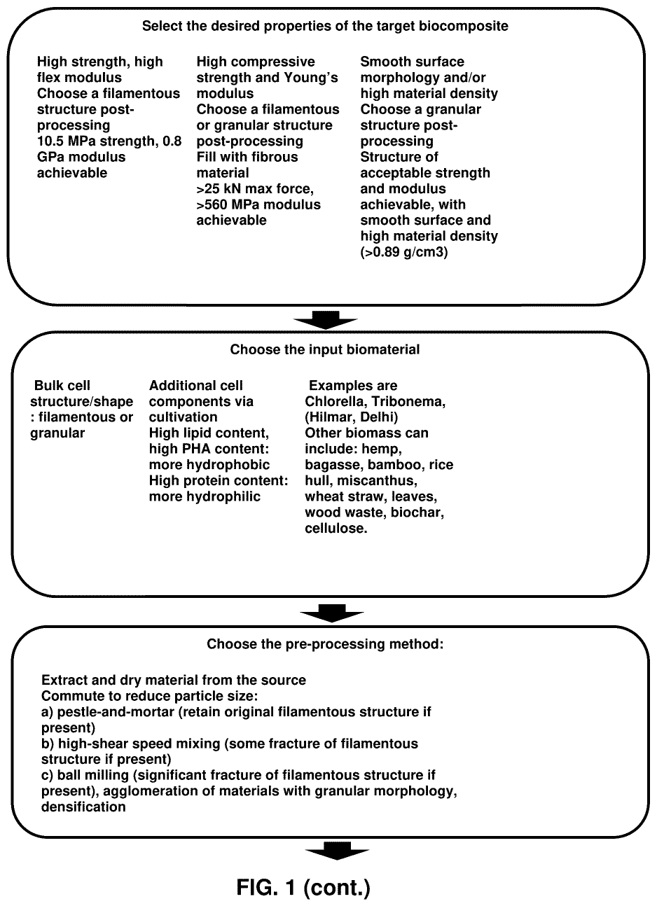

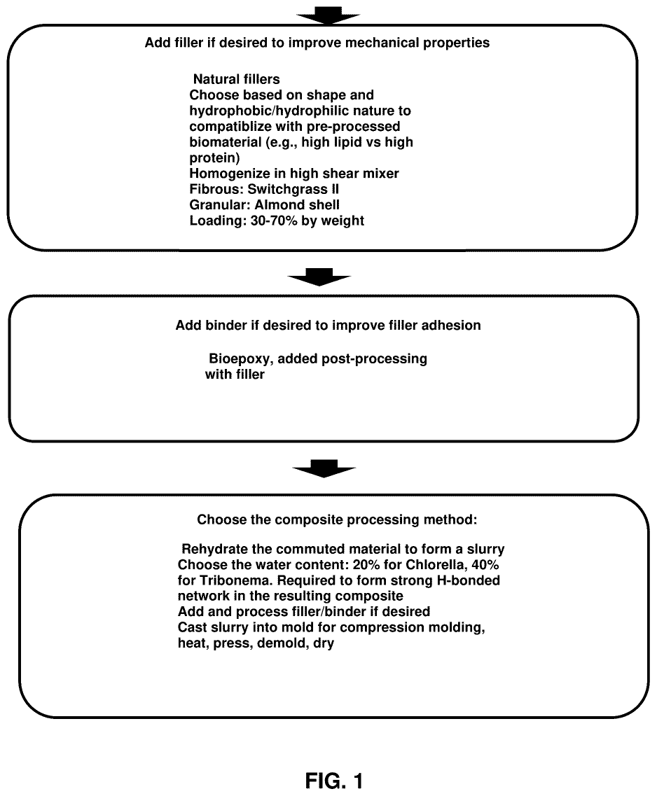

This example illustrates an exemplary decision tree for a user fabricating a biocomposite of the disclosure, serving as a standard operating procedure (SOP) that follows the workflow shown in FIG. 1. The process demonstrates how a series of deliberate choices, starting from the desired final properties, leads to a specifically tailored biocomposite material.

The process begins with the first decision: selecting the desired properties of the target biocomposite. For this example, the user requires a material for a lightweight structural application, and therefore selects a target of high compressive strength and high Young's modulus.

This initial choice directly informs the next decision: selecting the input biomaterial. To achieve high strength, a biomaterial with an inherently filamentous bulk cell structure is chosen. The specific feedstock selected is the wastewater-derived alga Hilmar, which is known to produce materials with superior stiffness and strength. The selected Hilmar biomass is then extracted from its source and dried.

The third decision is selecting the pre-processing method. Since the goal is to leverage the strength benefits of the filamentous structure, a comminution technique is chosen that retains the original filamentous morphology of the Hilmar biomass. A pestle-and-mortar method is selected for this purpose, as it provides particle size reduction while preserving the high aspect ratio of the particles, which is critical for mechanical interlocking.

Next, the user decides to add a filler to further improve mechanical properties. A fibrous filler, switchgrass, is selected to complement the filamentous algae matrix. To ensure maximum performance, the user also decides to add a bio-epoxy binder to the mixture to enhance the interfacial adhesion between the filler and the powder. The engineered powder, switchgrass filler, and bio-epoxy are then homogenized.

The final decision is selecting the composite processing method. Because the formulation includes a bio-epoxy binder that requires heat to cure, the thermo-mechanical route is the necessary choice. The homogenized dry powder mixture is placed in a mold and consolidated under high temperature and pressure, which causes thermal fusion of the particles and activates the binder. Following this procedure, a biocomposite is formed that meets the initially selected target properties of high strength and stiffness.

### Example 3: Method for Fabricating a Tunable Biocomposite

A tuned biocomposite material was fabricated according to the method illustrated in the exemplary flowchart of FIG. 1 and described in Example 2.

First, a target property of high strength and high flexural modulus was selected for the final biocomposite. Based on this selection, an input biomaterial with a filamentous bulk cell structure, specifically the alga Hilmar, was chosen. The Hilmar biomass was then extracted and dried from its source.

Following drying, the biomass was subjected to a pre-processing step to create an engineered powder. To retain the original filamentous structure of the Hilmar algae, the dried material was comminuted using a pestle-and-mortar. This pulverization step resulted in an engineered bio-powder with a high-aspect-ratio particle morphology.

Next, a fibrous natural filler, switchgrass, was blended with the engineered bio-powder at a loading of 50% by weight. A bio-epoxy binder was also added to the mixture to improve filler adhesion. The powder, filler, and binder were then homogenized using a high-shear mixer to ensure a uniform distribution. Finally, a thermo-mechanical composite processing method was chosen to consolidate the mixture. The homogenized powder was placed in a mold and subjected to high heat and pressure. This step served to both consolidate the particles and cure the bio-epoxy binder, maximizing interfacial adhesion. After being held at temperature and pressure, the material was cooled and demolded, resulting in the final, high-strength biocomposite. Alternatively, for binder-free formulations, an aqueous plasticization route could be chosen, which would involve rehydrating the powder to form a paste before compression and drying.

### Example 4: Preparation of Engineered Powders by Mechanical Pre-Processing of Algal Feedstocks

An experiment was performed to demonstrate that a mechanical pre-processing step can transform dried algal biomass into an “engineered powder” with a specific, predetermined, and non-random particle aspect ratio distribution. The purpose was to validate the core manufacturing step of the predictive design framework, wherein the morphology of the powder's constituent particles is deliberately controlled. This engineered morphology is a key variable that dictates the internal architecture and, consequently, the final mechanical properties of the consolidated biocomposite.

To achieve this purpose, four distinct dried algal feedstocks (Chlorella, Delhi, Tribonema, and Hilmar) were subjected to a mechanical pre-processing step using an electric blade grinder to provide engineered powders.

The following biocomposite fabrication workflow for dry high-pressure process was followed (1) Dry biomaterials are sourced (algae and agricultural residues). (2) Comminution: feedstocks are size-reduced using a blade grinder or other grinding method until a fine powder is obtained. (3) Sieving: ground powders are sieved with a 40 mesh (or other size) sieve to exclude oversized particles. (4) Blending: sieved powders are homogenized in a high-shear speed mixer, overhead mixer, or other type of mixer to combine algae with agricultural residues, forming a uniform mixture. (5) Compression molding: blended powders are compacted into cylindrical forms, square forms, or other shaped molds, under controlled pressure. (6) Extract and measure: molded samples are demolded, measured for physical dimensions (height in mm+SD, SD=standard deviation) and density (g cm-3+SD), and prepared for further testing. Right panel: representative biocomposite specimens fabricated from Chlorella, Tribonema, Hilmar, and Delhi feedstocks, with annotated dimensions and SDs.

The resulting powders were then analyzed using optical microscopy and automated image analysis software to determine the statistical distributions of key morphological parameters, including particle volume and particle aspect ratio.

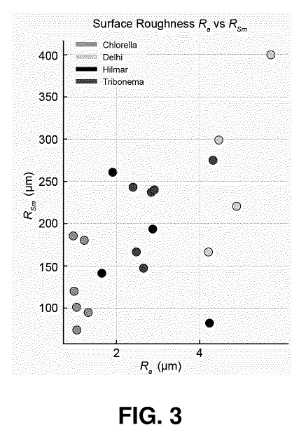

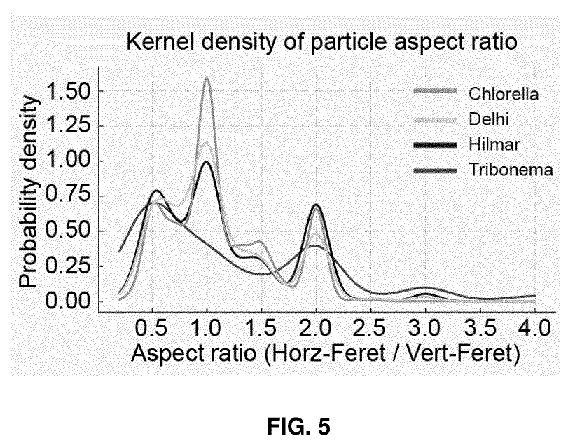

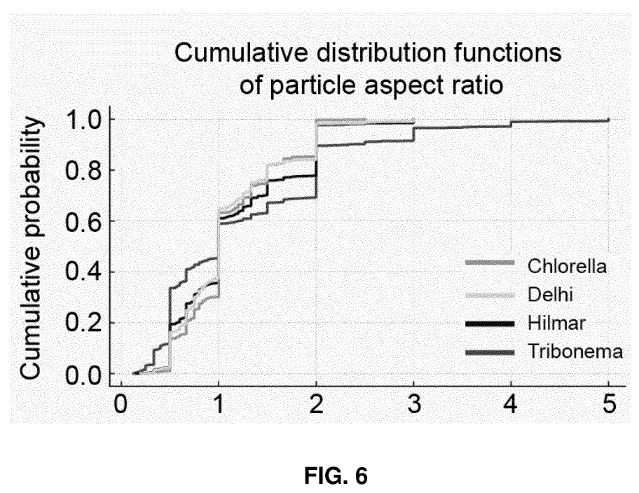

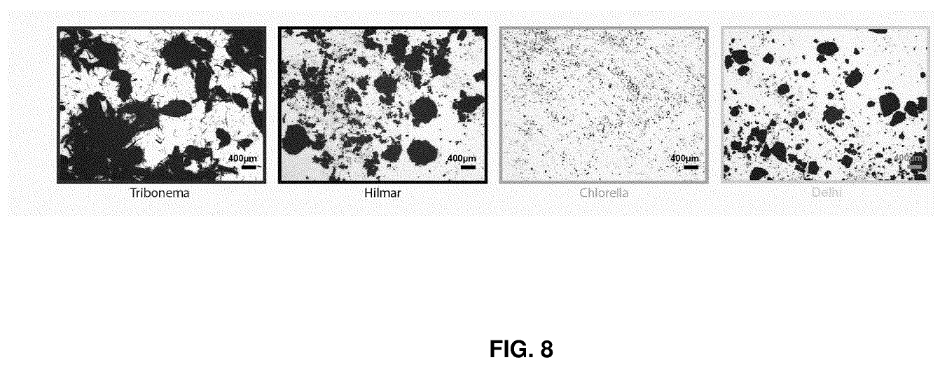

The results of the particle characterization are schematically illustrated in FIGS. 3-8. The Kernel Density Estimate (KDE) plot (FIG. 5) and Cumulative Distribution Function (CDF) plot (FIG. 6) show that the powders derived from Chlorella and Delhi have narrow, unimodal distributions centered at a low aspect ratio (AR≈1.2), with 90% of their particles having an AR of 1.5 or less. These powders consist of substantially equiaxed, granular particles. In contrast, the powders from Tribonema and Hilmar exhibit broader, right-skewed, or bimodal distributions, confirming a substantial population of elongated, filamentous particles with AR values often greater than 2.0. The optical micrographs in FIG. 8 provide direct visual confirmation of these distinct morphologies.

This data demonstrates that the mechanical pre-processing of a selected dried biomass is an effective method for preparing an engineered powder with a controlled particle architecture. The resulting quantifiable particle aspect ratio distribution serves as a “fingerprint” for the powder and is predictive of the final properties of the consolidated biocomposite25. Therefore, a person of ordinary skill in the art can practice the invention by applying a specific pre-processing method to a selected feedstock to create a powder with a target morphology. To achieve high stiffness through dense packing, one would prepare a powder with a low AR and a narrow distribution, as seen for Chlorella. To achieve high toughness through mechanical interlocking, one would prepare a powder with a high AR and a broad or bimodal distribution, as seen for Tribonema.

### Example 5: Characterization of Engineered Powders from Algal Feedstocks

The physical and morphological properties of exemplary engineered powders that serve as the primary building blocks for the biocomposites were characterized.

The purpose of this characterization was to establish a quantitative and predictive link between the inherent properties of a starting biological feedstock, the effects of a selected mechanical pre-processing method, and the resulting particle-level characteristics of the engineered powder. These characteristics, particularly the particle aspect ratio and volume distributions, are the key result-effective variables that are controlled to tune the mechanical properties of the final biocomposite material. This example provides the objective, measurable basis for the predictive design framework that enables the fabrication of biocomposites with tailored properties.

In order to achieve this purpose, four distinct dried algal feedstocks (Chlorella, Delhi, Tribonema, and Hilmar) were subjected to a mechanical pre-processing step using an electric blade grinder to provide engineered powders. The resulting powders were then analyzed using optical microscopy and automated image analysis software to determine the statistical distributions of key morphological parameters, including particle volume, particle aspect ratio, and particle surface area. The surface texture of final biocomposite panels made from these powders was also analyzed using profilometry to determine the arithmetic mean surface roughness (Ra) and other related parameters.

The results of the particle characterization and surface texture analysis are illustrated in FIGS. 3-8.

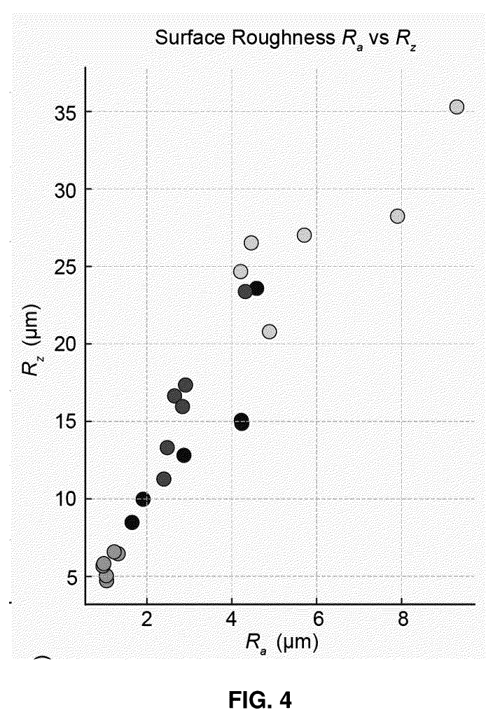

The data in FIGS. 3 and 4 establishes a direct and generalizable link between the morphology of the engineered powder and a measurable property of the final consolidated product. The observed correlations show that powders comprising particles with a higher aspect ratio distribution (e.g., Tribonema) consistently result in a final biocomposite with a higher arithmetic mean surface roughness (Rₐ). This demonstrates that the final surface texture of the biocomposite is a direct topological map of the underlying particle architecture, reinforcing the predictive power of the design framework and providing a verifiable structural feature in the final product.

As will be understood by a skilled person, the statistical distributions of the particle aspect ratio (AR) shown in the Kernel Density Estimate (KDE) plot in FIG. 5 and the Cumulative Distribution Function (CDF) plot in FIG. 6 shows that powders derived from Chlorella and Delhi have narrow, symmetric, and unimodal distributions centered at an AR of approximately 1.2. In contrast, the powders derived from Tribonema and Hilmar exhibit broader distributions that are visibly bimodal or skewed to the right, indicating a significant population of particles with AR values greater than 2.0.

Therefore the data shown in FIGS. 5 and 6 provide objective, measurable evidence of the “predetermined, non-random particle aspect ratio distribution” that defines the engineered nature of the powder.

These results support the conclusion that it is possible to creating an engineered powder with a specific distribution variating AR can be used to achieve a desired outcome as will be understood by a skilled person.

For example, to create a tough biocomposite whose internal architecture is dominated by mechanical interlocking, a skilled person would produce a powder with a right-skewed or bimodal distribution, as seen for Tribonema and Hilmar, ensuring a substantial population of high-AR particles (e.g., a mean AR>1.5). Conversely, to create a stiff biocomposite whose internal architecture is dominated by dense particle packing, a skilled person would produce a powder with a narrow, unimodal distribution, as seen for Chlorella and Delhi, to obtain a powder of substantially equiaxed, granular particles (e.g., a mean AR<1.5).

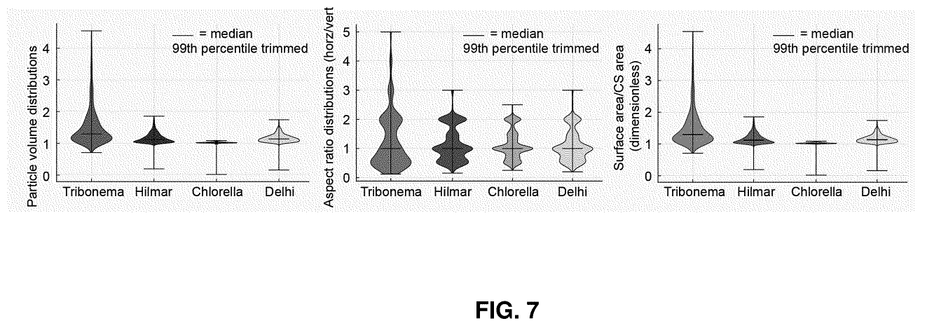

Similar considerations apply to the data of FIG. 7. The violin plots in FIG. 7. provide specific, measurable parameter ranges that enable a skilled person to practice the invention. The data shows, for example, that the median particle volume can be controlled within a range from approximately 1.37×10⁴ μm³ for Chlorella to approximately 1.18×10⁵ μm³ for Delhi. This allows a skilled person to select or create a powder with a target particle volume to control the resulting packing density and pore structure in the final composite.

Also The optical micrographs in FIG. 8 provide direct visual confirmation that these statistical distributions correspond to tangible and distinct physical particle morphologies, with the Tribonema and Hilmar particles being visibly elongated and fibrous, and the Chlorella and Delhi particles being more compact and granular.

Therefore, the data presented in FIG. 3-8 overall demonstrates that the mechanical pre-processing of different biological feedstocks results in engineered powders with distinct, measurable, and non-random particle morphologies. These quantifiable morphologies provide a verifiable “fingerprint” for the powder and are predictive of the final properties of the consolidated biocomposite, providing the basis for the predictive design framework of the present disclosure as will be understood by a skilled person.

### Example 6: Quantitative Analysis of Engineered Particle Aspect Ratio Distributions

The statistical distributions of the particle aspect ratios for the engineered powders described in Example 1 were quantitatively analyzed.

The purpose of this analysis was to provide an objective, measurable definition for the “predetermined, non-random particle aspect ratio distribution” that is a key structural feature of the engineered powders and the resulting biocomposites of the present disclosure. This example demonstrates that different starting feedstocks, when subjected to the same pre-processing method, produce powders with measurably distinct and well-defined particle aspect ratio distributions. This provides further support for the predictive design framework, wherein these measurable distributions are used to select and produce a powder that will yield a final biocomposite with a desired set of mechanical properties.

In order to achieve this purpose, the four engineered powders from Example 1 (Chlorella, Delhi, Tribonema, and Hilmar) were analyzed via automated image analysis of more than 18,000 discrete particle fragments per strain. The horizontal and vertical Feret diameters of each particle were measured to calculate an aspect ratio. This data was then used to generate Cumulative Distribution Function (CDF) and Kernel Density Estimate (KDE) plots for each powder.

The results of the quantitative analysis of the particle aspect ratio distributions are illustrated in FIGS. 5 and 6.

As will be understood by a skilled person, the data presented in FIG. 3-8 provides a quantitative fingerprint for the different classes of engineered powders. The Cumulative Distribution Function (CDF) plot in FIG. 6 shows that the powders derived from Chlorella and Delhi exhibit steep curves, with 90% of their constituent particles having an aspect ratio of approximately 1.5 or less. In contrast, the powders derived from Tribonema and Hilmar exhibit much shallower curves, indicating that a substantial population of their constituent particles have higher aspect ratios; for these powders, the 90% cumulative threshold is not reached until an aspect ratio of approximately 2.0 to 2.3.

This result supports the conclusion that the pre-processing method creates at least two distinct and well-defined classes of engineered powders: a first class comprising substantially equiaxed, granular particles (Chlorella, Delhi), and a second class comprising a significant population of elongated, filamentous particles (Tribonema, Hilmar). The Kernel Density Estimate (KDE) plot in FIG. 5 provides further support for this conclusion. The Chlorella and Delhi powders exhibit single, symmetric modes centered near an aspect ratio of 1.2, which is characteristic of a uniform, granular powder. In contrast, the Tribonema powder exhibits a broad, right-skewed distribution with a shoulder extending beyond an aspect ratio of 2.5, and the Hilmar powder exhibits a distinct bimodal distribution with maxima at approximately 1.4 and 2.1.

Therefore, a person of ordinary skill in the art can use this quantitative data to practice the invention by engineering a powder with a specific, desired particle aspect ratio distribution to achieve a targeted mechanical outcome. For example, to create a stiff biocomposite whose internal architecture is dominated by dense particle packing, a skilled person would produce an engineered powder having a narrow, unimodal aspect ratio distribution with a mean aspect ratio of less than 1.5, as exemplified by the Chlorella and Delhi powders. Conversely, to create a tough biocomposite whose internal architecture is dominated by mechanical interlocking, a skilled person would produce an engineered powder having a bimodal or right-skewed aspect ratio distribution wherein a substantial fraction (e.g., at least 10%) of the particles have an aspect ratio greater than 2.0, as exemplified by the Tribonema and Hilmar powders.

### Example 7: Mechanical and Surface Characterization of Pure Algae Biocomposites

The bulk mechanical and surface properties of exemplary biocomposites, which were fabricated from the four distinct engineered powders described in Example 5, were characterized.

The purpose of this characterization was to establish a direct, quantitative link between the engineered particle morphology of the powder (the cause) and the final material's performance characteristics, including stiffness, strength, and surface wettability (the effect). This example provides the objective, measurable data to support the conclusion that the predictive design framework of the present disclosure enables the fabrication of biocomposites with tailored properties. It further provides the basis for product claims directed to biocomposites having specific, measurable mechanical and surface properties.

In order to achieve this purpose, the four engineered powders from Example 1 (Chlorella, Delhi, Tribonema, and Hilmar) were consolidated into cylindrical biocomposite specimens using a high-pressure compression molding process. The resulting solid biocomposite specimens were then subjected to mechanical compression testing to determine their Young's Modulus and Maximum Force at failure. The surface wettability of the biocomposite panels was also measured using static water contact angle measurements.

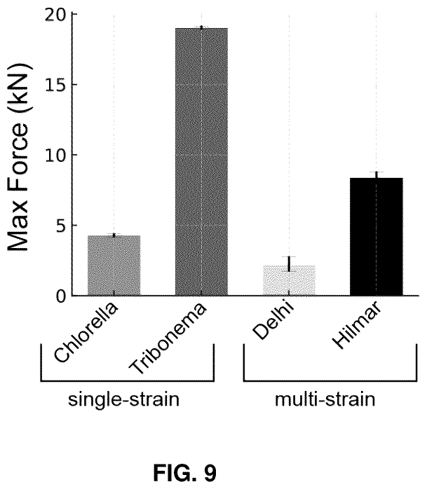

The results of the mechanical and surface characterization of the pure algal biocomposites are illustrated in FIGS. 9-11B.

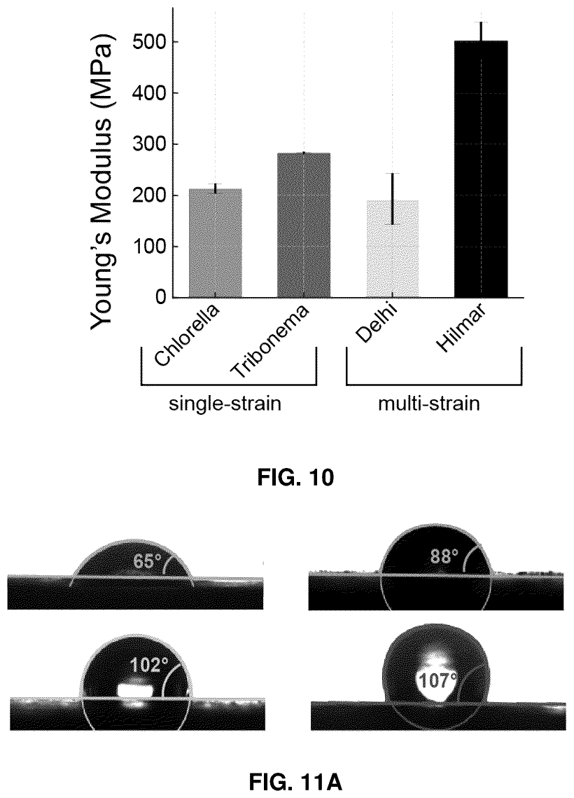

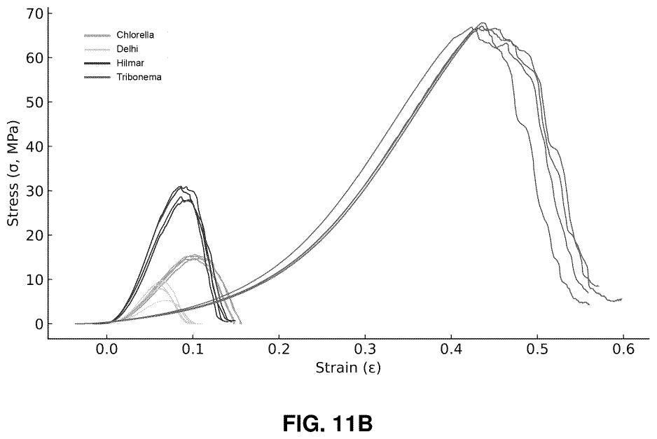

As will be understood by a skilled person, the data presented in FIGS. 9-11B demonstrates that the different particle morphologies of the engineered powders, as characterized in Example 1, directly and predictably control the final bulk properties of the consolidated biocomposite materials. The bar charts in FIG. 9 and FIG. 10 show that the biocomposites made from the feedstocks comprising filamentous particles (Tribonema and Hilmar) exhibit significantly higher strength and stiffness compared to those made from the feedstocks comprising granular particles (Chlorella and Delhi). The Hilmar biocomposite, in particular, exhibited the highest Young's Modulus (approximately 502 MPa) and the second-highest Maximum Force (approximately 8.37 kN). The Tribonema biocomposite exhibited the highest Maximum Force (approximately 19.0 kN). In contrast, the Chlorella and Delhi biocomposites showed lower values for both properties. The stress strain curves in FIG. 11B provide further evidence for this, showing that the materials made from Tribonema and Hilmar powders sustain higher loads before failure. The curve for Tribonema, in particular, shows a more gradual softening after the peak load, which is indicative of energy-dissipating mechanisms such as fiber pull-out. This is in stark contrast to the curve for Chlorella, which shows an abrupt, brittle failure at a much lower load.

These results support the conclusion that the high-aspect-ratio particles of the Tribonema and Hilmar powders form an internal architecture dominated by mechanical interlocking, which leads to superior mechanical performance. Therefore, a person of ordinary skill in the art can use this data to practice the invention and create a biocomposite with a desired mechanical profile. For example, to create a strong and tough material, a skilled person would select a feedstock and pre-processing method that yields a powder of high-aspect-ratio, filamentous particles, as this leads to a final product with a Young's Modulus greater than 280 MPa and a maximum failure force greater than 8 kN.

Similar considerations apply to the data of FIG. 11.A. The static water contact angle measurements show that the biocomposites made from the mixed-strain wastewater feedstocks (Hilmar and Delhi) are hydrophobic, with contact angles of 107° and 102°, respectively. In contrast, the biocomposites from the single-strain feedstocks (Chlorella and Tribonema) are more hydrophilic, with contact angles of 88° and 65°, respectively.

This result provides clear guidance to a skilled person for creating a biocomposite with a desired barrier function. To fabricate a water-resistant biocomposite, a skilled person would select a feedstock comprising a mixed-strain microbial community, such as that found in the Hilmar or Delhi wastewater sources, as this results in a hydrophobic surface.

Therefore, the data presented in FIG. 9-11B overall validates the predictive design framework of the present disclosure. It demonstrates that by selecting a starting feedstock based on its inherent morphology (e.g., filamentous vs. granular) and origin (e.g., mixed-strain wastewater vs. single-strain culture), a person of ordinary skill in the art can predictably fabricate a final biocomposite material having a specific, predetermined combination of mechanical and surface properties.

### Example 8: Microstructural Characterization of Consolidated Biocomposites

The internal and external microstructures of exemplary biocomcomposites, fabricated from the four distinct engineered powders as described in Example 5, were characterized.

The purpose of this characterization was to provide direct, visual evidence of the novel internal architecture of the final biocomposite materials. Specifically, these experiments were performed to demonstrate that the engineered particle morphology of the starting powder (e.g., high vs. low aspect ratio) directly dictates the final strengthening mechanism (e.g., mechanical interlocking vs. dense particle packing) within the consolidated monolithic body. This example provides a verifiable structural “fingerprint” for the different embodiments of the invention and supports product claims directed to a biocomposite having a specific, observable internal structure and fracture morphology.

In order to achieve this purpose, the consolidated biocomposite specimens from Example 2 were cryo-fractured to expose their internal structure. The resulting internal fracture surfaces and the original exterior surfaces of the specimens were then analyzed using Scanning Electron Microscopy (SEM) at various magnifications and optical microscopy.

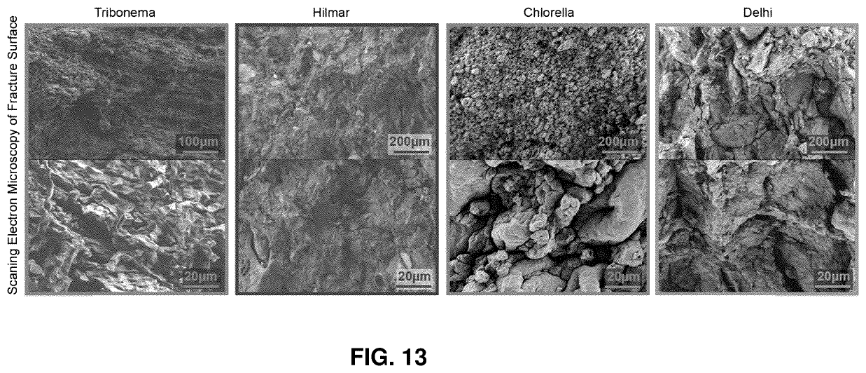

The results of the microstructural characterization are illustrated in FIGS. 13-15.

As will be understood by a skilled person, the data presented in FIGS. 9-11B reveals that the biocomposites of the present disclosure possess distinct and well-defined internal architectures that are a direct consequence of the engineered powders from which they are formed. The Scanning Electron Microscopy (SEM) images in FIG. 13 show the fracture morphologies of the four exemplary biocomposites. The biocomposite made from the filamentous Tribonema powder exhibits a fracture surface characterized by interwoven, fibrous networks and clear evidence of elongated fiber pull-out features. In contrast, the biocomposite made from the granular Chlorella powder exhibits a highly particulate fracture surface composed of compact, spheroidal structures with limited evidence of fiber bridging, which is characteristic of a brittle, inter-granular fracture. The biocomposites from the mixed-strain Hilmar and Delhi feedstocks show intermediate, heterogeneous granular textures.

This result supports the conclusion that the final material's internal architecture and mechanical failure mode are directly controlled by the morphology of the constituent particles. The observation of fiber pull-out in the Tribonema sample is a classic energy-dissipating mechanism and a verifiable structural feature of a tough, fiber-reinforced composite. Therefore, a person of ordinary skill in the art can use this data to practice the invention and confirm the creation of a tough biocomposite by verifying the presence of these interwoven, fibrous networks and pull-out features on a fracture surface. Conversely, to confirm the creation of a stiff biocomposite, a skilled person would verify the presence of a compact, particulate fracture surface characteristic of dense packing.

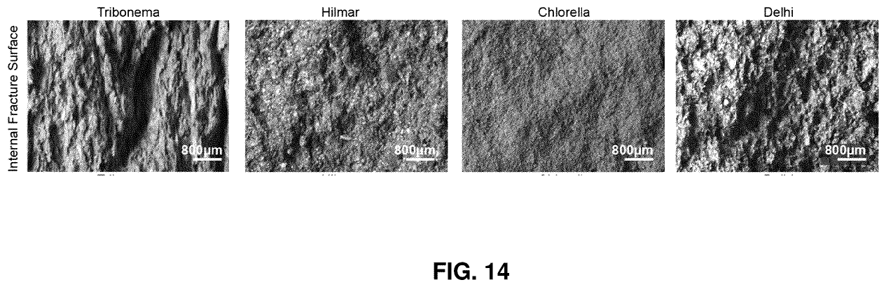

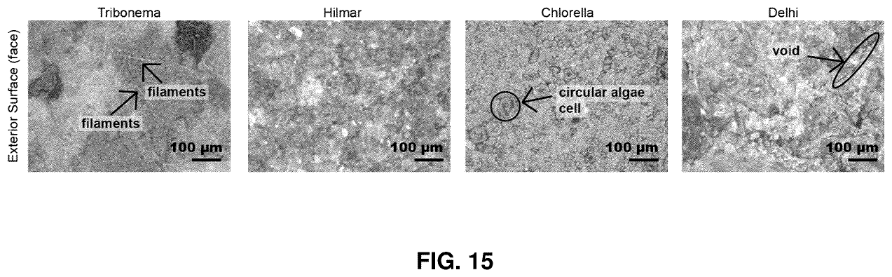

Similar considerations apply to the optical micrographs of the internal and exterior surfaces. The images of the internal fracture surfaces in FIG. 14 confirm the SEM findings at a larger scale, showing the homogeneous, tightly packed filamentous network of the Tribonema composite versus the fine, granular texture of the Chlorella composite. Furthermore, the images of the exterior surfaces in FIG. 15 show that the Tribonema composite has a visibly fibrous surface texture, while the Chlorella composite has a uniform, matte surface of tightly packed granules. This confirms the link between the particle aspect ratio of the engineered powder and the final surface roughness (Rₐ) of the product, providing another verifiable physical feature of the final biocomposite.

### Example 9: Fabrication and Characterization of Reinforced Algae-Fiber Biocomposites

The mechanical properties of exemplary reinforced biocomposites, comprising an algal matrix and an agricultural waste filler, were characterized.

The purpose of these experiments was to demonstrate that the mechanical properties of the biocomposites of the present disclosure can be further tuned and enhanced by incorporating a second population of discrete particles (a filler) into the primary algal matrix. Specifically, this example was performed to show that the morphology of the filler particles is a critical result-effective variable, with fibrous, high-aspect-ratio fillers providing significant reinforcement, while granular, low-aspect-ratio fillers provide limited or negative reinforcement. This example provides further support for the predictive design framework, wherein a skilled person can select a specific filler type to achieve a targeted mechanical outcome.

In order to achieve this purpose, the four engineered algal powders from Example 1 (Chlorella, Delhi, Tribonema, and Hilmar) were used as the matrix material. Each algal powder was blended with one of two distinct agricultural waste fillers: a fibrous, high-aspect-ratio filler (ground switchgrass) or a granular, low-aspect-ratio filler (ground almond shells). The blended powders were then consolidated into monolithic biocomposite bodies using high-pressure molding. The resulting reinforced biocomposites were then subjected to mechanical testing to determine their Young's Modulus and Maximum Compressive Force.

The results of the mechanical testing of the reinforced biocomposites are summarized in Table 3.

TABLE 3
Young's Modulus and Max Compressive Force of
Algae Composite Materials

| | Young's | | | |
|---|---|---|---|---|
| | Modulus | | | σ_max |
| Composite | (MPa) | Max Force (kN) | | (MPa) |
| Chlorella (Pure) | 213.3 ± 9.5 | 4.28 ± 0.14 | | 15.10 ± 0.14 |
| Chlorella + | 212.4 ± 22.4 | 4.53 ± 0.30 | (+5.8%) | 15.98 ± 0.30 |
| Almond (70%)* | (−0.4%) | | | |
| Chlorella + | 359.4 ± 3.8 | 23.60 ± 0.29 | (+451.4%) | 83.24 ± 0.29 |
| Switchgrass II | (+68.5%) | | | |
| Delhi (Pure) | 192.8 ± 50.0 | 2.24 ± 0.53 | | 7.90 ± 0.53 |
| Delhi + Almond | 254.3 ± 69.1 | 5.11 ± 1.70 | (+128.1%) | 18.02± |
| (50%)* | (+31.9%) | | | |
| Delhi + | 509.2 ± 16.5 | 18.81 ± 0.67 | (+739.7%) | 66.34± |
| Switchgrass II | (+164.1%) | | | |
| Hilmar (Pure) | 502.0 ± 37.1 | 8.37 ± 0.44 | | 29.52± |
| Hilmar + Almond | 389.6 ± 14.7 | 8.51 ± 0.30 | (+1.7%) | 30.01± |
| (30%)* | (−22.4%) | | | |
| Hilmar + | 564.4 ± 26.2 | 25.86 ± 0.58 | (+209.0%) | 91.21± |
| Switchgrass II | (+12.4%) | | | |
| Tribonema (Pure) | 283.0 ± 2.0 | 19.0 ± 0.15 | | 67.01± |
| Tribonema + | 235.8 ± 6.8 | 7.57 ± 0.37 | (−60.2%) | 26.70± |
| Almond (70%)* | (−16.7%) | | | |
| Tribonema + | 445.4 ± 12.9 | 24.18 ± 0.64 | (+27.3%) | 85.28± |
| Switchgrass II | (+57.4%) | | | |

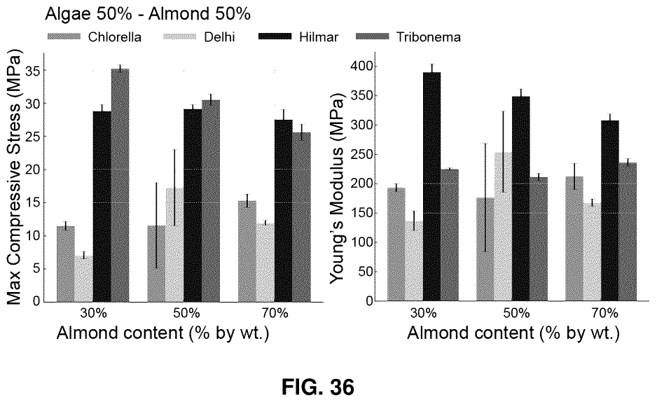

Mechanics of pure algae and algae-filler composites (mean ± SD). Percentage changes relative to the corresponding pure algae are shown in parentheses.
*Almond composites marked with an asterisk correspond to the filler ratio (30-70% by weight) that provided the most favorable reinforcement response for each matrix. In cases where modulus and maximum force did not coincide, the ratio giving the highest Young's modulus was reported (full comparisons of all almond percentages in supplemental FIG. 36).

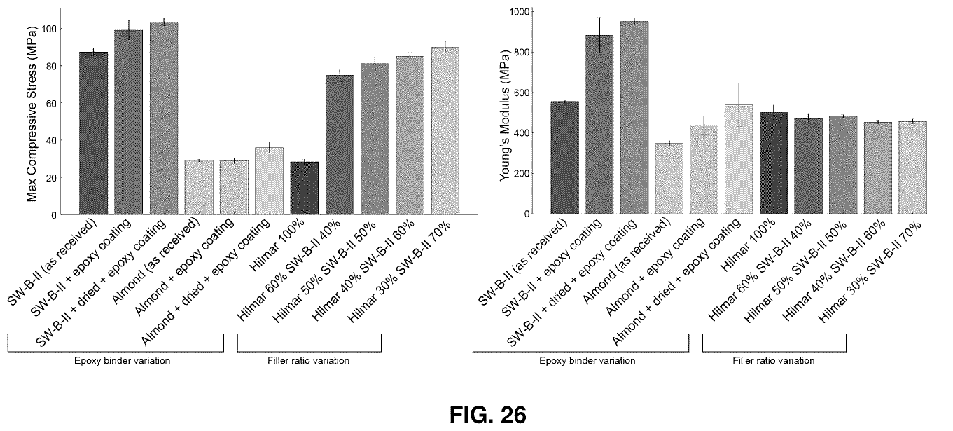

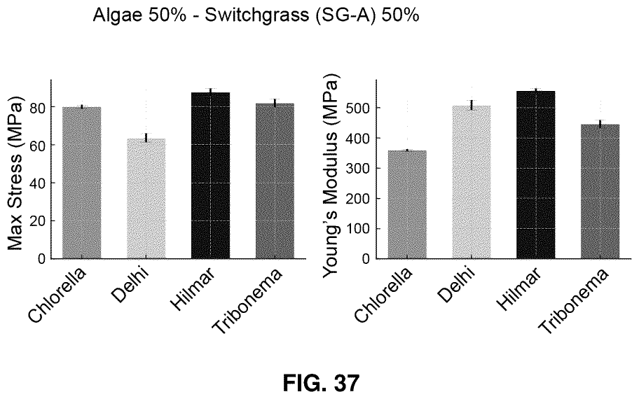

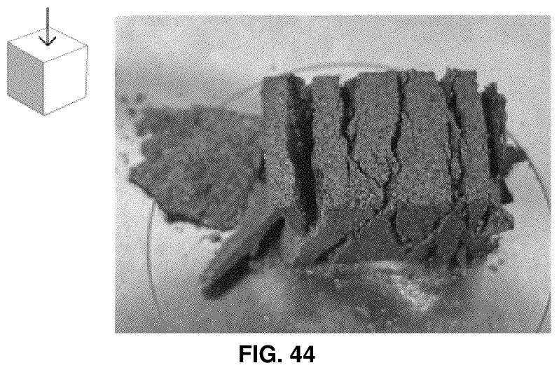

The resulting composites highlighted a strong dependence on both matrix identity and filler type with switchgrass consistently outperforming almond sells. Almond filler provided limited or negative reinforcement: Delhi exhibited modest gains (+32% modulus, +128% strength), whereas Hilmar actually lost stiffness (−22% modulus) and showed only a negligible strength change (+2%). Chlorella remained essentially unchanged in modulus (−0.4%), while Tribonema suffered substantial reductions (−17% modulus, −60% strength), underscoring the poor load-transfer efficiency of granular almond particulates. At higher almond loadings, matrix continuity was further disrupted and stress transfer diminished. FIGS. 36 and 37 compare almond and algae switchgrass composites modulating the algae and filler percentages. Among these composites, Hilmar-switchgrass composites delivered the best combined performance, motivating further exploration of this matrix-filler pairing in subsequent experiments (FIG. 41-44 and FIG. 26 and supplemental note 3).

Switchgrass fibers delivered substantially more effective reinforcement than almond shells, consistent with their high aspect ratio (FIG. 37) compared to pure algae. Chlorella-switchgrass composites increased modulus by +69% and strength by +451%, Delhi-switchgrass reached +164% modulus and +740% strength, Tribonema-switchgrass achieved +57% modulus and +27% strength, and Hilmar-switchgrass showed a modest modulus gain (+12%) but a dramatic +209% increase in strength (Table 3). Across all cases, switchgrass composites reached the highest maximum force and Young's modulus, demonstrating a superior load transfer between fibrous fillers and algae matrices. This consistent reinforcement underscores the benefit of switchgrass over almond particulates.

As will be understood by a skilled person, the data presented in Table 3 shows that the mechanical properties of the final biocomposite are strongly dependent on both the identity of the algal matrix and, the morphology of the filler material. As shown in Table 3, the addition of the granular almond shell filler provided minimal or even negative reinforcement across all four algal matrices. For example, the incorporation of almond shells into the Hilmar matrix resulted in a 22.4% decrease in Young's Modulus, and incorporation into the Tribonema matrix resulted in a 16.7% decrease in modulus and a 60.2% decrease in maximum force. In contrast, the addition of the fibrous switchgrass filler provided substantial and consistent reinforcement. For example, the incorporation of switchgrass into the Delhi matrix resulted in a 164.1% increase in Young's Modulus and a 739.7% increase in maximum force. Similarly, incorporation into the Hilmar matrix resulted in a 12.4% increase in modulus and a 209.0% increase in maximum force.

This result supports the conclusion that the aspect ratio of the filler particle is a key variable for achieving mechanical reinforcement. The superior performance of the high-aspect-ratio switchgrass fibers is attributed to their ability to form an interlocking reinforcing network within the algal matrix, which enables efficient load transfer and enhances both stiffness and strength. The poor performance of the low-aspect-ratio almond shell particles is attributed to their inability to form such a network, instead acting as non-reinforcing inclusions that can disrupt the continuity of the matrix. Furthermore, the data supports the conclusion that certain algal matrices are superior for creating reinforced composites; the Hilmar feedstock consistently produced the composites with the highest final Young's Modulus and strength, both in its pure form and when combined with a filler.

Therefore, a person of ordinary skill in the art can use this data to practice the invention by selecting a filler material based on its particle aspect ratio to achieve a desired mechanical outcome. For example, to significantly increase the stiffness and strength of a biocomposite, a skilled person would select a fibrous, high-aspect-ratio filler such as ground switchgrass and combine it with a matrix-forming powder, such as one derived from Hilmar algae, that exhibits high inherent mechanical properties.

### Example 10: Characterization and Theoretical Modeling of Reinforced Biocomposites

The mechanical properties of exemplary reinforced biocomposites, comprising an algal matrix and a variety of agricultural waste fillers, were characterized and compared to theoretical performance models.

The purpose of these experiments was twofold. First, to demonstrate that the mechanical properties of the biocomposites can be further tuned by the incorporation of different types of agricultural fillers, and to establish that the morphology of the filler is a critical result-effective variable. Second, to compare the experimentally measured performance of these composites to classical micromechanical models to quantify the role of the filler-matrix interface. This example provides further support for the predictive design framework by showing how filler selection can be used to control properties and demonstrates that engineering the interfacial adhesion is a key, non-obvious step to unlocking the full mechanical potential of these materials.

In order to achieve this purpose, an engineered algal powder derived from the Hilmar feedstock was selected as the matrix material based on its superior baseline properties as shown in previous examples. This matrix was blended with a variety of agricultural waste fillers having different morphologies, including fibrous (e.g., switchgrass, corn stover), woody (e.g., pine), and granular (e.g., almond shell) particles. The blended powders were consolidated into monolithic biocomposite bodies using high-pressure molding. The mechanical properties (compressive strength, Young's Modulus) and surface properties (contact angle, surface roughness) of the resulting composites were measured. The experimental Young's Modulus was then compared to theoretical values predicted by the Counto, Ishai-Cohen, and Halpin-Tsai micromechanical models.

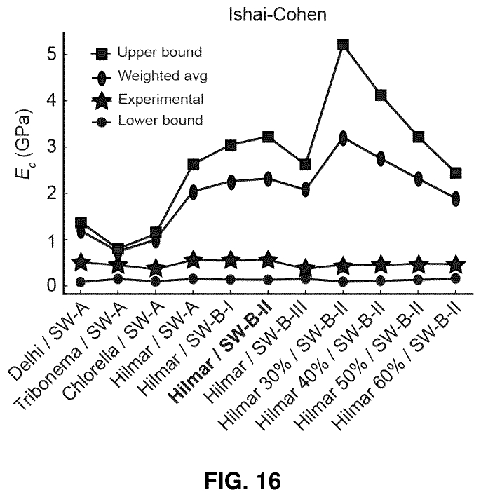

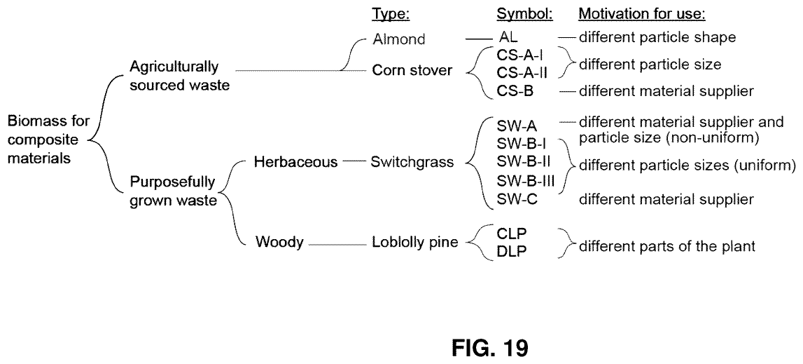

The results of the mechanical characterization are illustrated in FIGS. 19-25, and the comparison to theoretical models is illustrated in FIGS. 26 and 16-18.

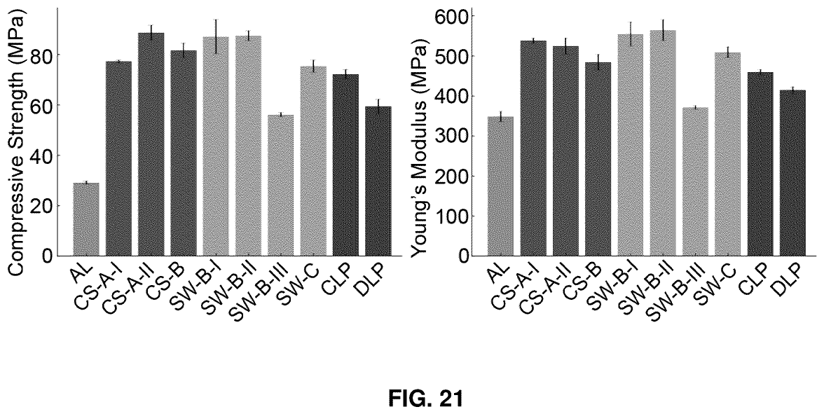

In particular the results of mechanical testing reported in FIGS. 19-25 showed that pure Hilmar achieved the highest compressive strength (19.03±0.15 kN) and modulus (283.0±2.0 MPa) among all pure algae formulations (FIG. 21). Incorporation of raw fillers produced varied effects on mechanical performance, depending on the morphology and compatibility of the biomass. Switchgrass-based composites retained relatively high properties, reaching 25.9±0.6 kN and 564.4±26.2 MPa, values slightly above the pure Hilmar matrix but within experimental uncertainty. Corn stover fillers produced intermediate performance, with moduli ranging from 484±20 to 538±7 MPa and peak forces of 22.9-26.2 kN, consistently higher than almond or pine but somewhat lower than switchgrass. Pine yielded more variable results depending on source, with clean pine achieving 21.3±0.6 kN and 460±7 MPa, while dirty pine dropped to 17.6±0.9 kN and 415±9 MPa. Almond composites consistently showed the lowest values, with a maximum of only 8.51±0.30 kN and 389.6±14.7 MPa, underscoring the limited reinforcing ability of granular particulates in the absence of surface treatment.

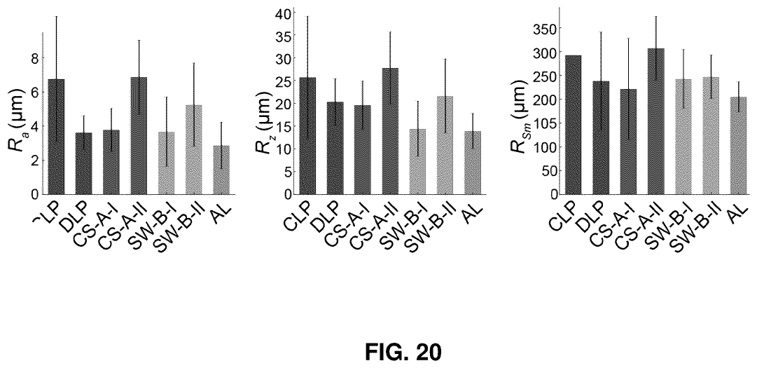

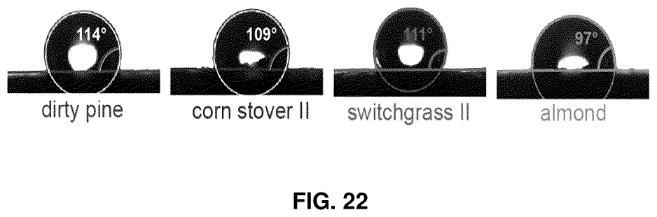

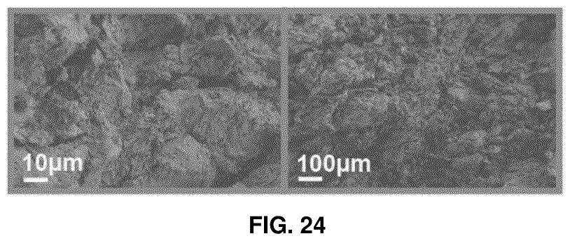

Surface and interfacial properties helped explain these trends. Contact angle measurements indicated hydrophobic differences across fillers, with switchgrass displaying higher wettability than almond or pine (FIG. 22). Profilometry revealed variation in roughness parameters (Rₐ, R₂, R_{Sm}), with herbaceous residues exhibiting more irregular surfaces than almond, which was consistent with enhanced mechanical interlocking potential (FIG. 20). Microstructural imaging confirmed these distinctions: SEM of switchgrass composites highlighted fiber pull-out and void formation at the interface, which are characteristic signs of poor adhesion, while almond composites appeared more uniform but poorly integrated (FIG. 24). Optical microscopy further showed heterogeneous filler distribution in switchgrass formulations compared to the smoother but weaker almond composites.

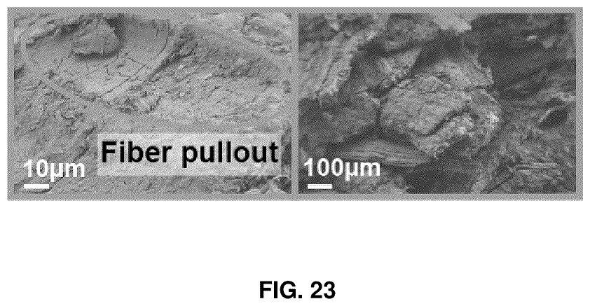

Therefore, the data presented in FIGS. 19-25 demonstrates that the morphology of the filler material is an important variable in controlling the final mechanical properties of the reinforced biocomposite as will be understood by a skilled person. The bar charts in FIG. 21 show that composites reinforced with fibrous, high-aspect-ratio herbaceous fillers (switchgrass and corn stover) consistently exhibited the highest compressive strength and Young's Modulus. In contrast, composites reinforced with granular, low-aspect-ratio particulates (almond shells) consistently showed the lowest mechanical performance. For example, the composite with switchgrass II achieved a Young's Modulus of 564.4±26.2 MPa, whereas the composite with almond shells only reached 389.6±14.7 MPa. The surface property data in FIGS. 20 and 22 and the microstructural images in FIGS. 23-25 provide a physical basis for these results, showing that the fibrous fillers have a rougher, more irregular surface that is more conducive to mechanical interlocking with the algal matrix.

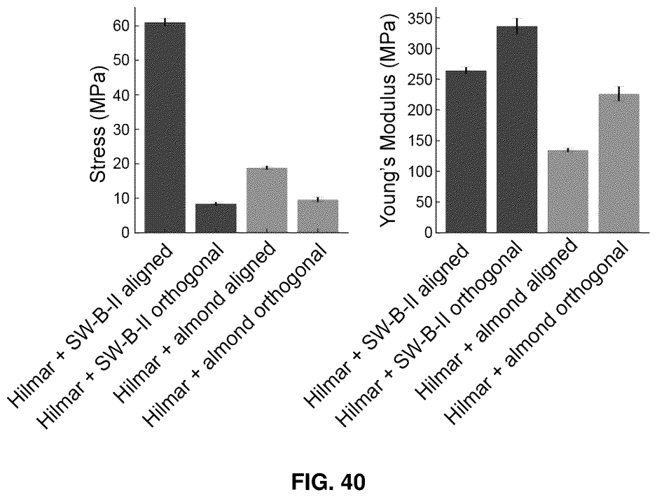

Furthermore, systematic testing revealed that the composites are highly anisotropic; they are strong when loaded along the compression axis but prone to delamination when loaded orthogonally (FIG. 40, 42-44). This behavior, coupled with SEM evidence of fiber pull-out and interfacial voids in untreated systems (FIG. 23), points to imperfect stress transfer at the algae-filler interface as the primary performance-limiting factor.

This result supports the conclusion that a filler's aspect ratio and morphology are key predictive parameters for reinforcement efficiency. Therefore, a person of ordinary skill in the art can use this data to practice the invention by selecting a filler with a specific morphology to achieve a targeted mechanical outcome. For instance, to maximize the strength and stiffness of the biocomposite, a skilled person would select a fibrous, high-aspect-ratio lignocellulosic filler, such as switchgrass, to incorporate into the algal matrix.

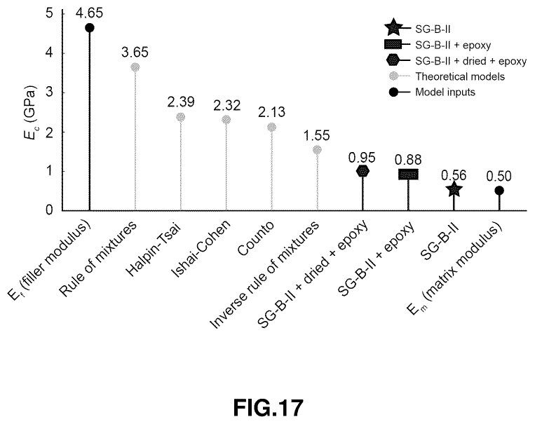

Further, as will be understood by a skilled person, the data presented in FIGS. 16-18 and FIG. 26 demonstrates the significance of the filler-matrix interface. The plots in FIG. 16 show a significant discrepancy between the experimentally measured Young's Modulus (star shapes) and the moduli predicted by the three classical micromechanical models (Counto, Ishai-Cohen, and Halpin-Tsai). Across all composite formulations, the theoretical models, which assume perfect bonding and no voids at the filler-matrix interface, consistently overestimate the Young's Modulus by a factor of two to threefold. The lollipop plot in FIG. 17 further highlight this deviation by showing the hypothetical upper and lower bounds with the rule of mixtures and inverse rule of mixtures, alongside the Halpin-Tsai, Ishai-Cohen and Counto theoretical models.

The combined results of this example supports the conclusion that the simple bulk properties of the matrix and filler alone are insufficient to predict the final performance of the composite. The significant deviation from the idealized models indicates that the quality of the interfacial adhesion between the algal matrix and the filler particles is the dominant factor limiting the material's mechanical performance. This finding indicates that imperfect stress transfer at the interface prevents the full reinforcing potential of the fillers from being realized. Therefore, this sets the basis for an active engineering of the filler-matrix interface through methods such as surface modification enabling one of skill to produce a high-performance biocomposite, as will be detailed in subsequent examples.

### Example 11: Enhancement of Mechanical Properties Via Interfacial Engineering of Fillers

The effect of a bio-epoxy surface treatment on the mechanical and microstructural properties of exemplary reinforced biocomposites was characterized.

A set of experiments was performed to demonstrate that the mechanical performance of the reinforced biocomposites can be significantly enhanced by actively engineering the interfacial adhesion between the algal matrix and the filler particles. The previous examples established that imperfect stress transfer at this interface is a primary factor limiting the performance of untreated composites. This example demonstrates a solution to this non-obvious problem by showing that the application of a surface modification, such as a bio-epoxy coating, to the filler particles is a key inventive step that unlocks the full reinforcing potential of the fillers and enables the creation of a high-performance biocomposite.

In order to achieve this purpose, an engineered algal powder derived from the Hilmar feedstock was used as the matrix. Two types of fillers were tested: a fibrous, high-aspect-ratio filler (switchgrass) and a granular, low-aspect-ratio filler (almond shell). For each filler type, three sets of biocomposites were fabricated: a first set with untreated (as-received) filler, a second set with filler coated with a bio-epoxy, and a third set with filler that was first dried and then coated with the bio-epoxy. The composites were consolidated using a hot-press method to facilitate the curing of the epoxy. The resulting biocomposites were then subjected to mechanical testing (compressive strength, Young's Modulus), Scanning Electron Microscopy (SEM), and surface profilometry.

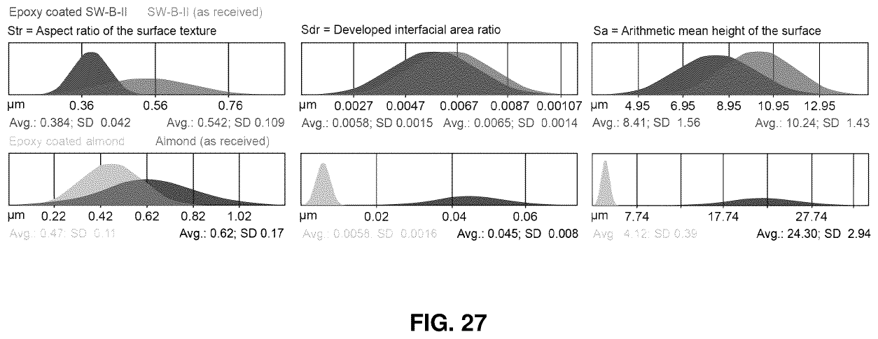

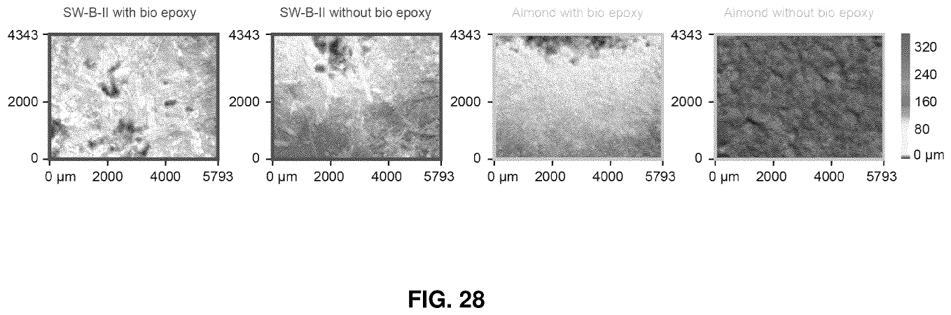

The results of the characterization of the surface-treated biocomposites are illustrated in FIG. 26-, FIG. 27 and FIG. 28.

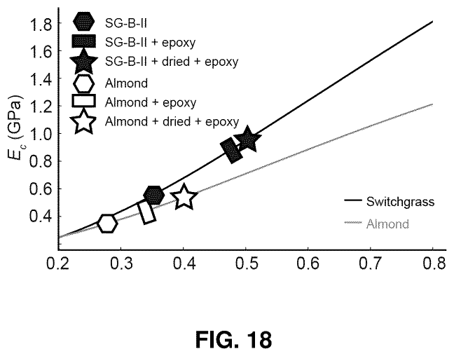

Untreated switchgrass composites reached a compressive strength of 87.4±2.2 MPa and a Young's modulus of 555.5±8.5 MPa. Epoxy coating increased these values to 99.1±5.2 MPa and 883.2±88.2 MPa, respectively, while the addition of a drying step prior to coating provided a further increase to 103.6±2.2 MPa and 951.3±18.2 MPa (FIG. 26 and FIG. 18). These results indicate that the material benefitted from moisture reduction, which improved packing and stiffness, as well as enhanced interfacial adhesion, which suppressed fiber pull-out.

Almond-filled composites, although lower in absolute performance, showed a similar trend. Untreated samples measured 29.1±0.7 MPa in compressive strength and 348.7±12.8 MPa in modulus, while epoxy coating raised the modulus to 439.6±44.4 MPa with little change in strength. Incorporating the drying step further improved properties, increasing compressive strength to 35.9±3.0 MPa and modulus to 538.8±106.9 MPa. These findings demonstrate that epoxy treatment is more effective in fibrous fillers such as switchgrass, where adhesion dominates, but still provides measurable gains in granular fillers like almond, particularly when combined with moisture reduction (FIGS. 18, 26, 27, 28).

Microscopy further highlighted differences in filler-matrix interactions. FIG. 28 presents scanning electron micrographs of fractured surfaces, which confirmed that bio-epoxy treatment promoted adhesion of Hilmar algae to switchgrass fibers, with clear evidence of fiber embedding and reduced pull-out relative to untreated samples. In contrast, untreated composites showed frequent fiber-matrix separation, leaving voids and weakened load paths. Fiber retention within the algae matrix therefore represents a critical mechanism underlying the enhanced compressive performance observed with surface modification.

To complement these qualitative observations, surface profilometry provided quantitative evidence of interfacial improvement. For both fillers, epoxy coating shifted the distributions of roughness parameters (Sₜᵣ, S_{dr}, Sₐ) toward lower values, indicating smoother and more isotropic surface textures (FIG. 27). Switchgrass exhibited pronounced reductions in interfacial area ratio (S_{dr}) from 10.24±1.43 to 8.24±1.56 μm, while almond particles displayed substantial decreases in mean surface height (Sₐ) after coating from 24.30±2.94 to 4.12±0.39. Heat maps of the surface profiles confirmed this topographic smoothing, with epoxy-treated fillers displaying more uniform and continuous surfaces than their untreated counterparts (FIG. 28). Together, these findings demonstrate that bio-epoxy treatment improves filler surface characteristics, strengthens filler-matrix adhesion, and enhances the bulk mechanical performance of Hilmar-based composites, particularly when reinforced with switchgrass.

Therefore, the data presented in FIGS. 26, 27, 28 demonstrates that the surface treatment of the filler particles provides a substantial and unexpected improvement in the mechanical properties of the final biocomposite as will be understood by a skilled person. The bar charts in FIG. 26 show the mechanical performance of the Hilmar-switchgrass and Hilmar-almond composites. For the switchgrass composites, the untreated sample exhibited a compressive strength of 87.4±2.2 MPa and a Young's modulus of 555.5±8.5 MPa. Applying an epoxy coating to the switchgrass filler increased these values significantly, to 99.1±5.2 MPa for strength and 883.2±88.2 MPa for modulus. A further increase was observed when a drying step was performed prior to coating, with the final composite reaching a strength of 103.6±2.2 MPa and a Young's modulus of 951.3±18.2 MPa. The almond-filled composites showed a similar trend, with the Young's Modulus increasing from 348.7±12.8 MPa in the untreated sample to 538.8±106.9 MPa in the dried and epoxy-coated sample.

This result supports the conclusion that engineering the filler-matrix interface via a surface treatment is a critical step for maximizing mechanical performance. The data indicates that the treatment is particularly effective for fibrous fillers like switchgrass, where interfacial adhesion dominates the reinforcing mechanism. Therefore, a person of ordinary skill in the art can use this data to practice the invention by applying a surface coating, such as a bio-epoxy, to the filler particles to create a high-strength, high-stiffness reinforced biocomposite.

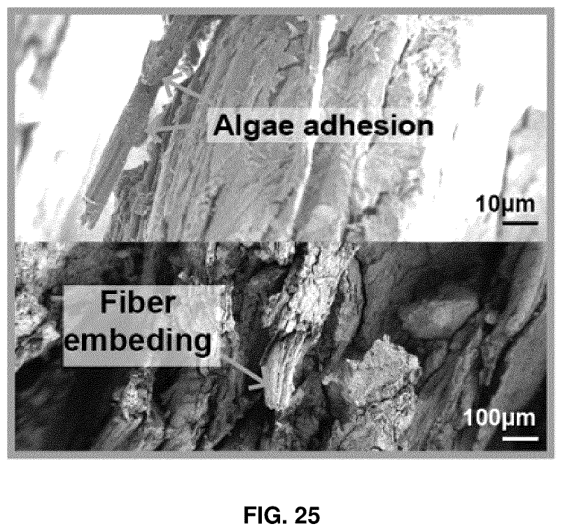

Further, the microstructural and surface analysis provides a clear physical basis for these mechanical improvements. The SEM images in FIG. 25 show the filler-matrix interface of a switchgrass-reinforced composite. The images confirm that the bio-epoxy treatment promotes strong adhesion of the Hilmar algae matrix to the switchgrass fibers, with clear evidence of fiber embedding and a significant reduction in interfacial voids.

This is in stark contrast to the untreated composites (as shown in FIGS. 23-24), which exhibited frequent fiber pull-out. The improved fiber retention within the matrix is a key mechanism responsible for the enhanced compressive performance. The surface profilometry data in FIG. 28 and the SEM in FIG. 25 provides quantitative evidence of this interfacial improvement. For both switchgrass and almond fillers, the application of the epoxy coating shifted the distributions of roughness parameters toward lower values and created a more uniform and continuous surface, which is conducive to stronger and more consistent bonding with the matrix.

The data discussed in this example also supports the conclusion that, the role of curing impact these outcomes. The fabrication of these exemplary composites involves a hot-pressing step, which is beneficial for curing certain types of surface treatments, such as the bio-epoxy used here. Certain curing agents require elevated temperatures (e.g., 160-180° C.) to achieve full polymerization. This controlled heating during the consolidation step is beneficial for maximizing the chemical bonding at the interface and is a key parameter for achieving the enhanced mechanical performance observed in the surface-treated composites.

### Example 12: Characterization of Agricultural Residue Fillers

The physical and morphological properties of exemplary agricultural residue fillers, which can serve as a second population of discrete particles in a reinforced biocomposite, were characterized.

The purpose of this characterization was to demonstrate that different agricultural residues possess distinct, inherent, and measurable particle morphologies. This example establishes that these morphological characteristics, particularly particle volume, aspect ratio, and surface roughness, are key result-effective variables that can be quantified and used by a person of ordinary skill in the art to select a specific filler to achieve a desired reinforcing effect in the final biocomposite. This provides further support for the predictive design framework of the present invention.

In order to achieve this purpose, a variety of as-received, dried agricultural residues were analyzed, including herbaceous biomass (multiple batches of switchgrass and corn stover), woody biomass (clean and dirty pine fractions), and hard particulate residues (almond shells). The fillers were analyzed using optical microscopy and automated image analysis software to determine the statistical distributions of key morphological parameters. Surface profilometry was also used to characterize the surface roughness of the different filler types.

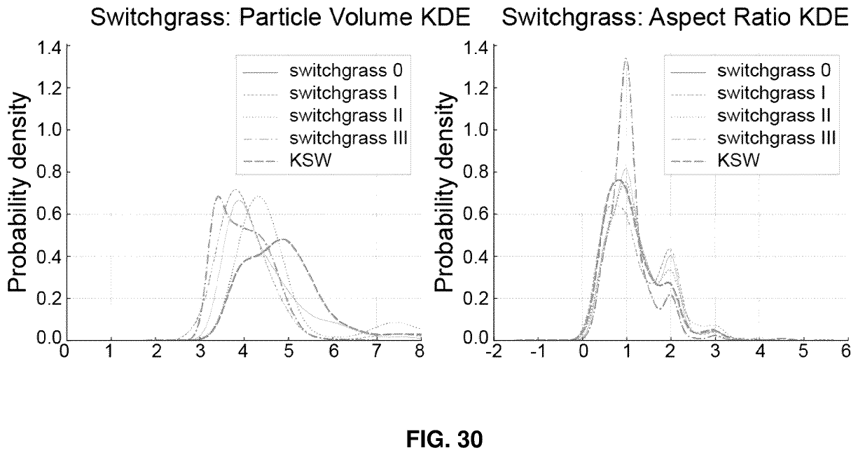

The results of the characterization of the agricultural residue fillers are illustrated in the supplementary figure FIGS. 30-35.

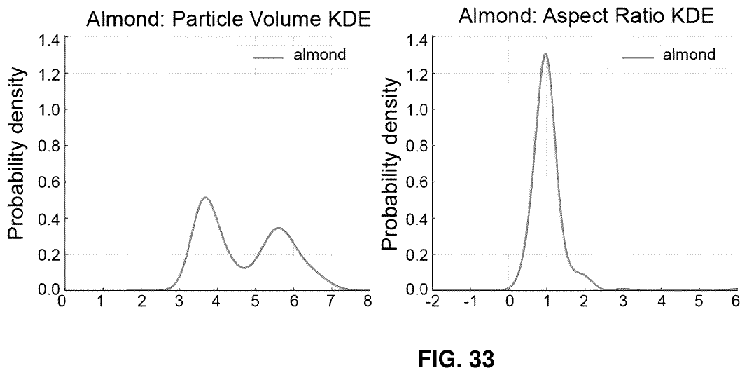

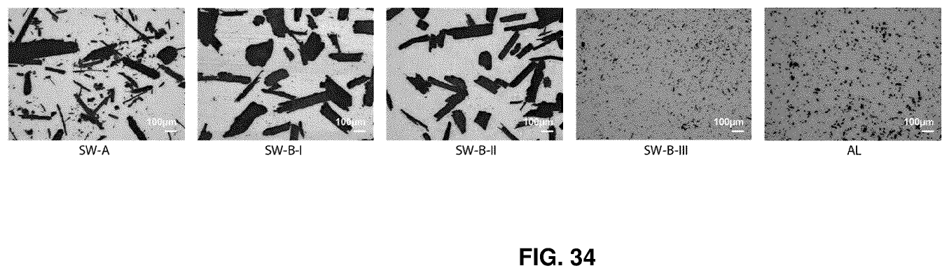

As will be understood by a skilled person, the data presented in FIGS. 30-35 demonstrates that different agricultural residues have measurably distinct and variable particle morphologies, which can be leveraged to control the final properties of a reinforced biocomposite. The Kernel Density Estimate (KDE) plots in FIGS. 30-33 reveal marked variability in both particle volume and aspect ratio, not only between different types of biomass but also between different batches or suppliers of the same biomass. For example, as shown in FIG. 30, different batches of switchgrass produce distinct particle size distributions and multimodal aspect ratio peaks. In contrast, the almond shell filler shown in FIG. 33 exhibits a narrow and unimodal aspect ratio distribution centered near an equant value (~2) but with a distinctive bimodal particle volume profile, reflecting its mixture of large flakes and fine particulates. The optical micrographs in FIG. 34 provide direct visual confirmation of these morphological differences, showing that switchgrass particles are visibly elongated and fibrous, while almond particulates are compact, isotropic, and granular.

This result supports the conclusion that agricultural residues can be classified and selected based on their quantifiable particle morphology. A person of ordinary skill in the art can use this data to practice the invention by selecting a filler with a specific particle aspect ratio distribution to achieve a targeted reinforcing effect. For example, to create a tougher, reinforced biocomposite where the filler contributes to mechanical interlocking, a skilled person would select a filler with a high average aspect ratio and a broad or right-skewed distribution, as exemplified by the switchgrass particles. Conversely, if the goal is to use a filler primarily for bulking or to enhance dense packing, a skilled person could select a filler with a low average aspect ratio and a narrow, unimodal distribution, as exemplified by the almond shell particles.

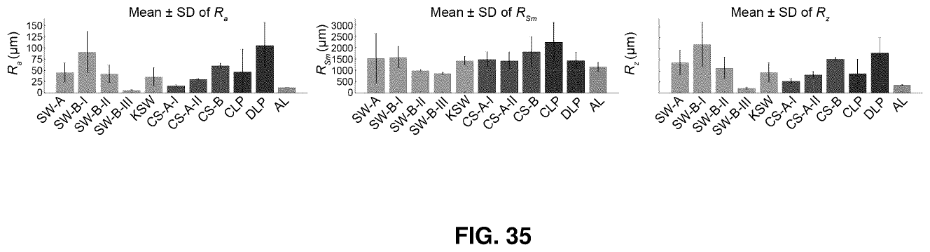

Furthermore, the surface profilometry data in FIG. 35 provides an additional set of measurable parameters for filler selection. The data shows that the fibrous switchgrass batches exhibit relatively high surface roughness parameters (Ra, RSm, Rz), which is consistent with their irregular geometry and is conducive to enhanced mechanical interlocking with a matrix. In contrast, the granular almond particulates exhibit the lowest roughness values, reflecting their smoother surfaces and lower structural anisotropy. Therefore, these quantitative measurements demonstrate that the inherent morphology of the filler feedstock strongly influences its physical characteristics, which in turn affect its potential for interfacial adhesion and load transfer in a composite. This provides a clear, rational basis for selecting a specific agricultural residue to engineer a reinforced biocomposite with desired properties.

### Example 13: Variability in Agricultural Residue Morphology and Its Role in Composite Reinforcement

With Hilmar identified as the most effective algal matrix, agricultural residues were next investigated as reinforcing fillers through particle characterization and mechanical testing. The as-received residues were first characterized morphologically to establish their baseline role within algae composites.

Kernel density estimates (KDEs), a non-parametric method for visualizing the distribution of a variable, of particle volume and aspect ratio reported in FIG. 30 and discussed in Example 8. revealed marked variability both within and across biomass types.

This inherent heterogeneity is a well-known characteristic of agricultural feedstocks, with properties often varying by source, harvest time, and processing history. Switchgrass exhibited the widest variability, with one supplier providing material in different particle size fractions and an additional sample from a second provider (KSW) included for comparison.

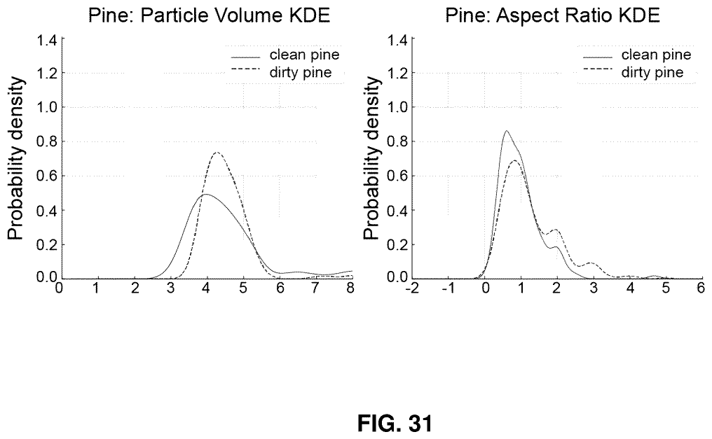

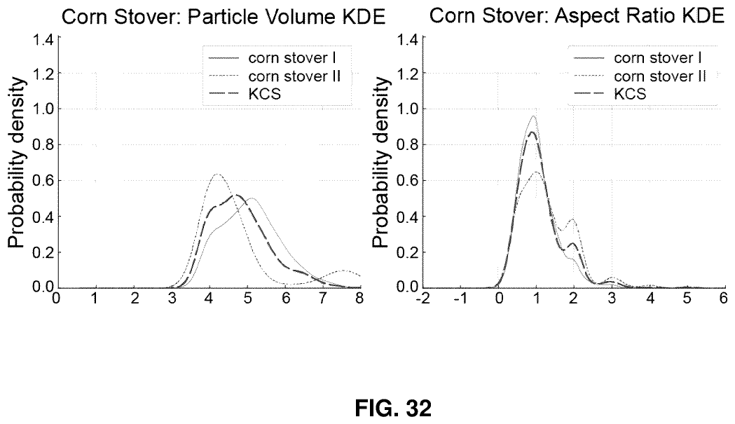

Together, these sources produced distinct particle size distributions and multimodal aspect ratio peaks (FIG. 30). Pine exhibited more consistent overall behavior, though the ‘clean’ and ‘dirty’ fractions from the same source differed in both particle volume and elongation (FIG. 31). Corn stover also showed batch and supplier effects, with KCS material containing smaller and more uniform particles relative to the broader distributions observed in other batches (FIG. 32). In contrast, almond shell displayed a narrow and unimodal aspect ratio distribution centered near equant values (~2), but with a distinctive bimodal particle volume profile reflecting its mixture of large flakes and fine particulates (FIG. 33).

Optical microscopy confirmed these morphological differences (FIG. 34). Switchgrass particles appeared elongated and fibrous, with variable cross-sections and occasional splintered fragments, whereas almond particulates were compact, isotropic, and granular. These contrasts highlight fundamental differences in how herbaceous fibers and rigid shells are likely to interact with an algal matrix during consolidation, as the literature indicates that particle shape affects powder packing and compaction behavior.

Surface profilometry further distinguished filler morphologies (FIG. 35). Switchgrass batches exhibited relatively high roughness parameters (Rₐ, R_{Sm}, R_{z}), consistent with their irregular geometry and fibrous nature. Corn stover showed intermediate values, while pine fractions displayed higher R_{z} due to their larger fragment surfaces. Almond particulates, by contrast, had the lowest roughness values, reflecting smoother surfaces and less structural anisotropy. These quantitative measurements demonstrate that feedstock origin and inherent morphology strongly influence filler characteristics, which in turn affect interfacial adhesion and load transfer in the resulting composites. These differences were most evident in composites reinforced with almond and switchgrass, where the smoother almond particulates provided only limited stiffening, while the rougher, fibrous switchgrass particles enabled greater reinforcement efficiency, partly due to enhanced mechanical interlocking, as explored in FIGS. 30-35.

### Example 14: Interface Morphology and Surface Roughness Correlate with Mechanics

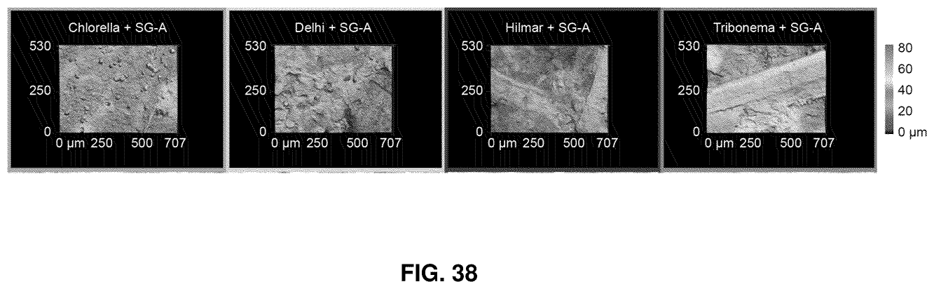

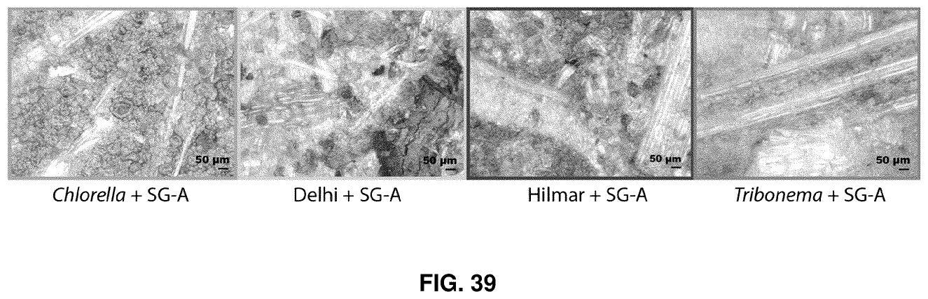

Surface and microstructural analyses clarified these differences. Profilometry (FIG. 38) indicated that Hilmar-switchgrass composites exhibited the smoothest, most continuous interfaces with the lowest apparent roughness, whereas Chlorella- and Delhi-derived composites showed numerous adherent fines (surface asperities from residual particulates) that produced a mottled texture and elevated peak-valley features. Tribonema-switchgrass specimens displayed out-of-plane fiber protrusions, yielding local height spikes and pronounced directional roughness. Optical microscopy (FIG. 39) corroborated these observations: Hilmar showed dense algae-fiber contact with minimal gaps; Chlorella and Delhi revealed granular debris and interfacial discontinuities, whereas Tribonema presented exposed filament ends. Together, these features explain the mechanical trends: Hilmar's continuous interface supported efficient load transfer and underpinned its sharp increase in strength, while Tribonema benefited from filament interlocking, providing moderate stiffness gains despite its rougher, protrusion-rich surfaces.

### Example 15: Anisotropy of Biocomposite and Filler Percentage Modulation

Hilmar-switchgrass composites were systematically varied to probe the influence of filler content, orientation, and surface treatment (FIGS. 40-44). Increasing switchgrass content enhanced both stiffness and strength up to the studied fractions, though excessive filler loadings in general can disrupt matrix continuity in natural fiber composites. Anisotropy became pronounced (FIGS. 40, 42-44): specimens that were compressed along the fabrication direction withstood greater stresses, while those tested orthogonally exhibited higher modulus but frequent delamination. Surface modification with a bio-epoxy coating markedly improved interfacial adhesion, suppressing fiber pull-out and elevating both Young's modulus and compressive strength (FIG. 26). These findings establish the Hilmar-switchgrass composites, particularly those incorporating coated fillers, as the optimal formulation for balancing reinforcement efficiency with process scalability.

Mechanical testing of Hilmar composites reinforced with 50% switchgrass or almond revealed clear orientation-dependent differences (FIG. 40). Specimens loaded parallel to the compaction direction exhibited significantly higher compressive strength compared to orthogonally tested samples, underscoring the role of laminar alignment in resisting fracture. Young's modulus followed the opposite trend, with orthogonally tested specimens showing greater stiffness but a propensity for interfacial delamination. Switchgrass provided superior reinforcement relative to almond, achieving higher strength and stiffness across both orientations, likely due to the fiber geometry differences discussed at length in FIG. 40.

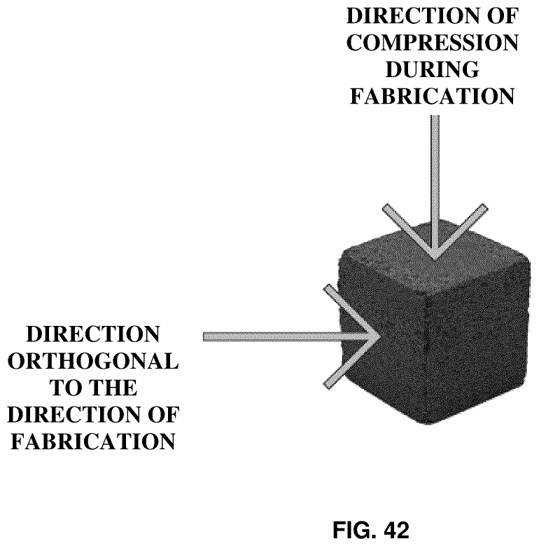

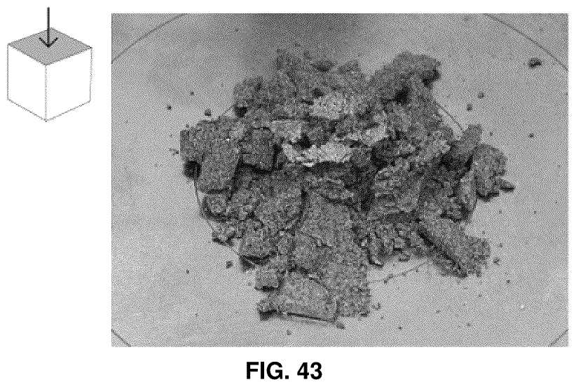

The influence of filler fraction was further examined by varying Hilmar-to-switchgrass ratios (FIG. 26). Pure Hilmar specimens reached a maximum force of 19.03±0.15 kN, corresponding to a compressive strength of ~90 MPa, and exhibited a Young's modulus of 283.0±2.0 MPa. Introducing switchgrass initially enhanced performance: at an algae: SG ratio of 70:30, the composites sustained a maximum force of 25.9±0.6 kN (~100 MPa strength) with a modulus of 564.4±26.2 MPa. At higher filler fractions, stiffness and strength progressively declined. For algae: SG=60:40, the maximum force was 26.6±0.9 kN with a modulus of 457±12 MPa; for 50:50, 25.1±0.6 kN and 454±10 MPa; for 40:60, 24.0±1.1 kN and 482±9 MPa; and for 30:70, 22.1±1.0 kN and 471±24 MPa. This reduction at elevated switchgrass loadings reflects diminished matrix continuity, which limits load-transfer efficiency despite the inherent stiffness of the fibers. The correlation between microstructural disruption and mechanical response was reinforced by failure mode observations. As shown in FIGS. 42 and 43, specimens compressed parallel to the fabrication direction primarily failed by bulk fragmentation, whereas those tested orthogonally exhibited higher stiffness but failed by layered delamination along compaction planes.

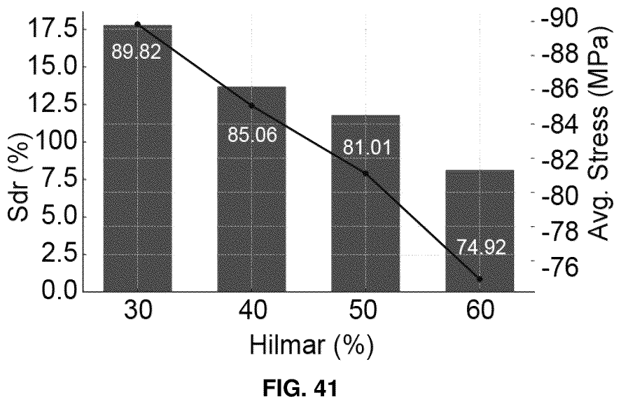

Surface roughness analysis provided a mechanistic link between filler content and composite strength (FIG. 41). The developed interfacial area ratio (Sar) decreased steadily from 89.82 to 74.92 with increasing Hilmar content, correlating with improved compressive strength. Conversely, composites with higher switchgrass fractions (60-70%) exhibited rougher interfacial textures and lower stress capacity. Together, these results highlight the competing effects of fiber reinforcement and matrix continuity, showing that mechanical performance can be tuned through careful control of filler orientation and loading fraction.

### Example 16 Systematic Framework for Fabricating and Evaluating Algae-Based Composites Reinforced with Agricultural Residues

The results described in the previous examples establish a systematic framework for fabricating and evaluating algae-based composites reinforced with agricultural residues. Initial screening of pure algae matrices identified Hilmar, a filamentous mixed-strain microalga sourced from the Hilmar wastewater treatment facility, as the optimal feedstock due to its strong compressive strength and Young's modulus combined with it's hydrophobicity. Hilmar was subsequently reinforced with lignocellulosic fillers of varying morphology, including fibrous (switchgrass), woody (pine), and particulate (almond shell) residues. Filler incorporation produced mixed outcomes: switchgrass consistently enhanced strength and stiffness, while almond fillers exhibited variable effects, improving or diminishing performance depending on interfacial compatibility. The strongest gains were achieved when bio-epoxy surface treatments were applied to the fillers to promote adhesion.

Mechanical testing revealed pronounced orientation effects, with specimens loaded parallel to the compaction axis sustaining higher stresses, whereas orthogonal loading increased stiffness but often led to interfacial delamination. Microscopy and profilometry confirmed that filler morphology and surface interactions govern these behaviors, linking fiber alignment and adhesion quality to bulk mechanical performance. Epoxy treatment mitigated fiber pull-out and improved load transfer at the interface, offering a scalable strategy to enhance structural performance in algae-based composites.

Together, these findings demonstrate that two abundant waste streams, both wastewater algae and agricultural residues, can be transformed into mechanically resilient composites using straightforward processing. Mechanical compaction offers a low-energy baseline route, while epoxy-assisted pressing delivers enhanced strength through enhanced interfacial adhesion. This scalable approach highlights a pathway toward sustainable materials for packaging, insulation, and lightweight structural panels, advancing waste valorization and supporting the circular bioeconomy.

### Example 17 Exemplary Procedure for Coating Particles and Fillers

This example describes a procedure for preparing epoxy-coated fillers to enhance the interfacial adhesion within a biocomposite. In this example, an epoxy coating solution was prepared based on a two-component system comprising an epoxy resin and a hardener, also known as a curing agent. The epoxy resin and hardener were combined in a 4:1 mass ratio and dissolved in methanol to form a homogenous solution with a final epoxy concentration of 8 weight percent. The components were mixed vigorously to ensure homogeneity. A person of ordinary skill in the art would understand that other epoxy resins, including bio-based resins such as Ecopoxy biopoxy 36 or synthetic resins such as poly(bisphenol A-co-epichlorohydrin) glycidyl end-capped, may be used. Similarly, other hardeners, such as dicyandiamide, amine, or anhydride, may be used. The mass ratio of resin to hardener may range from 0.1 to 10, and the final epoxy concentration in a suitable solvent, such as ethanol, isopropanol, or acetone, may range from 0.5 to 50 weight percent.

The prepared epoxy solution was then applied to agricultural or biomass fillers. The solution was distributed in a gradual and uniform manner to thoroughly coat the filler material, targeting a mass ratio of the epoxy system to the filler of 1:30. It will be understood that this ratio can be varied, for example, within a range of 0.01 to 1, to achieve a desired level of coating and interfacial modification.

Following the application of the solution, the coated fillers were subjected to a drying process to remove the solvent and any residual moisture. In this example, the treated fillers were first left at room temperature for approximately 15 minutes to allow for the initial evaporation of the solvent. Subsequently, the fillers were dried in an oven at 60° C. for approximately 48 hours. The drying temperature may be selected from a range of 20° C. to 150° C., and the drying duration may range from 0.1 to 100 hours, depending on the specific solvent and filler used. The resulting dried, epoxy-coated fillers were then ready to be blended with an engineered bio-powder for subsequent consolidation and curing of the biocomposite, which is typically performed using a thermo-mechanical route at elevated temperatures, for example between 85° C. and 185° C., to activate the epoxy.

### Example 18 Preparation of Epoxy-Coated Agricultural Fibers

This example describes an exemplary procedure for preparing epoxy-coated agricultural fibers for use as a filler in a biocomposite. To enhance the interfacial adhesion between the algae matrix and the fibers, an epoxy solution was prepared. The solution was based on a two-component system comprising an epoxy resin and a hardener. In this example, a solution was created by dissolving bisphenol A diglycidyl ether as the epoxy resin and dicyandiamide as the hardener in acetone. The resin and hardener were combined in a 2:1 mass ratio, and the total epoxy concentration in the acetone was 10 weight percent. The components were added to a vial and shaken vigorously to ensure the formation of a homogeneous solution prior to application.

The prepared epoxy solution was then used to coat the agricultural fibers by an impregnation method. The solution was distributed gradually and uniformly over the dry fiber material to ensure thorough and even coating, targeting a mass ratio of the total epoxy system to the fibers of approximately 1:20. It will be understood that this ratio can be varied, for instance, within a range of 0.01 to 1, to modify the level of interfacial adhesion.

After the coating was applied, the treated fibers were dried to remove the solvent. The coated fibers were first allowed to rest at room temperature for a brief period to allow for the bulk of the acetone to evaporate. Subsequently, the fibers were placed in an oven and dried at 80° C. for 24 hours. A person of ordinary skill in the art would understand that the drying conditions can be modified, with temperatures ranging from 20° C. to 150° C. and durations ranging from 0.1 to 100 hours, to suit the specific components used. The resulting dry, epoxy-coated fibers were then ready for blending with the engineered bio-powder and subsequent fabrication of the biocomposite material.

### Example 19 Fabrication of a Biocomposite Via the Aqueous Plasticization Route

This example describes a method for fabricating a dense biocomposite using a low-pressure, wet processing method, also referred to as the aqueous plasticization route. In this example, an engineered bio-powder derived from a dried feedstock biomass was first prepared. The dry powder was then rehydrated with a controlled amount of water to create a plasticized, moldable paste. The amount of water was selected based on the properties of the powder; for example, a powder derived from Chlorella was rehydrated with approximately 20 percent water by weight, while a powder derived from a filamentous feedstock such as Tribonema was rehydrated with approximately 40 percent water by weight.

The resulting moldable paste was then placed into a porous mold, which is configured to allow water to escape during the subsequent compression step. A low pressure was then applied to the paste within the mold. The pressure was applied in a gradual ramp, for example, by stepping up the pressure to approximately 80 PSI, or 0.55 MPa, over a period of several hours. This gradual application of pressure facilitated the consolidation of the particles into a dense packing and the egress of water from the paste through the porous mold.

After the initial water was expressed from the paste during compression, the damp, consolidated part was carefully removed from the mold. The consolidated part was then subjected to a final drying step to remove the remaining water and allow for the formation of hydrogen bonds between the adjacent particle surfaces. For example, the part was dried for an extended period, such as 15 days, in a desiccator. In this method, the water acts as a temporary plasticizer, allowing the particles to slide and rearrange into a dense packing under lower pressure, and the final density of the monolithic biocomposite is achieved through a combination of this initial compression and the shrinkage that occurs during the final drying step.

### Example 20 Fabrication of a Biocomposite Via the Thermo-Mechanical Route

This example describes a method for fabricating a dense, high-performance biocomposite using a high-pressure, dry processing method, also referred to as the thermo-mechanical route. In this example, a dry engineered bio-powder, having been prepared according to a previous embodiment, was used as the starting material. In some variations, this powder was used by itself, while in other variations, it was blended with dry fillers, such as agricultural residues, to form a uniform blended powder prior to consolidation.

The prepared dry powder was placed into a solid mold for consolidation. A high pressure was then applied to the powder within the mold, for example, a controlled loading of 8 tonnes, which corresponds to a pressure of approximately 227 MPa. This high-pressure compression was performed under different thermal conditions depending on the composition of the powder. For binder-free compositions, the compression was carried out at ambient temperature. For compositions including a heat-activated additive, such as a bio-epoxy binder, the compression was carried out at an elevated temperature, for example, approximately 175° C., to facilitate the curing of the additive.

In this method, the applied high pressure is the primary force that physically compacts the particles, collapses the interstitial voids between them, and causes the particles to fuse or bond together at their contact points. This process results in the formation of a dense, monolithic final part with high structural integrity. This method is a primary route for achieving the highest densities in the biocomposite, for example, densities of approximately 1.457 g/cm³.

### Example 21: Exemplary Biopolymers Result Effective Variables in Producing Biocomposite of the Disclosure

Translating the inherent potential of biomaterial composites into materials with reliable, high-performance characteristics presents significant scientific and engineering challenges.

A major challenge lies in achieving the required performance characteristics, particularly mechanical properties, thermal stability, and barrier functions. Incorporating raw or minimally processed biomass into polymer matrices can lead to a reduction in mechanical strength (tensile, flexural, impact) compared to the neat polymer, limiting load-bearing applications.

This is often due to poor interfacial adhesion between the filler and matrix and potential stress concentration points introduced by the biomass particles. The biochemical diversity of biomaterials provides a rich resource for biomaterial composite development. For example, distinct primary structural and storage compounds relevant to bioplastics and biocomposites can be produced by biosynthesis in a particular species or genus.

Relevant biopolymers which can be include (with examples given for algae-based sources) polysaccharides proteins and lipids.

Polysaccharides include starch and cellulose, commonly found for example in microalgae. Starch, composed of amylose and amylopectin, can be processed into thermoplastic starch or used as a filler, though often requires modification due to moisture sensitivity and lower mechanical strength. Cellulose, a structural component of cell walls, offers biodegradability and can reinforce composites. Macroalgae (seaweeds) are particularly known for their unique hydrocolloids.

Exemplary polysaccharides comprise alginate: Extracted from brown seaweeds (Phaeophyceae), this linear polysaccharide forms gels in the presence of divalent cations and is valued for its biocompatibility in biomedical applications like wound dressings and drug delivery. Exemplary polysaccharides further comprise carrageenan: Sulfated polysaccharides derived from red seaweeds (Rhodophyta), existing in different forms (kappa, iota, lambda) with varying gelling properties, used in food packaging and films. Exemplary polysaccharides also comprise Agar: Another gelling agent from red seaweeds. Exemplary polysaccharides additionally comprise Ulvan: Sulfated polysaccharide from green seaweeds (Chlorophyta).

Exemplary proteins comprise proteins of the algal cells which can be comprised in the biomass in relatively high amounts. In certain microalgae, for example, notably Spirulina, can contain very high protein levels (50-70% dry weight). Algal proteins can be processed into bioplastics, often through blending with other polymers or plasticizers, although their use competes with high-value applications in food and feed.

Exemplary Lipids and Polyhydroxyalkanoates (PHAs) comprise lipids part of the cell wall of biomass. For example in algal cells, while algal lipids are primarily targeted for biofuels, some microalgae and cyanobacteria can synthesize PHAs intracellularly. PHAs are biodegradable polyesters exhibiting thermoplastic or elastomeric properties, making them attractive bioplastic candidates. PHA production can potentially be coupled with CO₂ capture and wastewater treatment.

### Example 22: Processing of Algae into Binder-Free Biomaterials

Algae harvested from wastewater were processed into binder-free biomaterials using various grinding methods coupled with compression molding. Algae particle morphology determined densification and mechanical response, with filamentous Tribonema retaining superior performance compared to spherical Chlorella. The results establish structure-property relationships for whole-cell algae and highlight their use as sustainable feedstocks for polymer composites.

Algal Biomass Sources: The filamentous algae used in this study were cultivated outdoors in 3.4-m2, paddlewheel-mixed tanks fed nitrified, filtered reclaimed wastewater produced by the City of San Luis Obispo (California) Water Resource Recovery Facility. These raceway tanks were operated in ongoing efforts to develop economically viable algae biofuels and bioproducts in conjunction with removal of polluting nutrients from wastewater. The filamentous strain selected for this research was Tribonema minus, and it was shown to be more productive than a volunteer polyculture of algae. The Chlorella food grade algae powder was sourced from the commercial brand ‘Food to Live’, was freeze dried, and was purchased via Amazon.

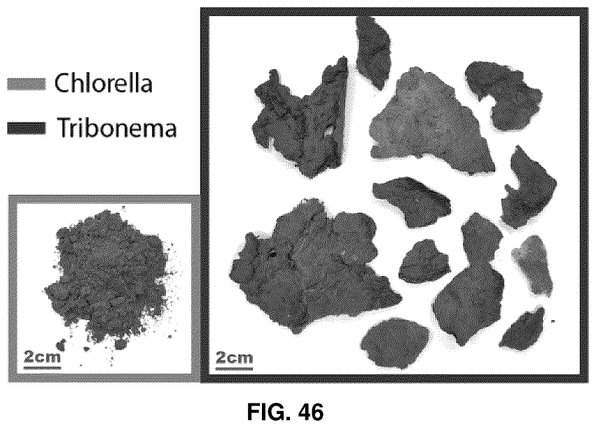

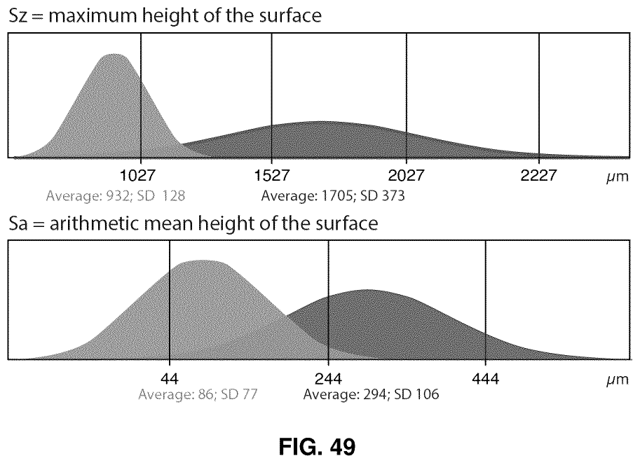

Preprocessing Techniques: Extraction and drying processes can result in agglomeration of the dry wastewater algae. Therefore, three dry pre-processing techniques, speed-mixer, ball-milling, and mortar-and-pestle, were applied to reduce particle size and alter biomass morphology prior to rehydration and compression molding. For the speed mixing, biomass was pulverized using a Flacktek 330 speed mixer at 1500 RPM with a 2:1 ratio of algae to yttrium beads (10 g algae to 5 g beads). The biomass was processed for 30 seconds, repeated three times with 10-minute intervals between cycles. These rest periods were included to minimize the buildup of condensation on the inner walls of the container, which likely resulted from frictional heating and the release of residual moisture from the biomass. Intermittent mixing helped reduce clumping and promoted more uniform particle size distributions. See FIGS. 46-51 and FIG. 46.

For the ball-milling, algae were processed in four cycles of 5 minutes each, with 20-minute intervals between cycles to minimize heating and clumping. The repeated cycles allowed progressive reduction of particle size while reducing thermal buildup that could affect powder uniformity. For the mortar-and-pestle, dry algae were manually ground using a granite mortar-and-pestle. The grinding duration varied by strain due to differences in physical structure. Approximately 15 to 75 minutes of manual grinding were required per 15 grams of algae to achieve the minimum required powder fineness. No rest periods were included during this manual grinding process as the open design of the mortar allowed for constant air circulation. This open design prevented heat and condensation buildup, as opposed to the closed container systems used in the other two preprocessing methods. Following grinding, the entire set of algae powders from all three preprocessing methods were passed through a 40-mesh sieve (424 μm) to ensure no excessively large particles were in the batch before rehydration and molding.

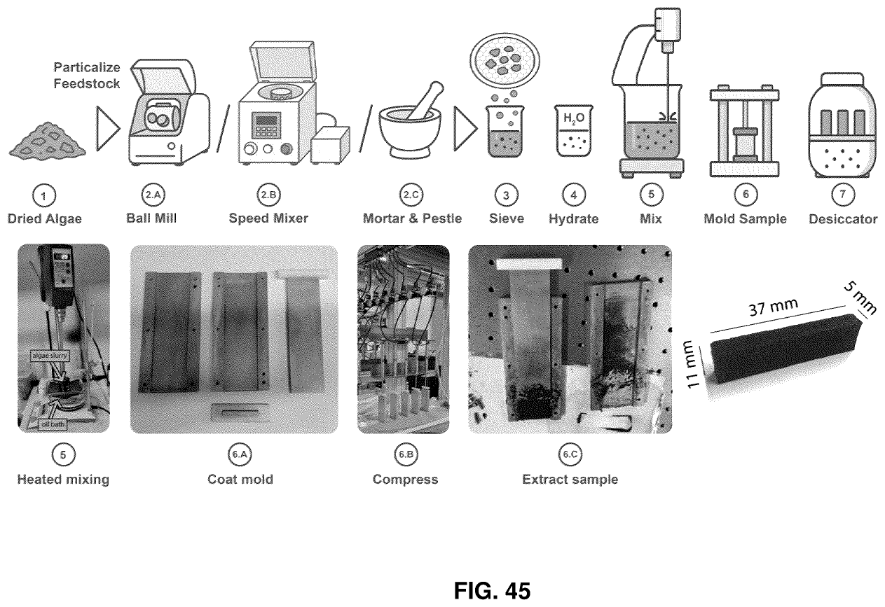

Biomaterial Fabrication: The fabrication of the binder-free biomaterials followed a systematic, multi-stage workflow, as illustrated in FIG. 45.

(1) Algal Biomass Acquisition: The process began with algae biomass that was first cultivated and harvested from raceway tanks and then sun-dried (Tribonema) or freeze dried (Chlorella) to obtain the raw, dry algae feedstock. (2) Dry-Powder Comminution: The dry biomass then underwent comminution to reduce its particle size. This step was performed using one of three distinct methods: (2.A) planetary ball-milling, (2.B) high-shear speed-mixing, or (2.C) manual grinding with a granite mortar-and-pestle, each aimed at producing a fine, consistent powder. (3) Sieving: Following comminution, all powders were passed through a 40-mesh sieve to exclude any oversized granules and ensure a uniform particle-size distribution for subsequent steps. (4) Rehydration: The sieved powders were then rehydrated with deionized water to form a homogeneous slurry. The water content was optimized by strain to ensure proper cohesion. An initial 40% water-by-weight ratio proved excessive for Chlorella, leading to slurry over fluidization and leakage of algae material through the mold seams. Therefore, Chlorella's water content was adjusted to 20% by weight. For Tribonema, the 40% water ratio was maintained as it yielded cohesive biomaterials. (5) Overhead Mixing: To ensure uniform dispersion of the water, the slurries were subjected to heated overhead mixing, stirred at 25 rpm for 15 minutes within a temperature-controlled 70° C. silicon oil bath. This rehydration process results in cell-wall biopolymers becoming plastic and tacky. This short “activation” step replaces any external binder. (6) Compression Molding: Once prepared, the slurry was cast into porous aluminum molds (6.A), which were designed to allow for water egress during compression. A uniaxial pneumatic pressure valve applied a stepwise pressure ramp (6.B), starting at 10 psi and increasing hourly to 20 psi, then 40 psi, then 60 psi and finally 80 psi. After this 4-hour ramp, the samples were held at 80 psi for an additional 20 hours before being carefully demolded (6.C). This gradual method leveraged water-mediated cohesion while preventing the trapping of residual moisture; as the slurry is transferred into porous aluminum molds, capillary bridges form between neighboring particles and, under a gentle step-wise pressure ramp, coalesce into a continuous hydrogen-bonded network. Water is simultaneously wicked away through the mold walls, locking the network in place without generating steam pockets or large shrinkage stresses. (7) Desiccation: To remove any remaining moisture and prevent cracking, the demolded specimens were placed in a desiccator and dried under vacuum for 15 days to achieve their final, stable form.

### Example 23: Processing of Algae into Binder-Free Biomaterials

The properties of the binder-free algae biomaterial composites and related particles following the processing methods of Example 22 have been detected with the following methods.

Microscopy: The morphology of the algae powder and algae bulk biomaterials were evaluated using optical microscopy (Keyence VK-X3000 optical microscope and Zeiss LSM 880 in two-photon mode), and Zeiss Merlin VP scanning electron microscopy (SEM) at a voltage of 1 kV. For algae bulk biomaterial, the sample was fractured in liquid nitrogen, and the fracture surfaces were imaged. Two-photon z-stacks were acquired on the Zeiss LSM 880 using an excitation wavelength of 810 nm and a non-descanned detector (NDD). Transmitted light channels were also collected where possible, although penetration was limited. The raw images were imported into Huygens software, where deconvolution was applied with bleaching correction and varying signal-to-noise ratios (20-40) to optimize image clarity. Processed datasets were exported as 16-bit TIFF files. The particle size of the algae was analyzed with the built-in Keyence software, which was also used to examine algae powder morphology and the surface structure of the fabricated bulk biomaterials.

Photographic Imaging: Bulk samples and unprocessed Chlorella and Tribonema powders were photographed by spreading the powders thinly on clean paper and imaging them under uniform diffuse lighting at a 2 cm scale. Images were acquired with a Nikon D750 digital camera mounted on a fixed tripod and subsequently edited in photoshop to remove background and shadows. Microscopy of whole cell Tribonema used wet mounts on a bright-field microscope (CX41 upright microscope, Olympus Lifescience, Shinjuku, Tokyo) and were recorded with a microscope mounted camera (INFINITY2-1R, Teledyne Lumenera, Ottawa, Ontario) and image capture software (Infinity Analyze and Capture, Teledyne Lumenera, Ottawa, Ontario).

Particle Volume Analysis: Three independent batches of each algae for each strain, as processed via ball-milling, mortar-and-pestle, or high-shear speed mixing, were imaged with the Keyence VK-X3000 optical microscope (20× objective). For each treatment, ≥5 particles were segmented in thresholded grayscale micrographs using the built in Keyence area selection features software, and their three-dimensional volumes were measured and visualized in topography maps. The range of the color mapping (0-75) was manually adjusted to ensure standardized colorization between different samples to allow for visual inspection and comparison of the different samples.

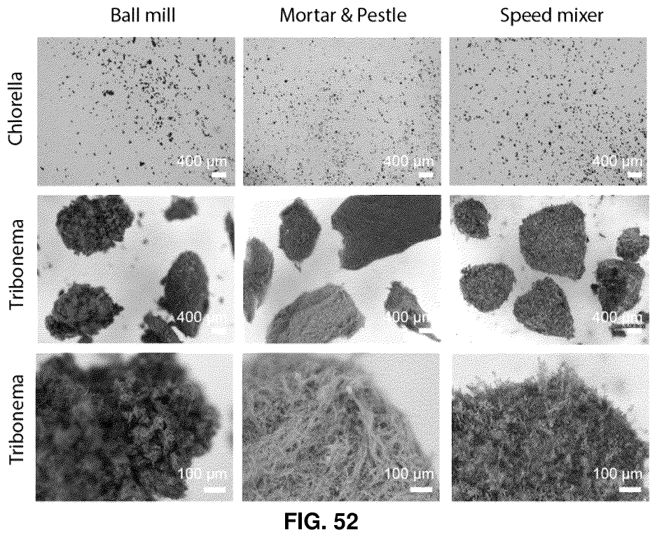

Surface Profile Roughness Analysis: In addition to aerial topography, surface profile roughness of the dried biomaterial samples was analyzed using a VK-X3000 3D surface profiler. Multiple line profiles were extracted from the topography data for each sample condition (3 horizontal and 3 vertical). From these profiles, standard roughness parameters were calculated, generally conforming to ISO 21920-2:2021. As shown in FIGS. 52-55 the profile parameters reported include the arithmetic mean height of the profile (Rₐ), the maximum height of the profile curve (R_{z}), which is calculated as the sum of the maximum profile peak height (Rp), the maximum profile valley depth (Rv) within the sampling length, and the mean width of the profile elements (R_{Sm}), by analyzing the profile elements of a surface, which are the peaks and valleys within the roughness profile]. The built-in analysis feature determines the length (width) of each element and then calculates the arithmetic mean of these widths along the sampling length. Optical profilometry was used to measure the ISO-standard maximum profile height (Sz), which captures the vertical distance between the highest peak and lowest valley in a sampled area.

Differential Scanning calorimetry (DSC): Approximately 5 mg of dried algae powder was hermetically sealed in aluminum pans and scanned from −40° C. to 200° C. at 10° C. min-1 under nitrogen (50 mL min-1) using a DSC250 (TA Instruments).

Thermogravimetric Analysis (TGA): TGA was performed on 10 mg algae powders heated from 25° C. to 250° C. at 10° C. min-1 in nitrogen (60 mL min⁻¹) on a TA5500 (TA Instruments, USA). Mass loss curves were normalized to initial sample mass to yield percent weight retention vs. temperature.

Thermal Conductivity: Thermal conductivity was measured with the Trident thermal conductivity system (C-Thermal Technologies, Canada) at 25° C. with a Modified Transient Plane Source (MTPS) method followed by the ASTM D7984.

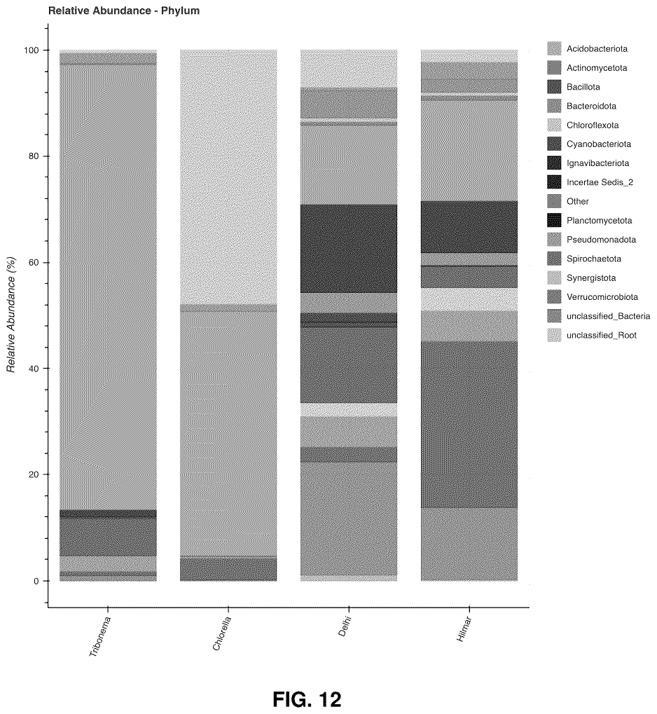

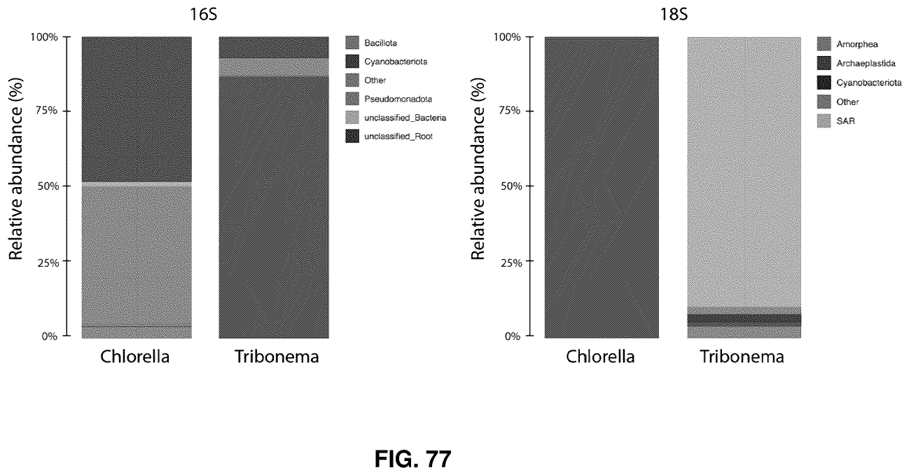

Genetic Characterization: 16S/18S rRNA Gene Sequencing and Microbial Community Profiling (FIG. 12 and FIG. 77). Genomic deoxyribonucleic acid (DNA) was extracted from rehydrated biomass samples of commercial Chlorella powder, and Tribonema filaments. Total DNA was isolated using the MoBio PowerSoil DNA Isolation Kit according to the manufacturer's protocol. The 16S (bacterial) and 18S (eukaryotic) rRNA gene regions were PCR-amplified and sequenced on an Illumina MiSeq platform. Raw reads were demultiplexed, and primer/adaptor sequences removed. The resulting FASTQ files were processed through the DADA2 pipeline to denoise and infer amplicon sequence variants. Taxonomic assignment was performed by alignment against the NCBI nucleotide database, yielding species-level profiles for each input biomass.

Surface Wettability: The wettability of the biomaterials was measured with a dataphysics OCA 50 goniometer using the sessile drop method at room temperature. The data was processed with Dipmax software. At least three measurements were taken from each sample type using 2 μm of deionized water.

Mechanical Testing: Flexural properties were measured by quasi-static three-point bending test with triangular prism rods on an Instron E3000 universal tester equipped with a 250 N load cell. Rectangular specimens (37×11×5 mm; length×width×thickness, respectively) were placed on supports with a 26 mm span, which corresponds to an approximate specimen span length to thickness ratio of 5.2. The samples were loaded at a constant crosshead speed corresponding to a nominal strain rate of 0.004±0.001 s⁻¹ under a rate control-strain ramp condition until failure. For each condition, at least four replicates were tested. To ensure dimensional stability, the overall thickness of each specimen was monitored using a caliper, with measurements taken every 48 hours until the dimensions plateaued. The flexural modulus (Ef in MPa), stiffness (Kf in N mm2), and strength (of in MPa) were determined from each resulting load-displacement curve by applying Eqs. (I)-(III):

$${E}_{f} = \frac{m}{4 w} {( \frac{l}{t} )}^{3} \qquad ( I )$$

$${E}_{f} = \frac{m}{4 w} {( \frac{l}{t} )}^{3} \qquad ( II )$$

$${E}_{f} = \frac{m}{4 w} {( \frac{l}{t} )}^{3} \qquad ( III )$$

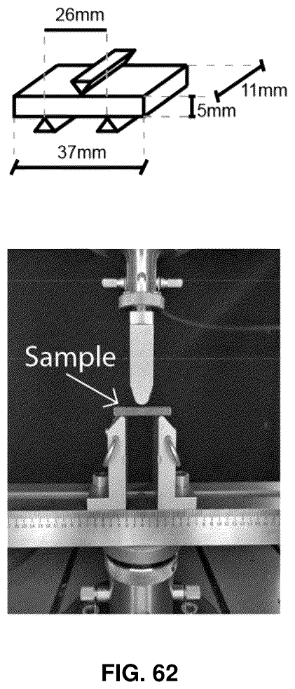

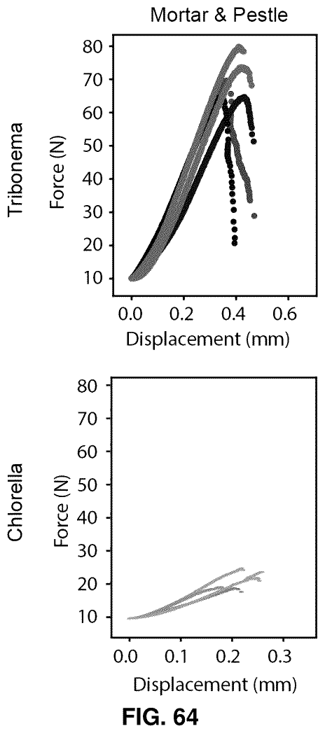

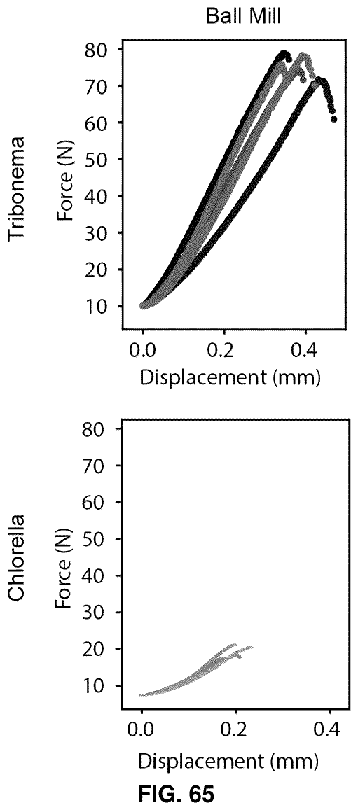

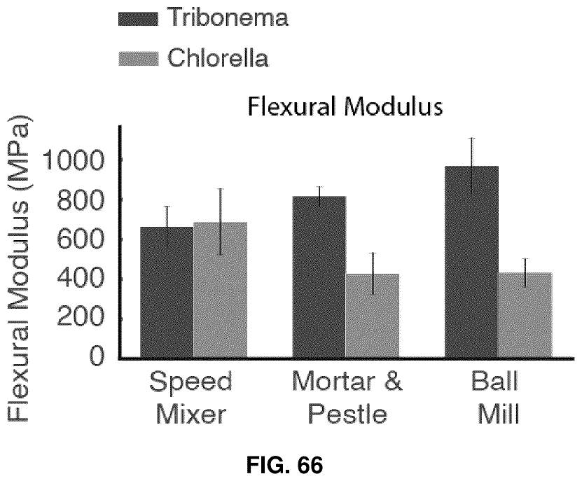

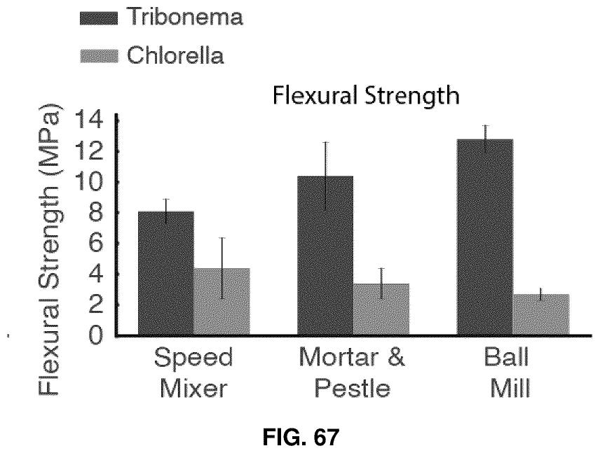

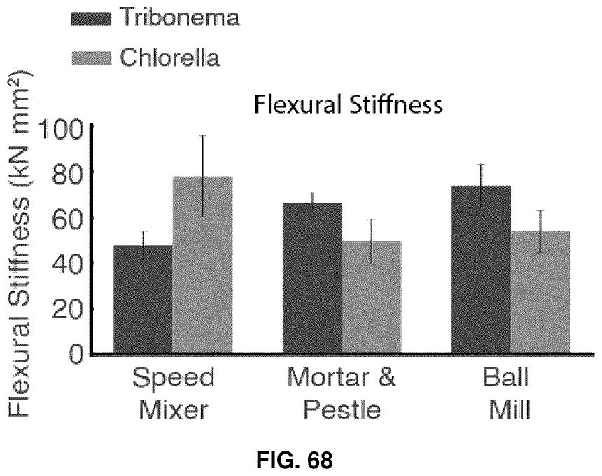

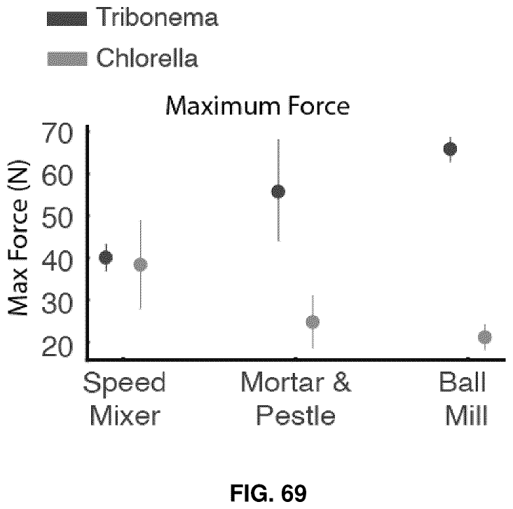

In these equations, m (N mm-1) signifies the slope of the linear elastic portion of the force-displacement curve, P (N) is the applied load, 1 (mm) represents the length of the span, w (mm) denotes the width of the specimen, and t (mm) indicates the height of the specimen (see FIGS. 62-69).

### Example 24: Feedstock Morphology and its Role in Processability for Binder-Free Algae Biocomposites

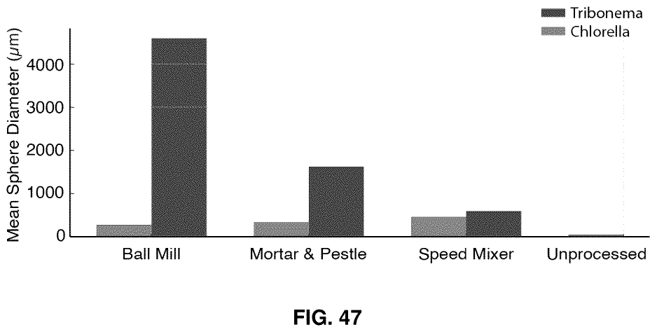

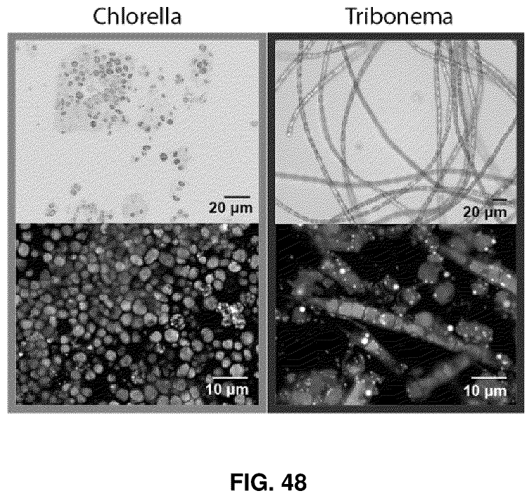

Wastewater-grown multicellular filamentous Tribonema was compared to food-grade unicellular Chlorella. Tribonema grows as long, unbranched filaments (0.5-3 mm length; 3-15 μm cross-section diameter) as shown in FIG. 48 (right), whereas Chlorella consists of individual 2-10 μm spheres, as shown in the optical images in FIG. 48 (left). Prior to fabricating the biocomposite, dry powders of Chlorella and wastewater-cultured Tribonema were comminuted by high-shear speed-mixing, planetary ball-milling, or granite mortar-and-pestle. These distinct comminution routes were chosen to test whether aggressive size reduction (ball mill), mild fracture (mortar-pestle), or shear-induced aggregation (speed-mix) would differentially affect spherical versus filamentous feedstocks. The Chlorella experienced an increased size of particle dimensions after treatments, likely due to agglomeration, whereas the sizes of Tribonema filaments reduced significantly (FIG. 47). When subjected to comminution, Tribonema filaments fractured into progressively smaller bundles depending on the method, with particle sizes ranging from approximately 600-4600 μm mean sphere diameter (FIG. 47). In contrast, the Chlorella particles largely retained their spheroidal morphology (with a precomminution mean sphere diameter of 57 μm) but tended to agglomerate, resulting in post-processing particle diameters between 283-466 μm (FIG. 47). This divergence shows that filamentous versus spherical architectures respond fundamentally differently to mechanical stress: filaments can lose aspect ratio, while spheres primarily cluster together.

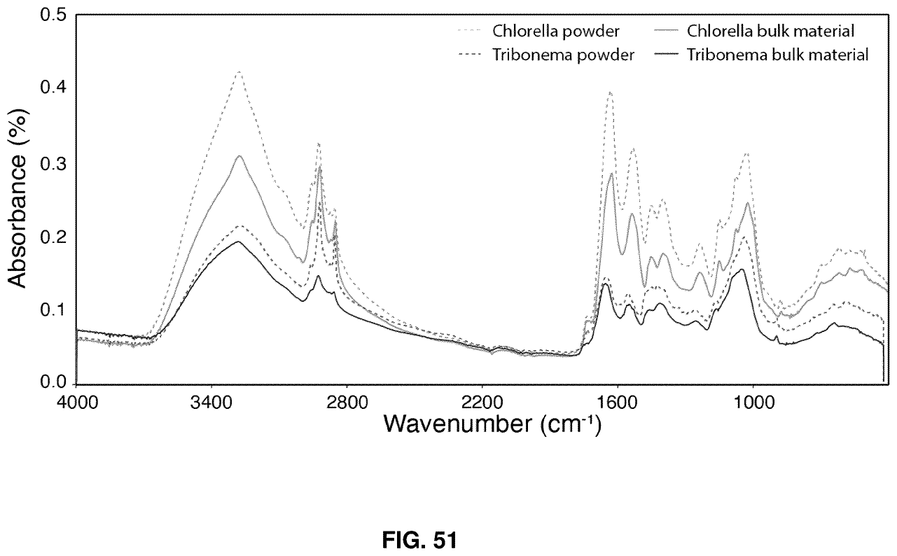

Fourier-transform infrared (FTIR) spectra of ball-milled powders and their corresponding biomaterials (FIG. 51) was analyzed, which highlighted distinct chemical and structural changes upon composite formation. All spectra showed the expected O—H/N—H stretching bands (3200-3500 cm-1) and C—H stretching bands (2800-3000 cm-1). However, the carbonyl (C═O) absorption near 1700 cm-1 shifted upon bulk material formation for Tribonema, consistent with new hydrogen bonding between cell-wall components. No comparable shift was detected for Chlorella, suggesting weaker interparticle bonding in its bulk materials.

To complement the physical and chemical characterization, the microbial communities associated with each algal strain were also examined by amplifying and sequencing 16S and 18S rRNA genes. At the phylum level, the Chlorella sample was dominated by Arcaeplastida, whereas the Tribonema sample contained a mixture of Arcaeplastida, Amorphea, and Cyanobacteriota, with SAR as the most abundant group.

Thermal transitions of the algal powders were examined to test whether inherent thermal stability differed between strains. Differential scanning calorimetry (DSC) revealed no sharp endothermic peaks, confirming the predominantly amorphous nature of both Tribonema and Chlorella. A broad endotherm spanning ~50-150° C. was attributed to moisture evaporation. Additionally, a subtle but consistent baseline shift near 30° C. was observed for both strains, consistent with a glass-transition-like relaxation of the water-plasticized cell-wall biopolymer network. This shift, which occurs below the primary water evaporation endotherm, is interpreted as the glass transition temperature range of the water-plasticized amorphous components of the algal cell walls. Algal cell walls are complex composites containing amorphous biopolymers such as hemicelluloses, pectins, and non-crystalline cellulose. In the presence of residual moisture, water acts as a potent plasticizer, lowering the glass transition temperature of these polymers into the observed range. This depressed glass transition temperature is significant for processing; it indicates that at room temperature and above (including the 70° C. heated mixing step), these cell wall components are in a rubbery and tacky state. This rubbery state facilitates the strong inter-particle bonding and network formation that occurs during the compression molding and consolidation of the biomaterials. The DSC results suggest that intrinsic thermal stability is broadly similar for the strains, implying that morphology and interparticle chemistry, rather than bulk thermal transitions, underlie the differences in composite performance.

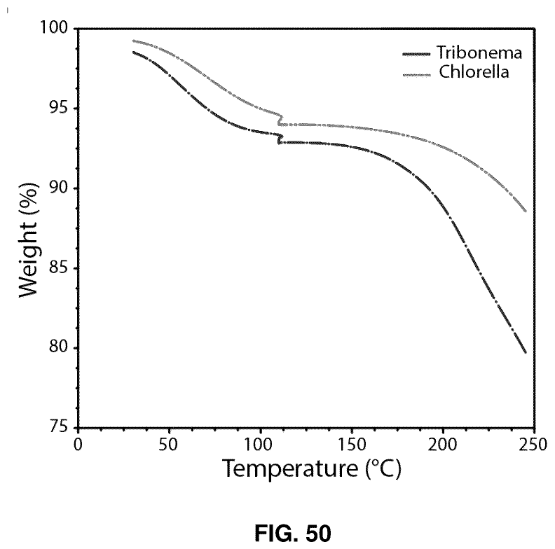

To further examine stability under heating, thermogravimetric analysis (TGA, FIG. 50) was performed to compare the water retention of the strains. Both Tribonema and Chlorella remained stable up to approximately 200° C., showing two distinct mass-loss events below this threshold. The first, between 30-120° C., corresponded to the release of loosely bound water and other volatiles. The second, centered near 150° C., reflected the loss of more strongly bound water. Consistent with DSC, this dehydration corresponded to ~4% mass loss for Chlorella and ~6% for Tribonema. The greater water retention in Tribonema could reflect differences in density or microstructural porosity. This finding reinforces that feedstock morphology not only dictates comminution behavior but also influences water interactions during thermal cycling.

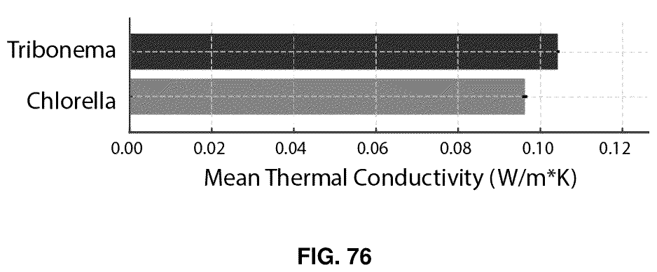

Tribonema showed slightly higher conductivity (0.094±0.003 W m⁻¹ K⁻¹) than Chlorella (0.085±0.002 W m⁻¹ K⁻¹). Although this difference is small, both values are low compared to conventional polymers, supporting the potential use of algae-based biomaterials in thermal insulation applications. These low thermal conductivities also complement the mechanical findings, suggesting that algal composites may uniquely combine structural reinforcement with insulation potential. See FIG. 76.

### Example 25: Processing-Structure Relationships: Comminution, Hydration, and Densification Resulting in Controlled Composite Properties

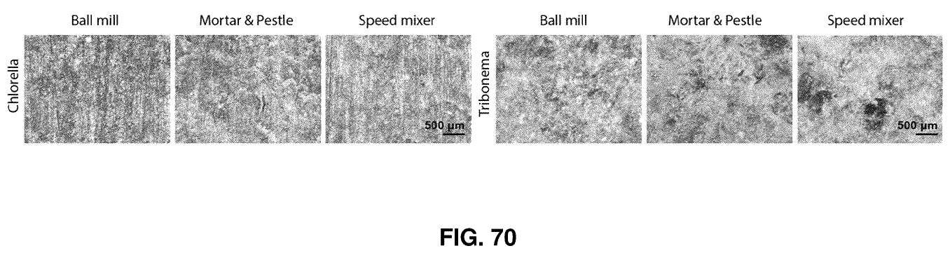

The pre-compaction structure of the algal feedstock proved to be a critical factor in how each strain responded to mechanical processing. Surface roughness of the pre- and post-comminution algae powders was measured with a profilometer. The resulting surface roughness distributions show a clear distinction between the two feedstocks (FIGS. 70-72). The filamentous alga, Tribonema, was highly susceptible to structural changes during comminution. Untreated Tribonema filaments exhibited a maximum profile height (Sz) of 1705±373 μm, which significantly decreased to 932±128 μm after processing with a speed-mixer, indicating pronounced axial fracture. In contrast, the small, spheroidal cells of Chlorella demonstrated remarkable resilience to the same mechanical forces. Chlorella maintained an Sz value of less than 20 μm regardless of the comminution method, confirming that its morphology underwent minimal alteration. These Sz results show that the initial particle architecture dictates how stress is accommodated: filaments fragment, whereas spheroidal particles largely preserve geometry.

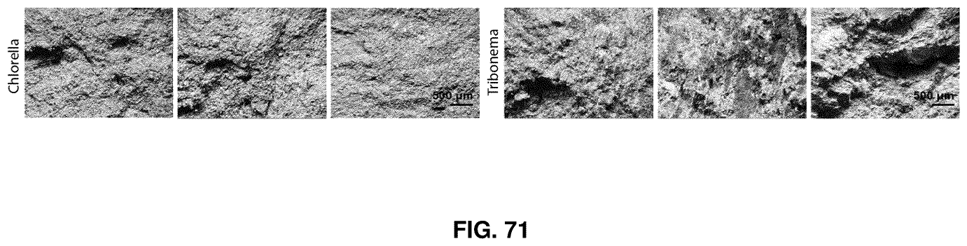

These morphological and processing contrasts are directly translated into the composite microstructures. High-magnification optical micrographs (400×) highlight the stark contrast between the two algal feedstocks (FIG. 70). Tribonema appears as long, intertwined filaments (FIG. 70, right), whereas Chlorella consists of discrete spheroidal cells (FIG. 70, left). Once cast and compressed, these morphologies translate directly into the biomaterial surface textures: the Tribonema bulk biomaterials display a rough, filament-bridged topology (FIG. 71 right), while the Chlorella bulk biomaterials are comparatively smooth and with minimal features (FIG. 71 left). In summary, comminution, hydration, and densification collectively governed the pre-compaction structure of the feedstocks.

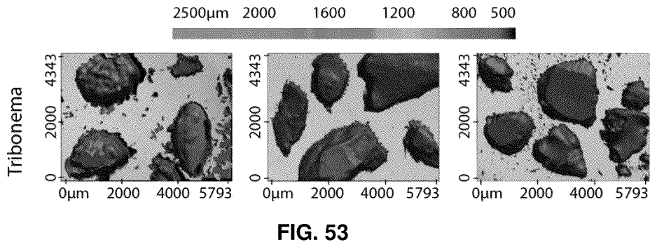

Powder morphology and surface topography (FIGS. 52 through 55) illustrate how the chosen comminution method shapes particle structure and, in turn, defines the surface architecture of the resulting bulk materials. The BF micrographs (FIG. 52) show that while Chlorella forms granular fragments (283-466 μm), Tribonema remains in larger, anisotropic agglomerates whose form depends on the method. Ball milling yields compact granules (≈4600 μm), mortar-and-pestle preserves felt-like bundles (≈1600 μm), and high-shear speed mixing produces a loosely entangled “wool” of fractured filaments (≈600 μm). The 3D maps of these particles (FIG. 53) reveal how mixing methods govern their shapes. Although the ball-milled flakes are the longest, their maximum feature height (≈2500 μm) is comparable to that of the shorter mortar-and-pestle bundles. In contrast, the speed-mixed particles are substantially flatter (<1500 μm), a trend that indicates a progressive loss of aspect ratio with increasing shear.

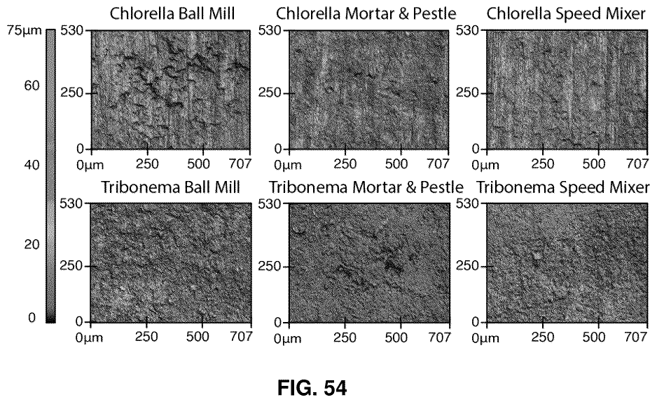

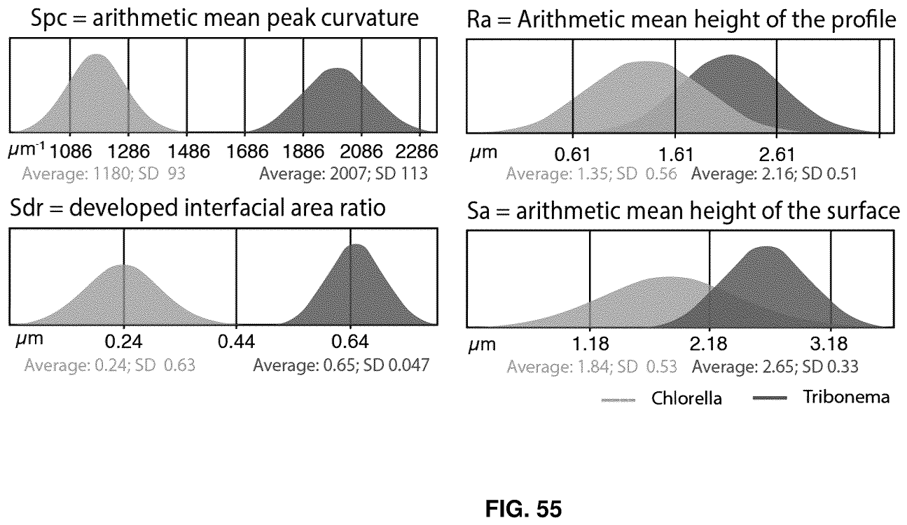

When these powders were compacted, their upstream morphologies translated directly into the surface topography of the molded samples (FIGS. 54 and 55). Chlorella produced uniformly smooth panels, with <40 μm relief across all preprocessing routes. Tribonema, by contrast, consistently displayed pronounced peak-valley structures: orange-peel roughness after ball milling, deep ridges from mortar-and-pestle, and flatter but still asperity-rich skins under high-shear mixing. Quantitative roughness parameters of the bulk biomaterials extracted from the profilometry data (FIG. 55) reinforce these qualitative trends. Tribonema exhibits a higher arithmetic mean peak curvature (Spc≈2007 μm⁻¹) than Chlorella (Spc≈1180 μm⁻¹) across the different preprocessing methods, reflecting sharper asperities. Areal roughness measures are likewise elevated: Tribonema surfaces show arithmetical mean height of a surface (Sa) Sa=2.65±0.33 μm and Ra=2.16±0.51 μm, whereas Chlorella averages Sa=1.84±0.53 μm and Ra=1.35±0.56 μm. The developed interfacial area ratio, Sdr, reaches 0.65±0.05 for Tribonema, nearly three-fold Chlorella's 0.24±0.63, indicating that the true contact area of the Tribonema surface is ~65% larger than its projected footprint.

These findings indicate that gentle comminution routes preserved the filamentous features of Tribonema, producing rough, high-surface-area topologies capable of mechanical interlocking, fiber pull-out, and crack bridging. In contrast, Chlorella's morphology was essentially insensitive to comminution intensity, yielding smooth, densely packed fracture skins. These surface features set the stage for the stress-strain behaviors discussed in the next subsection. Because morphology drives surface roughness, and roughness in turn sets up shrinkage and densification patterns, the next step is to examine how these features influence dimensional stability during drying. See FIGS. 52 through 55.

### Example 26: Surface Wettability and Composite Density

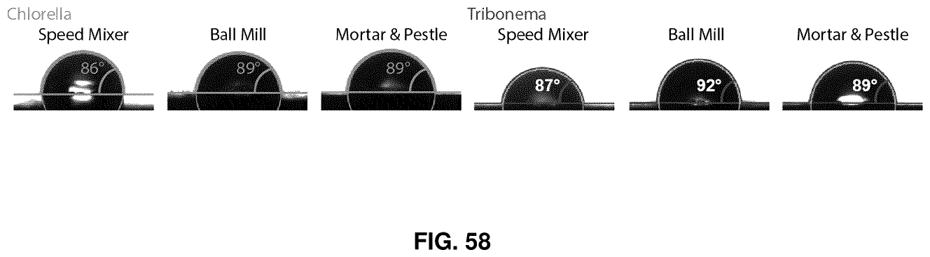

Surface wettability tests (FIG. 58) showed that all biomaterials had contact angles clustered between 85° and 92°, but subtle differences emerged with processing method. For Chlorella, speed-mixed panels gave the lowest angle (86±4°), while ball-milled and mortar-and-pestle ground samples converged near 89±3°. In Tribonema, speed mixing again yielded the lowest angle (87±4°), mortar-and-pestle reached 89±3°, and ball milling produced the highest value (92±4°). These results indicate that while both strains are moderately hydrophilic, filament fragmentation may modulate water affinity, which can influence interfacial adhesion and fluid uptake.

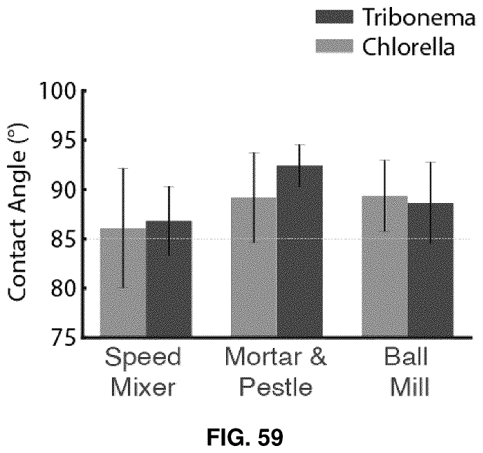

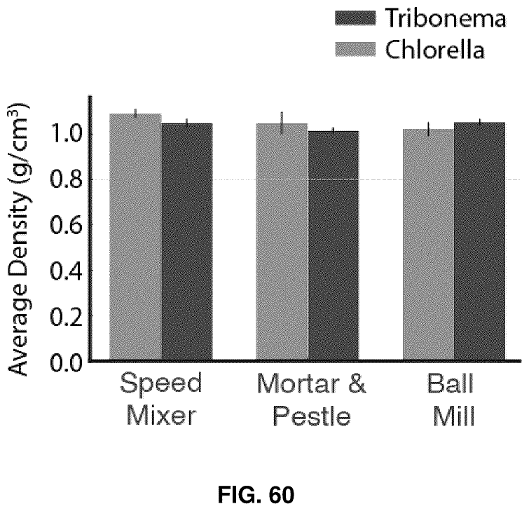

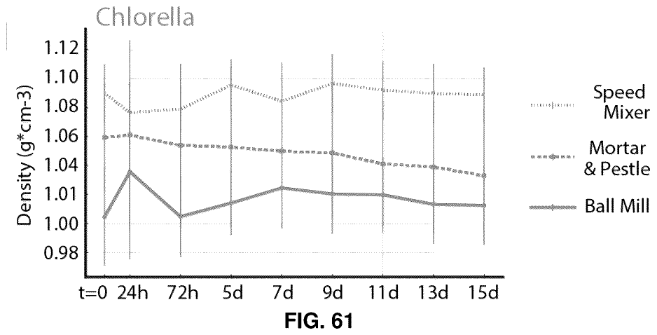

In addition to surface chemistry, bulk density plays a critical role in determining how stress will be transmitted through the material. Final, dried biomaterial density correlates more directly with particle size than with drying time. Larger fragments pack more efficiently in the mold, delivering higher bulk density, while finer particles leave more interstitial voids. For Chlorella, which forms roughly equiaxed microgranules, average sphere diameters increase in the order ball mill (283 μm±3991)<mortar-and-pestle (345 μm±5462)<speed mixer (466 μm±6987), and the corresponding biomaterial densities follow the same trend: 1.017 g/cm³±0.031 (ball mill)<1.049 g/cm³±0.049 (mortar-and-pestle)<1.088 g/cm³±0.019 (speed mixer). For Tribonema, the ball-mill and speed-mixer treatments produce remarkably similar packing densities despite an order-of-magnitude difference in fragment size. Ball milling yields fragments of 4601 μm (±14 596) and a density of 1.047 g/cm³ (±0.015), while speed mixing gives much smaller fragments of 595 μm (±4027), yet a nearly identical density of 1.045 g/cm³ (±0.019). This convergence suggests that once the long filaments are cleaved below a few millimeters in length, further size reduction delivers diminishing returns in packing efficiency. In contrast, the mortar-and-pestle method, which produces mid-sized fragments (1624 μm±2336), results in the lowest density (1.015 g/cm³±0.015). In other words, for filamentous Tribonema, once a critical fragment size threshold is reached, intrinsic filament geometry rather than fragment diameter is what governs how tightly the particles consolidate. Together, the wettability and density results establish that both surface interactions and bulk packing are strongly coupled to particle morphology and comminution route. See FIGS. 58 through 61.

### Example 27: Mechanical Performance of Binder-Free Algal Biocomposites

The mechanical results confirm how strongly microstructural morphology interacts with preprocessing method. Force-displacement curves (FIGS. 62 through 69) show that Tribonema-based biomaterials consistently withstand greater loads and exhibit larger displacements before failure compared to Chlorella-based biomaterials when preprocessed by either ball milling or mortar and pestle. For instance, ball-milled Tribonema samples reached peak forces of approximately ≈65 N at 0.33 mm displacement, while Chlorella biomaterials peaked at only ≈21 N at 0.15 mm. The larger displacement observed in the Tribonema samples suggests residual plasticity or energy dissipation mechanisms, possibly due to lipid content and partial preservation of filamentous microstructure, even under intense shear. This enhanced performance under gentle comminution is due to the preservation of Tribonema's high-aspect-ratio filaments. Ball milling (≈4600 μm) and mortar-and-pestle (≈1600 μm) processing maintained large particle fragments that enabled effective load transfer and crack bridging. By contrast, the aggressive, high-shear speed mixer pulverizes these reinforcing filaments, dramatically reducing their size to just ≈600 μm and destroying their structural advantage.

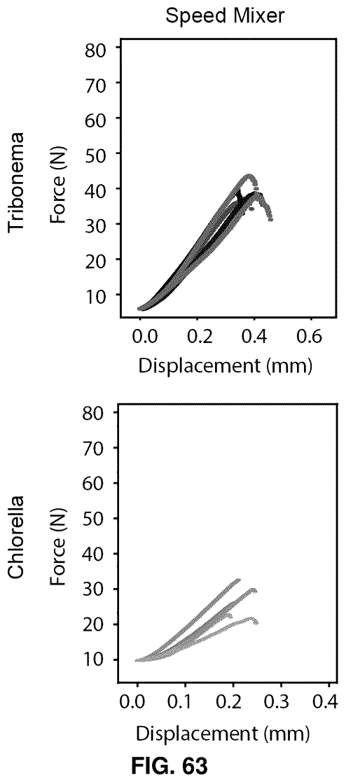

Conversely, Chlorella biomaterials show the opposite trend, with mechanical properties improving with processing intensity. This is because comminution causes the small, spherical cells to agglomerate into larger particles. As processing becomes more aggressive, the mean diameter of these granular agglomerates increases, growing from 283 μm (ball mill) to 466 μm (speed mixer). These larger and more uniform agglomerates lead to more efficient particle packing, which is directly reflected in the rise of the final biomaterial density from 1.017 g/cm³ (ball mill) to a peak of 1.088 g/cm³ (speed mixer). This denser, better-packed matrix minimizes voids and explains why the maximum force for Chlorella nearly doubles from ≈20 N with ball milling to ≈40 N with speed mixing (FIG. 63). This leads to a convergence of both particle size and mechanical properties under the speed mixer condition, as supported by the quantitative flexural data (FIGS. 63 through 68).

Notably, the convergence in performance is mirrored by a convergence in particle size. After processing, the speed-mixed Tribonema fragments (≈600 μm) and the speed-mixed Chlorella agglomerates (≈466 μm) are of a similar magnitude. As a result, the significant performance gap seen with gentler methods disappears, and both algae exhibit a similar flexural modulus (≈650 MPa) and fracture at comparable force levels (≈40 N). This reveals that the mechanical performance of Tribonema is governed by the integrity of its filamentous network, while Chlorella's performance is driven by its particle packing density. Intense processing degrades Tribonema's primary structural asset while simultaneously optimizing Chlorella's, causing their mechanical properties to converge. These results underscore how critical preprocessing is to the ultimate biomaterial performance and demonstrate that the morphology-mechanics relationship is sensitive not only to algal species, but also to how the biomass is physically treated before molding.

The divergent mechanical responses and shrinkage behaviors observed between the Tribonema and Chlorella-based biomaterials appear to stem from three interrelated factors: filamentous morphology, molecular level bonding, and possibly intracellular lipid content. In the case of Tribonema, long unbranched filaments promote entanglement, resulting in increased initial porosity and enhanced crack-bridging during deformation. These characteristics enable greater energy dissipation under flexural loading, particularly when the filament architecture is preserved through gentler comminution methods. In contrast, Chlorella's compact, spherical cells offer less opportunity for such interlocking, producing a more rigid and brittle material response. This mechanistic understanding provides the foundation for the next section, which examines how water exposure and dimensional stability further reflect the same morphology-processing interactions.

Beyond morphology, the biochemical composition modulates the mechanical response. A contributing factor to the adhesion in these binder-free materials is likely the formation of a strong hydrogen-bond network between the biopolymers of adjacent particles. In this context, the low lipid content (6% wt/wt) of this particular Tribonema strain is advantageous, as hydrophobic lipids would impede such bonding. For Tribonema, mechanical performance is a trade-off: aggressive comminution exposes more surfaces for bonding but destroys the critical morphology needed for fiber reinforcement. The results suggest the mechanical loss from eliminating the reinforcing structure outweighs the benefits of increased surface bonding. Conversely, Chlorella lacks a native reinforcing morphology, so its strength is dominated by inter-particle adhesion. Aggressively milling its tough, protein-rich cells creates a larger surface area for hydrogen bonding between exposed polysaccharides and proteins to occur during compaction, leading to a denser, more cohesive matrix. Surface morphology also plays a key role and reinforces this contrast.

Focus-variation profilometry reveals that Tribonema fragments retain high surface roughness even after processing (Sz>900 μm), promoting interparticle friction and fiber pull-out during flexural testing mechanisms that enhance toughness. In contrast, Chlorella's smoother surface profile reduces frictional interactions, limiting energy absorption. Sz, the maximum profile height, is defined as the vertical distance between the highest peak and lowest valley across a measured area (FIG. 55) and serves here as a quantitative metric of roughness amplitude that supports these microstructural interpretations.

Finally, the severity of comminution dictates the final biomaterial structure by controlling inter-particle bonding and moisture dynamics during consolidation. High-shear speed mixing fractures particles, which dramatically increases their surface area. This promotes extensive hydrogen bonding and van der Waals contacts that “weld” the fragments into a continuous, load-bearing network, explaining the marked strength gains in the densely packed Chlorella. However, this process introduces a trade-off. The fine powders shed water rapidly during molding, which can induce excessive pore collapse and generate micro-cracks that compromise dimensional stability. In contrast, gentler processing preserves a more open, porous network that limits such damage by trapping moisture longer, but at the expense of the enhanced mechanical integrity offered by dense packing. Therefore, optimal processing requires balancing the intensity needed to increase surface area for bonding against the need to maintain sufficient scaffold porosity to ensure dimensional stability and mechanical integrity.

After demolding and desiccation, surface morphology differed strongly between strains. Chlorella panels present a comparatively smooth, fine-grained skin. Ball-milled and speed-mixed specimens show faint, longitudinal striations produced by the porous-aluminum mold. Whereas the mortar-and-pestle samples display a slightly rougher matte finish with isolated micro-pocks. In contrast, Tribonema panels are far more textured: ball-milling yields an “orange-peel” morphology with shallow undulations, mortar-ground material retains visible filament bundles protruding from the resin-free matrix, and the speed-mixed surface exhibits flattened patches interspersed with small pits where shortened fibrils have been torn away. Mechanical testing reinforced these morphological contrasts.

Optical micrographs captured after three-point bending reveal that Chlorella fractures along planar, featureless planes regardless of comminution route, confirming its brittle response observed in FIGS. 62 through 69. Conversely, Tribonema cracks are intrinsically tortuous: ball-milled specimens show step-like delaminations where stacked filament sheets have separated; mortar-and-pestle panels exhibit large, fibrous asperities and visible pull-out voids; speed-mixed panels, though flatter, still possess micro-ridges formed by compressed, platelet-like debris. The increased crack roughness seen for the low-energy comminution routes coincides with the higher peak load and greater displacement at failure measured in bending, implying a larger amount of energy absorbed during fracture.

### Example 28: Surface Morphology and Fracture Analysis of Binder-Free Algal Biocomposites

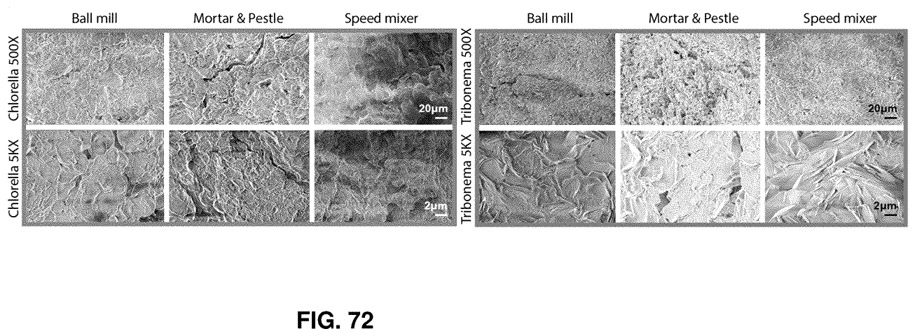

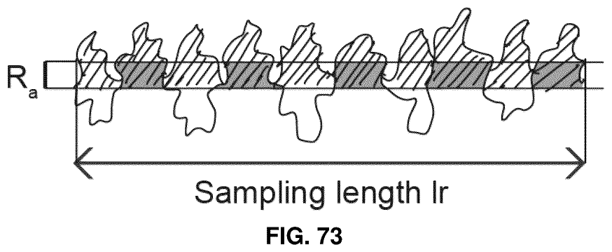

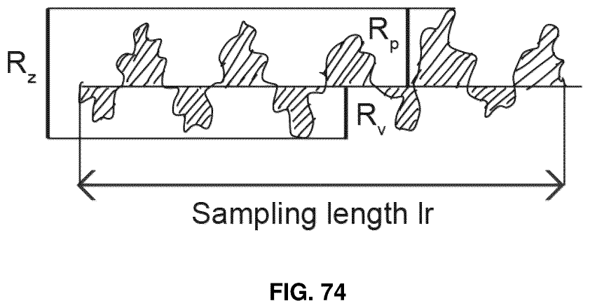

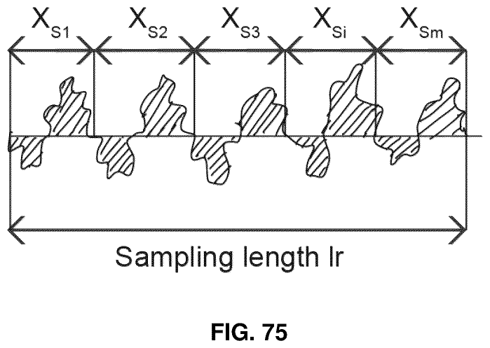

Mechanical results show that Tribonema's superior performance depends on preserving its filamentous network, whereas Chlorella benefits from densification through comminution, a contrast that is directly reflected in the fracture morphologies revealed by various microscopy techniques (FIG. 70-72). Scanning-electron microscopy (FIG. 72) of the fracture surface shows that fracture morphology depends strongly on both algal strain and comminution intensity. Chlorella (left)>the ball-milled specimen at 500× displays a relatively smooth, planar fracture surface through densely packed cell remnants. The higher-resolution (5Kx) image reveals compact, polygonal cell walls that have fractured cleanly with little evidence of pull-out or bridging, consistent with brittle failure. Mortar-and-pestle processing introduces shallow micro-voids and interparticle cracks; at 5Kx these appear as jagged intercellular gaps, suggesting slightly weaker interfacial cohesion. In the speed-mixed sample the fracture plane is the smoothest of the three: the 5Kx image shows tightly fused cell-wall fragments that form a continuous, featureless matrix, in agreement with the higher packing density and modest strength increase observed for speed-mixed Chlorella. For Tribonema (right) the filamentous feedstock produces markedly rougher fracture surfaces. The ball-milled panel (500×) shows layered sheets of compressed filaments; at 5Kx individual cell walls remain elongated, and several filaments bridge the fracture gap, indicating effective load transfer. Mortar-and-pestle treatment retains even more of the native filament architecture: coarse bundles protrude from the surface, and high-magnification images show long fibers pulled part-way out of the matrix, a classic signature of energy-dissipating crack-bridging. Speed mixing, however, shreds the filaments into short, platelet-like fragments. The 500× view is comparatively flat and featureless, while the 5K×image reveals a dense mat of fractured fibrils with micro-cracks propagating along preferred planes—features that coincide with the reduced modulus and strength measured for speed-mixed Tribonema.

These SEM results suggests that gentler comminution (ball mill or mortar-and-pestle) preserves Tribonema's filamentous network, enabling fiber pull-out and enhanced toughness, whereas aggressive speed mixing erodes this advantage and yields a microstructure that resembles the more granular Chlorella matrix. Conversely, Chlorella's spherical particles are largely insensitive to comminution severity; speed mixing simply compacts them into a smoother, denser fracture surface, which helps explain the convergence of mechanical performance between the two algae under high-shear processing. Taken together, these observations link microstructural evolution to bulk mechanical response.

The final mechanical and surface properties of the binder-free biocomposites are dictated by a complex interplay between the intrinsic algal morphology, the chosen comminution route, and the material density. Specifically, gentler methods such as mortar-and-pestle processing, preserve the high-aspect-ratio filamentous microstructure of Tribonema. This method was found to produce samples with superior modulus and generally higher strength, though it also led to the retention of large-scale roughness and limited densification. In contrast, high-shear speed mixing disrupts Tribonema's advantageous fiber network, but for Chlorella, it achieved the finest surface topography and highest density, which boosted its mechanical performance to levels comparable with Tribonema. Thus, this processing-induced inversion of mechanical properties underscored that tuning the comminution method was critical for balancing the preservation of reinforcing microstructures against the maximization of particle packing and interfacial adhesion. See FIGS. 70-72.

### Example 29 Exemplary Workflow for Processing Biomaterials

A skilled person would understand the target mechanical, thermal and/or surface properties of the desired composite and select the component materials and processing methods as outlined in the description as follows:

First, a suitable biomaterial is chosen, selected based on its chemical composition, morphology, desired processing method and cost. For example, a high protein content (>50%) will afford high mechanical stability to the resulting composite so a protein-rich algal biomaterial such as Spirulina is suitable as a starting material. Similarly, an aspect ratio distribution ≥2.0 (indicating a fibrous material) will bring high mechanical stability to the resulting composite, so a filamentous algal biomaterial such as Tribonema or a fibrous plant like tobacco will be suitable as a starting material. Biomaterials with high lipid content (>20%) can be processed into composites in a binder-free manner, as the lipid acts as an internal plasticizer, so lipid-rich algal biomaterials such as Tribonema and Chlorella can be selected for this scenario, with the choice being determined by the resulting desired mechanical properties where the filamentous structure of Tribonema may or may not be required. Likewise, waste products such as wastewater algae or waste plants are of low cost and ready availability, so the starting material may be chosen to satisfy a target composite cost once the desired properties are understood in terms of the starting material composition and morphology.

Next, a series of pre-processing steps are chosen. First, a dehydration step is performed using suitable equipment like a vacuum oven or freeze dryer, to reduce the volume of the biomaterial in the next processing step. A final water content of <15% can be chosen for composites that are produced in a binder-free manner (as these require subsequent rehydration). For composites that blend additional materials or binders for improved mechanical properties, a water content of <5% can be chosen to minimize potential points of failure in the resulting composite.

Second, the dried biomaterial is subjected to size reduction in advance of the composite processing steps. The method of size reduction is chosen based on the desired morphology of the resulting processed biomaterial. If a higher biomaterial aspect ratio distribution (≥1.5) is desired to be retained in the composite, milder methods such as mechanical cutting or pestle-and-mortar grinding are used; such methods will retain e.g. filamentous structures of Tribonema algae or tobacco plant fibers, and will result in larger particle sizes overall, suitable for mechanically-stronger composites. If a biomaterial aspect ratio distribution closer to 1.0 is desired in the composite, more aggressive methods such as speed mixing, planetary mixing and cryogrinding can be used. These will afford processed biomaterials of smaller and more uniform aspect ratios compared to the milder methods, suitable for composites of high density and more-homogeneous surface properties.

Next, additional components may be added to the processed biomaterials based on the desired composite properties. For example, if an extremely mechanically-strong composite is required, additional fibrous fillers may be added such as switchgrass or hemp. Here, the fibrous nature of the filler is selected to match the filamentous morphology of the processed biomaterial, with aspect ratio distribution >1.0. Likewise, if the processed biomaterial has an aspect ratio distribution closer to 1.0 a more spherical filler such as almond shell is selected to match the shape of the processed biomaterial. The biomaterial and filler can be mixed together using any of the mixing methods described above, with care to retain the desired morphology of the components of the mixture (e.g., using milder methods if filamentous and/or fibrous structures are desired).

Subsequently, additional binder can be added to further optimize the properties of the resulting composite. For example, a thermoset such as an epoxy, and a hardener, a tackifier suck as Escorez (Exxon), or a natural binder such as tree sap can be added to improve the adhesion of the components and the resulting composite strength. Similarly, a toughener such as a rubber emulsion can be added to improve the impact resistance, toughness and elastomeric properties of the resulting composite. Alternatively, natural wood products such as hemp and wood flour can be added as stiffeners to increase modulus and stiffness where required.

Finally, the processing steps are selected based on the ingredients and the desired composite properties. For binder-free composites, the biomaterial is first rehydrated to make it processible; depending on the morphology of the processed biomaterial the additional water required can be from 20% (for biomaterials with aspect ratios close to 1.0) to 40% (for biomaterials with filamentous or fibrous structures). Once rehydrated, a pressure molding method such as use of a Carver press is appropriate to form the composite, followed by drying in a desiccator. Alternatively, an extrusion method may be used with subsequent drying step. For composites of highest mechanical strength that include additional fillers and binders, a pressure molding method that includes a heating step and/or a vacuum step can be used to ensure full curing of the binder and enhanced compatibility with the filler. Alternative methods include sheet molding compounding (SMC) whereby the mixture of components is injection molded at high temperature for a short period of time, and vacuum-assisted resin transfer molding (VARTM) whereby preformed composites of biomass with properties equivalent to foam, balsa wood and core inserts could be manufactured and inserted into VARTM fiberglass and carbon fiber prepregs for improved stiffness, weight reduction and reinforcement. End of life usage could also reduce carbon footprint as percentage of biodegradable components would be increased in the final composite structure.

### Example 30 Mechanical Disruption and Processing of Biomaterials

Specific biomaterials have characteristic challenges for initial size reduction. Water content >15% affords soft and tacky biomaterials. Hence, pre-drying algae in a vacuum oven to reduce moisture content is critical to the resultant properties, and can be done in several water evaporation stages before the initial biomaterial is suitable for processing.

First, the biomaterial needs to be dried to an appropriate water content to enable adequate handling and eventual composite properties. From a handling perspective, reduction of initial water content to 15% or below is necessary such that the final volume of the dehydrated biomaterial is appropriately manageable in a selected processing method. From a composite property perspective, reduction of the water content to 10% or even 5% or below is preferred in certain cases where composite mechanical strength is targeted, as the higher the initial water content the lower the eventual strength of the composite.

Some materials can be cryo-milled to fine powders and if the material is covered in dry ice during the milling process it will have to be dried after the dry ice has dissipated and the material is returned to room temperature. Hemp and wood products can be quickly processed this way.

Preprocessing Techniques: Extraction and drying processes can result in agglomeration of the dry wastewater algae. Therefore, three dry pre-processing techniques, speed-mixer, ball-milling, and mortar-and-pestle, were applied to reduce particle size and alter biomass morphology prior to rehydration and compression molding.

For the ball-milling, algae were processed in four cycles of 5 minutes each, with 20-minute intervals between cycles to minimize heating and clumping. The repeated cycles allowed progressive reduction of particle size while reducing thermal buildup that could affect powder uniformity. For the mortar-and-pestle, dry algae were manually ground using a granite mortar-and-pestle. The grinding duration varied by strain due to differences in physical structure. Approximately 15 to 75 minutes of manual grinding were required per 15 grams of algae to achieve the minimum required powder fineness. No rest periods were included during this manual grinding process as the open design of the mortar allowed for constant air circulation. This open design prevented heat and condensation buildup, as opposed to the closed container systems used in the other two preprocessing methods. Following grinding, the entire set of algae powders from all three preprocessing methods were passed through a 40-mesh sieve (424 μm) to ensure no excessively large particles were in the batch before rehydration and molding.

In one embodiment, ultrasonic disruption can be used to break up biomaterial such as algae. Appropriate methods to manage heat generation can be applied. For example, immersion of the biomaterial a liquid phase before an ultrasonic probe can be used, whereby the liquid phase provides to disrupt biomaterials when needed, then separated, drained and dried. In certain cases freeze drying methods may be employed initially after ultrasonic cell disruption.

In another embodiment, a mechanical cutting method can be used to break down larger pieces of biomaterials, for example using scissors, razor blades, or a coffee grinder or similar attrition method.

In further embodiments, biomaterials can be ground using a speed mixer or high-shear mixer.

In other embodiments, the biomaterials are quite thick and tough, requiring initial breakdown via milling using zirconium beads or steel balls by ball milling in steel mixers or grinder mills or planetary mills at room temperature.

In yet other embodiments, grinding of biomaterials can be performed at cryogenic temperatures using pre-chilled biomaterials placed in dry ice powder or liquid nitrogen followed by running through the mill to create an ultrafine powder. Once thawed, the resulting powder can be placed into a vacuum oven for further drying if required.

The desired resulting aspect ratio distribution (ARD) of the pre-processed biomaterial is an important criterion influencing the selection of the pre-processing method, as outlined further in the Description and in the Examples. In general, a desired ARD of >1, or ≥1.5, or ≥2.0 can be achieved by starting with biomaterial with an ARD of >1, or ≥1.5 or ≥2.0 and pre-processing using a milder method that does not substantially disrupt the fundamental shape of the biomaterial cells. Examples of such methods given above include mild ultrasonic treatment, mechanical cutting, speed mixing and high-shear mixing. Example of methods that give significant reduction in ARD include ball milling and cryogenic grinding.

After pre-processing, the resulting biomaterial can be mixed with additives in powder form to create composite mixtures with varying amounts of each additive. Suitable mixing methods include speed mixing, high shear mixing and ball milling. The resulting ARD of the biomaterial in the composite mixture can be affected by the choice of mixing method as outlined above.

Composites can be created using molding techniques and extrusion techniques. For example, a Carver press with pressure capability of 20 tons can be used with piston-type molds by loading the biomaterial composite mixture into the cylindrical mold, placed onto the press and then applying high pressure. Both heated and non-heated presses can be used to mold parts.

In certain aspects, addition of other materials that require heat for binding to the biomaterial requires use of a heated compression and/or vacuum element during the composite formation process. Examples of such additional materials include thermoset polymers such as epoxys, binders such as natural tree sap or thermoplastic materials such as rubbers. Appropriate heat or vacuum treatment of the biomaterial/additive mixture will serve to maximize the resulting composite properties in a rational manner. Adding epoxy as binding agent can be done in room temperature for high pressure molding. Other natural binders can be used such as tree saps. Likewise, adding rubber to the biocomposite matrix enhances toughness of the composite and elasticity. In certain cases, natural rubbers can create processing challenges and can be received as emulsion which may have to be sonicated and precipitated and dried after removal from these emulsions.

### Example 31 Characterization of Dimensional Stability, Thermal Properties, and Genetic Identity of Binder-Free Algal Biocomposites

An experiment was conducted to characterize the dimensional stability, thermal properties, and genetic identity of exemplary binder-free biomaterials. The purpose was to evaluate how the intrinsic morphology of the starting algal feedstock and the selected mechanical comminution method influence the final physical properties of the consolidated biomaterials.

To achieve this purpose, biomaterial panels were fabricated from two distinct algal feedstocks: a wastewater-grown, filamentous alga (Tribonema minus) and a food-grade, unicellular alga (Chlorella vulgaris). Each feedstock was processed using three different comminution methods—ball mill, mortar and pestle, and high-shear speed mixer—before being rehydrated and consolidated into panels via the aqueous plasticization route as described in Example 19. The resulting panels were then subjected to analysis.

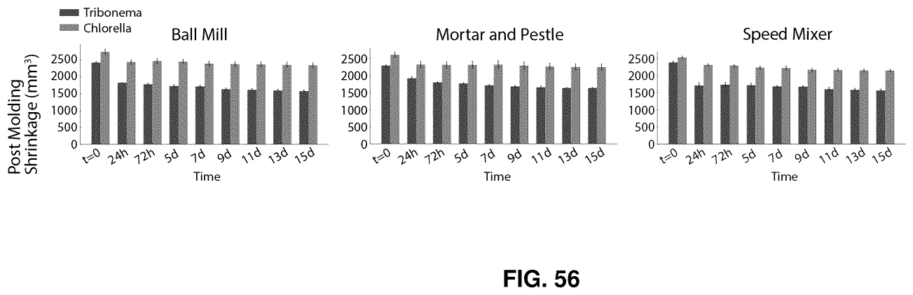

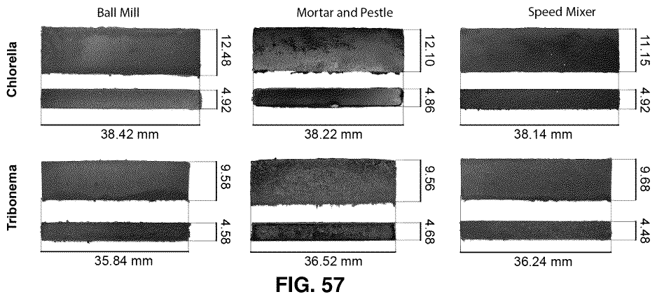

The dimensional stability of the biomaterials during the post-molding drying phase was evaluated by measuring their volumetric shrinkage over a 15-day period of desiccation drying. The results of this analysis are illustrated in FIGS. 56 and 57.

As shown in the chart in FIG. 56, the biomaterials experienced the most rapid shrinkage within the first 72 hours of drying due to water evaporation. The materials derived from the filamentous Tribonema feedstock exhibited significantly more shrinkage, losing 25-30% of their initial volume, compared to only 11-13% for the materials derived from the granular Chlorella feedstock. This difference is attributed to the higher initial water content required to form a moldable paste with the more porous Tribonema powder. FIG. 57 provides representative images of the fully dried panels, visually confirming the final dimensions. For example, after 15 days, ball-milled Chlorella specimens measured 38.4 mm in length, whereas the corresponding Tribonema panels were shorter at 35.8 mm, demonstrating that the initial feedstock morphology directly impacts the dimensional stability of the final product.

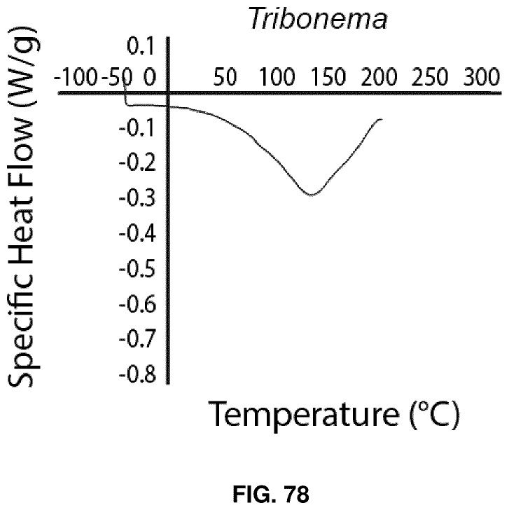

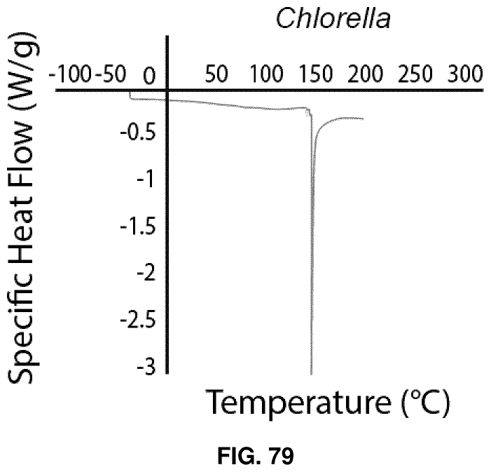

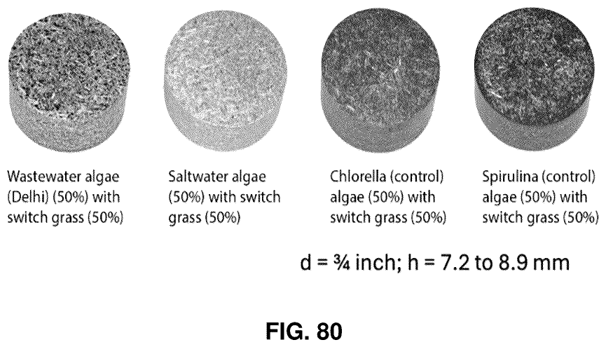

The thermal and genetic properties of the feedstocks were also characterized, with the results shown in FIGS. 76 to 79. The thermal conductivity of the algal powders was measured using a Modified Transient Plane Source (MTPS) method. As shown in FIG. 76, the Tribonema powder demonstrated a slightly higher thermal conductivity (0.094±0.003 W/m·K) compared to the Chlorella powder (0.085±0.002 W/m·K). Both values are low in comparison to conventional polymers, indicating the potential for these materials to be used in thermal insulation applications. The thermal transitions of the powders were examined using Differential Scanning calorimetry (DSC), as shown in FIGS. 78 and 79. For both Tribonema and Chlorella, the thermograms revealed a broad endotherm between approximately 50° C. and 150° C., which is attributed to moisture evaporation, confirming the predominantly amorphous nature of the materials. Finally, the genetic identity of the feedstocks was confirmed using 16S and 18S rRNA gene sequencing, as illustrated in FIG. 77. The analysis confirmed that at the phylum level, the Chlorella sample was dominated by Archaeplastida, whereas the Tribonema sample contained a mixture including Archaeplastida and Cyanobacteriota, with the SAR supergroup being the most abundant. This genetic verification confirms the distinct taxonomic profiles.

Exemplary mechanical disruption and Processing of Biomaterials are further illustrated in Examples 32 to 40

### Example 32 Dehydration Using a Vacuum Oven

Vacuum oven drying was used to remove water. Monitoring water loss was done by pre-weighing material to be dried then bringing into oven or vacuum chamber at room temperature and pulling high vacuum with liquid nitrogen traps attached to vacuum lines while heating oven to at least 80-90C at 30 mmHg. Once heated for several hours, the heat was reduced while still under vacuum and when cooled to room temperature the oven was back-filled with inert gas, after which the powder was transferred to a desiccator until needed.

### Example 33 Ultrasonic Treatment

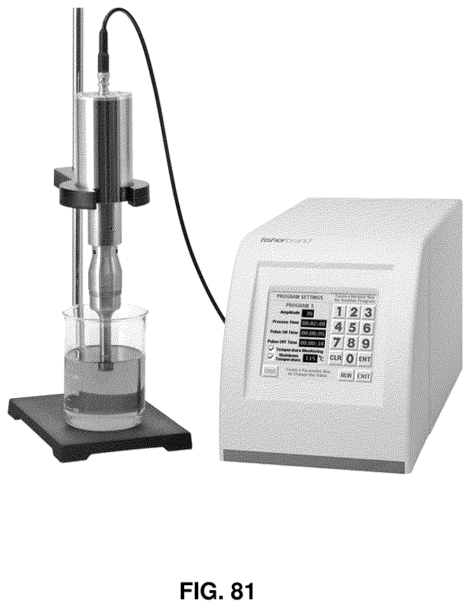

Algae and natural rubber emulsion was sonicated for 5 minutes and then precipitated from excess carrier solution using isopropanol. The material was then dried further before subsequent processing. See FIG. 81.

### Example 34 Planetary Milling

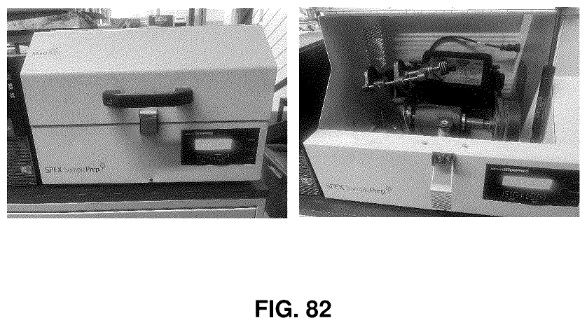

Algae samples were loaded into planetary mill alongside with beads in steel cylinder. Heat was generated quickly and needed to be monitored. To address this, the mill was run in a cycle, 5 minutes on then 10 minutes off to cool down. See FIG. 82.

### Example 35 Speed Mixing

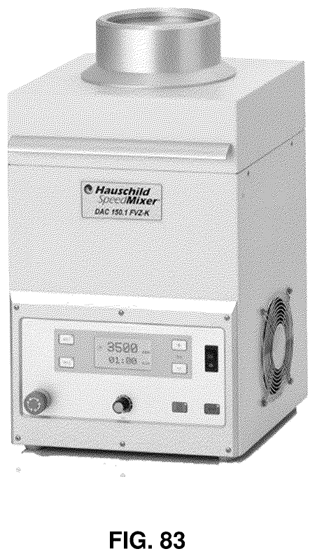

For the speed mixing, biomass was pulverized using a Flacktek 330 speed mixer at 1500 RPM with a 2:1 ratio of algae to yttrium beads (10 g algae to 5 g beads). The biomass was processed for 30 seconds, repeated three times with 20-minute intervals between cycles. These rest periods were included to minimize the buildup of condensation on the inner walls of the container, which likely resulted from frictional heating and the release of residual moisture from the biomass. Intermittent mixing helped reduce clumping and promoted more uniform particle size distributions. See FIG. 83.

### Example 36 Cryomilling

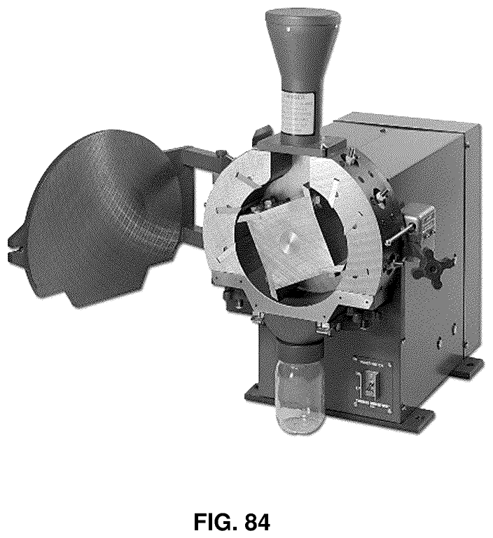

Dry ice powder was run through a hammer mill to pre-chill the blades, and subsequently collected and mixed with biomaterials such as hemp and rigid algae to freeze them. The mixture of dry ice and chilled biomaterial was then added to the hammer mill resulting in a fine powder which was then allowed to warm to room temperature. See FIG. 84.

### Example 37 Compression Molding

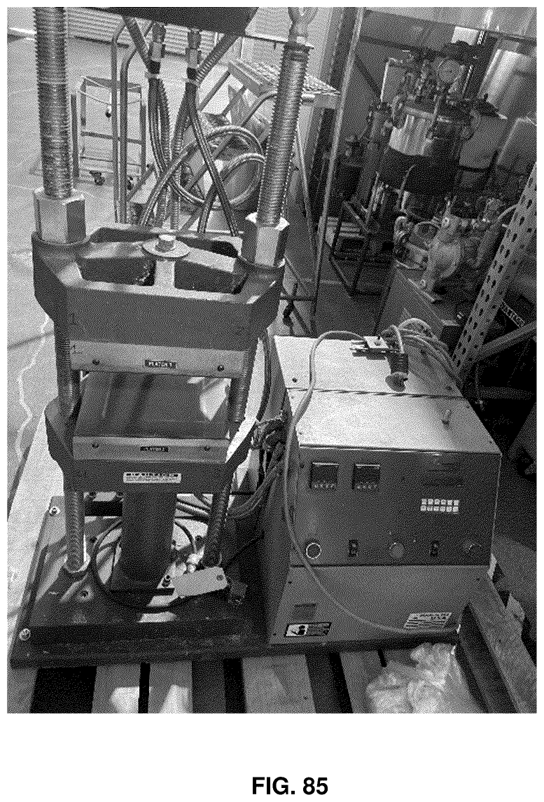

A Carver press with pressure capability of 20 tons was used with piston-type molds by loading the biomaterial composite mixture into the cylindrical mold, placed onto the press and then applying high pressure. See FIG. 85.

### Example 38 Extrusion

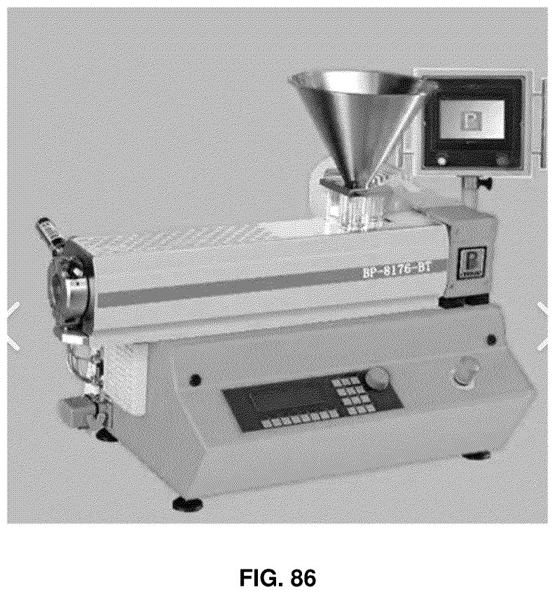

Dried biomaterials were mixed with additives such as rubber in an extrusion hopper and then molded using a single or a twin screw extruder. See FIG. 86.

### Example 39 Compression Tool

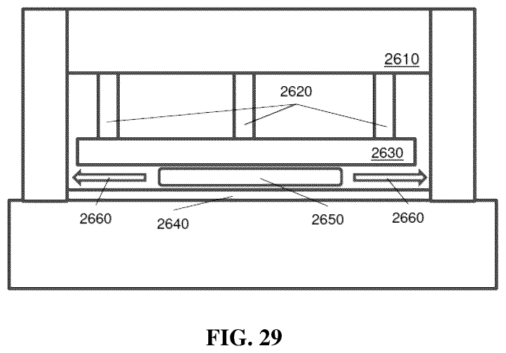

An example of a compression tool used for compression and dehydration is shown in FIG. 29, in the form of a hydraulic hot press. A hydraulic actuator (2610) moves hydraulic pistons/rams (2620) to move a pressure plate (2630) to compress a sample (2650) against a bolster plate (2640). The pressure (controlled by the actuator (2610)) allows water to exit (2660) the sample. The pressure plate (2630) and/or bolster plate (2640) can be heated. The press can also be configured in other orientations, such as where the actuator, pistons, and pressure plate are below the sample and the pressure is applied upwards to a bolster plate above the sample. The sample can include a mold surrounding the material to be pressed, limiting lateral (with respect to the press plates) movement of the material.

The press can include multiple plates stacked vertically such that multiple samples can be pressed at the same time. Those skilled in the art would understand the various press configurations known in the art. In some embodiments, the compression tool is a compression mold. Preferably a compression mold is a porous more preferably an at least 5% porous mold, for example a 15% porous mold. Additional description of how to operate the compression mold in connection with production of biocomposite is described in patent U.S. Pat. No. 11,807,760 having application number U.S. Ser. No. 16/911,269 issued on Nov. 7, 2023 which is incorporate by reference in its entirety.

### Example 40 Grinder

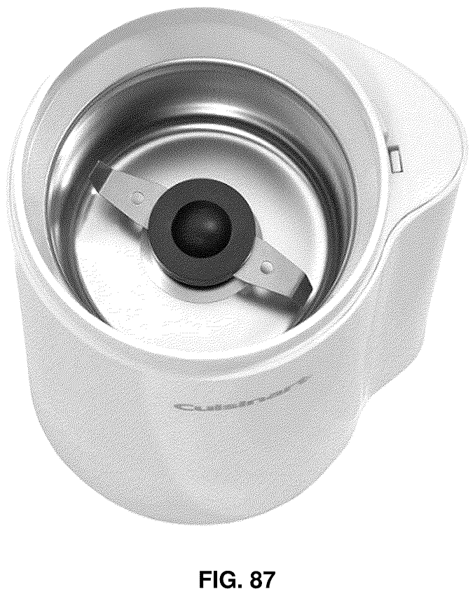

An example of a grinder used to chop/grind algae or fibers is shown in FIG. 87.

In summary, described herein are methods for engineering a tuned biocomposite, engineered bio-powders used therein, and the resulting biocomposite, as well as method for engineering the biopowder and related devices methods and systems The engineered bio-powder comprises discrete particles derived from a dried biomass and is characterized by a specific biochemical composition of protein, lipid, and carbohydrate content, as well as by a controlled particle aspect ratio distribution. The method for engineering the biopowder comprises pulverizing the biomass to achieve a target particle morphology, such as a granular powder for stiffness or a filamentous powder for toughness, and then consolidating the powder via an aqueous plasticization or a thermo-mechanical route. The method for engineering the biopowder and/or to manufacture the biocomposite from the engineered biopowder can include incorporating additives, such as fillers, and applying surface treatments, like a bio-epoxy coating, to engineer interfacial adhesion. The resulting tuned biocomposite is a dense, monolithic, self-adhered body with an anisotropic microstructure, which is engineered to exhibit specific properties including high stiffness, high toughness, high thermal stability, or a hydrophobic barrier function.

The examples set forth above are provided to give those of ordinary skill in the art a complete disclosure and description of how to make and use the embodiments of the engineered biopowder, biocomposites and related compositions, devices, methods and systems of the disclosure, and are not intended to limit the scope of what the Applicants regard as their disclosure. Modifications of the above-described modes for carrying out the disclosure can be used by persons of skill in the art and are intended to be within the scope of the following claims.

The entire disclosure of each document cited (including patents, patent applications, journal articles including related supplemental and/or supporting information sections, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed. Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

When a Markush group or other grouping is used herein, all individual members of the group and all combinations and possible sub-combinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure.

Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations, which is not specifically disclosed herein.

“Optional” or “optionally” means that the subsequently described circumstance can or cannot occur, so that the description includes instances where the circumstance occurs and instances where it does not according to the guidance provided in the present disclosure. Combinations envisioned can be identified in view of the desired features of the device in view of the present disclosure, and in view of the features that result in the formation.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In particular, it will be understood that various modifications may be made without departing from the spirit and scope of the present disclosure. Accordingly, other embodiments are within the scope of the following claim.

### REFERENCES

1. A. K. Mohanty, M. Misra, G. Hinrichsen, Biofibres, biodegradable polymers and biocomposites: An overview. Macromol. Mater. Eng. 276, 1-24 (2000).
2. A. K. Mohanty, S. Vivekanandhan, J.-M. Pin, M. Misra, Composites from renewable and sustainable resources: Challenges and innovations. Science (80). 362, 536-542 (2018).
3. A. K. Mohanty, M. Misra, L. T. Drzal, Natural Fibers, Biopolymers, and Biocomposites (CRC Press, 2005).
4. O. Faruk, A. K. Bledzki, H. P. Fink, M. Sain, Biocomposites reinforced with natural fibers: 2000-2010. Prog. Polym. Sci. 37, 1552-1596 (2012).
5. P. Q. Nguyen, N. M. D. Courchesne, A. Duraj-Thatte, P. Praveschotinunt, N. S. Joshi, Engineered Living Materials: Prospects and Challenges for Using Biological Systems to Direct the Assembly of Smart Materials. Adv. Mater. 30, 1704847 (2018).
6. M. Schaffner, P. A. Rühs, F. Coulter, S. Kilcher, A. R. Studart, 3D printing of bacteria into functional complex materials. Sci. Adv. 3, eaao6804 (2017).
7. P. A. Rühs, F. Storz, Y. A. López Gómez, M. Haug, P. Fischer, 3D bacterial cellulose biofilms formed by foam templating. npj Biofilms Microbiomes 4, 21 (2018).
8. R. A. J. Verlinden, D. J. Hill, M. A. Kenward, C. D. Williams, I. Radecka, Bacterial synthesis of biodegradable polyhydroxyalkanoates. J. Appl. Microbiol. 102, 1437-1449 (2007).
9. M. Haneef, L. Ceseracciu, C. Canale, I. S. Bayer, J. A. Heredia-Guerrero, A. Athanassiou, Advanced Materials from Fungal Mycelium: Fabrication and Tuning of Physical Properties. Sci. Rep. 7, 41292 (2017).
10. L. Valentini, S. B. Bon, S. Signetti, M. Tripathi, E. Iacob, N. M. Pugno, Fermentation based carbon nanotube multifunctional bionic composites. Sci. Rep. 6, 27031 (2016).
11. N. M. Pugno, L. Valentini, Bionicomposites. Nanoscale. 11, 3326-3335 (2019).
12. M. Jones, T. Bhat, E. Kandare, A. Thomas, P. Joseph, C. Dekiwadia, R. Yuen, S. John, J. Ma, C. Wang, Thermal Degradation and Fire Properties of Fungal Mycelium and Mycelium-Biomass Composite Materials. Sci. Rep. 8, 17583 (2018).
13. E. Karana, D. Blauwhoff, E. J. Hultink, S. Camere, When the material grows: A case study on designing (with) mycelium-based materials. Int. J. Des. 12, 119-136 (2018).
14. K. Cerimi, K. C. Akkaya, C. Pohl, B. Schmidt, P. Neubauer, Fungi as source for new bio-based materials: a patent review. Fungal Biol. Biotechnol. 6, 17 (2019).
15. W. Sun, M. Tajvidi, C. G. Hunt, G. McIntyre, D. J. Gardner, Fully Bio-Based Hybrid Composites Made of Wood, Fungal Mycelium and Cellulose Nanofibrils. Sci. Rep. 9, 3766 (2019).
16. L. J. Gibson, The hierarchical structure and mechanics of plant materials. J R Soc Interface. 9, 2749-2766 (2012).
17. J. Song, C. Chen, S. Zhu, M. Zhu, J. Dai, U. Ray, Y. Li, Y. Kuang, Y. Li, N. Quispe, Y. Yao, A. Gong, U. H. Leiste, H. A. Bruck, J. Y. Zhu, A. Vellore, H. Li, M. L. Minus, Z. Jia, A. Martini, T. Li, L. Hu, Processing bulk natural wood into a high-performance structural material. Nature. 554, 224-228 (2018).
18. L. A. Berglund, I. Burgert, Bioinspired Wood Nanotechnology for Functional Materials. Adv. Mater. 30, 1704285 (2018).
19. F. Jiang, T. Li, Y. Li, Y. Zhang, A. Gong, J. Dai, E. Hitz, W. Luo, L. Hu, Wood-Based Nanotechnologies toward Sustainability. Adv. Mater. 4, 1703453 (2018).
20. T. Li, J. Song, X. Zhao, Z. Yang, G. Pastel, S. Xu, C. Jia, J. Dai, C. Chen, A. Gong, F. Jiang, Y. Yao, T. Fan, B. Yang, L. Wågberg, R. Yang, L. Hu, Anisotropic, lightweight, strong, and super thermally insulating nanowood with naturally aligned nanocellulose. Sci. Adv. 4, eaar3724 (2018).
21. L. Berglund, M. Noël, Y. Aitomäki, T. Öman, K. Oksman, Production potential of cellulose nanofibers from industrial residues: Efficiency and nanofiber characteristics. Ind. Crops Prod. 92, 84-92 (2016).
22. T. Nagata, Y. Nemoto, S. Hasezawa, Tobacco BY-2 Cell Line as the “HeLa” Cell in the Cell Biology of Higher Plants. Int. Rev. Cytol. 132, 1-30 (1992).
23. N. Gierlinger, T. Keplinger, M. Harrington, Imaging of plant cell walls by confocal Raman microscopy. Nat. Protoc. 7, 1694-1708 (2012).
24. E. E. Väisänen, A. I. Smeds, K. V. Fagerstedt, T. H. Teeri, S. M. Willför, A. Kärkönen, Coniferyl alcohol hinders the growth of tobacco BY-2 cells and Nicotiana benthamiana seedlings. Planta. 242, 747-760 (2015).
25. J. H. Wiley, R. H. Atalla, Band assignments in the raman spectra of celluloses. Carbohydr. Res. 160, 113-129 (1987).
26. R. J. Moon, A. Martini, J. Nairn, J. Youngblood, A. Martini, J. Nairn, J. Simonsen, J. Youngblood, Cellulose nanomaterials review: structure, properties and nanocomposites. Chem. Soc. Rev. 40, 3941-3994 (2011).
27. R. Arévalo, T. Peijs, Binderless all-cellulose fibreboard from microfibrillated lignocellulosic natural fibres. Compos. Part A Appl. Sci. Manuf. 83, 38-46 (2016).
28. A. Meng, S. Chen, H. Zhou, Y. Long, Y. Zhang, Q. Li, Pyrolysis and simulation of typical components in wastes with macro-TGA. Fuel. 157, 1-8 (2015).
29. J. Li, J. Xu, L. Mo, J. Gong, Z. Xiang, Research on cellulose nanocrystals produced from cellulose sources with various polymorphs. RSC Adv. 7, 33486-33493 (2017).
30. D. J. Cosgrove, Plant cell wall extensibility: Connecting plant cell growth with cell wall structure, mechanics, and the action of wall-modifying enzymes. J. Exp. Bot. 67, 463-476 (2016).
31. L. Valentini, S. Bittolo Bon, N. M. Pugno, Graphene and Carbon Nanotube Auxetic Rubber Bionic Composites with Negative Variation of the Electrical Resistance and Comparison with Their Nonbionic Counterparts. Adv. Funct. Mater. 27, 1606526 (2017).
32. R. Di Giacomo, C. Daraio, B. Maresca, Plant nanobionic materials with a giant temperature response mediated by pectin-Ca2+. Proc. Natl. Acad. Sci. U.S.A 112, 4541-4545 (2015).
33. R. Di Giacomo, B. Maresca, M. Angelillo, G. Landi, A. Leone, M. C. Vaccaro, C. Boit, A. Porta, H. C. Neitzert, Bio-nano-composite materials constructed with single cells and carbon nanotubes: Mechanical, electrical, and optical properties. IEEE Trans. Nanotechnol. 12, 1026-1030 (2013).
34. L. Valentini, S. Bittolo Bon, S. Signetti, N. M. Pugno, Graphene-Based Bionic Composites with Multifunctional and Repairing Properties. ACS Appl. Mater. Interfaces. 8, 7607-7612 (2016).
35. R. Di Giacomo, B. Maresca, A. Porta, P. Sabatino, G. Carapella, H.-C. Neitzert, Candida albicans/MWCNTs: A Stable Conductive Bio-Nanocomposite and Its Temperature-Sensing Properties. IEEE Trans. Nanotechnol. 12, 111-114 (2013).
36. K. G. Satyanarayana, G. G. C. Arizaga, F. Wypych, Biodegradable composites based on lignocellulosic fibers—An overview. Prog. Polym. Sci. 34, 982-1021 (2009).
37. K. Iiyama, T. Lam, B. A. Stone, Covalent Cross-Links in the Cell Wall. Plant Physiol. 104, 315-320 (1994).
38. E. Roumeli, E. Pavlidou, A. Avgeropoulos, G. Vourlias, D. N. D. Bikiaris, K. Chrissafis, Factors Controlling the Enhanced Mechanical and Thermal Properties of Nanodiamond-Reinforced Cross-Linked High Density Polyethylene. J. Phys. Chem. B. 118, 11341-11352 (2014).
39. A. J. Benítez, A. Walther, Cellulose nanofibril nanopapers and bioinspired nanocomposites: a review to understand the mechanical property space. J. Mater. Chem. A. 5, 16003-16024 (2017).
40. Y. C. Hsieh, H. Yano, M. Nogi, S. J. Eichhorn, An estimation of the Young's modulus of bacterial cellulose filaments. Cellulose. 15, 507-513 (2008).
41. D. N. Mastronarde, Automated electron microscope tomography using robust prediction of specimen movements. J. Struct. Biol. 152, 36-51 (2005).
42. D. N. Mastronarde, Correction for non-perpendicularity of beam and tilt axis in tomographic reconstructions with the IMOD package. J. Microsc. 230, 212-217 (2008).
43. I. De Baere, W. Van Paepegem, J. Degrieck, On the design of end tabs for quasi-static and fatigue testing of fibre-reinforced composites. Polym. Compos. 30, 381-390 (2009).
44. H. Wang, D. Wei, A. Zheng, H. Xiao, Soil burial biodegradation of antimicrobial biodegradable PBAT films. Polym. Degrad. Stab. 116, 14-22 (2015).
45. M. Kačuráková, N. Wellner, A. Ebringerová, Z. Hromádková, R. Wilson, P. Belton, Characterisation of xylan-type polysaccharides and associated cell wall components by FT-IR and FT-Raman spectroscopies. Food Hydrocoll. 13, 35-41 (1999).
46. A. Cogulet, P. Blanchet, V. Landry, Wood degradation under UV irradiation: A lignin characterization. J. Photochem. Photobiol. B Biol. 158, 184-191 (2016).
47. K. Schenzel, S. Fischer, NIR FT Raman spectroscopy—A rapid analytical tool for detecting the transformation of cellulose polymorphs. Cellulose. 8, 49-57 (2001).
48. U. P. Agarwal, J. D. McSweeny, S. A. Ralph, FT-raman investigation of milled-wood lignins: Softwood, hardwood, and chemically modified black spruce lignins. J. Wood Chem. Technol. 31, 324-344 (2011).
49. R. Quesada Cabrera, F. Meersman, P. F. McMillan, V. Dmitriev, Nanomechanical and structural properties of native cellulose under compressive stress. Biomacromolecules. 12, 2178-2183 (2011).
50. T. T. Nge, S. H. Lee, T. Endo, Preparation of nanoscale cellulose materials with different morphologies by mechanical treatments and their characterization. Cellulose. 20, 1841-1852 (2013).
51. T. Gubica, A. Temeriusz, K. Paradowska, A. Ostrowski, P. Klimentowska, M. K. Cyrański, Single-crystal and powder X-ray diffraction and solid-state 13C NMR of p-nitrophenyl glycopyranosides, the derivatives of d-galactose, d-glucose, and d-mannose. Carbohydr. Res. 344, 1734-1744 (2009).
52. P. Sarkar, E. Bosneaga, M. Auer, Plant cell walls throughout evolution: Towards a molecular understanding of their design principles. J. Exp. Bot. 60, 3615-3635 (2009).
53. Y. Zeng, M. E. Himmel, S. Y. Ding, Visualizing chemical functionality in plant cell walls Mike Himmel. Biotechnol. Biofuels. 10, 263 (2017).
54. A. C. Balazs, T. Emrick and T. P. Russell (2006) ‘Nanoparticle Polymer Composites: Where Two Small Worlds Meet’, Science, 314 (5802), pp. 1107-1110. Available at: http://www.sciencemag.org/content/314/5802/1107.abstract.
55. Bigall, N. C. et al. (2008) ‘Fungal templates for noble-metal nanoparticles and their application in catalysis’, Angewandte Chemie—International Edition, 47 (41), pp. 7876-7879. doi: 10.1002/anie.200801802.
56. Cosgrove, D. J. (2005) ‘Growth of the plant cell wall’, Nature Reviews Molecular Cell Biology, 6 (11), pp. 850-861. doi: 10.1038/nrm1746.

57 Cosgrove, D. J. (2014) ‘Re-constructing our models of cellulose and primary cell wall assembly’, Current Opinion in Plant Biology. Elsevier Ltd, 22, pp. 122-131. doi: 10.1016/j.pbi.2014.11.001.
58 Gasparovic, L., Korenova, z. and Jelemensky, I. (2010) ‘Kinetic study of wood chips decomposition by TGA’, Chemical Papers, 64 (2), pp. 174-181. doi: 10.2478/s11696-009-0109-4.
59. Gibson, L. J. and Ashby, M. F. (1997) Cellular Solids. Cambridge: Cambridge University Press. doi: 10.1017/CB09781139878326.
60. Hafren, J., Fujino, T. and Itoh, T. (1999) ‘Changes in cell wall architecture of differentiating tracheids of Pinus thunbergii during lignification’, Plant and Cell Physiology, 40 (5), pp. 532-541. doi: 10.1093/oxfordjournals.pcp.a029574.
61. Huang, V. et al. (2019) ‘Conductive Polymer Composites from Renewable Resources: An Overview of Preparation, Properties, and Applications’, Polymers, 11 (2), p. 187. doi: 10.3390/polym11020187.
62. Kinloch, I. A. et al. (2018) ‘Composites with carbon nanotubes and graphene: An outlook’, Science, 362 (6414), pp. 547-553. doi: 10.1126/science.aat7439.
63. Lv, S. et al. (2017) ‘Biodegradation behavior and modelling of soil burial effect on degradation rate of PLA blended with starch and wood flour’, Colloids and Surfaces B: Biointerfaces. Elsevier B.V., 159, pp. 800-808. doi: 10.1016/j.colsurfb.2017.08.056.
64. Mccann, M. C., Wells, B. and Roberts, K. (1990) Direct visualization of cross-links in the primary plant cell wall.
65. Mendu, V. et al. (2011) ‘Identification and thermochemical analysis of high-lignin feedstocks for biofuel and biochemical production’, Biotechnology for Biofuels, 4 (October). doi: 10.1186/1754-6834-4-43.
66. Okubo-Kurihara, E. et al. (2016) ‘Modification of plant cell wall structure accompanied by enhancement of saccharification efficiency using a chemical, lasalocid sodium’, Scientific Reports, 6 (1), p. 34602. doi: 10.1038/srep34602.
67. Pugno, N. M. and Valentini, L. (2019) ‘Bionicomposites’, Nanoscale, 11 (7), pp. 3102-3111. doi: 10.1039/C8NR08569B.
68. Turku, I. et al. (2017) ‘Characterization of wood plastic composites manufactured from recycled plastic blends’, Composite Structures, 161, pp. 469-476. doi: 10.1016/j.compstruct.2016.11.073.
69. Zhang, T., Zheng, Y. and Cosgrove, D. J. (2016) ‘Spatial organization of cellulose microfibrils and matrix polysaccharides in primary plant cell walls as imaged by multichannel atomic force microscopy’, Plant Journal. doi: 10.1111/tpj.13102.
70. Zhu, H. et al. (2016) ‘Wood-Derived Materials for Green Electronics, Biological Devices, and Energy Applications’, Chemical Reviews, 116 (16), pp. 9305-9374. doi: 10.1021/acs.chemrev.6b00225.
71. H. Herzog, D. Golomb, Encyclopedia of Energy 1:1-11 (2004)
72. Kock-Yee Law, “Definitions for Hydrophilicity, Hydrophobicity, and Superhydrophobicity: Getting the Basics Right,” J. Phys. Chem. Lett. 2014, 5, 686-688
73. Hyun-Ju Hwang, Yong Tae Kim, Nam Seon Kang, Jong Won Han A Simple Method for Removal of the Chlamydomonas Reinhardtii Cell Wall Using a Commercially Available Subtilisin (Alcalase) J Mol Microbiol Biotechnol. 2018; 28 (4): 169-178. And
74. Jurgen Voigt DagmarWrannHans-PeterVogeler Wilfried A. König Marianne Mix Hydroxyproline-containing and glycine-rich cell wall polypeptides are widespread in the green algae Microbiological Research, Volume 149, Issue 3, September 1994, Pages 223-229
75. Paul-Hubert Baudelet ^{a}GuillaumeRicochon ^{b}MichelLinder^{a} LionelMuniglia A new insight into cell walls of Chlorophyta Algal Research Volume 25, July 2017, Pages 333-371
76. Viridiplantae and Algae. Malcolm A. O'Neill, Alan G. Darvill, Marilynn E. Etzler, Debra Mohnen, and Serge Perez 2015-2017 by The Consortium of Glycobiology Editors, La Jolla, California.

77 B. Liu and A. B. Koc, “Mechanical properties of switchgrass and miscanthus,” Transactions of the ASABE, vol. 60, no. 3, pp. 581-590, 2017, doi: 10.13031/trans. 11925]
78 D. P. Pfister and R. C. Larock, “Green composites using switchgrass as a reinforcement for a conjugated linseed oil-based resin,” J of Applied Polymer Sci, vol. 127, no. 3, pp. 1921-1928 February 2013, doi: 10.1002/app.37536.]

1.-90. (canceled)

91. An engineered bio-powder for fabricating a tuned bio-composite, the bio-powder comprising a plurality of discrete particles derived from a feedstock biomass, wherein the engineered bio-powder has a composition comprising:
a) a powder protein content, a powder lipid content, and a powder carbohydrate content, wherein each content is a percentage of the dry weight of the particles;
b) a powder aspect ratio distribution; and
c) a mean particle volume ranging from 1.0×10\hat{ }2 μm\hat{ }3 to 1.0×10\hat{ }7 μm\hat{ }3;
wherein the composition is configured to fabricate a tuned bio-composite having at least one tunable property selected from a mechanical property, thermal stability, and a barrier function; and
wherein the plurality of discrete particles comprises particles with a granular morphology, particles with a filamentous morphology, or a combination thereof, and has a powder aspect ratio and distribution selected based on the at least one tunable property of the tuned bio-composite to be manufactured.

92. The engineered bio-powder of claim 91, wherein the plurality of discrete particles comprises particles with the granular morphology, and wherein greater than 90% of the discrete particles have an aspect ratio of less than 1.5.

93. The engineered bio-powder of claim 91, wherein the plurality of discrete particles comprises particles with the filamentous morphology, and wherein at least 10% of the discrete particles have an aspect ratio of 2.0 or greater.

94. The engineered bio-powder of claim 91, wherein the plurality of discrete particles comprises particles with the granular morphology and particles with the filamentous morphology wherein no more than 5% of the discrete particles have an aspect ratio greater than 5.0.

95. The engineered bio-powder of claim 91, wherein the feedstock biomass comprises algal cells, and wherein the mean particle volume ranges from 1.0×10\hat{ }3 μm\hat{ }3 to 1.0×10\hat{ }6 μm\hat{ }3.

96. The engineered bio-powder of claim 91, wherein the composition comprises an initial water content of less than 15% by weight.

97. The engineered bio-powder of claim 91, wherein the composition comprises a powder protein content from 40% to 70% by dry weight, a powder lipid content from 5% to 65% by dry weight, and a powder carbohydrate content from 25% to 40% by dry weight.

98. The engineered bio-powder of claim 91, wherein the powder protein content is from 50% to 70% by dry weight, and wherein greater than 90% of the discrete particles have an aspect ratio of less than 1.5.

99. The engineered bio-powder of claim 91, wherein the powder lipid content is less than 15% by dry weight, minimizing hydrophobic interference with a hydrogen-bond network, and wherein at least 10% of the discrete particles have an aspect ratio of 2.0 or greater.

100. The engineered bio-powder of claim 91, wherein the feedstock biomass comprises a mixed-strain microbial community, and wherein the engineered bio-powder is configured to fabricate a tuned bio-composite having a hydrophobic surface with a static water contact angle of greater than 100 degrees.

101. The engineered bio-powder of claim 91, wherein the biological feedstock comprises a single-strain culture.

102. The engineered bio-powder of claim 91, wherein the powder protein content and the powder carbohydrate content provide hydrophilic biopolymers on surfaces of the discrete particles, wherein the hydrophilic biopolymers are configured to self-adhere the discrete particles into a binder-free monolithic body via a hydrogen-bond network.

103. The engineered bio-powder of claim 91, further comprising an additive selected from the group consisting of cellulose, hydroxyethyl cellulose, and combinations thereof.

104. The engineered bio-powder of claim 91, further comprising a non-reactive bulk modifier acting as a plasticizer selected from the group consisting of glycerol, urea, triethyl citrate, and combinations thereof.

105. The engineered bio-powder of claim 91, further comprising a reactive bulk modifier acting as a cross-linking agent selected from the group consisting of glutaraldehyde, epichlorohydrin, citric acid, and combinations thereof.

106. The engineered bio-powder of claim 91, wherein the discrete particles have been chemically modified by a surface treatment selected from the group consisting of an alkali treatment, silanization, acylation, an isocyanate treatment, and a plasma treatment.

107. A method for coating the engineered bio-powder of claim 91 to improve interfacial resistance, the method comprising:
a) providing the engineered bio-powder;
b) preparing a coating solution comprising an epoxy resin and a hardener dissolved in a solvent;
c) applying the coating solution to the engineered bio-powder to form a coated engineered bio-powder; and
d) drying the coated engineered bio-powder to remove the solvent.

108. A coated engineered bio-powder comprising:
the engineered bio-powder of claim 91 coated with a dried layer of an epoxy system comprising an epoxy resin and a hardener.

109. A coated particle composition for fabricating a tuned bio-composite, the composition comprising:
the coated engineered bio-powder of claim 108; and
a filler;
wherein the filler is coated with the dried layer of the epoxy system.

110. The coated particle composition of claim 109, wherein the filler comprises particles derived from an agricultural residue selected from the group consisting of switchgrass, corn stover, almond shells, pine, and combinations thereof.

111. The coated engineered bio-powder of claim 108, wherein the epoxy resin is selected from the group consisting of a bio-based epoxy resin, poly(bisphenol A-co-epichlorohydrin) glycidyl end-capped, bisphenol A diglycidyl ether, poly(ethylene glycol) diglycidyl ether, and mixtures thereof, and wherein the hardener is selected from the group consisting of a bio-based hardener, dicyandiamide, an amine, an anhydride, poly(ethylene glycol) bis(carboxymethyl) ether, tetraethylenepentamine, and mixtures thereof.

112. A method for fabricating a tuned bio-composite using an aqueous plasticization route, the method comprising:
a) providing the engineered bio-powder of claim 91;
b) rehydrating the engineered bio-powder with a predetermined amount of water to form a plasticized, moldable paste;
c) compressing the moldable paste at a temperature below 100 degrees C. to consolidate particles of the paste into a monolithic body; and
d) desiccating the monolithic body to remove the water, causing formation of hydrogen bonds between adjacent particle surfaces.

113. The method of claim 112, wherein the predetermined amount of water is between 20% and 40% by weight of the engineered bio-powder.

114. The method of claim 112, wherein the compressing is performed in a porous mold configured to allow for egress of water from the moldable paste.

115. A method for fabricating a tuned bio-composite using a thermo-mechanical route, the method comprising:
a) providing the engineered bio-powder of claim 91; and
b) consolidating the engineered bio-powder into a monolithic body by extrusion, injection molding, or compression molding under a mechanical pressure of at least 25 MPa and at a selected temperature.

116. The method of claim 115, further comprising blending the engineered bio-powder with a dry filler to form a blended powder prior to consolidation.

117. The method of claim 115, wherein the selected temperature is an elevated temperature of at least 85 degrees C.

118. The method of claim 117, wherein the elevated temperature is in a range from 170 degrees C. to 185 degrees C.

119. The method of claim 115, wherein the mechanical pressure is in a range from 25 MPa to 227 MPa.

120. A tuned bio-composite, comprising:
a monolithic body comprising the engineered bio-powder of claim 91,
wherein the discrete, multi-cell particles are consolidated and self-adhered to one another at interfacial boundaries, wherein the monolithic body has a water content of less than 15 wt % and detectable pores with a diameter of less than 10 micrometers.

121. The tuned bio-composite of claim 120, wherein the monolithic body has a density between 0.89 and 1.41 g/cm\hat{ }3.

122. The tuned bio-composite of claim 120, wherein the monolithic body has an anisotropic, layered microstructure wherein the consolidated particles are flattened and aligned substantially perpendicular to an axis of compression.

123. The tuned bio-composite of claim 120, wherein the discrete particles are derived from a mixed-strain microbial community and the barrier function is characterized by a hydrophobic surface with a static water contact angle of greater than 100 degrees.

124. The tuned bio-composite of claim 120, having a mechanical property characterized by a Flexural Strength of greater than 10 MPa.

125. The tuned bio-composite of claim 120, having a mechanical property characterized by a Young's Modulus of greater than 900 MPa and a Compressive Strength of greater than 100 MPa.
